(19) United States
(12) Patent Application Publication
(10) Pub. No.: US 2003/0145310 A1
(43) Pub. Date: Jul. 31, 2003

(54) Computer memory structure for storing original source information and associated interpretative information

(75) Inventors: Joseph M. Thames, Saratoga, CA (US); Steven W. Duckett, Klawock, AK (US)

Correspondence Address: Forrest Gunnison, Gunnison, McKay & Hodgson, L.L.P., 1900 Garden Road, Suite 220, Monterey, CA, 93940, US

(73) Assignee: Metacyber. Net.

(21) Appl. No.: 10/150,803

(22) Filed: May 17, 2002

Related U.S. Application Data
(60) Provisional application No. 60/335,250, filed on Oct. 31, 2001.

(51) Int. Cl. G06F 9/44; G06F 15/00

(52) U.S. Cl. 717/123; 715/513; 715/501.1; 715/524

(57) ABSTRACT

A computer memory having stored therein a structure including a metatree. The metatree includes: a root directory for a module in a computer program source file; a patch subdirectory in the root directory; a patch file in the patch subdirectory where the patch file includes original source code of one patch in the module; a symbol reference statistics file in the patch subdirectory where the symbol reference statistics file comprises symbol reference statistics data for name symbols referring to elements of the patch; a generic annotation file in the patch subdirectory where the generic annotation file includes auto-generically generated interpretative information for the patch; an application specific annotation file in the patch subdirectory where the application specific annotation file includes specific interpretative information for the patch; and a set of scope subdirectories in the patch subdirectory where each scope subdirectory in the set is defined by a namespace for a set of name symbols.

### RELATED APPLICATIONS

This application claims the benefit of U.S. Provisional Application No. 60/335,250 filed Oct. 31 2001, entitled “Computer-based Structures and Methods for Generating, Maintaining, and Modifying a Source Document and Related Documentation” and naming Joseph M. Thames and Steven W. Duckett, as inventors, which is incorporated herein by reference in its entirety.

### BACKGROUND OF THE INVENTION

1. Field of the Invention

The present invention relates generally to documenting information, and more particularly to the automatic generation of documentation for complex detailed information such as computer program source code.

2. Description of Related Art

Over the last twenty years, the quest for software reusability has created a revolution in software architecture-the object-oriented software paradigm. However, this paradigm achieved reusability at the expense of complicating software development, and greatly increasing the effort needed to maintain and upgrade software. This is a serious and widespread problem, since it is estimated that over one million people are involved in software maintenance in the U.S. (Capers Jones, Software Assessments, Benchmarks and Best Practices, Addison-Weseley 2000)

The tools currently being used for software maintenance are essentially the same tools used for development (editors, debuggers, etc.) and are not optimum for maintenance, where the major problem is understanding the old code by people who were generally not the original developers of that code. This understanding may be further hampered by poor comments in the code, or comments that are out of synchronization with the present code because of other efforts to maintain or modify the original code.

It is well known that program documentation is always lowest priority in development, and programmers are notoriously lax in documentation preparation. Moreover, even with good initial documentation, there is hardly ever any means for its maintenance during later modification of the software. This results in serious costs for companies that rely on temporary programming consultants managed by user-peers (non-programmers), a practice that is prevalent even in high-tech companies. Lack of documentation results in highly paid hourly consultants having to spend many hours researching the code to troubleshoot problems and devise solutions. This is further hampered by the fact that the user-peers that manage the consultants usually have no understanding of the code, except from its meager documentation. Moreover, old documentation that has not been updated to keep up with the flow of modifications engenders confusion to the consultants, often misleading them into incorrect fixes that have to be fixed again.

Another basic problem is the level of documentation provided. Typically, documentation for computer program source code is a one-size-fits-all tautological document with information that is too general (and often too circular) about what one wants to know for a specific case, embedded in a whole lot of other irrelevant verbiage which is distracting at best. Consequently, even the best of documentation usually gets unused.

The present situation, where most of the tools used for maintenance are development tools that are inefficient for maintenance, is further complicated by lack of a unified interface that combines all the tools into an easy-to-use system. Faced with a hodge-podge of tools and user-interfaces, most maintainers of software do a minimum, poorly documented, job with one or two tools that they have mastered, thus making the job even harder for the next group of maintainers.

### SUMMARY OF THE INVENTION

One embodiment of the present invention includes a system that in turn includes a plurality of novel structures and methods that utilize a cradle structure that includes at least one metatree. In one embodiment, the novel structures and methods in the system include (a) a cradle structure that includes at least one metatree; (b) a method and apparatus for generating the at least one metatree; (c) a method and apparatus for generating rapid comprehension source documentation using the information stored in the at least one metatree; (d) the rapid comprehension source documentation; (e) an interface for displaying the rapid comprehension source documentation; (f) a web annotator for supplementing information in the rapid comprehension source documentation that in turn is stored in the at least one metatree; (g) a revision control system that requires lockstep documentation for any modification to the information in the at least one metatree; (h) a webpage composer utilizing the at least one metatree in combination with the method and apparatus for generating a metatree and optionally the revision control system; and (i) a testing and verification manager for use with metatrees in the cradle structure.

Various combinations of these structures and method can be used to create a wide-variety of new apparatuses and methods.

### (A) CRADLE STRUCTURE THAT INCLUDES AT LEAST ONE METATREE

According to one embodiment of the present invention, a non-volatile computer memory includes a cradle file system that in turn includes at least one metatree. The metatree stores original input information, such as a computer program source module file, and interpretative information that permits users with varying degrees of knowledge to understand the original input information at their particular level of knowledge. The metatree comprises a memory-resident structure that in turn comprises a plurality of key-indexed memory structures. The key-indexed memory structures include a plurality of patch directories where each patch directory includes (i) a patch file where each patch file includes a different portion of the input information so that an assemblage of a plurality of patch files in the metatree provides the original input information, and (ii) for each patch file (a) a symbol reference generic annotation statistics file that includes statistics for every name symbol reference in the patch file (b) an auto-annotation text file where the auto-annotation text file includes a plurality of generic annotations where each generic annotation is an automatically translated text description of a sub-unit of the information in the corresponding patch file (e.g., a line of the computer program source module file) or an adaptation of comments appearing in the source text, and (c) a manual annotation text file that includes a plurality of specific descriptions of features in the input information acquired through the web annotator.

The metatree further includes a set of scope subdirectories for each patch directory. Each scope subdirectory is defined by a namespace for a set of resident name symbols and associated symbol referents (variables, functions, etc.), which are accessible during software execution only within the scope of the namespace. Within each scope subdirectory is a plurality of files, each named for a name symbol (and its associated symbol referent) resident in the scope; each contains attributes of the symbol referent, including its type, storage class, dimension, etc.; and each file also contains a plurality of keys to the statistics of all references to the name symbol occurring throughout the program module.

In some embodiments, the original input information includes information that is associated with a plurality of metatrees in the cradle file system (e.g., a computer application that includes global variables used in various modules that are each represented by a different metatree) as described above. In this embodiment, the cradle file system further includes a global metatree that in turn includes a plurality of files and a subdirectory for each of the other different metatrees. The plurality of files includes a file named for each global name symbol that includes the symbol referent type and the metatree name in which the global name symbol is allocated. The subdirectories include files that define statistics and keys for reference to the global name symbols in a particular metatree.

### (B) A METHOD AND APPARATUS FOR GENERATING A METATREE

In one embodiment of the method and apparatus for generating a metatree, as described above, a computer program is executed on a processing unit that results in a source code adapter structure for, and a method including (i) a source code patching process; (ii) a parsing and data assimilation process; (iii) and an explode process that includes an interleaved explode module data into cradle metatree process and an add external data cradle global metatree process for each module in the input information.

A source code adapter operation contains a loop to process each source code module file in a program. The loop includes a source-code patching operation which partitions each module file into patches. Each patch includes an external container patch representing the outer context of the module file, and one or more internal patches, representing operating functions (subroutines) or markup containers. The partitioning is followed by the parsing and data assimilation operation that generates a plurality of hashes and then the explode operation, which explodes the hashes and writes module data into a metatree file set in the cradle file system. A further sub-process of the explode operation adds external data, common to all modules, to a global metatree in the cradle file system.

Execution of a patcher program generates the source code patching process. The source code patching process includes a non-linear scan of the input information that partitions the input information into patches, which are display units in the rapid comprehension document. If the source code includes preprocessor directives for conditional compilation, two kinds of metatrees can be generated: (a) undifferentiated metatrees which contain the conditional compilation directives, thereby retaining indeterminate ambiguity, but including the complete original text of a module file; and (b) differentiated metatrees, sometimes called diversion metatrees, in which the conditions of the conditional compilation directives are evaluated, resulting in a reduction of the undifferentiated text to an incomplete form in which the ambiguity and indeterminism are removed.

The internal patches resulting from a diversion of the original source code identically correspond to functions (subroutines) and other program containers or markup language containers, however; undifferentiated patches can span conditionally compiled program parts.

In partitioning module files for undifferentiated metatrees, the source code patching process first accumulates all conditional compilation directive cell groups and then locates function body blocks contained in each directive cell group. If a function body block is fully contained in one of the directive cell groups, the function body block is defined as a patch. If the function body block is not fully contained in one of the directive cell groups, a patch is defined that includes the function body block but has a beginning or an ending that matches a boundary of one of the directive cell groups thus extending the patch beyond the boundaries of the function.

In partitioning module files for diversion metatrees, the conditional compilation cells are removed by a pre-processing pass, which evaluates the conditional compilation cells. In this case, patches identically correspond to function definitions, or other program or markup containers. When all the patches are defined, two patch definition hashes are generated, a first for use in the parsing and data assimilation process and a second for use in the explode process that includes an interleaved explode module data into cradle metatree process and an add external data cradle global metatree process for each module in the input information.

In one embodiment of the parsing and data assimilation operation, a parse, scan and statement translation parser performs one of a plurality of data assimilation sub-processes in response to a corresponding recognition and translation event in a plurality of recognition and translation events. The sub-processes generate information that is stored in hashes. Each recognition event and the corresponding data assimilation sub-process are included in either an auto-generic recognition and identification process, an auto-generic statement code to prose/pseudocode translation process, or an auto-specific comment-translation process.

The recognition events included in one embodiment of the auto-generic recognition and identification process are a start of patch event, an end of patch event, a symbol declaration event, and a symbol reference event. The recognition events included in the statement code-to-prose/pseudocode translation process, in this embodiment, are a back-reference link event translation, an external-reference link event translation, and a no-link event translation. In this embodiment, the recognition event included in auto-specific comment-translation process is a comment translation event.

The start of patch event and the end of patch event invoke sub-processes that result in an entry being generated in a patch definition hash that includes the patch name and the text contained in the patch. The symbol declaration event invokes a symbol declaration data assimilation sub-process that in turn generates an entry in a symbol hash that includes a name of the name symbol, a scope of the name symbol and a reference key into a symbol reference statistics hash. In one embodiment, the name and scope are keys into the symbol hash. The name symbol data type (integer, floating point, etc.), storage class (static, external, automatic, etc.), and symbol category (scalar, array, struct, enum, union, function, macro, etc.) are also stored with the symbol entry. The symbol reference event invokes a symbol reference data assimilation sub-process that in turn writes characterizing information for the name symbol reference in the appropriate entry in the symbol reference statistics hash, and a key to this statistics entry in the symbol hash.

The back-reference link event invokes a generate back reference link annotation sub-process that in turn invokes a footnote data assimilation sub-process. The external-reference link event invokes a generate external reference link annotation sub-process that in turn invokes the footnote data assimilation sub-process. The no-link event invokes the footnote data assimilation sub-process. The footnote data assimilation process generates an entry in an annotation hash that contains a footnote display entry. One example of a footnote display entry is a translation of source code statements and phrases into prose/pseudocode descriptions. Hence, the data assimilation sub-processes result in information stored into hashes in a patch-hatch buffer memory.

The explode process makes the data in the hashes persistent by generating the data files comprising the metatree. Upon completion of the explode process, the original computer source code module is stored in a form, i.e., a metatree in the cradle file system so that rapid source code documentation can be generated using the hypertext page generator described below, and so that the original module can be recreated for revision using the information maintenance controller, as described below.

Thus, in one embodiment of the invention, a computer-based method for converting source information into a hierarchical memory structure includes:

converting the source information into a memory-resident aggregate database including (i) the source information, and (ii) at least one auto-generic annotation for the source information, wherein the at least one auto-generic annotation was automatically assimilated from the characteristics of information in the source information; and

exploding the memory-resident aggregate database into the hierarchical memory structure.

A source information adapter includes:

a memory;

an information patcher coupled to the memory wherein the information patcher generates a line patches hash containing information characterizing at least one patch from source information in the memory; and

a parser-hasher coupled to the memory to access the line patches hash, wherein the parser-hasher converts the source information into a memory-resident aggregate database including (i) the source information, and (ii) at least one auto-generic annotation for the source information, and further wherein the at least one auto-generic annotation was automatically assimilated from the characteristics of information in the source information.

In another embodiment, a source information adapter includes:

a memory;

an information patcher coupled to the memory wherein the information patcher generates a line patches hash, containing information characterizing at least one patch from source information, in the memory; and

a parser-hasher coupled to the memory to access the line patches hash, wherein the parser-hasher parses the at least one patch and generates (i) a symbol hash including a symbol name of a name symbol and (ii) an annotation hash containing an auto-generic annotation associated with the name symbol.

Still another feature of this embodiment is a computer program product including computer program code wherein execution of the computer program code results in a method for converting source information into a hierarchical memory structure comprising:

converting the source information into a memory-resident aggregate database including (i) the source information, and (ii) at least one auto-generic annotation for the source information, wherein the at least one auto-generic annotation was automatically assimilated from the characteristics of information in the source information; and

exploding the memory-resident aggregate database into the hierarchical memory structure.

One method utilized by the source information adapter, in one embodiment, includes a computer-based method for defining a patch in computer source code including conditional compilation cell groups, the method including:

selecting a conditional compilation cell group;

locating a pre-defined computer source code block relative to the conditional compilation cell group wherein the pre-defined computer source code block comprises a block end and a heading;

determining whether both the heading and the block end are contained within the conditional compilation cell group; and

defining a patch as the pre-defined computer source code block upon determining that both the heading and the block end are contained within the conditional compilation cell group.

A structure used to implement this method includes:

means for selecting a conditional compilation cell group;

means for locating a pre-defined computer source code block relative to the conditional compilation cell group wherein the pre-defined computer source code block comprises a block end and a heading;

means for determining whether both the heading and the block end are contained within the conditional compilation cell group; and

means for defining a patch as the pre-defined computer source code block upon determining that both the heading and the block end are contained within the conditional compilation cell group.

Still yet another method utilized in another embodiment of the source code adapter is a computer-based method for parsing and hashing source information comprising a combined grammar to create documentation for the source information, the computer-based method comprising:

processing lines of the source information written using a first grammar with a first parser-hasher to generate annotations for the information written using the first grammar; and

processing lines of the source information written using a second grammar with a second parser-hasher different from the first parser-hasher to generate annotations for source information written using the second grammar.

A structure used to implement this method, in one embodiment, includes:

means for processing lines of the source information written using a first grammar with a first parser-hasher to generate annotations for the source information written using the first grammar; and

means for processing lines of the source information written using a second grammar with a second parser-hasher different from the first parser-hasher to generate annotations for the source information written using the second grammar.

### (C) A METHOD AND APPARATUS FOR GENERATING RAPID COMPREHENSION SOURCE DOCUMENTATION USING THE INFORMATION STORED IN AT LEAST ONE METATREE

In one embodiment, a hypertext page generator creates a plurality of webpages making up the rapid comprehension source documentation using information stored in a metatree or metatrees in the cradle file system. The hypertext page generator first creates a program menu webpage file for a particular source code program in the cradle file system. Next, for each metatree in the cradle file system for the particular source code program, the hypertext page generator aggregates the data in the cradle file system for the metatree including data in the global metatree and then for each patch in the metatree generates a patch code frame webpage and a patch heading frame webpage. After all the webpages for the patches are generated, the hypertext page generator generates a sidebar menu frame webpage for each name symbol in the metatree. These operations are repeated for each metatree, i.e., each module in the source code program. The result is a plurality of webpages that make up the rapid comprehension source documentation according to one embodiment of the present invention. Advantageously, the data in the cradle file systems is stored in a form that when aggregated, the aggregated data is in a form that is convertible to tagged-language webpages by the hypertext page generator. In particular, a unique keys system is used that facilitates generating the webpages with the various annotations and links.

Thus, in one embodiment, this structure includes:

a memory-based metatree wherein the memory-based metatree stores data, including (i) source information and (ii) annotations for the source information, in a hierarchical structure;

a memory, coupled to memory-based metatree, having stored therein a plurality of hashes wherein the plurality of hashes store information including the source information and the annotations for the source information; and

a hypertext page generator coupled to the memory wherein the hypertext page generator uses the information stored in the plurality of hashes to generate memory-based rapid comprehension documentation for the source information.

A computer-based method for generating memory-based documentation for source information includes:

aggregating data, from a memory-based metatree storing the source information and annotations for the source information, into a plurality of hashes in a memory;

generating a patch data webpage using data in the plurality of hashes wherein the patch data webpage comprises:

at least a portion of a patch in the source information;

a plurality of annotation trigger symbols; and

a plurality of annotations for information in the at least the portion of the patch,

wherein each annotation in the plurality of annotations is associated with a different one of the plurality of annotation trigger symbols; and

at least one annotation in the plurality of annotations is an auto-generic annotation that was automatically assimilated from characteristics of the information in the at least the portion of the patch.

A computer program product includes computer program code where execution of the computer program code results in this method for generating memory-based documentation for source information.

### (D) RAPID COMPREHENSION SOURCE DOCUMENTATION

A computer memory based rapid comprehension source documentation for a computer program code source module includes, in one embodiment, (1) program-flow emulation by hypertext linkage; (2) auto-generic footnote annotation that was assimilated from the characteristics of the programming language via code-to prose/pseudocode translation; and (3) name symbol, e.g., variable, type/scope analysis and cross-reference linking. In addition, application-specific footnote annotation, subtitle descriptions, and synopsis information to more completely flesh out the source code documentation are included.

The rapid comprehension source code documentation, in this embodiment, includes four different layers, a menu layer, an executive synopsis layer, a source code to prose/pseudocode description and annotation layer, and pre-formatted source code layer. The combination of the menu layer and the executive synopsis layer form an executive rapid comprehension document. The combination of the executive synopsis layer and the source code to prose/pseudocode description and annotation layer form a user-peer technician rapid comprehension document, while the combination of the source code to prose/pseudocode description and annotation layer and the pre-formatted source layer form a programmer rapid comprehension document.

Information for one patch in the rapid comprehension source code documentation is presented on a computer display device as a webpage using a novel user interface, as described more completely below, that includes a plurality of frames, as explained more completely below. In one embodiment, the pages used to display rapid comprehension source code documentation form an exploded-view virtual reality presentation of the computer program code source module.

Each of the layers of rapid comprehension source code documentation includes hypertext links that allow a user at any layer to access documentation appropriate for that layer. In one embodiment, the use of hypertext links parallels the execution flow of computer program code source module and this operational flow can be comprehended at all descriptive levels, allowing quick comprehension of the application's operation by anyone in the management, support, and programming hierarchy.

When a cursor is positioned over a name symbol in a displayed statement of a displayed patch from the pre-formatted source code layer, the name symbol is described by a tooltip, which, in one embodiment, is a popup box. When a cursor is positioned over the name symbol, and the program symbol is selected, for example, by clicking the mouse button, a sidebar frame is filled with more information about the name symbol, and, in one embodiment, with a menu of all of the cross-references to that name symbol within the computer program code source modules making up the complete computer program. Whenever a choice is selected in the menu, a navigation event occurs whereby the corresponding code patch is displayed, and the symbol reference target in the patch is highlighted. This feature enables a programmer to trace the data paths of the computer program code source module as well as the control (logic) paths, and to quickly comprehend the detailed operation of computer program code source module.

Any punctuation character, (at the end or within) each source-code statement, or any identifier or number symbol in the display may be an annotation trigger symbol. The annotation trigger symbol is a “footnote” link to an annotation description (e.g., prose/pseudocode) of that statement or reference in the source code to prose/pseudocode description and annotation layer. This annotation aids a layman or programmer unfamiliar with the source-language to understand the nature of the statement or reference. In one embodiment, when the cursor is positioned over the annotation trigger symbol, the annotation is displayed as a tooltip message. Additional footnote trigger symbols (Greek letters, for example) are appended to lines in the code display, and used to invoke additional footnotes as tooltip displays whenever the mouse cursor is positioned over them. The tooltip displays can be held in place to allow context-sensitive external navigation. For example, the tooltip displays may contain hypertext links to other webpages containing information that is more detailed.

When in a source-code statement, there is a name symbol that is either an invocation of a patch (e.g., a call to a subroutine, function, method, macro, etc.) or a hyperlink to a markup-page location and the cursor is positioned over that invocation or hyperlink, a tooltip is displayed that provides a short description of the operations performed by the call. If the invocation of the patch is selected, for example by clicking the mouse, the description of the code statements in the patch as well as the content of the patch are displayed. This action simulates the actual run-time call of the patch for the purposes of understanding the logical flow of the computer program code source module. In one embodiment, links in the rapid comprehension source documentation are associated with permission levels so that users are limited in the information available to them.

In this embodiment, a computer-based rapid comprehension documentation method for source information includes:

emulating source information flow using hypertext linkage between a plurality of webpages; and

using at least one auto-generic annotation with an annotation trigger symbol in one of the plurality of webpages to document the source information included in the one of the plurality of webpages,

wherein the auto-generic annotation is hidden from view until a user selects the annotation trigger symbol and then the auto-generic annotation is displayed, and further wherein

said auto-generic annotation was automatically assimilated from characteristics of the source information.

A computer program product includes computer program code where execution of the computer program code results in this embodiment of a computer-based rapid comprehension documentation method for source information.

### (E) AN INTERFACE FOR DISPLAYING THE RAPID COMPREHENSION SOURCE DOCUMENTATION

One embodiment of this invention includes a computer display interface for information in a metatree stored in the cradle file system. The interface includes four frames. A first frame is a navigation frame. A second frame is a patch heading frame that includes a title of a patch displayed in a third frame, and optionally can include a synopsis of the patch. The third frame is a patch code frame that includes the computer source code making up the patch. A fourth frame is a sidebar menu frame. This interface provides information that characterizes the patch and information associated with the patch in a way that is easily understood and utilized by those of varying skills.

### (F) A WEB ANNOTATOR FOR SUPPLEMENTING INFORMATION IN THE RAPID COMPREHENSION SOURCE DOCUMENTATION THAT IN TURN IS STORED IN AT LEAST ONE METATREE

In one embodiment of the present invention, a web annotator is used to manually add application-specific annotation content to a metatree in the cradle file system. In one embodiment, this manual-specific information is manually acquired through interactive editing of information displayed in annotator popup entry-edit forms.

In one embodiment, the manual-specific information is stored in a metatree file containing the application-specific annotation text based upon comments within the source computer program file and comments that are added using the web annotator of this invention. In another embodiment, the manual-specific information is stored in a metatree file of its own.

In one embodiment, the web annotator permits direct editing of webpages via a right-button mouse-click, or a mouse-click while simultaneously pressing a specific keyboard key. This event brings up an annotator popup entry-edit form enabling the browser user to add or edit annotation text pertaining to the symbol or area of the display selected by the browser user. Upon pressing a form-submission button in the annotator popup entry-edit form, the entered annotation data is sent to a server-side program, which formats the data and stores the formatted data in the appropriate metatree files for the patch being displayed. Next, the display file (e.g., HTML file) for the patch display is regenerated from the cradle files, and re-presented to the browser user.

This mechanism adds application-specific annotation of four different types: (1) subroutine synopsis annotation, a multi-line paragraph describing the overall purpose and general description of a subroutine; (2) subroutine subtitle description annotation, a single-line of text that will be appended to the subroutine display, and becomes the message displayed upon mouseover covering any call reference to the subroutine; (3) name symbol-description annotation, a single-line message appended to the onMouseOver-attribute of the heading of the sidebar name symbol cross-reference menu for the name symbol, and appended to the onMouseOver-attribute of every name symbol reference anchor tag so as to display upon a mouseover covering any reference to the name symbol; (4) footnote annotation pertaining to a referenced statement, of any length, which becomes a mouseover annotation for punctuation characters in the statement (if one of these characters is pointed to) or for to-be-added symbols (from a predefined list of footnote symbols) if statement text is pointed to. The manual annotation changes wrought by the above process become a permanent part of the maintained software.

The web annotator, in one embodiment, is a set of dynamic HTML functions to manually edit and add application specific annotation content to the cradle file system and the website associated with the rapid comprehension source documentation

In this embodiment, the resulting information may be accessed in two methods, depending on whether the mouse cursor is in a sidebar frame or in a code patch frame. In the former case, the auto-generic description is displayed as before, and the application-specific description appears in a tooltip whenever the mouse cursor covers the symbol name or the auto-generic description. At the end of the tooltip is a hyperlink “[more]” which when clicked displays a popup window displaying the synopsis information. In the latter case (code frame), this same tooltip is displayed whenever the name symbol (e.g., variable name) is covered by the mouse cursor. The auto-generic information no longer appears in the tooltip, but only appears in the heading of the sidebar frame.

### (G) A REVISION CONTROL SYSTEM FOR THE AT LEAST ONE METATREE THAT REQUIRES LOCKSTEP DOCUMENTATION FOR ANY MODIFICATION TO THE INFORMATION IN THE AT LEAST ONE METATREE

Yet another embodiment of this invention includes an apparatus for maintaining the contents of a hierarchical directory-tree object, i.e., a metatree, using a revision control system, which contains the means to maintain all versions of the contained source information such as programs, associated markup-text, and the metacompiler metaprograms, enabling the current version or any previous version to be reconstructed on request. In one embodiment, a source information maintenance controller (e.g., a source computer program code maintenance controller) details the historical maintenance and version control of source information files in lock step with the documentation stored in metatrees for the source information.

In one embodiment, the source information maintenance controller includes a create command process, a checkout process, an assemble process, and a check-in process, i.e., includes means for performing each of these processes. The create command process enters a module file into a control version system repository in the cradle file system as a metatree and generates a metatree in a user working storage area in the cradle file system. In one embodiment, the create command process includes four operations: a source code adapter operation, a Concurrent Versions System (CVS) registration operation, an import operation, and a check-out operation.

The source code adapter operation assimilates and explodes a source module file into a hierarchic directory-tree object, i.e., a metatree, in a temporary staging area. The CVS registration operation adds a module entry in a CVS administration file. This operation also initializes a plurality of files in the metatree root in the temporary storage area, which are used in the revision control. The import operation imports the metatree in the temporary storage area into the CVS repository as a CVS module. Finally, the checkout operation causes the new CVS module to be copied into a subdirectory of the user's working directory. This checkout also establishes the working copy of the metatree as a CVS module. Following the checkout operation, an assemble process reassembles the source module file for editing or building (compiling and loading of binary executables).

The source computer program code maintenance controller performs the check-out process for manually extracting and checking out CVS modules including individual versions source-code-module files or markup-language text files containing aggregates of individual source-code program-elements, single source-code elements, aggregates of markup-language patches, or single markup-language patches for editing, testing, and debugging the source-code program element(s).

The checkout process first employs a CVS checkout command to checkout a CVS module that is a hierarchic directory-tree object, i.e., a working metatree in one embodiment, into the user's working directory. The version of the working metatree in the user's working directory is updated and then a clone operation is performed to copy the working metatree into the temporary staging area to maintain the “as checked out” metatree for later comparison following editing. The assemble process is used to generate a source module file.

The source computer program code maintenance controller performs the check-in process for checking in source-code modules and/or regression-test threads to become new versions of the CVS module, with automatic association of documentation and with various optional means (according to externally-applied administrative options) for enforcing the manual addition of documentation; or automatic re-association from prior versions of all of the previously associated documentation; and optional means for enforcing the manual addition of documentation for all changes detected by comparing the previous checked-out version of each module or element with the new version that is checked in.

One embodiment of a module check-in process includes seven operations. A generate patches operation copies the modified external program module file to a staging area and using the source code adapter, repartitions the copied modified external program module file into patch files in a denuded metatree without the assimilation associated with generating annotations. In a modify metatree operation, the patch files of the corresponding module in the working metatree in the user's working directory are deleted. The patch files from the denuded metatree are then copied into the working metatree.

An update metatree patch files operation is a first of two CVS update operations performed to merge patch files from the archived metatree in the CVS repository into the equivalent files in the working metatree. This operation is used to identify any code change conflicts made by concurrent users. Hence, each of the patch files in the working and archived metatrees is processed. If a patch file is revised, that file is marked to indicate the nature of the revision. If conflicting revisions have been made to a patch file in the working and the archived metatrees, both revisions are copied to the patch file in the working directory and the patch file is marked as having a conflict. After all the patch files are processed for conflicts, a list of the patch files having conflicting revisions is generated.

If the list of the revised patch files for which conflicts between concurrent revisions must be resolved is empty, a conflicts operation is skipped and processing passes to a reparse and reconcile operation. Otherwise, if the list of the revised files for which conflicts between concurrent revisions must be resolved is not empty, a conflicts operation presents the user with all the overlapped text formats that must be resolved and the user is required to select one of the following choices before correcting any of the conflicts:

1) Abort the module check-in process for offline study leaving the archived metatree, i.e., the CVS module, unlocked;

2) Abort the module check-in process for offline study leaving the archived metatree, i.e., the CVS module, locked;

3) Fork a new branch from the checked-out CVS module version, and perform module check-in process on this new branch; and

4) Fork an experimental branch from the repository's current module version and immediately resolve concurrent conflicts; and

5) Immediately resolve concurrent conflicts.

In the options to resolve conflicts that include a fork, the controller issues a CVS command to fork a new branch, and future checkouts and check-ins are on this branch by default, until the default is explicitly changed.

If no fork is requested, but conflicted patches resulted, the controller opens an editing process for the user to resolve the conflicts. The user edits each patch to unify the separated file difference display sections in the files in the conflicts list. Upon completion of resolving the conflicts, processing transfers to a reparse and reconcile operation that reconciles all of the changes in annotation brought about by the revisions to the patches.

In the reparse phase of the reparse and reconcile operation, the patches that are different in the working metatree and in the as checked out metatree are identified, i.e., the revised patches are identified. The associative data arrays, e.g., hashes, are aggregated using the as checked-out metatree. Selected information in the hashes for the revised patches is deleted, e.g., the hashes are cleaned. Specifically, in one embodiment, for all of the revised patches, all data entries of the symbol and symbol annotation hashes pertaining to the revised patches are deleted, and all of the auto-generic and auto-specific entries of the annotation hash pertaining to the revised patches are deleted, but the manual-specific entries in the annotation hash are left in place.

Each of the revised patches is re-parsed using the source code adapter and the auto-generic and auto-specific annotation changes resulting from the revised patches are inserted in the cleaned hashes, i.e., into the metacontext.

A reconciliation procedure is executed for each of the revised patches to reconcile all of the application-specific footnote annotation reference keys and values that were impacted by line shifts and text changed; and to elicit, via a GUI dialog, new application-specific annotation (from the programmer) with respect to the changes made.

A user dialog is initiated for each of the revised patches to elicit a description and synopsis response to update this information for the revised patch. A summary log of this response also is recorded for later inclusion in the output log file.

The metacontext, now with all reconciliation complete, is written (exploded) into the metatree in the working directory. For all patches in the metatree, the summary logs and detailed logs for this revision are written to a temporary logfile (a hash file) in the staging area, to be subsequently appended to a revision history file.

Upon completion of the reconciliation process, in an update metatree operation, the CVS update command is executed again to clear the CVS gate for the final commit-operation.

In the commit operation, the controller processes the arguments in the command check-in to set the CVS commit options. Next, the CVS commit command is executed, causing advancement of the revision number, and releasing the lock on the repository version of the current metatree.

Next the log file created, as described above is updated to prepend the new versions number to all of its record keys, and the file is appended to a history file in the root of the archived metatree to complete the module check-in process.

This novel module check-in process is a primary ongoing event to enforce documentation in lockstep with program modifications. Whenever a module is checked in, in one embodiment, the programmer is required to annotate the source program code according to management-imposed options.

During subsequent check-ins, following checkout for modification, rigorous annotation of the changes are elicited from the programmer making the modification. These annotations and their purpose are appended to logs documenting the history of modifications. The requirement of providing documentation for each module check-in process eliminates the source of confusion that often leads to incorrect fixes in troubleshooting by temporary consultants unfamiliar with the source program code.

In one embodiment, the revision controller of this invention includes means for tracking, logging, and accumulating the historical statistics of the changes to the contained CVS modules, i.e., metatrees in a CVS repository, including the name and association of the programmer, the time and date of the change, the code content of the change, the associated documentation changes, the revision numbers associated with the change, along with other information pertinent to the change according to administrative options; and storage of the assimilated information in the hierarchical directory-tree object.

This revision controller further includes means for selectively enhancing the display-pages generated in the rapid comprehension documentation with footnote-hypertext links adjacent to code and documentation changes, pointing to generated footnote display-pages containing the historical statistics of the changes, whereby the enhanced (footnoted) display-pages and the pointed-to statistics display-pages, intended for administrative viewers, are encrypted upon storage according to administrative password masks and decrypted upon retrieval for display by the passwords, assigned to individual administrative viewers, which are mapped according to externally-applied algorithms into the password masks used for encryption, thereby restricting the use of the enhanced (footnoted) display-page versions and the pointed-to statistics display-pages to privileged administrative users.

One embodiment of this invention further includes a method of contained software modification and maintenance by application programmers within the controlled context of the combined apparatus described herein in which management independently enforces a discipline of quality compliance upon the programmers making surgical code changes to meet arising user requirements, wherein all changes are audited and tracked by version control, and rapid comprehension documentation of the changes is incorporated in lock-step with the code changes, and the compliance performance of the users is monitored.

Hence, in one embodiment, the computer-based revision control method includes

detecting changes to the original source information;

finding annotations corresponding to the changes;

presenting to a user an opportunity for revising the annotations to match the changes; and

maintaining a log of revisions made by the user.

For this embodiment, a revision control structure includes:

means for detecting changes to the original source information;

means for finding annotations corresponding to the changes;

means for presenting to a user an opportunity for revising the annotations to match the changes; and

means for maintaining a log of revisions made by the user.

The following definitions are provided to assist in understanding the DETAILED DISCLOSURE that follows:

Aggregation—The merging of multiple disk-resident key-indexed data files (hash files) into single memory-resident key-indexed data structures (hashes).

Annotation trigger symbol—an element in a webpage, where upon display of the webpage and an occurrence of predefined event associated with the element, e.g., a mouseover of the element, a tooltip annotation that was previously hidden from view is displayed.

Auto-generic annotation—an annotation that is automatically assimilated from the generic characteristics of the original source information (e.g. from the characteristics of the language of the source information—code-to-prose/pseudocode is auto-generic annotation which is assimilated from the language and is generic to the application).

Auto-specific annotation—An annotation that is automatically assimilated from specific commentary in the original source information concerning specific commentary about the source information (e.g. source commentary is usually application specific).

Explode—Convert a source-code module file into multiple files containing its constituent display elements (patches) and associated key-indexed data files (hash files) containing description elements (footnotes, symbol descriptions, symbol-reference descriptions, etc.)

Hash—Key-indexed (associative) memory-resident data structure. Can be a simple key-indexed array (simple hash), or a complex structure (hashplex) consisting of hashes of hashes, hashes of arrays, etc.

Hash File—Disk-resident file of key-indexed (associative) data derived from memory-resident hashes. Usually a hash file contains only a subset of the memory-resident hash it is extracted from or contributes to.

Manual-specific annotation—Annotation supplied by a user concerning information contained in the original source information.

Module—A natural standardized unit associated with the source information. The source information either can be a single module, or can contain a plurality of modules. For example, a source computer program code file may contain multiple modules that each typically contains multiple program elements, functions or subroutines. However, in another embodiment, a module may constitute a whole source computer program.

Metatree—A convenient hierarchical storage distribution, e.g., explosion, of a combination of aggregated memory data-structure objects made up of arrays and associative arrays, e.g., name indexed arrays.

Patch—High-level elements of program-code containment corresponding to (1) units of program operation (functions) and design (data declaration containers), and (2) units of hypertext display of the code elements, in which the hypertext display linkages parallels the corresponding program flow linkages, so that the understanding of program flow is portrayed by the browsing of the hypertext linkage.

Name Symbol—A symbol that is a referent to a source element in the source information. Name symbols for source information that is a computer program module include function names, variable names, macro names, class names, etc.

CVS—Concurrent Versions System, an industry-standard open-source version control system built upon another industry-standard version control system, RCS. Its internal archiving, symbol-replacement and logging (e.g. $keyword$ substitution), and revision numbering methods belong to RCS, and are referred to as RCS characteristics.

### BRIEF DESCRIPTION OF THE DRAWINGS

FIG. 1A is a block diagram of a system that includes a documentation generator, an information maintenance controller, a website composer, and a testing and verification manager for original source information, according to one embodiment of the present invention.

FIG. 1B is a block diagram of a system that includes a documentation generator, a software application source code maintenance controller, a website composer, and a testing and verification manager for an original source computer program, according to another embodiment of the present invention.

FIG. 2A is a more detailed block diagram of the documentation generator of FIG. 1A including a source information adapter, a hypertext page generator, a rapid comprehension documentation, a web annotator and a user display interface, according to one embodiment of the present invention.

FIG. 2B is a more detailed block diagram of the documentation generator of FIG. 1B including a source code adapter, a hypertext page generator, a rapid comprehension source code documentation, a web annotator and a user display interface, according to one embodiment of the present invention.

FIG. 2C is an illustration of one definition of patches for a non-tagged computer program language, according to one embodiment of the present invention.

FIG. 2D is an illustration of one definition of patches for a tagged computer program language, according to one embodiment of the present invention.

FIG. 2E is a more detailed block diagram of the documentation generator of FIG. 2B including a source code adapter, a hypertext page generator, a rapid comprehension source code documentation, a web annotator and a user display interface, according to another embodiment of the present invention.

FIG. 3A is a representation of an exploded-view virtual reality representation of the rapid comprehension source code documentation, according to one embodiment of the present invention.

FIG. 3B is a representation of an exploded-view virtual reality representation of the rapid comprehension source code documentation, according to another embodiment of the present invention.

FIG. 3C is a representation of an exploded-view virtual reality representation of the rapid comprehension source code documentation, according to yet another embodiment of the present invention.

FIG. 4A is a process flow diagram for the source code adapter, according to one embodiment of the present invention.

FIG. 4B is a process flow diagram for the source code patching operation of FIG. 4A, according to one embodiment of the present invention.

FIG. 5A is an illustration of parsing and data assimilation operation of FIG. 4A that is performed by the parser-hasher, according to one embodiment of the present invention.

FIG. 5B is a process flow diagram for the various sub-processes of FIG. 5A, according to one embodiment of the present invention.

FIG. 5C is a process flow diagram for one embodiment of the macro expansion and data assimilation process of FIG. 5A.

FIG. 5D is a process flow diagram for one embodiment of the recursive scan and expand process called in the process of FIG. 5C.

FIG. 6A is an example of a cradle file system, sometimes called cradle structure or just cradle, including a global metatree and a metatree, according to one embodiment of the present invention.

FIG. 6B is an example of a global diversion metatree and a diversion metatrees, according to one embodiment of the present invention, that are included in one embodiment of the cradle file system.

FIG. 6C illustrates the relationship between undifferentiated and differentiated (diversion) metatrees, according to one embodiment of the present invention.

FIG. 7A is an illustration of an explode module data into cradle metatree operation of FIG. 4A that is performed by the parser-hasher, according to one embodiment of the present invention.

FIG. 7B is an illustration of an add external data to cradle global metatree operation of FIG. 4A that is performed by the parser-hasher, according to one embodiment of the present invention.

FIG. 8 is an excerpt from one embodiment of a parser meta program, which generates a portion of parser-hasher that performs recognition events and data assimilation associated with the parsing of compound statement blocks of the C programming language, according to one embodiment of the present invention.

FIG. 9 is an excerpt of the lexer, showing the processes associated with recognition of the left brace {and the right brace} that are used to delimit a C-language compound statement block, according to one embodiment of the present invention.

FIG. 10 is an excerpt of the parser code showing the macro definitions containing calls to Perl subroutines referenced in FIGS. 11 and 12, according to one embodiment of the present invention.

FIG. 11 is an exemplary portion of computer program code for macros used in one embodiment of the present invention.

FIG. 12 is another exemplary portion of computer program code for macros used in one embodiment of the present invention.

FIG. 13 is process flow diagram for parsing and hashing by the source code adapter of a module that includes two computer language grammars, according to one embodiment of the present invention.

FIG. 14 is an illustration of a user display interface that includes a navigation frame, a patch heading frame, a patch code frame and a sidebar menu frame, according to one embodiment of the present invention.

FIG. 15 is a process flow diagram for the hypertext page generator of FIG. 2B, according to one embodiment of the present invention.

FIG. 16 is an illustration, according to one embodiment of the present invention, of a menu webpage in the menu layer of the rapid comprehension source code documentation that is generated by the hypertext page generator in the generate program menu HTML file operation of FIG. 15.

FIG. 17 is an illustration, according to one embodiment of the present invention, of another menu webpage in the menu layer of the rapid comprehension source code documentation that is generated by the hypertext page generator in the generate module menu HTML file operation of FIG. 15 and that is presented when link deMunck.c of FIG. 16 is selected.

FIG. 18A is an illustration of a data aggregation from module metatree operation of FIG. 15 that is performed by the hypertext page generator, according to one embodiment of the present invention.

FIG. 18B is an illustration of a data aggregation updating all global symbol references from global metatree operation of FIG. 15 that is performed by the hypertext page generator, according to one embodiment of the present invention.

FIG. 18C is an illustration of a data aggregation of the (now globalized) entries in hash %annostat and hash %symbol to a globalized statistics hash file annostat.dat and a globalized symbol reference statistics hash file symbol.dat in the metatree root, according to one embodiment of the present invention

FIG. 19 is an illustration, according to one embodiment of the present invention, of a webpage that includes information from the executive synopsis, source code to prose/pseudocode description and annotation, and preformatted source code layers of the rapid comprehension source code documentation that is generated by the hypertext page generator, and that is presented when link smatrix of FIG. 17 is selected.

FIG. 20 is an illustration, according to one embodiment of the present invention, of a webpage that includes a name symbol reference annotation that is displayed in response to an onMouseOver event associated with the corresponding function symbol reference nu.

FIG. 21 is an example, according to one embodiment of the present invention, of the HTML for the webpage that is displayed in the patch code frame of FIG. 20, and that is generated by the hypertext page generator.

FIG. 22 is an illustration, according to one embodiment of the present invention, of a webpage that is displayed in response to an onClick event associated with the corresponding function symbol reference nu in FIG. 20.

FIG. 23 is an illustration, according to one embodiment of the present invention, of a webpage that is displayed in the sidebar menu frame in response to an onClick event associated with the corresponding variable symbol reference eps in the patch code frame of FIG. 22.

FIG. 24 is an example, according to one embodiment of the present invention, of the HTML for the webpage that is displayed in the patch code frame of FIG. 23, and that is generated by the hypertext page generator.

FIG. 25 is an example, according to one embodiment of the present invention, of the static HTML for the webpage that is displayed in the sidebar menu frame of FIG. 23 in response to an onClick event associated with the corresponding variable symbol reference eps, and that is generated by the hypertext page generator.

FIG. 26 is an illustration, according to one embodiment of the present invention, of a cursor being positioned on function reference smatrix in the sidebar menu frame for the variable symbol reference eps in anticipation of an onClick event.

FIG. 27 is an illustration, according to one embodiment of the present invention, of a webpage that is displayed in response to an onClick event associated with the corresponding function symbol reference smatrix in FIG. 26 when static HTML is used.

FIG. 28 is an illustration, according to one embodiment of the present invention, of a webpage that is displayed in response to an onClick event associated with the corresponding function symbol reference main in FIG. 26 where the line in function main containing variable symbol reference eps is positioned at the top of the patch code frame.

FIG. 29 is an illustration, according to one embodiment of the present invention, of a webpage that is displayed in response to an onClick event associated with the corresponding function symbol reference smatrix in FIG. 26 when dynamic HTML is used so that variable symbol reference eps is highlighted.

FIG. 30 is an illustration, according to one embodiment of the present invention, of a webpage that is displayed in response to an onClick event associated with the corresponding function symbol reference main in FIG. 26 where variable symbol reference eps is highlighted in the patch code frame.

FIG. 31 is an example, according to one embodiment of the present invention, of the dynamic HTML for the webpage that is displayed in the sidebar menu frame of FIG. 29 in response to an onClick event associated with function smatrix for variable symbol reference eps, and that is generated by the hypertext page generator.

FIG. 32 is an example of one embodiment of a function Locate that is used in FIG. 31.

FIG. 33 is an example, according to one embodiment of the present invention, of webpage displayed in the sidebar menu frame in response to an onClick event associated with corresponding variable symbol reference eta of FIG. 30 and 33.

FIG. 34 is an illustration, according to one embodiment of the present invention, of a prose/pseudocode annotation that is displayed in response to an onMouseOver event associated with the corresponding semicolon annotation trigger symbol.

FIG. 35 is an illustration, according to one embodiment of the present invention, of a prose/pseudocode annotation that is displayed in response to an onMouseOver event associated with the corresponding footnote annotation trigger symbol β.

FIG. 36 is an illustration, according to one embodiment of the present invention, of a prose/pseudocode annotation that is displayed in response to an onMouseOver event associated with the corresponding footnote annotation trigger symbol, an opening left parenthesis.

FIG. 37 is an illustration, according to one embodiment of the present invention, of a prose/pseudocode annotation that is displayed in response to an onMouseOver event associated with the corresponding footnote annotation trigger symbol, a semicolon.

FIG. 38 is an illustration, according to one embodiment of the present invention, of a prose/pseudocode annotation that is displayed in response to an onMouseOver event associated with the corresponding annotation trigger symbol, an opening left brace and in addition the corresponding closing right brace is highlighted.

FIG. 39 is an illustration, according to one embodiment of the present invention, of a prose/pseudocode annotation that is displayed in response to an onMouseOver event associated with the corresponding annotation trigger symbol, a closing right brace and in addition the corresponding opening left brace is highlighted.

FIG. 40 is an example, according to one embodiment of the present invention, of the HTML for the patch code frame that is displayed in the patch code frame of FIGS. 38 and 39, and that is generated by the hypertext page generator.

FIG. 41A is an illustration, according to one embodiment of the present invention, of a prose/pseudocode annotation that is displayed in response to an onMouseOver event associated with the corresponding annotation trigger symbol and that includes a hypertext link.

FIG. 41B is an illustration, according to one embodiment of the present invention, of pressing a key to allow a cursor to moved into the annotation of

FIG. 41A to, in turn, activate the hyperlink.

FIG. 41C is an illustration, according to one embodiment of the present invention, of a popup window that is displayed in response to the activation of the hyperlink in FIGS. 41A and 41B.

FIG. 41D is an illustration, according to one embodiment of the present invention, of a prose/pseudocode annotation that is displayed in response to an onMouseOver event associated with the corresponding macro and that includes links to a full expansion and expansion by stages, and a full expansion popup window that is generated in response to an onClick event on the full expansion link.

FIG. 41E is an illustration, according to one embodiment of the present invention, of a prose/pseudocode annotation that is displayed in response to an onMouseOver event associated with the corresponding macro and that includes links to a full expansion and expansion by stages, and a first stage expansion popup window that is generated in response to an onClick event on the expansion by stage link and that includes a next expansion stage link.

FIG. 41F is an illustration, according to one embodiment of the present invention, of a prose/pseudocode annotation that is displayed in response to an onMouseOver event associated with the corresponding macro and a second stage expansion popup window that is generated in response to an onClick event on the next expansion stage link in the popup window of FIG. 41E and that includes a next expansion stage link.

FIG. 41G is an illustration, according to one embodiment of the present invention, of a prose/pseudocode annotation that is displayed in response to an onMouseOver event associated with the corresponding macro and a second stage expansion popup window that is generated in response to an onClick event on the next expansion stage link in the popup window of FIG. 41F.

FIG. 41H is an illustration, according to one embodiment of the present invention, of a prose/pseudocode annotation that is displayed in response to an onMouseOver event associated with a system function symbol that includes a link to more information.

FIG. 41I is an illustration, according to one embodiment of the present invention, of a prose/pseudocode annotation that is displayed in response to an onMouseOver event associated with a system function symbol and a popup window that is displayed upon clicking on the link to more information in FIG. 41H.

FIG. 42 is one embodiment of computer program function GenCodePatch used in generating webpages by the hypertext page generator, according to one embodiment of the present invention.

FIG. 43A is one embodiment of a computer program function MakeHtmlPatch that is called in function GenCodePatch in FIG. 42, according to one embodiment of the present invention.

FIG. 43B is an alternative embodiment of one line in the computer program function of FIG. 43A, according to one embodiment of the present invention.

FIGS. 44 is one embodiment of a computer program function PutHtmlLine that is called by function MakeHtmlPatch of FIG. 43A, according to one embodiment of the present invention.

FIG. 45A is one embodiment of a computer program function MakeVarMenus that is called in function GenCodePatch in FIG. 42, according to one embodiment of the present invention.

FIG. 45B is one embodiment of a computer program function GenVarMenuTop that is called by function MakeVarMenus of FIG. 45A, according to one embodiment of the present invention.

FIG. 46 is an example of an annotator popup entry-edit form for the web annotator, according to one embodiment of the present invention.

FIG. 47 is an illustration of a function symbol annotator popup entry-edit form that is generated in response to an extended click in a patch heading frame, according to one embodiment of the present invention.

FIG. 48 is an illustration of the contexts associated with a patch heading frame, according to one embodiment of the present invention.

FIG. 49 is an illustration of a variable symbol annotator popup entry-edit form that is generated in response to an extended click on a variable symbol in a sidebar menu frame, according to one embodiment of the present invention.

FIG. 50 is an illustration of the contexts associated with a variable symbol in a sidebar menu frame, according to one embodiment of the present invention.

FIG. 51 is an illustration of a variable symbol annotator popup entry-edit form that is generated in response to an extended click on a variable symbol in a patch code frame, according to one embodiment of the present invention.

FIG. 52 is an illustration of the contexts associated with a variable symbol in a patch code frame, according to one embodiment of the present invention.

FIG. 53 is an illustration of a variable symbol annotator popup entry-edit form that is generated in response to an extended click on a function symbol in a patch code frame, according to one embodiment of the present invention.

FIG. 54 is an illustration of the contexts associated with function symbol in a patch code frame, according to one embodiment of the present invention.

FIG. 55A is an illustration of a footnote annotation symbol annotator popup entry-edit form that is generated in response to an extended click on a code delimiter symbol in a patch code frame, according to one embodiment of the present invention.

FIG. 55B is an illustration of a footnote annotation symbol annotator popup entry-edit form that is generated in response to an extended click on a line number in a patch code frame, according to one embodiment of the present invention.

FIG. 55C is an illustration of a footnote annotation symbol annotator popup entry-edit form that is generated in response to an extended click on an end of line delimiter symbol in a patch code frame, according to one embodiment of the present invention.

FIG. 56 is an illustration of the contexts associated with a footnote annotation symbol in a patch code frame, according to one embodiment of the present invention.

FIGS. 57A and 57B are a web annotator process flow diagram for the web annotator, according to one embodiment of the present invention.

FIG. 58 is a process flow diagram for the update annotations operation of FIG. 57A, according to one embodiment of the present invention.

FIG. 59A is a more detailed diagram illustrating the structures utilized in the web annotator process of FIGS. 57A and 57B, according to one embodiment of the present invention.

FIG. 59B is an illustration of the files in a metatree that are used and updated by the web annotator, according to one embodiment of the invention.

FIG. 59C is an illustration of the web annotator updated data in the patch directory of the metatree to aggregate data from the patch directory hash files into the hashes in patch-hash buffer memory for use in generating a revised webpage that includes the updated data, according to one embodiment of the present invention.

FIG. 60 is an illustration, according to one embodiment of the present invention, of a web annotator interface for entry-editing of subroutine subtitle information (description) and subroutine synopsis information in the patch heading frame.

FIG. 61 is an illustration, according to one embodiment of the present invention, of a web annotator interface for entry-editing of variable symbol reference information.

FIG. 62 is an illustration, according to one embodiment of the present invention, of a web annotator interface for entry-editing associated with an annotation trigger symbol.

FIG. 63A is an illustration of a special function annotator that is used to modify information in a metatree using annotator entry-edit forms and a new application/file generator that uses the information in the metatree to generate a new application and/or file, according to one embodiment of the present invention.

FIG. 63B is an illustration of a special function annotator that is used to modify information in at least one metatree in a plurality of metatrees using annotator entry-edit forms and a new application/file generator that uses the information in the plurality of metatrees to generate a new application and/or file, according to one embodiment of the present invention.

FIG. 64 is an illustration of a temporary roll-up web annotator that is used with a temporary roll-up metatree and with a temporary roll-up annotation document, according to one embodiment of the present invention.

FIG. 65A is an illustration of a temporary annotation data popup window for a function symbol that is generated in response to a predefined event, according to one embodiment of the present invention.

FIG. 65B is an illustration of a query being entered in the temporary annotation data popup window of FIG. 65A, according to one embodiment of the present invention.

FIG. 65C is an illustration of the temporary annotation symbol presented in the user interface upon the temporary annotation data popup window of FIG. 65A being saved after entry of a query, according to one embodiment of the present invention.

FIG. 66A is an illustration of a high level temporary annotation menu in the user interface that lists patches including temporary annotations, according to one embodiment of the present invention.

FIG. 66B is an illustration of a patch level temporary annotation menu in the user interface that is presented upon the user clicking on patch smatrix in the temporary annotation menu of FIG. 66A wherein each temporary annotation entry includes a link to the user interface page containing that temporary annotation, according to one embodiment of the present invention.

FIG. 67A is an illustration of a user interface page that is generated upon the user clicking on the link in the patch level temporary annotation menu of FIG. 66B, and of the tooltip that is generated in response to an onMouseOver event of the temporary annotation symbol, according to one embodiment of the present invention.

FIG. 67B is an illustration of a temporary annotation data popup window for a function symbol that is generated in response to a predefined event associated with the temporary annotation symbol in FIG. 67A, according to one embodiment of the present invention.

FIG. 67C is an illustration of the temporary annotation symbol presented in the user interface upon the temporary annotation data popup window of FIG. 65A being saved following entry of a response the query, according to one embodiment of the present invention.

FIG. 67D is an illustration of a patch level annotation menu in the user interface that shows that the temporary annotation includes both a query and an answer, and each temporary annotation includes a link to the user interface page containing that temporary annotation, according to one embodiment of the present invention.

FIG. 68 is an illustration of a query tooltip that is displayed upon an onMouse event of the temporary annotation symbol and of an answer popup window that is generated on activation of the link in the query tooltip, according to one embodiment of the present invention.

FIG. 69A is an illustration of a temporary annotation data popup window for a function symbol that is generated in response to a predefined event and of a comment being entered in the temporary annotation data popup window, according to one embodiment of the present invention.

FIG. 69B is an illustration of the temporary annotation symbol presented in the user interface upon the temporary annotation data popup window of FIG. 69A being saved after entry of a comment, according to one embodiment of the present invention.

FIG. 70 is an example of a temporary annotation entry-edit form being used with a web annotator entry-edit form, according to one embodiment of the present invention.

FIG. 71 is an illustration, according to one embodiment of the present invention, of check-in and checkout processes of the source code maintenance controller of FIG. 1B.

FIG. 72 is a process flow diagram, according to one embodiment of the present invention, of create, check-in, and checkout processes of the source code maintenance controller of FIG. 1B.

FIG. 73A is an illustration, according to one embodiment of the present invention, of structures associated with the source code adapter operation and the CVS registration operation in the create process of FIG. 72.

FIG. 73B is an illustration, according to one embodiment of the present invention, of a metatree in the cradle file system that is used with the CVS repository.

FIG. 73C is an illustration, according to one embodiment of the present invention, of structures associated with the import operation in the create process of FIG. 72.

FIG. 73D is an illustration, according to one embodiment of the present invention, of structures associated with the checkout operation in the create process of FIG. 72.

FIG. 74A is an illustration, according to one embodiment of the present invention, of structures associated with the get metatree operation in the checkout process of FIG. 72.

FIG. 74B is an illustration, according to one embodiment of the present invention, of structures associated with the clone operation in the checkout process of FIG. 72.

FIG. 74C is an illustration, according to one embodiment of the present invention, of structures associated with the assemble process of FIG. 72.

FIG. 75A is an illustration, according to one embodiment of the present invention, of structures associated with the get patches operation and the modify metatree operation in the check-in process of FIG. 72.

FIG. 75B is an illustration, according to one embodiment of the present invention, of structures associated with the update metatree patch files operation in the check-in process of FIG. 72.

FIG. 75C is an illustration, according to one embodiment of the present invention, of structures associated with the resolve conflicts operation in the check-in process of FIG. 72.

FIG. 75D is an illustration, according to one embodiment of the present invention, of structures associated with the reparse and reconcile operation in the check-in process of FIG. 72.

FIG. 75E is an illustration, according to one embodiment of the present invention, of structures associated with the update metatree operation in the check-in process of FIG. 72.

FIG. 75F is an illustration, according to one embodiment of the present invention, of structures associated with the commit operation in the check-in process of FIG. 72.

FIG. 76 is an illustration, according to one embodiment of the present invention, of a process flow diagram for the update metatree patch files operation in the check-in process of FIG. 72.

In the Figures and the following Detailed Description, elements with the same reference numeral are the same or equivalent elements. For three digit reference numerals, the first digit of the reference numeral is the figure number of the Figure in which the element having that reference numeral first appears. Similarly, for four digit reference numerals, the first two digits of the reference numeral are the figure number of the Figure in which the element having that reference numeral first appears.

Headings within the Detailed Description are for convenience only and should not be interpreted as limiting the disclosure for an element to the disclosure under a particular heading. The disclosure for any element of the present invention includes all the information concerning that element herein irrespective of where the information is found.

### DETAILED DESCRIPTION

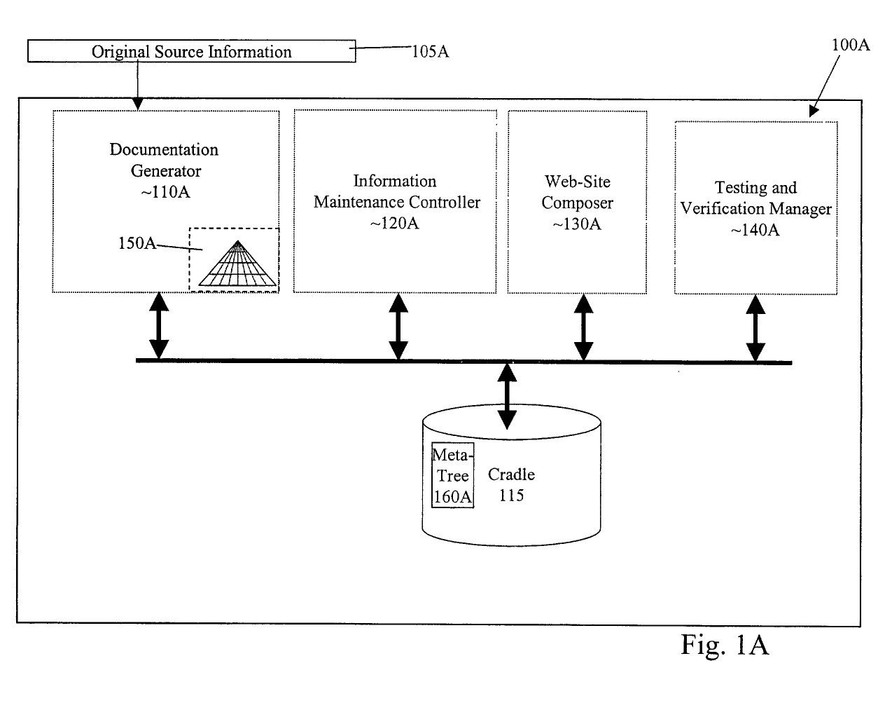

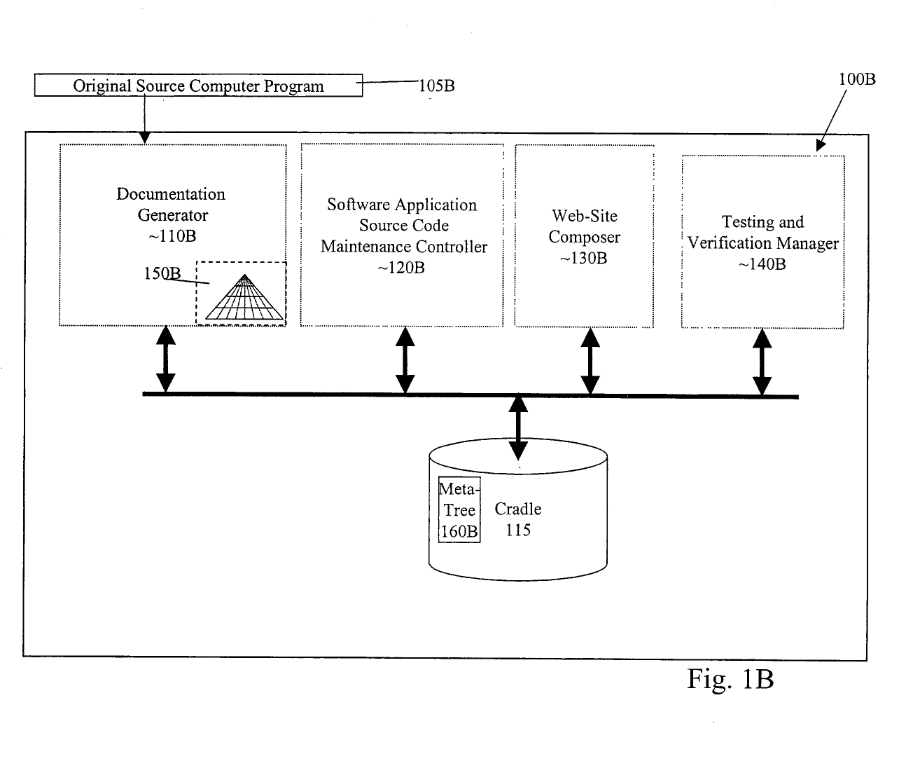

According to one embodiment of the present invention, a novel system 100A (FIG. 1A) functions as a composite facility for documentation, maintenance, composition, and testing of information in an original source information file 105A, sometimes called source information file 105A. For example, documentation generator 110A of system 100A converts the information in source information file 105A that is represented in a digital format into rapid comprehension documentation 150A. Typically, a portion of rapid comprehension documentation 150A, i.e., a patch, is presented to the user via a computer display device.

In one embodiment, computer-based rapid comprehension documentation 150A is a massive computer-based help utility for original source information 105A, which can be for example, a text document, a musical score, or computer source code. The comprehension provided by documentation 150A is hundreds of times richer, more relevant, and more specific than the comprehension provided by prior art help utilities. With computer-based rapid comprehension documentation 150A, the maximum of detailed information is accessible to the “stream of comprehension” via a flow of tooltip annotations following mouseover motions, augmented by hypertext links within the tooltips.

As a mouse pointer is moved from symbol to symbol on the computer display device, e.g., in response to the mouseover motion, tooltip annotations are presented as a wave or trace of revelation. The user can uncover more suggestive summaries of more detailed knowledge via links in the tooltip annotations, which lead to popup windows containing such summaries. Any symbol representing a variable or a function is a navigation link to a cross-reference menu of the variable, or to a display of the function patch, respectively.

All the while, this tooltip information and information accessed via links is hidden within the original text that is displayed. The displayed original text is reduced to its mere essence (most essential) form without encumbrance of permanent extraneous information obscuring its pristine operational flow. Moreover, the user has control to expose just those elements in rapid comprehension documentation 150A, which the user specifically needs to understand for a specific segment of a particular portion of original source information 105A.

This richness, in one embodiment, comes from auto-generic annotations, which comprise the majority of the annotations in computer-based rapid comprehension source documentation 150A. As used herein, an auto-generic annotation is an annotation that automatically was assimilated from the characteristics of original medium of source information 105A by documentation generator 110A.

The relevance of rapid comprehension source documentation 150A is greatly enhanced by a metacompiler-generated parser-hasher process used in documentation generator 110A, which is the ultimate in context-sensitivity, as explained more completely below. For example, when the source information is original source computer program 105B (FIG. 1B), the metacompiler-generated parser-hasher process uses the same logic that a computer software compiler uses to determine scope, dependency, calls, routines, variables, etc.

Documentation generator 110A makes literally tens of thousands of these annotations automatically, far more than could possibly be done by a person creating the usual prior art Help utility. As the annotations are generated via language (media) translation (code to prose/pseudocode) from the metacompiler-interpreted grammar of the language medium itself, the translation may be accompanied, through hypertext-links within the annotation tooltips, by an integrated manual of the language medium. This integrated manual is accessible at the optimum point of relevance to the stream of comprehension.

The specificity of rapid comprehension source documentation 150A is enhanced by the user's control of exactly what part of the original information in source information file 105A to highlight. The user can activate hyperlinks in documentation 150A, in one embodiment, to expose the information that the user needs to understand while almost all of the other information in documentation 150A remains hidden.

Hence, in this embodiment, the information/documentation created with documentation generator 110A is thousands of times richer and more tuned to the exact logic and context of the information in original source information file 105A than the prior art, and that immense richness is selectively browsed and uncovered using powerful web-based tools, in one embodiment, which have been especially tuned for this purpose. This is in sharp contrast to prior art-help utilities that were generally a one-size-fits-all tautological document with information that was too general, and often too circular. In addition, in the prior art, typically the information that the user wanted to understand was embedded in other irrelevant verbiage, which was distracting at best.

The properties in one embodiment of the present invention, which optimize rapid comprehension of original source information 105A, are associated with the notions of semantic thought-train (stream of comprehension) correlation, auto-articulation of detailed content, information hiding, trace revelation, and unified multilevel presentation. These properties govern the quality of information conveyance about original source information 105A. These properties of the present invention are further highlighted by considering original source computer program 105B and documentation generator 110B (FIG. 1B).

In general, the semantic thought-train correlation property relates to the correlation of a train of thought to the language in which the thought may be expressed. For the example of FIG. 1B, a computer programming language easily correlates with the thought patterns of a programmer contemplating a program design, and with the data processes a digital computer executes, thus fusing by analogic or metaphoric correlation, two disparate systems: programmer and computer.

A presentation medium, i.e., rapid comprehension source documentation 150B, which reinforces this correlation and maintains a chain of contexts of this correlation is more efficient in aiding comprehension than the prior art help documentation. Typically, the prior art help documentation diverted from the correlation in a discontinuous way, as for example, by a wholesale context change, which required reorientation and was incompatible to the context from which the shift was made.

The auto-articulation property relates to the use of an automatic information interpretation process, e.g., the metacompiler-generated parser-hasher process as explained more completely below, to provide a richness of detail by articulating, i.e., describing in detail, every nuance of the generic information being interpreted. In the embodiment of FIG. 1B, code to prose/pseudocode translation of original source computer program 105B is an example of such auto-articulation. The auto-articulation property achieved via this auto-generation process results in more available information in rapid comprehension source documentation 150B than in the thickest prior art software documentation manual.

To achieve the greatest advantage of the auto-articulation property, the property of information hiding is used to make visible to a user of rapid comprehension source documentation 150B only the necessary essence of a subject, e.g., to convey what the subject is about, while hiding the details of how the subject is accomplished unless the details are accessed by the user. In another sense, too much detail is like noise, which obscures the signal, and one user's signal can be another user's noise-particularly if the users operate in different contexts. In prior art program documentation, such as Unix man pages, this was a common problem, as a plethora of detail often compromised finding what was being sought.

The need to access different levels of detail by different users is provided by the trace revelation property, which, in this embodiment, is a method of revealing hidden information at points along (which correlate with) the user's stream of comprehension at which more detail can assist that comprehension. This achieves a noiseless signal trace within the stream of consciousness for the user. In one embodiment, hypertext is used as a medium, which achieves trace revelation. In this embodiment of the invention, the design of hypertext rapid comprehension documentation 150A and 150B, as explained more completely below, allows the user's pathway of information apprehension to be guided by the user's stream of comprehension.

In conjunction with the use of hypertext to implement the trace revelation property, the unified multi-level presentation property is achieved, in this embodiment, by a nested webpage format, which is tuned to the semantic thought-train correlation of programmers/developers. Each layer of rapid comprehension source documentation 150B has a similar style and appropriate logic, and the browsing tools to find, cross-reference, drill-down, popup, etc., have a consistent and similar feel that is also tuned to be highly logical and efficient for the code-revelation task at hand.

In the embodiment of FIG. 1A, documentation generator 110A includes a source information adapter. The source information adapter converts source information 105A into files in a memory. These files contain data that includes source information 105A and auto-generic documentation for source information 105A that is generated by the source information adapter. The source information adapter explodes this data into a hierarchical file structure (e.g., metatree 160A) in a cradle file system 115 that is coupled to the source information adapter.

Hence, metatree 160A includes both original source information 105A and the auto-generically generated interpretative information. As described above, the auto-generically generated interpretive information permits users with varying degrees of knowledge to understand original source information 105A at the particular levels of knowledge of the users.

As explained more completely below, a hypertext page generator in documentation generator 110A uses the data in metatree 160A to generate a plurality of webpages that make up rapid comprehension source documentation 150A that is stored in a memory. As indicated above and as described more completely below, in one embodiment, this plurality of webpages includes a pre-formatted information layer, a description and annotation layer, a synopsis layer and a menu layer. Selected webpages from each layer are used to form exploded-view virtual reality displays for perusal by users.

Documentation generator 110B (FIG. 1B) also includes a source code adapter that creates metatree 160B and a hypertext page generator that creates rapid comprehension source documentation 150B. Selected webpages from each layer in rapid comprehension source documentation 150B are used to form exploded-view virtual reality displays for perusal, for example by programmers, user-peer application technicians, and responsible managers.

For software program code maintenance, software application source code maintenance controller 120B maintains cradle file system 115 in a reversible historical and multi-lineal version lattice via an industry-standard revision control system. This enables concurrent development, maintenance and production in multiple versions and branches of progressive modification of the software program code.

Website composer 130B of system 100B utilizes information on cradle file system 115 to support interactive artistic graphical and textual composition of web-displays. Testing and verification manager 140B utilizes information on cradle file system 115 to support the synthesis and maintenance of regression tests and the debugging of software program code from the context of the exploded-view virtual reality displays.

Thus, novel system 100B serves multiple life-cycle purposes. One purpose is tactical (production-support) software management, and another purpose is strategic (development) software management. Tactical software management processes include generation of a website containing integrated documentation and source code; management of the source-code elements under revision quality-control; the management of production (binary) aggregates of the source-code elements under version quality-control; and the support of rollout and distribution of the production aggregates. The purpose of these processes is to support the original intent and configuration of the software application, as primarily understood by its users and the application programmers who support the software design, and to provide the means to counteract the prevalent devolution of this configuration and design in the course of its surgical modification.

The purpose of the strategic processes, which usually are beyond the knowledge and skill of users and application programmers, is to use this means, not just to counteract the devolution of surgical software modification, but to evolve it by re-integrating mutation-evolution in the truest sense-and even further to transform the whole configuration in stages into a refined engine structure that can be used to spawn spin-off products.

System 100B provides a framework for major productivity gains in software development, revision, and testing, as well as a process of management control, heretofore unprecedented, throughout these activities. As explained more completely below, the exploded-view virtual reality aspect of system 100B eliminates costs associated with essentially having to reverse engineer the source computer program code prior to making any fixes and/or changes by providing rapid comprehension source documentation (RCD).

The rapid comprehension source documentation, in this embodiment, emulates the program flow via hypertext linkage. Each hypertext link brings up descriptions supporting user-peer and upper-management understanding as well as programmer understanding. Essentially all flavors of software documentation are provided thereby enabling all personnel to understand the workings of the software system to the degree required by their responsibility.

According to one embodiment, system 100B functions as scaffolding that supports integrated, all-in-one documentation of contained software systems. System 100B provides a single comprehensive environment that can contain software ranging from single applications to worldwide systems of applications, under a single control process. In one embodiment, document generator 100B builds an environment that includes a website containing software documentation integrated with source code, with hypertext linkage emulating the program flow. Software application source code maintenance controller 120B maintains this environment by action of a revision control system, which enforces multi-levels of documentation when a checked-out element of the source computer program code is checked back into the revision control system.

In system 100A, information maintenance controller 120A, website composer 130A, and testing and verification manager 140A perform similar functions for original source information 105A. The particular functionality of each of these components is configured based upon the particular type of original source information 105A. Software application source code maintenance controller 120B is an example of one embodiment of information maintenance controller 120A

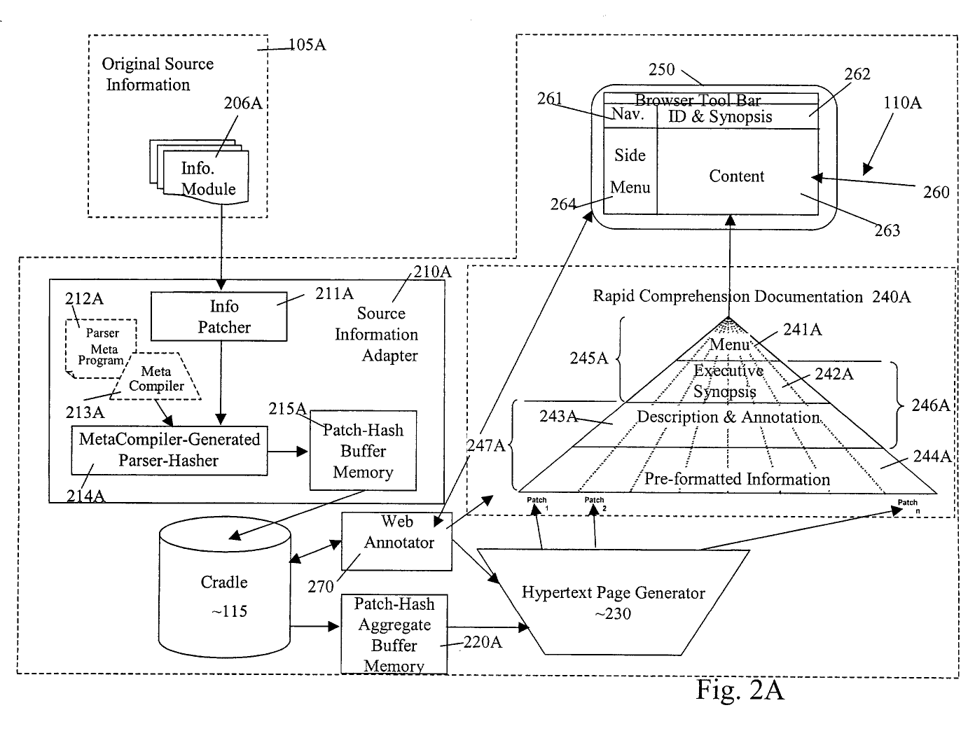

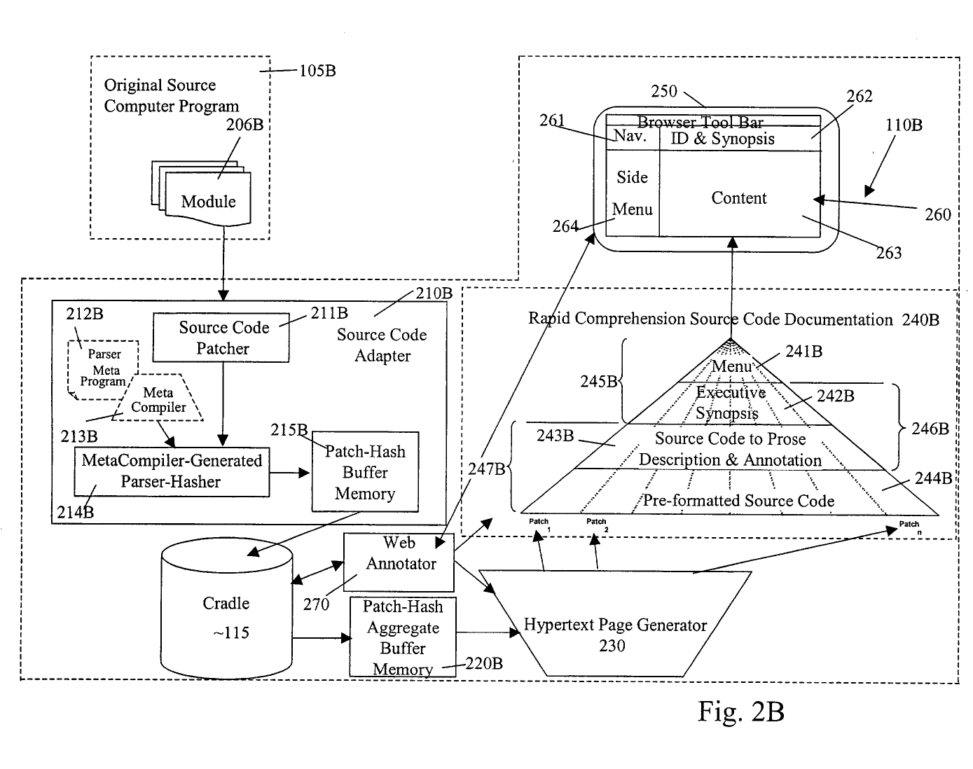

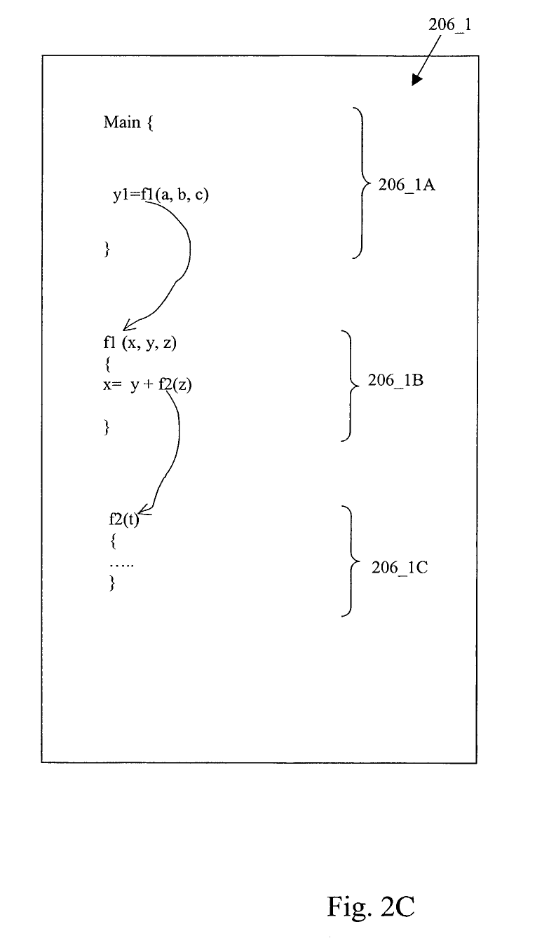

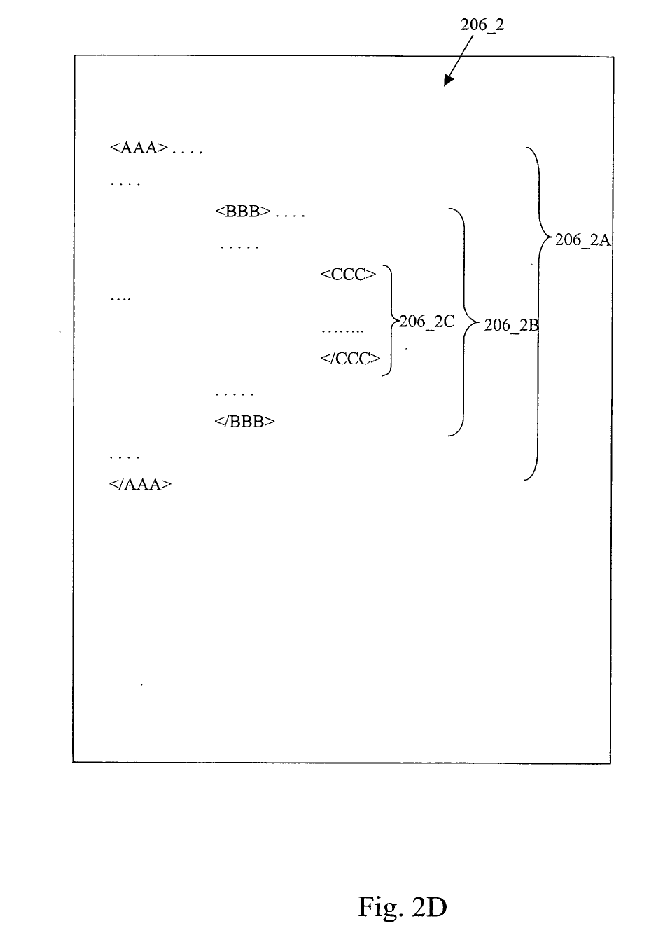

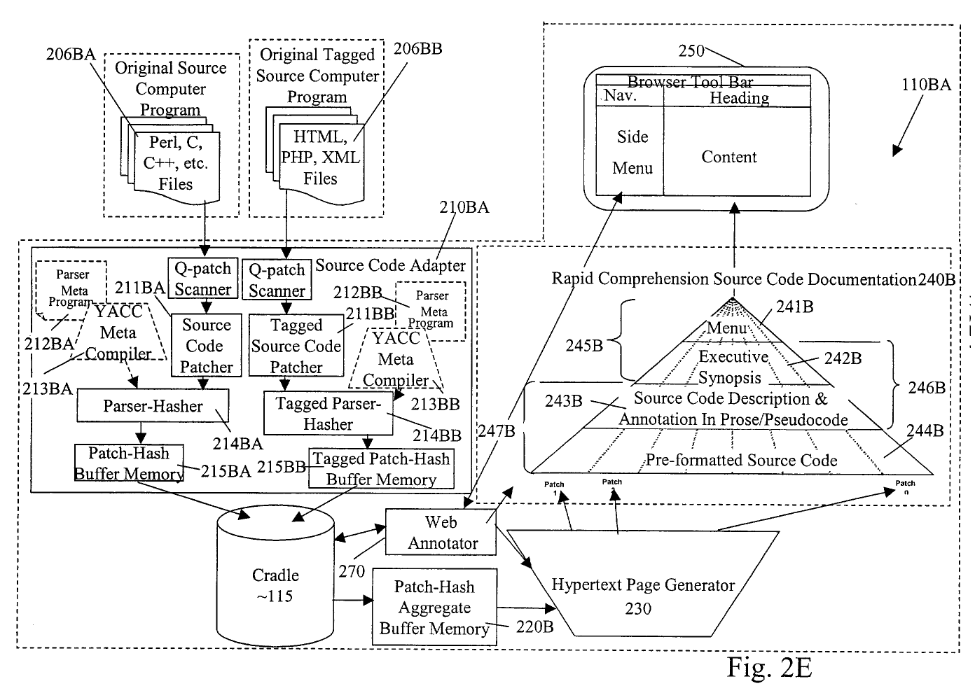

FIG. 2A is a more detailed block diagram of documentation generator 100A. A source information adapter 210A includes an information patcher 211A, and a metacompiler-generated parser-hasher 214A.

In one embodiment, a structure is imposed on source information file 105A. In this embodiment, source information file 105A includes a plurality of source information module files, one of which is source information module file 206A. The particular definition of a module depends upon the type of source information, for example, for a book, a module could be a chapter, for a musical score, a module could be a movement within the music score, etc. A module, e.g., information module file 206A (FIG. 2A), typically includes a plurality of patches that correspond to what can be characterized as containers, e.g., high-level elements, in module information file 206A.

Source information patcher 211A processes module information file 206A and determines boundaries for each patch in module information file 206A. Parser-hasher 214A processes each patch in file 206A. Parser-hasher 214A generates auto-generic documentation for a patch and stores the original source information and the auto-generic documentation in a plurality of associative array data structures and array structures in patch-hash buffer memory 215A. The auto-generic documentation is generated automatically by parser-hasher 214A based upon generic characteristics of the source information being parsed.

If the source information contains specific commentary about the source information, parser-hasher 214A processes the specific commentary and automatically generates auto-specific documentation in patch-hash buffer memory 215A for the patch being processed. Thus, the documentation generated by parser-hasher 214A includes generic documentation derived from the characteristics of the source information, and documentation specific to the particular application of the patch being processed.

In one embodiment, a hypertext page generator 230 creates a plurality of webpages making up rapid comprehension source documentation 240A using information, e.g., data, in a metatree or metatrees in cradle file system 115. Hypertext page generator 230 first creates a program menu webpage file for original source information 105A. Next, for each metatree in cradle file system 115 for original source information file 105A, hypertext page generator 230 aggregates the data for each patch in the metatree in patch-hash aggregate buffer memory 220A.

Using the aggregated data in patch-hash aggregate buffer memory 220A, hypertext page generator 230 generates a patch code frame webpage and a patch heading frame webpage for each patch. After all the webpages for the patches are generated, hypertext page generator 230 generates a sidebar menu frame webpage for each name symbol in the metatree, e.g., for each variable, function, macro, class, etc. These operations are repeated for each metatree, i.e., each module in original source information file 105A. The result is a plurality of webpages that make up rapid comprehension documentation 240A according to one embodiment of the present invention. Advantageously, the data in cradle file system 115 is stored in a form that when aggregated, the aggregated data is in a form that is convertible to tagged-language webpages by hypertext page generator 230.

In the embodiment of FIG. 2A, the plurality of webpages making up rapid comprehension source documentation 240A are shown as layers 241A to 244A. Each of layers 241A to 244A, in this example, includes information for each of patches 1 to n.

Layer 241A is a menu layer. Layer 242A is an executive synopsis layer 242A. Layer 243A is a source information to description and annotation layer 243A, and layer 244A is a pre-formatted source information layer 244A. The combination of menu layer 241A and executive synopsis layer 242A form an executive rapid comprehension document 245A. The combination of executive synopsis layer 242A and source information description and annotation layer 243A form a user-peer rapid comprehension document 246A, while the combination of source information description and annotation layer 243A and pre-formatted source information layer 244A form a programming technician rapid comprehension document 247A.

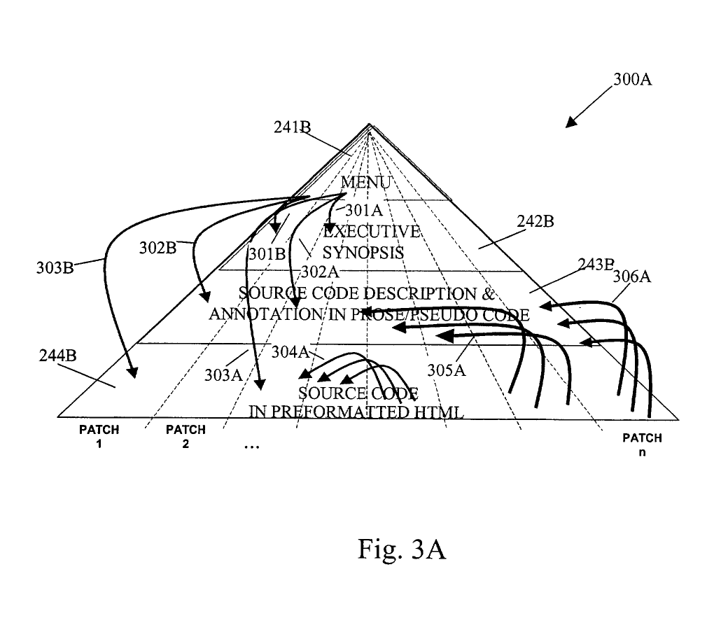

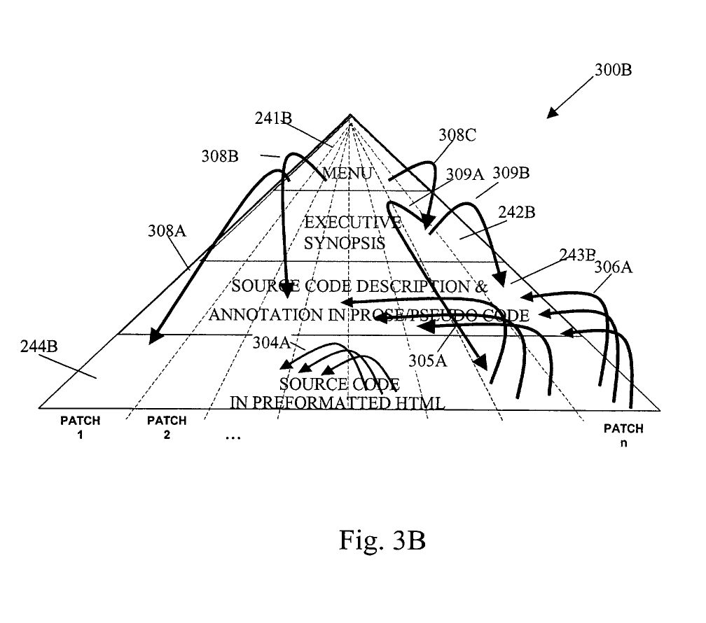

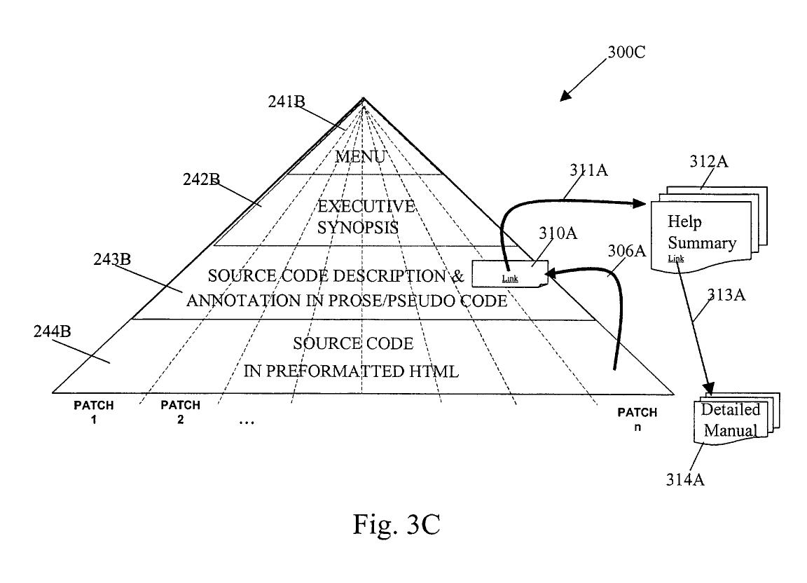

In the embodiment of FIG. 2A, the selected webpages from each layer that are used to form an exploded-view virtual reality display 260 on display device 250 are presented in a plurality of frames 261 to 264. As explained more completely below, frame 261 is a navigation frame; frame 262 is a patch heading frame that typically is used to display information in layers 241A to 242A; frame 263 is a content frame that typically is used to display information in pre-formatted source information layer 244A, which is dynamically augmented by source information translations from layer 243A that are displayed via mouseover tooltip displays; and frame 264 is a sidebar menu frame. The interaction and use of the information in each of the frames is described more completely below with respect to FIGS. 2B, and 3A to 3C, and that description is incorporated herein by reference.

Herein systems 110A and 110B are illustrated as a complete unit. However, this is illustrative only and is not intended to limit the inventions to such a configuration. In view of this disclose, those of skill in the art can implement systems 110A and 110B in a wide variety of systems. For example, systems 110A and 110B could be implemented using a workstation. In another embodiment, systems 110A and 110B could be implemented as client-server systems that include a network that can be a local area network, a wide area network, a telecommunications network, an intranet, an extranet, the Internet, or any desired combination of such networks.

For example, display device 250 could be on a client system and the other elements of systems 110A and 110B on one or more coupled servers coupled to the client system by at least one network. Alternatively, parts of systems 110A and 110B could be executed on a client device and other parts executed on at least one server. The particular configuration selected depends on the complexity and volume of the source information and the processing power, storage capacity, etc. of the various devices that make up the system. The particular configuration selected is not essential to this invention and so is not considered further.

As indicated above, auto-generic annotations are generated by parser-hasher 214A. These annotations provide a new level of understanding for original source information 105A. However, to further augment this understanding, web annotator 270 permits a user to add manual-specific annotation or annotations for each element in rapid comprehension source documentation 240A that is displayed on display device 250. Herein, an element may be a name symbol such as a variable symbol or a function call symbol, a footnote annotation trigger symbol, a line number, a blank line, text, a part of a variable symbol or of a function call symbol, a portion of text, or any other feature that is visible in the display.

To add manual-specific information, the user selects an element for further annotation, e.g., places the mouse cursor over the element, and in some embodiments clicks a mouse button while pressing a predefined key on a computer keyboard. In response to the further annotation selection, an annotator popup entry-edit form is generated on display device 250. The entry-edit form is specific to the element selected by the user for further annotation.

Typically, the annotator popup entry-edit form includes a plurality of windows that display any auto-generic information associated with the selected element, and any auto-specific information associated with the selected element. Typically, auto-specific information is a comment or comments in original source information 105A concerning the selected element. With some exceptions, as explained more completely below, the windows including the auto-generic and auto-specific information are read-only.

The annotator popup entry-edit form also includes at least one window that displays any manual-specific information that was previously entered for the selected element. The user is allowed to enter and/or modify the information in any manual-specific windows, i.e., the manual-specific information is read/write information.

In addition to reviewing annotations, and editing manual-specific annotation, the annotator popup entry-edit form permits the user to select information from the various windows in the form that is made available to the user. The user can choose the context in which the information is displayed (e.g., displayed directly, displayed in a tooltip, displayed via a link) as well as the content that is displayed in each selected context.

Specifically, the form includes a plurality of display configuration blend options from which the user can select one or none. If none of the options is selected, a default display configuration blend option is used. Moreover, if a configuration display blend option selected by the user is applicable to more than one context, the information is used in all applicable contexts, as explained more completely below. A configuration blend option specifies a configuration of content for at least one context, as explained more completely below.

If the user selected to save the information in the annotator popup entry-edit form, the information in the form is sent from the client device to the server. A function executing on the server saves the information in patch files of the metatree corresponding to the patch displayed on display device 250. The function regenerates a new webpage with the information from the metatree and sends the regenerated webpage to the client device for display on display device 250. In addition, the function updates other files in the metatree that are affected by the annotation changes and then updates any corresponding webpages in rapid comprehension source documentation 240A.

FIG. 2B is an example of documentation generator 110B for a specific type of an original source file, i.e., an original source computer program file 105B. Again, a structure is imposed on source file 105B. In this embodiment, source computer program code file 105B includes a plurality of source computer program module files, one of which is source computer program module file 206B.

Each source computer program module file, e.g., file 206B (FIG. 2B), is defined in terms of patches that correspond to what can be characterized as containers, e.g., high-level elements, in source computer program module file 206B. For non-tagged programming languages, these containers, typically, are elements such as functions, subroutines and the main program. For tagged programming languages, these containers are defined by the dual (opening-closing) tag structure. Note that in some embodiments, source file 105B is only a single module file 206B so that file 105B and file 206B are the identical file. Moreover, module file 206B may be a single patch.

In the example of FIG. 2C for a source computer program module file 206_1 written in an artificial non-tagged programming language, three patches 206_1A to 206_1C are illustrated. In this artificial programming language, the high level elements that are referred to as containers herein are defined by a declarative statement followed by one or more program code statements that are included within a set of braces. Within each patch are sub-elements such as source code statements that in turn include function calls, variables etc., for source code written in non-tagged programming languages.

In FIG. 2C, patch 206_1A is the main program that includes a source code statement that calls a function f1 that in turn is patch 206_1B. Function f1 includes a source code statement that calls another function f2 that is patch 206_1C. Each of patches 206_1A to 206_1B includes sub-elements that include variables, function calls etc.

In the example in FIG. 2D for a source computer program module file 206_2 written in an artificial tagged programming language, three patches 206_2A to 206_2C are illustrated. In this artificial programming language, each high level element that is referred to as a container herein is defined by a tag pair, e.g., tags <AAA> and </AAA> for patch 206_2A. Within patch 206_2A are two other patches 206_2B and 206_2C, so that there are a hierarchy of patches.

Returning to FIG. 2B, source code adapter 210B, in one embodiment, first elementizes source computer program module file 206B into patches. Within each patch, sub-elements, e.g., source code statements, function calls, and variables found within the source code statements, are cast into a form that facilitates generation of hierarchical documentation for the source code, revision control, and regression testing for example.

In one embodiment, source code adapter 210B performs auto-generic parsing and auto-generic documentation. As explained more completely below, source code adapter 210B first partitions source computer program module file 206B into patches corresponding to the containing elements of the source text. Each patch has permanent unity, identity, and scope throughout all program duty cycles, e.g., subroutines, functions, HTML tables, paragraphs, etc.

Next, source code adapter 210B recognizes and catalogs the location of invoking links, e.g., subroutine calls, in source computer program statements within each patch. Source code adapter 210B performs code-to-prose/pseudocode source statement translation that in turn is used to produce footnoting, as described more completely below, for source computer program module file 206B. This footnoting assists persons non-fluent in the programming language to fully understand operation of the computer program by reading the prose/pseudocode translation.

Next, source code adapter 210B recognizes and catalogs: (a) the location of name symbol references, e.g., variable symbol references, in the source code statements; and (b) the other language-defined attributes of the name symbols, e.g., data-type, scope, storage class, etc. Finally, source code adapter 210B stores this information on cradle file system 115 in a specific architecture so that document generator 110B can utilize the information to generate rapid comprehension source code documentation 240B.

Specifically, the information stored on cradle file system 115 is subsequently used by a hypertext page generator 230, e.g., a tagged language code page generator, which generates webpage files, sometimes called webpages, for a website. Rapid comprehension source code documentation 240B, in this website, is a system of annotations, footnotes, menus, linkages, synopses, and subtitle descriptions, which are ancillary to source file 105B and serve to document the application in source file 105B in situ.

As indicated above, source code adapter 210B produces auto-generic documentation, which derives from the application-generic characteristics of the languages being parsed, and in addition auto-specific documentation of application-specific commentary embedded in source file 105B. Subsequent application-specific annotation content is manually acquired through interactive editing of information in annotator popup entry-edit forms via web annotator 270, in one embodiment, as was described above and is described more completely below. This content is regarded as manual-specific

The semi-automatic auto-specific process augments the fully automatic process of the original auto-generic parsing process by taking advantage of existing coding styles in the commentary embedded in the parsed source code to extract application-specific annotation. Style-sheet templates, prepared by the programmers or user-peer technicians who apply the system, enable the metacompiler-produced parsers to automatically interpret and assimilate application-specific commentary embedded in the original source code, converting it into exploded synopsis and annotation material in the cradle files.

This kind of content data assimilation does not depend upon specific content knowledge of the contained application, but rather is derived from the stylistic characteristics of the comments, which are easily discerned without understanding of the application. Thus, relatively untrained labor (e.g., trainees, librarians) can be employed in the elucidation and rendering of valuable corporate-asset software. Over time, two expected trends are likely to converge to render this semi-automated process more fully automated: (a) the accumulation of style-sheet templates to encompass a wide variety of programming commentary styles; and (b) the standardization of programming commentary styles to be within the scope of existing templates.

Even without this further annotation, rapid comprehension source code documentation 240B provides, in one embodiment, (1) program-flow emulation by hypertext linkage; (2) auto-generic annotation that is assimilated from the characteristics of the programming language via code-to-prose/pseudocode translation; and (3) variable type/scope analysis and cross-reference linking. In addition, application-specific annotation, subtitle descriptions, and synopsis information to more completely flesh out the source code documentation are included.

Rapid Comprehension Source Documentation

In the embodiment of FIG. 2B, rapid comprehension source code documentation 240B also is divided-into four different layers: a menu layer 241B, an executive synopsis layer 242B, a source code to prose/pseudocode description and annotation layer 243B, and a pre-formatted source code layer 244B. In this embodiment, source computer program file 105B includes a plurality of modules that each, in turn, include a plurality of patches. For example, one module has n patches, patch 1, patch 2, . . . patch n, where n is an integer. The use of n patches for a module is illustrative only and is not intended to limit the invention to modules that include more than one patch. In many cases, n may be one.

The combination of menu layer 241B and executive synopsis layer 242B form an executive rapid comprehension document 245B. The combination of executive synopsis layer 242B and source code to prose/pseudocode description and annotation layer 243B form a user-peer technician rapid comprehension document 246B, while the combination of source code to prose/pseudocode description and annotation layer 243B and pre-formatted source layer 244B form a programmer rapid comprehension document 247B.

The information for one patch in documents 245B to 247B is presented on display device 250 as an exploded-view virtual reality presentation 260 in a plurality of frames 261 to 264, as explained more completely below. Briefly, frame 261 is a navigation frame; frame 262 is a patch heading frame that typically is used to display information in layers 241B to 242B; frame 263 is a content frame that typically is used to display information in pre-formatted source layer 244B which is dynamically augmented by source code to prose/pseudocode translations, from layer 243B, displayed tooltip displays and/or popup windows as annotation displays, which may also contain further hypertext linkages to more detailed information; and frame 264 is a sidebar menu frame.

FIG. 3A is an alternative representation of one embodiment of an exploded-view virtual reality presentation 300A used to display rapid comprehension source code documentation 240B. Each of layers 241B to 244B within documentation 240B includes hypertext links that allow a user at any layer to access documentation appropriate for that layer.

In FIG. 3A, the hypertext links are illustrated by arrows from one part of documentation 240B to another part of documentation 240B, e.g., arrows 301A, 301B, 302A, 302B, 303A, 303B, 304A, 305A, 306A. In one embodiment, when a hypertext link in menu layer 241B is selected by a user, a new page is displayed in exploded-view virtual reality presentation 260 that includes the information indicated by arrows 301B, 302B, and 303B, e.g., the information in the various layers for the module or patch selected in menu layer 241B. In one embodiment, menu layer 241B includes a menu for the plurality of source module files and a menu of patches for each of the source module files.

In one embodiment, the use of hypertext links parallels the execution flow of source computer program module file 206B and this operational flow can be comprehended at all descriptive levels, allowing quick comprehension of the module's operation by anyone in the management, support, and programming hierarchy. For example, an executive uses links in menu layer 241B to scan the executive synopsis of each patch i, in the plurality of patches, where i is any one of 1 to n, in executive synopsis layer 242B. If interested, the executive can drill-down to any level of detail in layers 243B and 244B.

User-peers, unfamiliar with programming languages, can nevertheless understand the descriptions and annotations that accompany program statements. A user-peer follows a link from menu layer 241B to code-to-prose/pseudocode translations of the program-statements in source code to prose/pseudocode description and annotation layer 243B, which appear as tooltip display messages by trace revelation following mouse pointer motion over symbols in the displayed text.

Troubleshooting programmers, unfamiliar with the program design of source computer program module file 206B or alternatively source computer program file 105B, can follow the program flow at the executive level via an executive synopsis layer 242B. They can read subroutine descriptions and synopses to gain rapid overall comprehension by reading the code-to-prose/pseudocode annotations in layer 243B, or perhaps obtain quick descriptions of unfamiliar library and API routines, rather than having to look them up in out-dated reference manuals.

The programmers can likewise drill-down to program statement in preformatted source code layer 244B via menu access links 303A or 303B for example. If the programmer positions the cursor over a program variable in a displayed statement in exploded-view virtual reality display 260, the program variable is described by a tooltip, which, in one embodiment, is a popup box, as described more completely below, in exploded-view virtual reality display 260.

If the programmer positions the cursor over a program variable, and selects the program variable (e.g., positions a mouse pointer over the program variable and clicks a mouse key) a sidebar frame 264 (FIG. 2B) is filled with more information about the program variable, and, in one embodiment, with a variable cross-reference menu of all of the cross-references to that program variable within source computer program module file 206B. Each cross-reference of the variable cross-reference menu is the name and line number in the respective patch where the variable is referenced. Here, a program variable is used as an example of a name symbol that refers to a source element in the original source information. The characteristics and functionality described here for the program variable are generally applicable to any symbol name that refers to a source element in the original source information.

Whenever a cross-reference is selected from the variable cross-reference menu by clicking a mouse key, for example, a navigation event occurs that causes the corresponding code patch to be displayed in frame 263, and the symbol reference target in the displayed code patch is highlighted. This feature enables the programmer to trace the data paths of source computer program module file 206B as well as the control (logic) paths, to quickly comprehend the detailed operation of source computer program module file 206B. This type of link within preformatted source code layer 244B is represented by arrow 304A, for example.

Any punctuation character, either at the end or within each source-code statement in exploded-view virtual reality display 260, may be a footnote annotation trigger symbol. The footnote annotation trigger symbol is a footnote link, as represented for example by arrow 306A, to an annotation description (e.g., prose/pseudocode) of that statement or reference in source code to prose/pseudocode description and annotation layer 243B. This annotation aids a layman or programmer unfamiliar with the source-language to understand the nature of the statement or reference. In one embodiment, when the cursor is positioned over the annotation trigger symbol, the annotation is displayed as a tooltip message in exploded-view virtual reality display 260.

Additional footnote annotation trigger symbols, for example, Greek letters, may be appended to lines in the displayed code, and may be used to invoke additional annotations as tooltip displays, sometimes called tooltips, whenever the mouse cursor is positioned over them. The tooltip displays are held in place and entered by the mouse cursor, by mouse button or key action (pressing the control key, for example), to allow context-sensitive external navigation. For example, the tooltip displays may contain hypertext links to other webpages containing more detailed information. This is particularly useful, in association with auto-generic code-to-prose/pseudocode translation footnoting, to automatically link language-reference manual pages describing a particular language construct to a specific example of the use of the construct, i.e., the actual code of source computer program module file 206B. This context-sensitive external-navigation embodiment is further explained below.

When in a source-code statement, there is either an invocation of a patch (e.g., a call to a subroutine, function, method, macro, etc.) or hyperlink to a markup-page location and the user positions the cursor over that invocation or hyperlink, a tooltip is displayed that provides a short description of the operations performed by the call. This is represented by arrow 305A, for example.

If the user selects the invocation of the patch, for example by clicking the mouse, the description of the code statements in the patch as well as the content of the patch are displayed, which is indicated by arrow 304A. This action simulates the actual run-time call of the patch for the purposes of understanding the logical flow of source computer program module file 206B.

In view of FIG. 3A, various alternative embodiments can be implemented of an exploded-view virtual reality presentation 300A using the hypertext links and layers 241B to 244B of rapid comprehension source code documentation 240B. For example, FIG. 3B illustrates another embodiment of an exploded-view virtual reality presentation 300B. In this embodiment, hypertext links are included in menu layer 241B to specific layers in documentation 240B. For example, hypertext links go to either information in source code layer 244B as arrow 308A or source code description and annotation layer 243B as represented by arrow 308B in addition to those in FIG. 3A so that the user can select the level of detail that is viewed at one time.

Alternatively, the links could be associated with permission levels so that users are limited in the information available to them. Hence, one permission level for a link would result in the display associated with arrows 301A to 303B of FIG. 3A while a second permission level for the same link would result in the display associated with link 308B in FIG. 3B.

Various combinations of hypertext links are also possible as illustrated by arrows 308C, 309A an 309B (FIG. 3B). In this example, hypertext links to varying levels of detail for other patches are included within executive synopsis layer 242B.

Context-sensitive external-navigation emanating from tooltip annotation is illustrated in FIG. 3C. In this embodiment, mouseover link 306A associated with an annotation trigger (punctuation) symbol in a program statement invokes a tooltip message 310A containing a prose/pseudocode translation of the language statement.

Contained within the tooltip message is an external navigation link 311A, accessible for navigation by mouse-button or key action, which holds the tooltip in place and allows the mouse-cursor to roam within tooltip message 310A to encounter external link 311A. When external link 311A is clicked-on, a help-summary webpage 312A is invoked in a popup window.

Help-summary webpage 312A pertains specifically to the language construct being used in preformatted source-code layer 244B, which contains the annotation trigger symbol. Help-summary webpage 312A may contain further links, such as link 313A to an entry in a more detailed language manual 314A.

Alternatively, link 306A (FIG. 3C) might be an application-specific footnote link associated with a Greek-letter or other extraneous annotation trigger symbol, which would appear only to users belonging to a particular permission level. The footnote message 310A might be a proprietary or classified message, and further links 311A, 313A, would be likewise restricted. Alternatively, footnote message 310A might be an unclassified message, while classified link 311A, would only appear to users belonging to the classified permission level.

An Embodiment of the Source-Code Adapter

FIGS. 2A and 2B include a more detailed illustration of a general embodiment of source information adapters 210A and 210B, respectively. Herein, source code adapter 210B is considered in more detail as an example of a source information adapter. This is illustrative only of one embodiment of the invention and is not intended to limit the invention to the specific embodiment described.

In this embodiment, the source-code module files are first partitioned into patches by a source code patcher 211B, which serves as the first pass for a compiler-like parser-hasher 214B. Source code patcher 211B employs a non-linear scanning process, unlike compilers, to identify display units, i.e., patches, which must treat conditional compilation (preprocessor) statements as if the conditional compilation statements were unconditional. This allows patches to span conditionally compiled program parts. This patching process relieves downstream parser-hasher 214B, a linear scanner, from having to determine where patches begin and end in the module files.

A metacompiler 213B is programmed by a parser metaprogram 212B, as explained more completely below for one embodiment, to produce a metacompiler generated parser-hasher 214B that parses (interprets) source code statements of a module 206B within source file 105B. Metacompiler 213B is meta-programmed in a combination of its base programming language (C, Java or Perl) and a derivative of a very-high-order metalanguage known as BNF (Backus-Naur Form), which is used to create parser metaprogram 212B. BNF is a simple rule-based descriptive language that is known to those of skill in the art. Typically, parser metaprogram 212B and metacompiler 213B are used only once to generate parser-hasher 214B.

In this embodiment, parser-hasher 214B writes the information parsed from source computer program module file 206B, both the original source information and corresponding auto-generic information generated by parser-hasher 214B, into a set of hashes, e.g., memory-resident associate array data structures, in patch-hash buffer memory 215B. The set of hashes, in turn, is exploded into cradle file system 115.

One embodiment of system 110B, i.e., system 110BA (FIG. 2E) utilizes two metacompilers, metacompiler PCYACC 213BA and metacompiler Bison 213BB. Both of these metacompilers are derivatives of the standard Unix/Linus metacompiler YACC. Metacompiler PCYACC is available from Abraxas Software, Inc. Portland 97208, OR, www.abxsoft.com. Metacompiler Bison is available from Free Software Foundation, 59 Temple Place, Suite 330, Boston Mass. 02111, www.gnu.org. The use of these two specific metacompilers is illustrative only and is not intended to limit the invention to the use of these specific metacompilers. In view of this disclosure, those of skill in the art can use any metacompiler of interest or alternatively could write an appropriate parser from scratch.

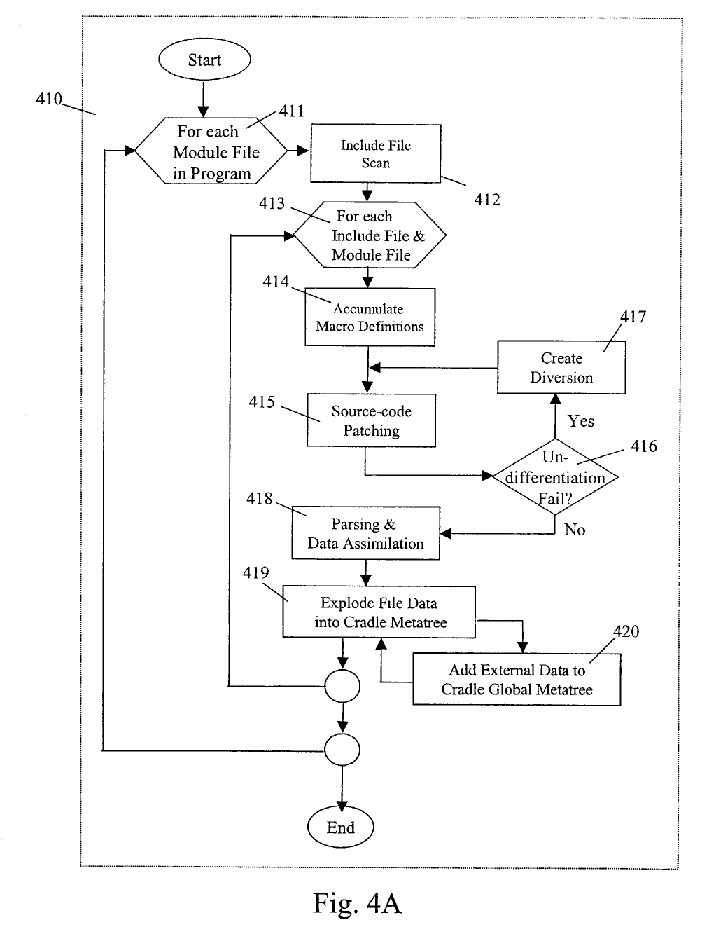

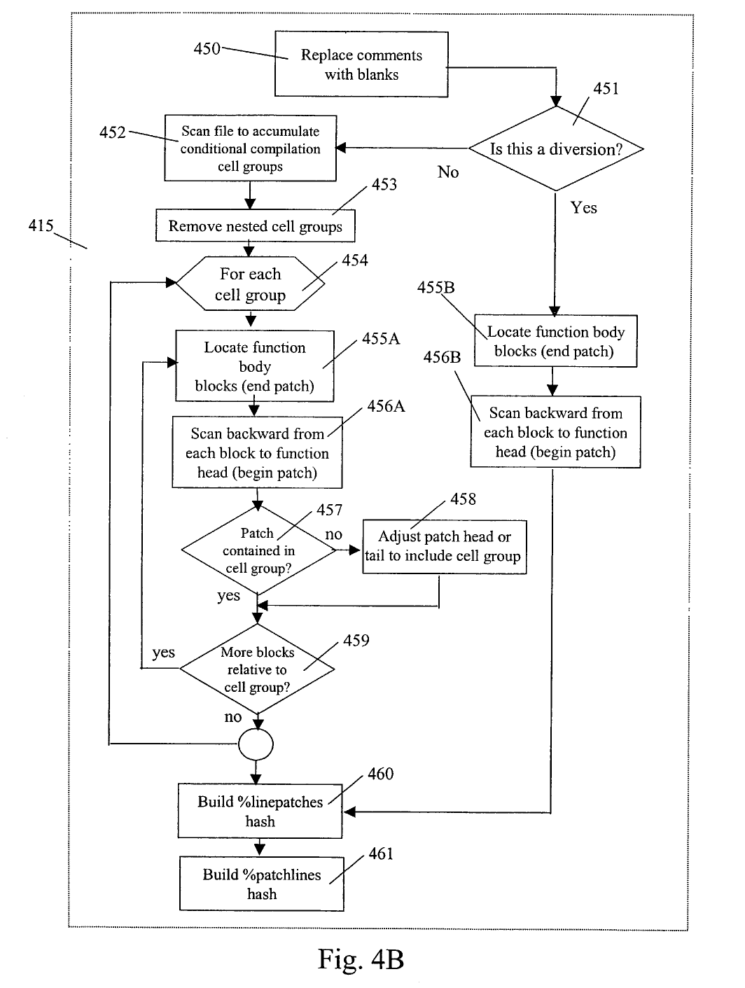

FIG. 4A is a process flow diagram for a source code adapter operation 410 for one embodiment of source code adapter 210B of the present invention. The operations included in this process flow diagram are illustrative only. In view of this disclosure, those of skill in the art can implement various alternative embodiments of a source code adapter that may not include all the operations in FIG. 4A, or alternatively may include additional operations.

Prior to considering operation 410 in further detail, it is useful to consider the general structure of a source-code module file for a non-tagged computer programming language. The module includes a main body that is written using conventional programming statements. For C-based programming languages, a module also may contain a number of statements, typically at the start of the module but such lines can occur anywhere, that each include a preprocessor token, e.g., a pound sign # for the C-programming language. Typically, a preprocessor performs conditional compilation, macro substitution, and inclusion of named files, and substitutes conventional programming statements for each of the lines including the preprocessor token so that the compiler sees a file that includes only conventional programming statements.

Conditional compilation directives are typically used to conditionally insert lines of text in a computer program source for compilation, if certain conditions are satisfied. Typically, whether a conditional compilation directive is included in the source code that is compiled depends on a condition set in previously scanned text such as the presence in previously scanned text of a particular identifier definition, e.g., #define UNIX or #define DOS. For this example, conditional compilation directives such as the following conditionally insert text.

#ifdef UNIX

(text lines to be inserted if UNIX is defined)

#elseif DOS

(text lines to be inserted if DOS is defined)

#endif

Hence, for this example, if neither UNIX nor DOS were defined in previously scanned text, these conditional compilation directives have no effect. If UNIX were defined, the conditional compilation directives have one effect, and if DOS were defined a different effect. Consequently, this simple example can result in three different outcomes in the source code that is compiled, and in the source code that is processed by source code adapter 210B.

Conditional compilation directives are also used to insert text whenever conditions involving macro definitions defining macro values, e.g., #define DEBUG 1, are defined. In this example, directives such as the following conditionally insert text.

#if DEBUG ==1

(text lines to be inserted if DEBUG is 1)

#else

(text lines to be inserted if DEBUG is not 1)

#endif

The various conditions that may be involved in a plurality of conditional compilation directives appearing in the original source computer program file 105B have the effect of differentiating the original source module files into diverse versions, sometimes called diversion files, or alternatively diversion modules.

Hence, in one embodiment of this invention, two different classes of metatrees and associated rapid comprehension source documentation are defined. A first class for the rapid comprehension source documentation and associated metatree is an undifferentiated class. A second class for the rapid comprehension source documentation and associated metatree is a differentiated class.

An undifferentiated metatree contains the whole text of a module including the conditional compilation directives and all of the conditional insertion text. Thus, the undifferentiated metatree is used to generate undifferentiated rapid comprehension source documentation that permits review of the module information in the form, which the module text would be externally edited in the prior art. (Note, that undifferentiated and differentiated, as used herein, relate to whether conditional directives in the original source have not or have been evaluated, and do not relate to the process of taking a mathematical derivative of a function.)

A differentiated metatree contains only a portion of the text of a whole module, as reduced from the text of the whole module by the evaluation of the plurality of conditional compilation directives by source code adapter 210B. Thus, the differentiated metatree is used to generate a differentiated rapid comprehension source documentation that permits review of the module information in the form as seen by a language compiler after pre-processing.

Hence, the conditional compilation directives in a module give rise to a plurality of metatrees corresponding to a single module, namely, an undifferentiated metatree, and a plurality of differentiated metatrees. The number of potential differentiated metatrees is a combinatoric function of the total number of conditions in the plurality of conditional compilation directives appearing in original source module file 206B. Therefore, it may be neither practical, nor of significant use, to generate differentiated metatrees for all of the possible combinations of the conditions in the conditional compilation directives, when the number of combinations is large.

In the actual browsing of the rapid comprehension source documentation, a user may be interested in either its undifferentiated form, containing the conditional compilation directives (e.g., a programmer preparing to edit the original source module) or one of the differentiated forms, corresponding to a particular computing platform (e.g., a HP 9000 platform, or a HPUX 11.0 platform). Consequently, this embodiment of the invention provides alternate techniques for generating undifferentiated metatrees and differentiated metatrees.

The generation of a differentiated metatree is a straight-forward process, and is deterministic because the ambiguity of a plurality of conditional compilation directives is removed. The generation of undifferentiated metatrees is not completely deterministic, however, and gives rise to alternate strategies of dealing with special cases of combined conditional compilation directives.

In one embodiment, both kinds of metatrees, i.e., undifferentiated metatrees and differentiated metatrees, may be generated with the same patching process. Herein, differentiated and diversion are used interchangeably. A diversion metatree, being deterministic, is always generated successfully, but dividing the undifferentiated module into patches may sometimes fail.

If the process of patching the undifferentiated module does not fail, which is expected in the majority of cases, the resulting undifferentiated metatree is the only metatree stored in cradle file system 115. This undifferentiated metatree is used to generate undifferentiated rapid comprehension source documentation. Subsequently, diversion metatrees of this undifferentiated metatree may be generated as required, and diversion rapid comprehension documents may be generated from the diversion metatrees. This embodiment is discussed immediately below.

In this embodiment, a source code adapter operation 410 (FIG. 4A) contains, as described more completely below, a loop 411 to process each source code module file in original source computer program 105B. The loop includes an include file scan operation 412, another loop 413 for each include file and module file, an accumulate macro definitions operation 414, and a source-code patching operation 415, which partitions each include file and each module file into patches.

In the case of an undifferentiated source code module file, source code patching operation 415 may fail due to indeterminism of patch boundaries in conditional compilation directives. A pass-fail check operation 416, therefore, is applied for each file to determine whether patching operation 415 failed.

If source code patching operation 415 successfully processed the text in the current file, check operation 416 transfers to parsing and data assimilation operation 418 and otherwise to create diversion operation 417. Hence, if a failure occurs in patching operation 415 due to indeterminism of patch boundaries, create diversion operation 417 is employed to reduce the undifferentiated text of the current module to its diversion form.

Operation 417 deletes all text for which conditional decisions in the conditional compilation directives fail (e.g., the conditional decision would execute as false and so the normal compiler would not see the text associated with that conditional decision) and deletes all the conditional compilation directive lines. Operation 417 transfers back to source-code patching operation 415 upon completion.

Source code patching operation 415 is repeated for the diversion module (which cannot fail) thus completing the partitioning. Hence, check operation 416 transfers to operation 418 following the patching of the diversion module.

Consequently, a successful partitioning of either the undifferentiated module or the diversion module is followed by a parsing and data assimilation operation 418 and an explode operation 419, which explodes and writes module data into a metatree file set, which is associated with the module-local data, in cradle file system 115. These operations are described more completely below. A further operation 420, which is a sub-process of operation 419, adds external data, common to all modules, to a global metatree in cradle file system 115.

For the current module in loop 411 (FIG. 4A), include file scan operation 412 scans the current module for include statements. Each file listed in an include statement is added to a list of files. Each file in the list of files is further scanned for additional include statements. This expansion is continued until no further include statements are found. Upon completion of include file scan operation 412, a list of files has been created and the include files in this list are ordered in compiler-apprehension order. The current module is the last entry in this list of files.

Upon completion of operation 412, loop 413 processes each entry, in sequence, in the list of files generated by operation 412. The first operation in loop 413 is accumulate macro definitions operation 414. For the current file, accumulate macro definitions operation 414 scans the current file for macro definitions.

Operation 414 saves each macro found in a macro hash. The macro name is a key to the macro within the macro hash, i.e., the macro hash is indexed by macro name for lookup during parsing and data assimilation operation 418. Multi-line macros are treated as quasi-patches, and in one embodiment, may have <macro_name>.pat files in the metatree. However, multi-line macros are not collapsed in the containing patch file. Upon completion of operation 414, processing transfers to source-code patching operation 415 in loop 413. Typically, only the module file has internal patches. The include files typically are each a patch. Other quasi-patches, such as structs, unions, or enums, may be found during patching operation 415 and are treated like macros.

FIG. 4B is a more detailed diagram of one embodiment of source-code patching operation 415, which is used to scan both undifferentiated source modules and diversions. If undifferentiated scanning can fail due to lack of determinism, this is the operation where that failure occurs.

Operation 415 is a non-linear scan of each include file and the module file to partition the files into rapid-comprehension display patches, which nominally correspond to functions (subroutines) or markup containers. However, as the undifferentiated source code module may contain conditional compilation directive cell groups (e.g., #ifdef . . . #else . . . #endif) display patches are adjusted to encompass such conditional compilation directive cell groups.

Operation 415 begins with a module pre-scan operation 450 to replace comments with blanks, so that comments do not interfere with subsequent scans. Diversion check operation 451 determines if the current module is an undifferentiated module or a diversion module. In one embodiment, diversion check operation 451 determines whether the current module contains any conditional compilation directives. In another embodiment, diversion check operation 451 determines whether a diversion flag has been set by operation 417. If conditional compilation directives are in the module, the module is conditionally undifferentiated. If no conditional compilation directives are found, the module is either a diversion module, where the conditional compilation directives have been removed by operation 417, or is unconditionally undifferentiated, i.e., no conditional compilation directives in the original module. If the module is conditionally undifferentiated, check operation 451 transfers to scan operation 452 and otherwise to operation 455B.

Scan operation 452 accumulates all conditional compilation directive cell groups. Conditional compilation directive cells-represented by the ellipses (. . . ) in the above example-contain lines of conditional text to be compiled or not depending on the condition of the directives. Operation 453 removes conditional compilation directive cells nested within the outer conditional compilation directive cells, since the nested conditional compilation directive cells do not affect the determination of the patch boundaries.

However, in some rare circumstances, these nested conditional compilation directive cells can affect the code-to-prose/pseudocode translation of parser-hasher 214B. In these rare circumstances, a nested conditional compilation directive cell breaks a metaprogram grammar rule (e.g., compound statement syntax rules) and as a result standard parsing fails.

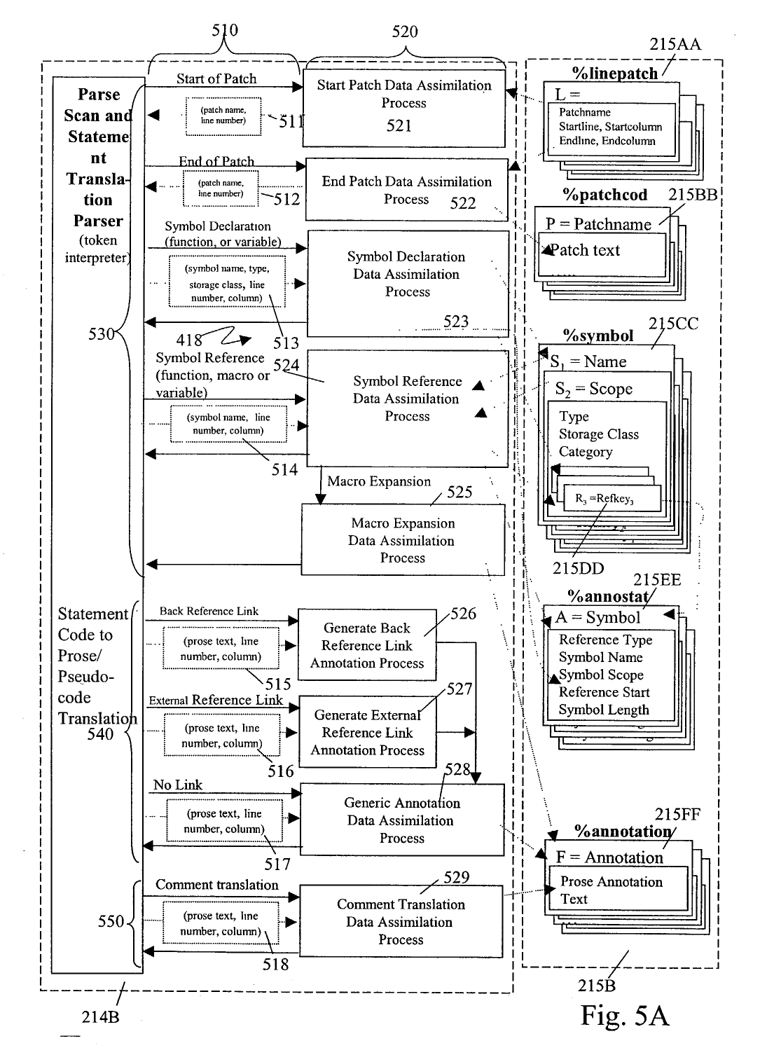

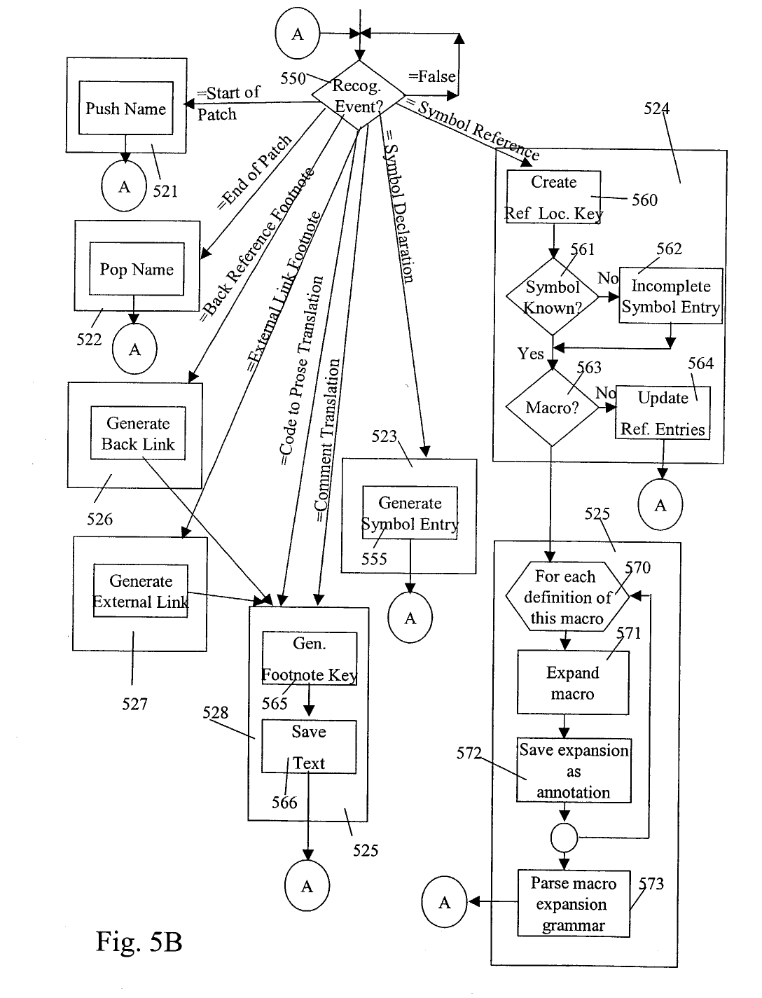

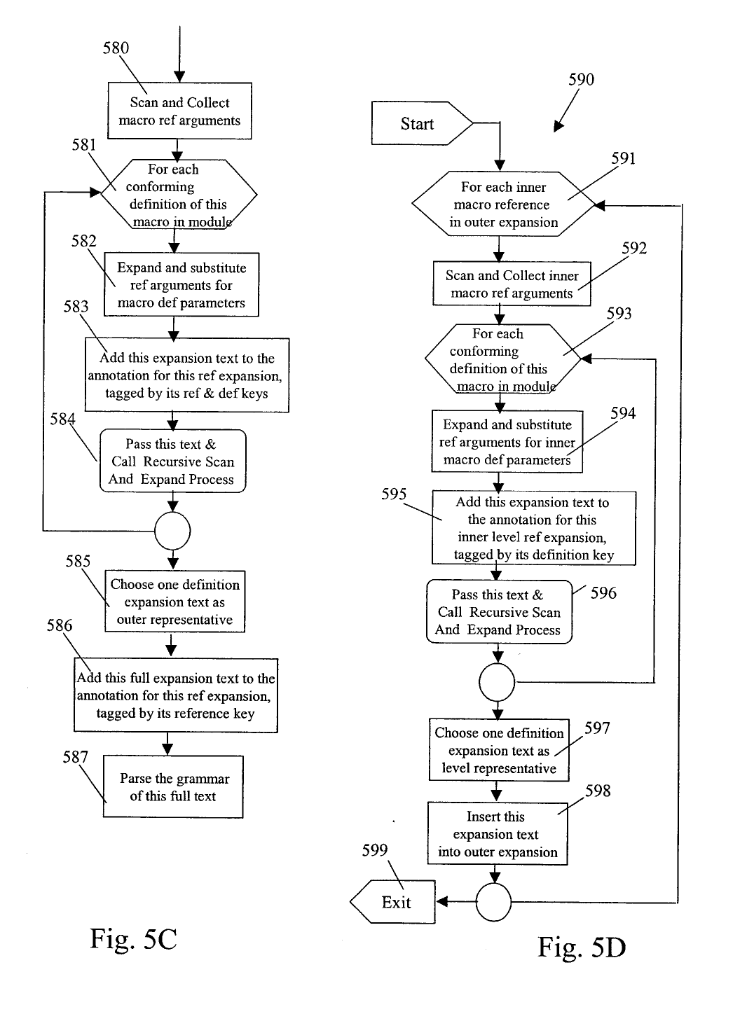

An alternative strategy for dealing with these special cases involves annotation-generating translation by parsing all of the relevant conditional directive cell expansions. In this special case, source code patcher 211B would recognize the special cases and upon recognition, would augment hash %linepatches 215AA (FIG. 5A) to convey the parameters necessary for parser-hasher 214B to perform alternative cell parsing.

Operations 455A to 459 in loop 454 deal with each conditional compilation directive cell, or if there are no conditional compilation directive cells, operations 455A to 459 are executed at least once. Operation 455A locates function body blocks contained within the conditional compilation directive cell. In one embodiment, this involves finding a beginning brace {, i.e., a left brace, and a corresponding ending brace}, i.e., a corresponding right brace, of each block containing the body of a function (applies to C-genre languages: C, C++, Java, Perl, PHP, etc.). The ending brace establishes the nominal end of a patch.

Operation 456A scans backward from the beginning of each block to the head of the function to establish the nominal beginning of a patch, i.e., a heading. Decision operation 457 examines the nominal patch begin and end lines relative to the conditional compilation directive cell. If the patch is not fully contained in the conditional compilation directive cell, operation 458 adjusts the beginning, the heading, or ending, the ending brace, of the patch to match the boundaries of the conditional compilation directive cell, thus extending the patch beyond the boundaries of the function. Operation 458 is said to adjust the patch boundaries so that the conditional compilation cell is contained within the patch. If both operation 456A and operation 458 are unsuccessful, operation 415 fails for indeterminism of the patch boundaries.

If the patch is fully contained within the conditional compilation directive cell, the nominal boundaries of the patch are accepted. Check operation 459 determines whether processing relative to a conditional compilation directive cell is complete (all blocks have been processed into patches). If processing is not complete, processing loops back to operation 455A.

After all patches have been defined, patch data is accumulated into two hashes, hash %linepatches, and hash %patchlines, by operations 460 and 461 respectively. The former (referring to FIG. 4A) is used in parsing and data assimilation operation 418, and the latter is used in explode operation 419.

If diversion check operation 451 found the text to be a diversion module, no conditional cell groups are present and operations 455B and 456B are executed only once. Operations 455A and 455B are the same operation, but are shown separately for clarity. Similarly, operations 456A and 456B are the same operation.

FIGS. 5A to 5D are a more detailed diagram of one embodiment of parsing and data assimilation operation 418. In operation 418, quasi-patches found during parsing are treated like macros. In this embodiment, parser-hasher 214 is a parse, scan and statement translation parser that performs one of a plurality of data assimilation sub-processes 520 in response to a corresponding recognition and translation event in a plurality of recognition and translation events 510. Each recognition event and the corresponding data assimilation sub-process are included either in an auto-generic recognition and identification process 530, in an auto-generic statement code to prose/pseudocode translation process 540, or in an auto-specific comment-translation process 550.

The sub-processes and corresponding recognition and translation events in FIGS. 5A to 5D are illustrative only of one embodiment of the invention and are not intended to limit the invention to the specific set of processes and events shown. In view of this disclosure, those of skill in the art can include all sub-processes and corresponding events necessary to successfully process each of the patches for a particular type of original source information.

Recognition events in auto-generic recognition and identification process 530 include start of patch event 511, end of patch event 512, symbol declaration event 513, and symbol reference event 514. Recognition events in statement code-to-prose/pseudocode translation process 540 include back-reference link event translation 515, external-reference link event translation 516, and no-link event translation 517. In this embodiment, the recognition event included in auto-specific comment-translation process 550 is comment translation event 518.

Start of patch data assimilation sub-process 521 (See FIG. 5B) is performed in response to start of patch event 511 and so is said to be the data assimilation process corresponding to start of patch event 511. Start of patch event 511 is triggered by a polling process at the beginning of each source line, where hash %linepatches 215AA is accessed with the current source line number as an index. If a patch begins at this line number, hash %linepatches 215AA has a corresponding entry, containing the patch name, start line and start column of the patch, along with the end line and end column of the patch.

After this event, a subsequent polling process is invoked as each subsequent character of text is read. The location of the character is tested to determine if the line-number matches the start line and the column number matches the start column. When this occurs, the patch data assimilation sub-process 521 (FIGS. 5A and 5B) is invoked and passed the patch name. In sub-process 521, the patch name is pushed onto a scope stack, registering that all subsequent symbol names encountered, while this name is on the top of the stack, belong to (are visible in) this patch's scope, and then sub-process 521 returns.

In FIG. 5B, the return is to recognition event check operation 550. However, this is illustrative only. Those of skill in the art will understand that parser-hasher 214 continues processing source computer program module file 206, and when one of the plurality of recognition events occurs, recognition event check operation 550 transfers processing to the corresponding data assimilation process. Hence, FIG. 5B should not be interpreted to require parser-hasher 214 to be idling in event check operation 550.

As each subsequent source-code character is read, the current line number and column number is polled to see if each matches the corresponding patch end line and end column, respectively. When this occurs, end of patch event 512 occurs, and processing transfers to end of patch data assimilation sub-process 522 (FIGS. 5A and 5B), which pops the patch name off the scope stack thereby returning the scope to that of the outer container patch, which is returned to the top of the stack. End patch data assimilation operation 522 also writes the patch text to hash %patchcode 215BB that is indexed by the patch name as a key.

When a symbol declaration event 513 occurs, processing transfers to symbol declaration data assimilation sub-process 523 (FIGS. 5A and 5B). Symbol declaration event 513 passes to sub-process 523 (i) the symbol name, (ii) the line number of the line in the source code that contains the symbol name, and (iii) the column in that line where the first character of the symbol name is located.

In symbol declaration data assimilation sub-process 523, generate symbol entry operation 555 (FIG. 5B) creates an entry for a name symbol in patch-hash buffer memory 215B. In one embodiment, process 523 creates the name symbol entry in a symbol hash structure %symbol 215CC with the symbol name and scope as keys. The symbol data type (integer, floating point, etc.), storage class (static, external, automatic, etc.), and symbol category (scalar, array, struct, enum, union, function, macro, etc.) are also stored with the name symbol entry. Operation 555 also creates a reference location key for the name symbol reference in a symbol reference statistics hash %annostat 215EE (see operation 524), and appends this key 215DD to an array of reference location keys in the name symbol entry.

In symbol reference data assimilation sub-process 524 (FIGS. 5A and 5B), the reference location key is created by operation 560. This key has the form shown in TABLE 1. The key is a juxtaposition of three items: patch name, line number within the patch, and symbol sequence letter indicating its position relative to other symbols on that line.

Symbol known decision 561 looks up the symbol name in hash %symbol 215CC to see if the symbol name is known, and to retrieve the scope of the symbol name if so. If the name symbol is known, operation 561 transfers to macro check operation 563, and otherwise to operation 562. Operation 562 generates an incomplete symbol entry to be completed by subsequent references. Operation 562 also transfers to macro check operation 563.

Macro check operation 563 determines whether the name symbol is a macro reference. If the name symbol is not a macro reference, an entry with this reference key is created or updated in hash %annostat 215EE in operation 564. The data associated with the key includes the reference type (function or variable), the name of the name symbol, the scope of the name symbol, the column number within the line, and the length of the name symbol.

If macro check operation 563 detects that the name symbol is a macro reference, macro expansion data assimilation process 525 (FIGS. 5A and 5B) is executed. Since there may be a plurality of definitions of the same macro in an undifferentiated module, e.g., in the module text or one of the include files of the module, it is important to expand each macro definition for the purpose of generating rapid comprehension source documentation. This is achieved by a loop 570 over the plurality of macro definitions, where each macro definition is expanded in-line with substitution of arguments of the macro reference (macro call) for each of the corresponding definition parameters by expand macro operation 571.

Next, in operation 572, this expansion text is saved as annotation in hash %annotation 215FF. The expansion text is displayed as a mouseover tooltip in the rapid comprehension source documentation for the name symbol that is the macro reference.

Finally, operation 573 parses the macro expansion grammar of one of the plurality of macro expansions. This is required to maintain grammatical continuity of the rules of the language syntax being processed. It is not necessary for annotation generation, however, therefore only the grammar pattern of the macro expansion is scanned to check its syntax. No translation or symbol lookup is performed.

Since a macro expansion may contain nested macro references, and the expansion of these macros may contain further macro references, etc., process 525 is actually a recursive process, as explained in more detail in FIG. 5C. In this embodiment, process 525 generates the maximum amount of annotation information to augment the ability of users to drill-down into the hidden logic of inline macro expansions, especially when macro nesting is employed. Moreover, in this embodiment, the same process is used to provide this documentation as part of the undifferentiated metatree rapid comprehension source documentation and as part of the single diversion metatree rapid comprehension source documentation.

Using process 525 for an undifferentiated source module adds considerable complexity over a diversion source module, which has only one definition per macro. Moreover, unless all members of the plurality of definitions per macro in the undifferentiated source have the same number of parameters, some of the definitions do not conform to the set of default conditions present in the parent macro definition in the undifferentiated source, sometimes called the parent diversion, and cannot be expanded in-line. Nevertheless, annotation of in-line expanded macro definitions can be generated for those macro definitions in the undifferentiated source that do conform to the parent macro definition. Such annotation is referred to as undifferentiated macro annotation.

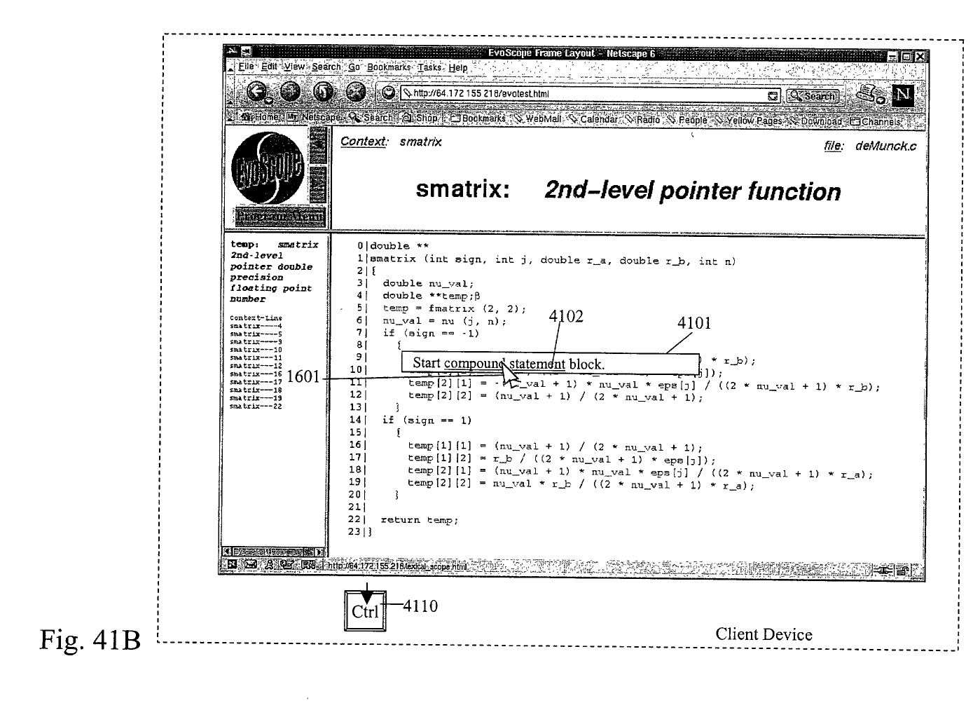

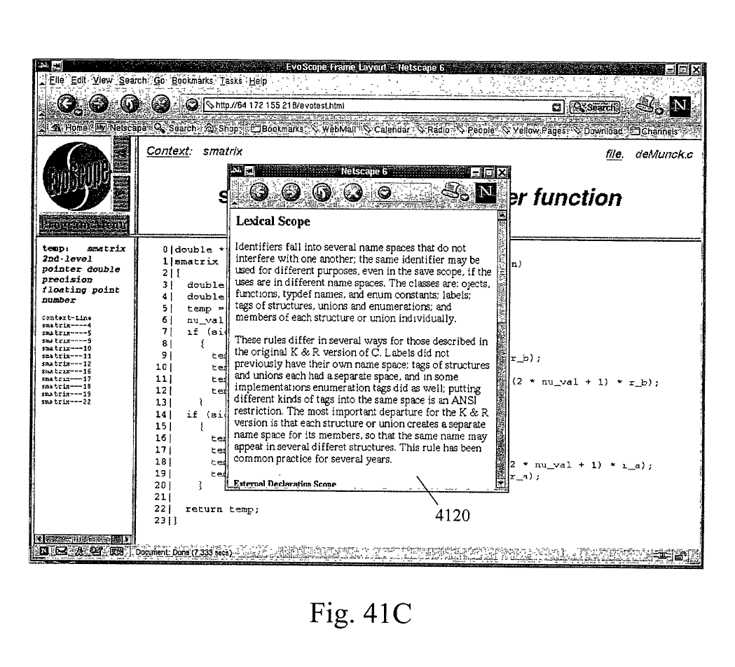

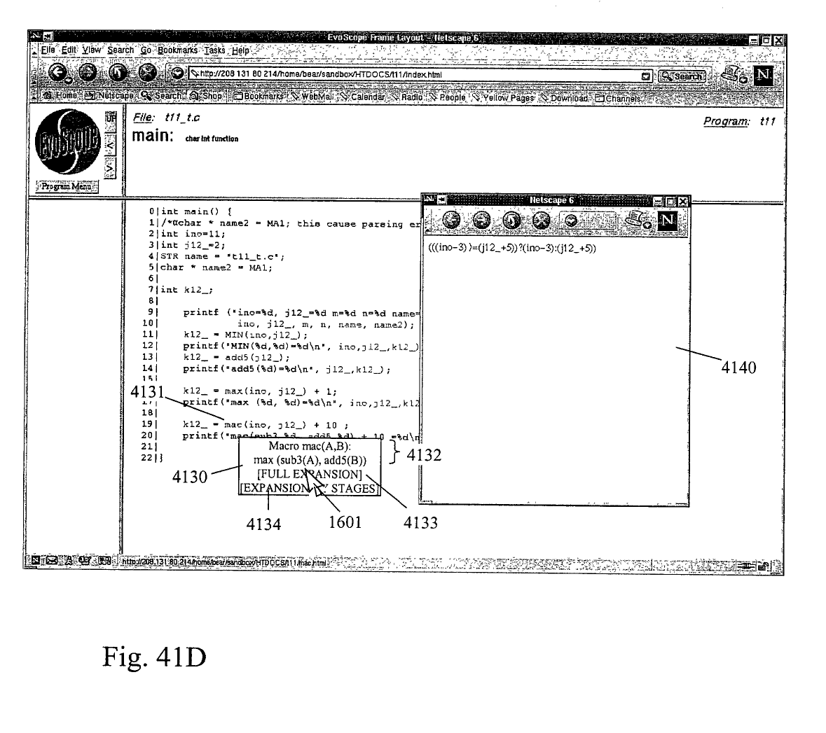

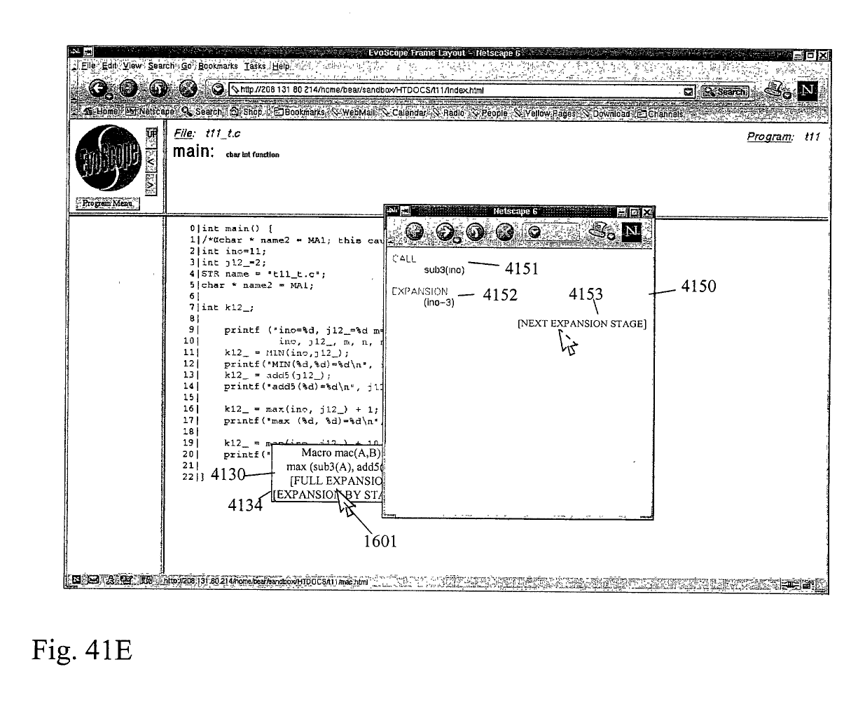

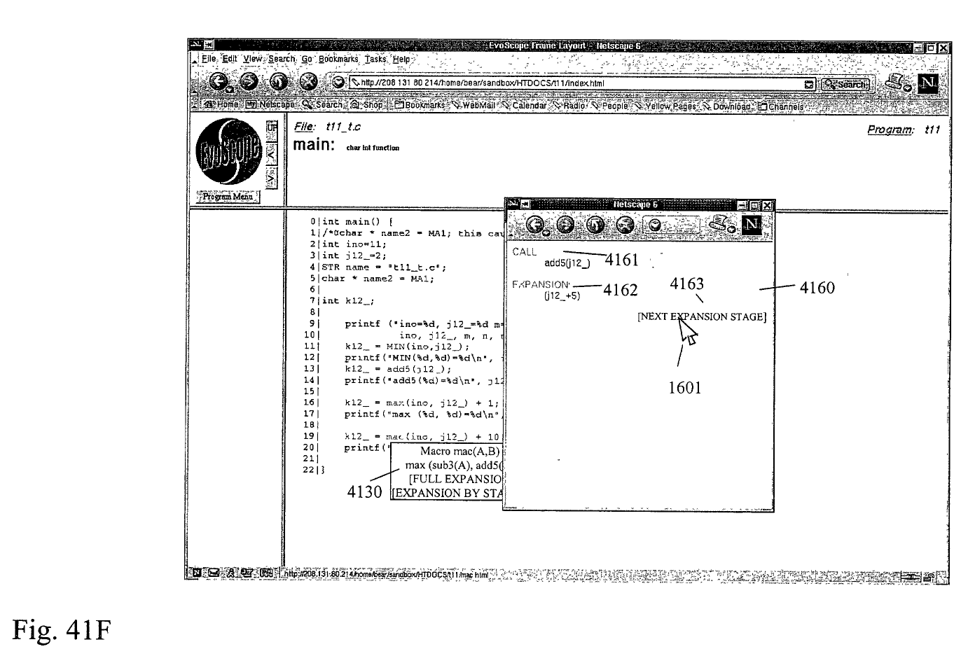

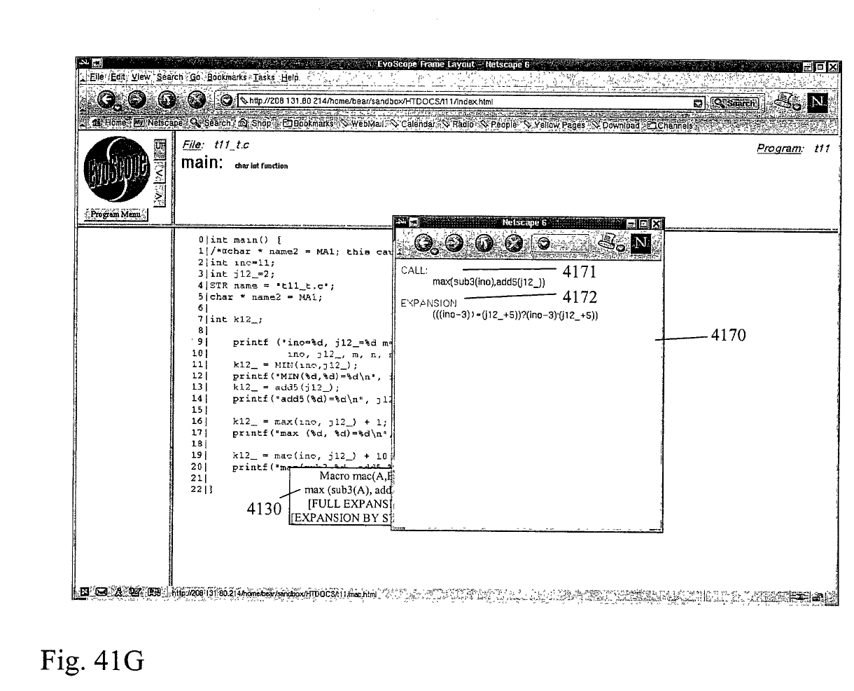

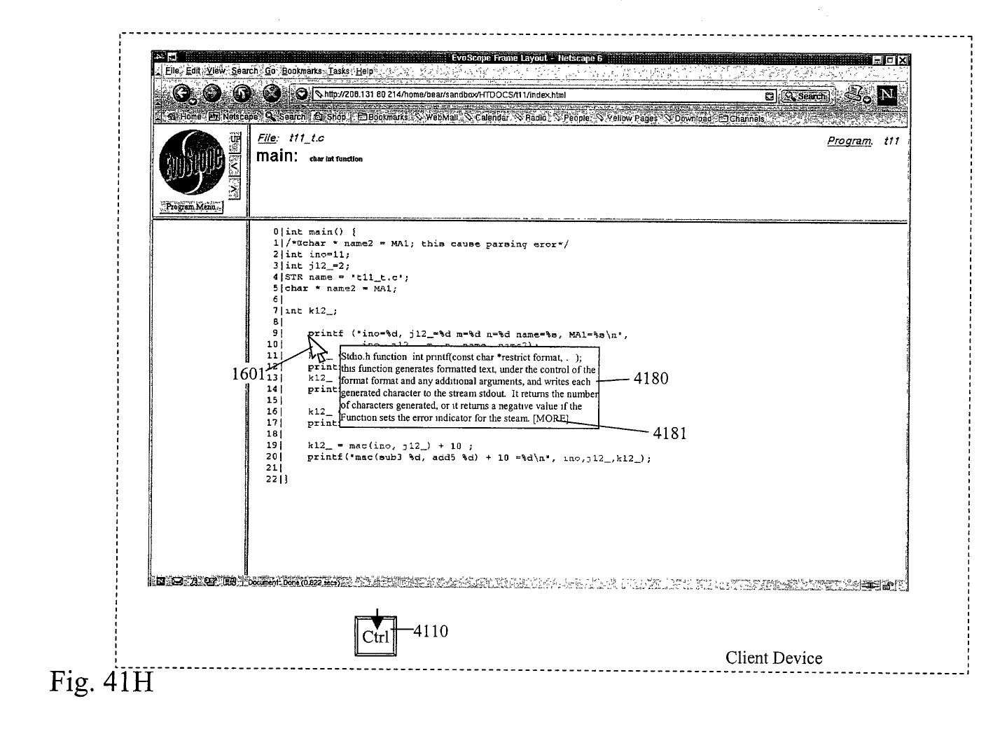

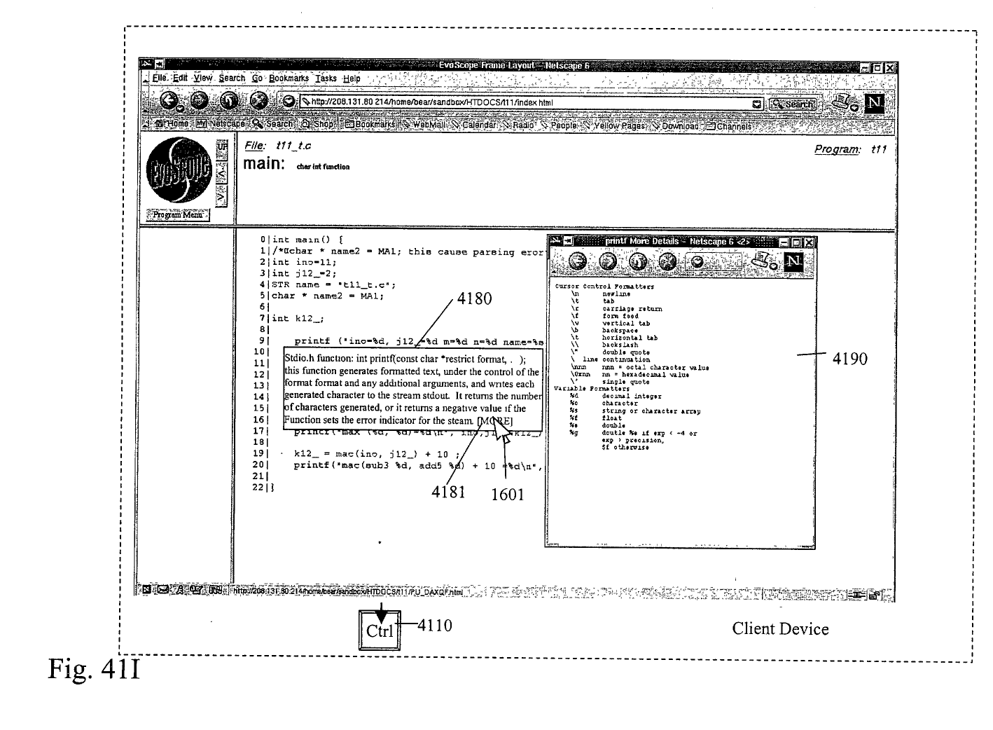

This undifferentiated macro annotation can only be practically displayed in the rapid comprehension source documentation in reduced form, namely a plurality of alternate single-stage macro expansions per a plurality of definitions, displayed as a menu of alternate linked components to be aggregated stage-by-stage and macro-by-macro in each stage into an expansion hierarchy representing the fully expanded text. See FIGS. 41D to 41G and the related description, which is incorporated herein by reference.

The hierarchy itself cannot be practically shown undifferentiated, as that would require a combinatoric plurality of hierarchies expanding all combinations of all alternative components. Only a single hierarchy can be shown, in general, corresponding to a choice being made for each component plurality. By convention, the component chosen is the one in each menu of alternates that belongs to the parent diversion macro.

FIG. 5C is a more-detailed linear representation of the portion of recursive process 525 that accumulates this undifferentiated annotation information for a single macro reference (call). First, operation 580 scans and collects the arguments of the call. Loop operation 581 cycles over each definition of this macro in the undifferentiated text of the module or in the include files for the module, i.e., all files in the include list, that conforms to the call, e.g., has the same number of parameters as the call has arguments.

Operation 582 expands the replacement text of the current conforming macro definition, and substitutes into this text the arguments of the macro call, for the parameters of the definition. Operation 583 adds this expansion text to hash %annotation 215FF. In one embodiment, the key for this expansion text is composed of the macro symbol reference key <patchname>-<line-number><sequence-letter> appended to the string $MX<macro-definition-index> that is a definition key. This key is referred to below as the higher key.

The macro symbol reference key relates to the position of the macro call symbol, from which a tooltip annotation in the rapid comprehension source documentation webpage is triggered in response to a mouseover event. The other string in the key is a menu index, which determines a pair of menu links in the tooltip annotation to popup windows containing the macro description and this expansion of that description respectively. Since this expansion can itself contain macro calls, operation 584 recursively scans this expansion text by calling a recursive scan and expand process 590 (FIG. 5D).

Recursive scan and expand process 590 receives the expansion text as a subroutine argument. Loop operation 591 cycles over each inner macro reference appearing in the current expansion text, if any.

Operation 592 sequentially scans each symbol in the expansion text for a macro symbol reference. If no macro symbol reference is found in operation 592, a break transfer is made from operation 592 to exit operation 599, which exits loop 591 and process 590. Conversely, if a macro symbol reference is found, operation 592 then scans for arguments of the macro symbol reference and transfers to loop 593.

Loop 593 is entered to cycle over each conforming definition of the macro symbol reference just found. Operation 594 expands the text of the current definition and substitutes the arguments of the inner macro reference for the arguments of the current definition, thus fleshing out the expansion text for this macro call at this expansion stage of the outer macro call.

Operation 595 adds this expansion text to hash %annotation 215FF. The key for this expansion text in hash %annotation 215FF is the higher key described above with the string <inner-macro-name>$<current-definition-index> appended. In the rapid comprehension source documentation, this annotation text is accessible in a popup window linked from the popup window containing the higher-level expansion of which this macro symbol reference is a part.

Since this expansion can itself contain macro calls, operation 596 recursively scans this expansion text by calling a recursive scan and expand process 590 (FIG. 5D).

When loop 593 is finished for each conforming definition of this macro symbol reference, hash %annotation 215 contains a list of keyed text produced in loop 593. In generating the rapid comprehension source documentation, as described below, this list of keyed text enables the popup window in the rapid comprehension source documentation that is associated with the higher key to contain a menu, properly interleaved in its expansion text, of the all of the definitions of each inner macro reference occurring within the corresponding conforming definition macro symbol reference.

In this manner, a hierarchy of linked popup windows is enabled, each containing a single level expansion of a macro call emanating from an original outer reference of a macro call. In this hierarchy of linked popup windows, all of the conformable expansions of the outer macro may be traced via a drill-down process, providing a reduction of the outer macro expansion, depending on which set of definition selections are made in the menu of each intermediate popup.

Upon exit of loop 593, operation 597, in this embodiment, chooses one of the definitions of the current inner macro expansions as representative of this level of the expansion, for the purpose of aggregating the hierarchy of definition choices into a single full expansion of macro replacement text of the outer macro call. Thus, a differentiation is made at this point, as a single choice must be made for aggregation, and to be free from error, the same choice must be made at each level, i.e., the same diversion must be selected. Thus, the choice conforming to the parent diversion is made. The expansion text of this macro definition for the current macro call is then inserted into the outer expansion text by operation 598. Upon completion of loop 591, operation 599 returns to the operation, which called process 590, i.e., either operation 596 or operation 584.

In the case of the latter (the outermost macro call), loop 581 continues to completion, fleshing out all of the reduced annotations that are linked into the tooltip display at the top of the reduced expansion hierarchy to popup sub-expansion menus constituting the lower hierarchy. Following the completion of loop 581, the choice made by operation 597 is also made by operation 585 to enable the aggregation of the full expansion text of the outer macro call. Finally, operation 587 parses the grammar of this fully expanded text, which completes operation 525. Operation 587 is one embodiment of operation 573. Parsing the macro text enables the parser to transition over the macro reference, which the parser would otherwise regard as a function call, or a variable name if the macro did not have an argument list.

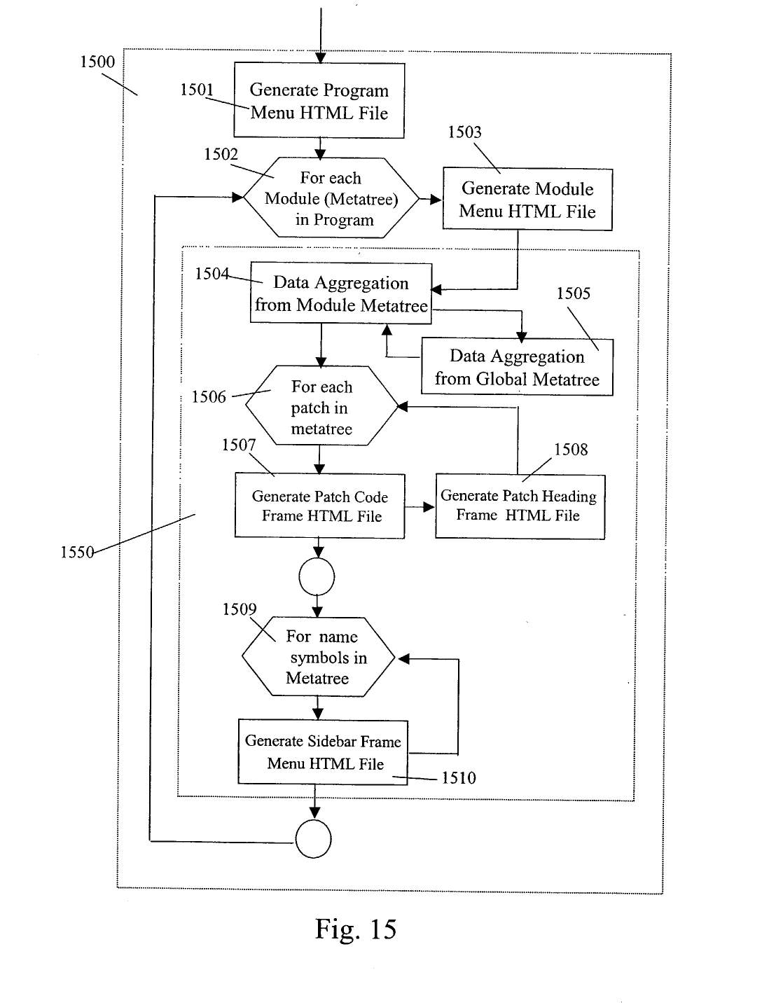

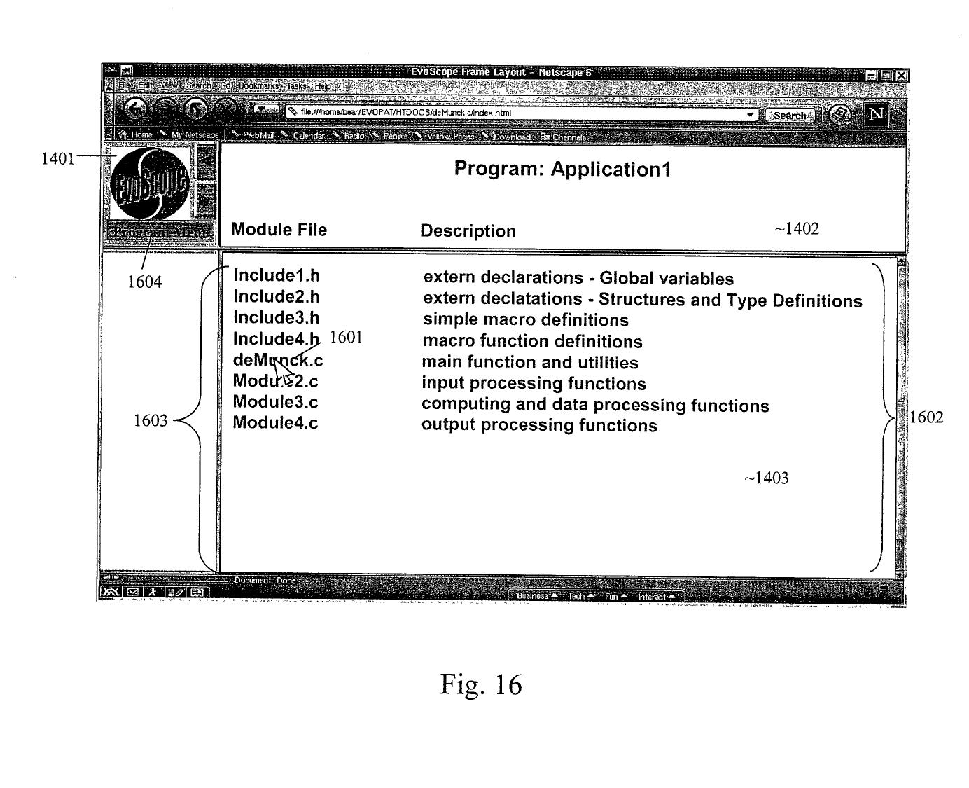

Thus, all of the macro expansion text is saved in hash %annotation. The reference key to the macro call in hash %annostat is <patchname><line#><symbol-index-letter> as the prefix to the key for hash %annotation, with a suffix $MX for full expansion of macros with arguments and $mx for macros without arguments. Macro stage subexpansions are stored using keys with the same structure with a stage number appended. The macro symbols are collected into hash %symbol (indexed by macro name and patch where the macro was defined), where the symbol entry contains a vector of the reference keys of hash %annostat that are globalized by operation 1504 and 1505 (FIG. 15), so all references in the program are accounted for and easily indexed during HTML generation. To reference the macro expansion text requires simply adding the $MX suffixes.

As explained more completely below, the saved macro call and expansion text, described above, are used to generate linked popup windows. The illustrations of FIGS. 41D to 41G show a single path expansion hierarchy where there is only one possible expansion at each stage, instead of a menu of alternative expansions. (Stage here means expansion sequence number not expansion level-there can be several macro calls in each macro body, which can be thought of as being on the same level, whereas expansion sequence proceeds left-to-right expanding each macro as soon as it is encountered, as a stage in the full expansion.)

In the case of multiple definitions (per stage), the FULL EXPANSION illustrated in FIG. 41D would only correspond to the parent diversion-the result of sequentially selecting each of the expansions in FIGS. 41E to 41G leading to the full expansion in FIG. 41I. In such a case, the stage wise popups in FIGS. 41E to 41G would each contain a menu of alternate expansions; and an arbitrary sequence of selections would lead to one of a plurality of full expansions.

Event operations group 540 (FIG. 5A) assimilate generic annotations by translation of source-code statements and phrases into prose/pseudocode descriptions, which (when later converted to webpage artifacts) are displayed as tooltip displays whenever certain punctuation or ancillary trigger symbols including single letters within names, line-numbers, and blank text before and after lines of text are intersected by the mouse cursor, which is called herein a mouseover. These annotation trigger symbols may have associated mouse-click links as well, with or without tooltip displays.

For example, a right brace} may be a footnote annotation trigger symbol, which when clicked causes the corresponding left brace {to be highlighted. This type of link is called a back-reference link. In addition to highlighting bracketed pairs, back-reference links are employed to highlight the target symbols referenced by goto, break, continue, and other types of source code statement, which invoke transfers between source code statements.

Another type of link may be contained within a displayed tooltip, as an ordinary hyperlink. These links are called external links, as their primary purpose is to invoke external webpages into auxiliary popup windows.

Hence, statement code-to-prose/pseudocode translation events 540 include, in this embodiment, back reference link events 515, external reference link events 516, and no link events 517. Reference link annotation operations 526 and 527 for link events 515 and 516, respectively, are preprocesses to generic annotation data assimilation sub-process 528. Operations 526 and 527 (FIG. 5B) merely generate the specific link tag and text, add the link tag and text to the annotation text, and call sub-process 528, which generates the annotation key and saves the complete annotation text in an annotation hash %annotation 215EE. Annotation keys have the structure shown in TABLE 2.

Auto-specific annotation process 550, which translates source code comments into annotations, invokes comment translation data assimilation sub-process 529, which also invokes generic annotation data assimilation sub-process 528.

A data assimilation sub-process results in information being read from or stored into hashes in patch-hatch buffer memory 215B. One embodiment of the hashes is presented in FIG. 5A. As explained more completely below, the information in patch-hatch buffer memory 215B is stored in cradle file system 115 in explode module data into cradle metatree operation 419, sometimes called explode operation 419.

The operations performed in explode module data into cradle metatree operation 419 depend upon the data storage structures used in cradle file system 115. Hence, prior to considering operation 419 in more detail, one embodiment for a cradle structure 600 that is used to store information in cradle file system 115, is considered.

Cradle Structure

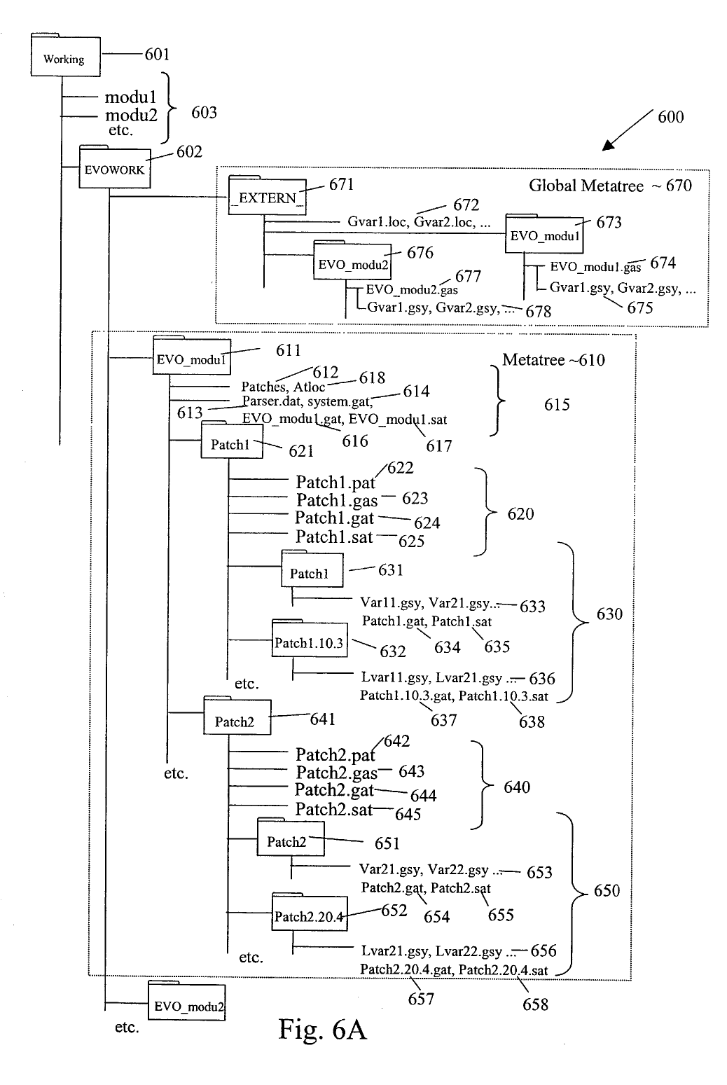

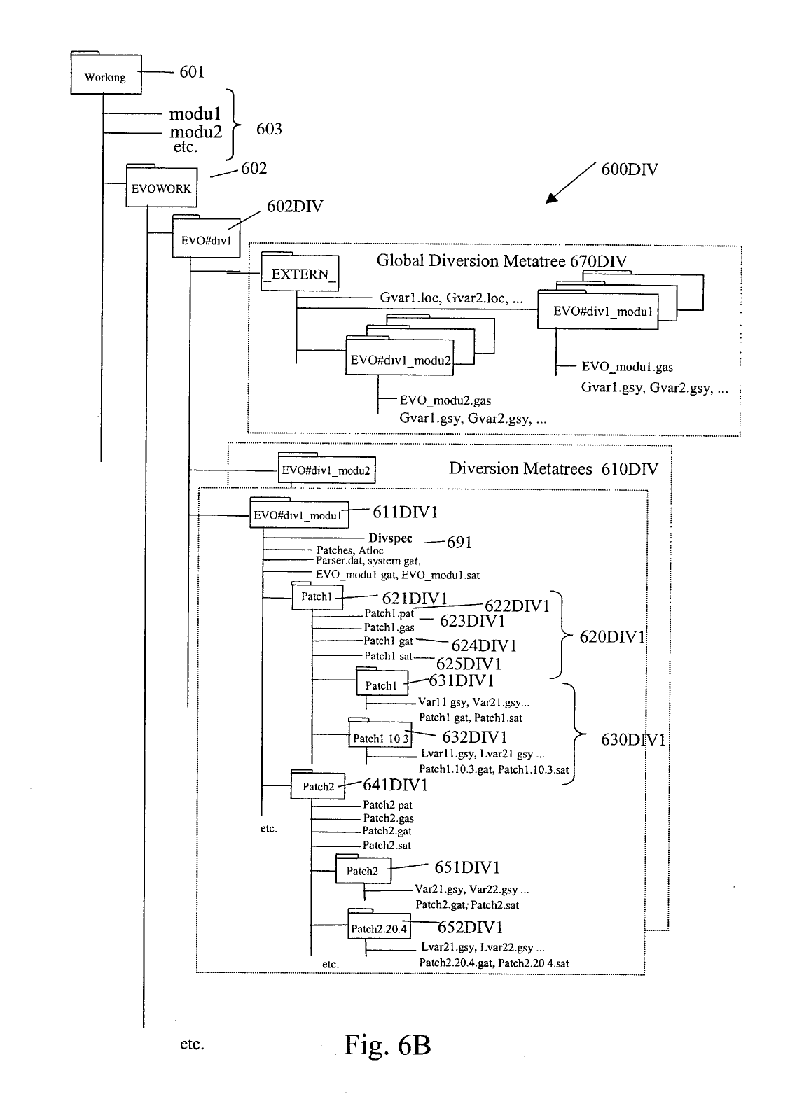

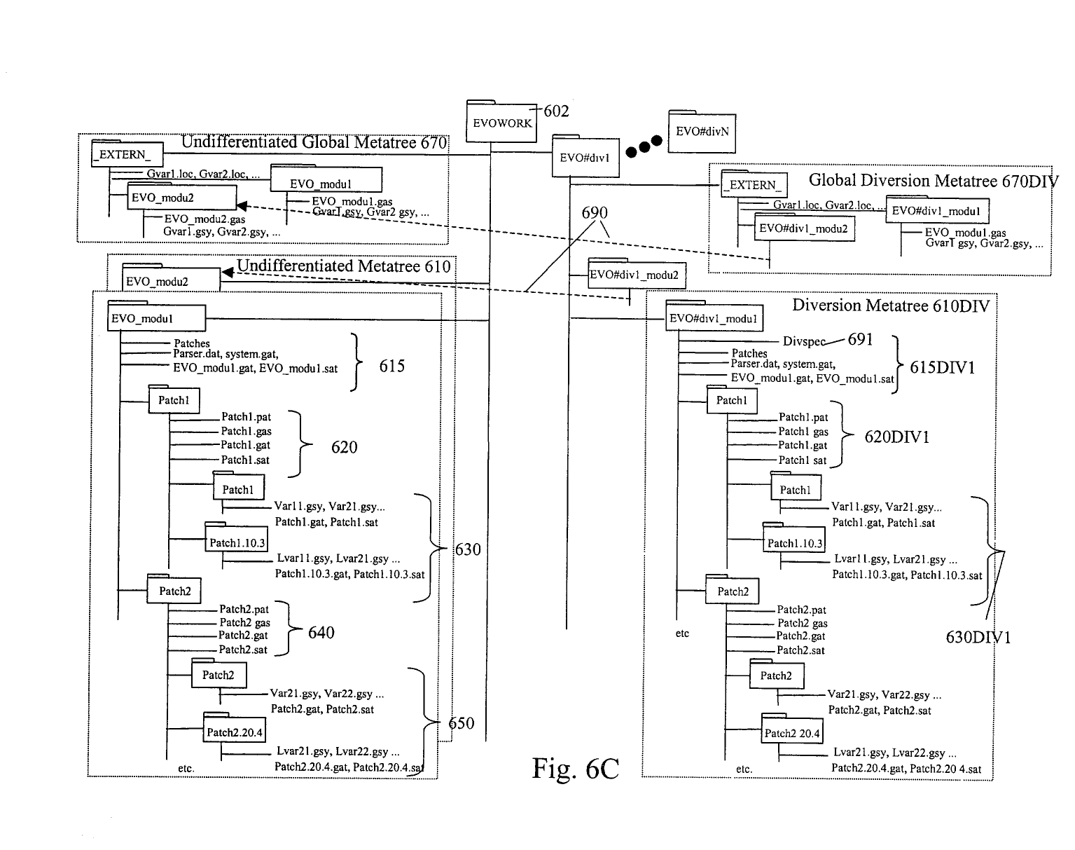

In general terms, a metatree, e.g., metatree 610 (FIG. 6A) is a convenient storage distribution of the data contained in a program module file, e.g., explosion of a combination of aggregated (e.g., merged) memory data-structure objects made up of arrays and associative arrays (e.g., name indexed arrays). The associative arrays, sometimes called hashes, are indexed by keywords, sometimes called keys, which may be composites of subdivided strings (e.g., prefix, name, suffix) in which the string subdivisions correspond to storage subdivisions.

This gives rise to the notion of hash files, which, like ISAM files, contain the keys as part of the data records. However, the keys are not used to address the records in the files, as in the case of ISAM addressing. Rather, as a gang process, the files are read into, i.e., aggregated into, associative array data objects in memory, where the speed of complex addressing is greatly enhanced. For data persistence, the associative array data objects are exploded into metatree 610 as a gang process, when data processing is complete or is transitioning to a separate process.

The keys are also content pointers in that the keys are coded to describe the patch, line, line position, e.g. column, and redundancy of the symbols that the keys pertain to in the source text. A further benefit of the exploded hash file hierarchy is that the keys provide visual aids to assist in debugging, when used by a powerful file manager, such as KDE Konqueror, which promotes very quick access to online data.

As illustrated in FIG. 6A, a working directory 601 includes a plurality 603 of original source computer program module files Modu1, Modu2, . . . Also, included in working directory 601 is an EVOWORK directory 602. Within EVOWORK directory 602 is a plurality of Evo_module directories (metatrees) EVO_modu1 611, EVO_modu2, . . . In cases where a program involves more than one module file, there is an _EXTERN_ directory 671 of a global metatree 670, which contains global symbol names, referenced from any other module (metatree) in the program. There is one EVOWORK directory for each original source computer program file collection that has been processed using source-code adapter 210B, in this example, and for which source code adapter operation 410 completed successfully.

Each EVOWORK directory has the same basic hierarchical structure and so only metatree 610 that includes directory EVO_modu1 611 is described. In view of the disclosure of this embodiment, those of skill in the art will understand the structure of the other EVO_module directories.

As illustrated in FIG. 6A, topmost directory EVO_modu1 611 is named as a derivative of the name of source computer program file Modu1. Directory EVO_modu1 611 contains subdirectories 621, 641 that are named as derivatives of the names of patches. The particular naming of the directories and files in metatree 610 is not critical to this invention. The naming convention used herein is illustrative only and is not intended to limit the invention to this embodiment.

As explained more completely below, each subdirectory in directory EVO_modu1 611 contains files, appropriately tagged to indicate content type. The attributes, derived from operations 415, 418, and 419 (FIG. 4A), pertaining to the patch associated with each subdirectory are stored employing associative-array correspondence relating the attributes of the text content of each partitioned element to the reference position (e.g., line and character position) in the text wherein the attribute pertains. As explained more completely below, this associative-array correspondence enables the files to be written from or read into associative-array data-structures in the computer memory.

In this embodiment, metatree 610 contains a set of metatree root files 615 pertaining to the whole metatree as representative of the whole source program module file. The set of metatree root files 615 includes a file patches 612, which lists the names of the patches into which source program module file Modu1 is subdivided. This file is used to reconstruct original module modu1, when needed by a user. File Parser.dat 613 contains information about the source language used in source computer program file Modu1, and identifies and locates the associated computer programs used in source code adapter operation 410. The set of metatree root files 615 also contains a file system.gat 614. File system.gat 614 is a hash file containing annotation text pertaining to system library symbols referenced in metatree 610.

File Atloc 618 is a directory index file containing the list of all subdirectories in the metatree containing annotation text files (*.gat, *.sat, etc.). File Atloc 618 is subsequently used in web annotator 270 to read annotation text from the files in a different order from that in which the files were written, consistent with different layers of annotation.

Also, in this set of metatree root files 615 are files EVO_modu1.gat 616 and EVO_modu1.sat 617. Files 616 and 617 include annotations for system variables and functions. The key system for system variables and functions is the same as for user-defined variable and functions, except that there is an additional key <function-name>$MD for auto-generic more details annotations. In this embodiment, this annotation is not used for user-defined functions.

A system record <function_name>$ contains the information shown in tooltip (FIG. 41H), and system record <function_name>$MD contains the information shown in the popup (FIG. 41I). The information in these records is read from a system library subdirectory containing a <library>.gat file for each system library, e.g., for standard input/output library stdio.h there is a file stdio.gat in this subdirectory, which documents this library. System include files *.gat are loaded into hash %annotation and hash %symbol when the parser-hasher is initialized.

All of the records in each file <lib>.gat are loaded for each library <lib>.h referenced in a system include statement (e.g. include <stdio.h>). While these files are being loaded, the top of the scope stack contains $$SYSTEM$$, so that as the files are stored in hash %symbol, the second (scope) key of the symbol hash has the value $$SYSTEM$$, denoting the symbols as system symbols. At the same time, an internal hash %unused{<symbol-name>} is initialized to all ones. Later during parsing, whenever the symbol is referenced, the corresponding entry in hash %unused{<symbol-name>} is set to zero. At the final wrapup phase of parsing (just before the explosion into cradle files), each system symbol having a one in the symbol's hash %unused{<symbol-name>} is deleted, so that only system symbols that were actually used are stored in file system.gat.

There is another point about file system.gat 614. As each file *.gat file is written from the contents of hash %annotation (grep is used to select keys based upon context defined by the key prefix (e.g. <patchname>), and the name of the file matches that context (e.g. <patchname>.gat); then these grep selected keys are used to delete the corresponding entries from hash %annotation. However, grep is not used in the case of file system.gat. File system.gat merely contains the rest of hash %annotation that is left over after all of the other files *.gat are written and their contents in hash %annotation deleted. Of course, this includes the system symbol annotation. But it also includes macro annotation, external variable and function generic information, etc.

Patch subdirectory Patch1 621 contains a set of patch subdirectory root files 620. In general, each patch subdirectory 621, 641 includes a set of patch subdirectory root files 620, 640 that have the name of the patch as the base of the file name and different extensions. In one embodiment, the set of files includes files <patchname>.pat, <patchname>.gas, <patchname>.gat, and <patchname>.sat.

File <patchname>.pat contains the text of the patch. File <patchname>.gas is a hash file containing the generic annotation statistics for every name symbol reference in the patch. Each record of file <patchname>.gas contains a key and five values, namely (1) the reference type (F=function declaration, M=macro definition, V=variable declaration, f=function call, m=macro call, v=variable reference), (2) the symbol name, (3) the name symbol scope, (4) the line position of the start of the name symbol reference, and (5) the length of the name symbol. TABLE 1 is one embodiment of the keys used in the records of file <patchname>.gas.

TABLE 1

| Key | Name Symbol Type |
|---|---|
| <patchname>-<line- | Function-call symbols and |
| number><symbol-sequence- | variable-reference |
| letter> | symbols |

The keys in TABLE 1 are illustrative only and are not intended to limit the invention to this specific embodiment. For example, for a tagged computer language, a key may be required to <symbol-sequence-letter> fields.

File <patchname>.gat is a hash file containing application-specific annotation text based on comments within the source code computer program file, and the generic annotation text. Each record of file <patchname>.gat contains (i) a key, as illustrated in TABLE 2, and (ii) a string value containing the prose/pseudocode text description of either a symbol name that refers to an element in the source computer program statement, or the source computer program statement itself. Herein, prose/pseudocode should be regarded as one language, which is a combination of prose text and pseudocode descriptions of elements in the code as well as lines of code. This string value is translated automatically from the program source code, as described more completely below. As illustrated in TABLE 2, a redundancy letter is added to the column-number of the key if more than one annotation is associated with a single column. This causes a plurality of ancillary footnote annotation trigger symbols (e.g., Greek letters) to be automatically inserted into the webpage, offset from the original footnote annotation trigger-symbol column.

Different content classes, indicated by the parenthesized letters in the record-type descriptions, are accommodated by slight differences in the structure of the keys. This enables the generated annotations to be assembled from combinations of text from different content sources (e.g., code-to-prose/pseudocode translation, adapted comments, and manually specified annotation text) according to configuration templates assigned to each annotation by web annotator 270.

TABLE 2

| | Annotation Text Record |
|---|---|
| Key | Type |
| <patchname>@<line- | Auto-generic annotation |

| | |
|---|---|
| number>:<column-number> | (G) |

| | |
|---|---|
| <patchname>@<line- | Auto-generic annotation |

| | |
|---|---|
| number>:<column- | (G) (redundant column |
| number><redundancy- | number) |
| letter> | |

| | |
|---|---|
| <patchname>@<line- | Auto-generic annotation |

| | |
|---|---|
| number>:<column- | more details (H) |
| number>@MD | |

| | |
|---|---|
| <patchname>@<line- | Auto-generic annotation |

| | |
|---|---|
| number>:<column- | more details (H) |
| number><redundancy- | (redundant column number) |
| letter>@MD | |

| | |
|---|---|
| <patchname>*<line- | Auto-specific annotation |

| | |
|---|---|
| number>:<column-number> | (A) |
| | (adapted comments) |

| | |
|---|---|
| <patchname>*<line- | Auto-specific annotation |

| | |
|---|---|
| number>:<column- | (A) |
| number><redundancy- | (redundant column number) |
| letter> | |

| | |
|---|---|
| <patchname>*<line- | Auto-specific annotation |

| | |
|---|---|
| number>:<column- | more details (B) |
| number>*MD | |

| | |
|---|---|
| <patchname>*<line- | Auto-specific annotation |

| | |
|---|---|
| number>:_{—} | (A) |
| | triggered on line number |

| | |
|---|---|
| <patchname>*<line- | Auto-specific annotation |

| | |
|---|---|
| number>_*MD | more details (B) |
| | triggered on line number |

| | |
|---|---|
| <patchname>-<line- | Auto-specific annotation |

| | |
|---|---|
| number>:_{—} | (A) |
| | triggered on end-of-line |
| | pad |

| | |
|---|---|
| <patchname>*<line- | Auto-specific annotation |

| | |
|---|---|
| number>:_<redundancy- | (A) |
| letter> | triggered on end-of-line |
| | pad (redundant) |

| | |
|---|---|
| <patchname>*<line- | Auto-specific annotation |

| | |
|---|---|
| number>_*MD | more details (B) |
| | triggered on end-of-line |
| | pad |

| | |
|---|---|
| <patchname>*<line- | Auto-specific annotation |

| | |
|---|---|
| number>_<redundancy- | more details (B) |
| letter>_*MD | triggered on end-of-line |
| | pad (redundant) |

File <patchname>.sat is a hash file containing comments that may be added using web annotator 270 of this invention. A plurality of record types are included in file <patchname>.sat, in one embodiment.

TABLE 3 is one embodiment of a key system used to distinguish between record types in <patchname>.sat, used to configure composite annotations associated with various single-column trigger symbols, e.g., punctuation, single letters in identifier symbols, line numbers in text, and end-of-line pad (blank spaces). The composite annotation text may be assembled from different content sources (e.g., code-to-prose/pseudocode translation, adapted comments, and manually specified annotation text) according to configuration templates assigned to each annotation by web annotator 270, as explained more completely below.

TABLE 3

| Key | Record Type |
|---|---|
| <patchname>#<line- | Manual-specific |

| | |
|---|---|
| number>:<column-number> | annotation (D) |

| | |
|---|---|
| <patchname>#<line- | Manual-specific |

| | |
|---|---|
| number>:<column- | annotation (D) |
| number><redundancy- | (redundant column number) |
| letter> | |

| | |
|---|---|
| <patchname>#<line- | Manual-specific |

| | |
|---|---|
| number>:<column- | annotation more details |
| number>#MD | (S) |

| | |
|---|---|
| <patchname>#<line- | Manual-specific |

| | |
|---|---|
| number>:<column- | annotation more details |
| number><redundancy- | (S) |
| letter>#MD | (redundant column number) |

| | |
|---|---|
| <patchname>#<line- | Manual-specific |

| | |
|---|---|
| number>:n-number>#MD | annotation more details |
| | (S) |

| | |
|---|---|
| <patchname>#<line- | Manual-specific |

| | |
|---|---|
| number>:<column- | annotation more details |
| number><redundancy- | (S) |
| letter>#MD | (redundant column number) |

| | |
|---|---|
| <patchname>#<line- | Manual-specific |

| | |
|---|---|
| number>:_{—} | annotation (D) |
| | triggered on line number |

| | |
|---|---|
| <patchname>#<line- | Manual-specific |

| | |
|---|---|
| number>:_#MD | annotation more details |
| | (S) |
| | triggered on line number |

| | |
|---|---|
| <patchname>#<line- | Manual-specific |

| | |
|---|---|
| number>:_{—} | annotation (D) |
| | triggered on end-of-line |
| | pad |

| | |
|---|---|
| <patchname>#<line- | Manual-specific |

| | |
|---|---|
| number>:_<redundancy- | annotation (D) |
| letter> | triggered on end-of-line |
| | pad (redundant) |

| | |
|---|---|
| <patchname>#<line - | Manual-specific |

| | |
|---|---|
| number>:_#MD | annotation more details |
| | (S) |
| | triggered on end-of-line |
| | pad |

| | |
|---|---|
| <patchname>#<line- | Manual-specific |

| | |
|---|---|
| number>:_<redundancy- | annotation more details |
| letter>#MD | (S) |
| | triggered on end-of-line |
| | pad (redundant) |

Note that the function description records can be used to store synopsis text for the patches. Alternatively, in another embodiment (not illustrated), files 620 can include a file <patchname>.syn that contains synopsis text for the patch.

In this embodiment, each patch subdirectory also contains a set of scope subdirectories 630, 650. Each scope subdirectory is defined by a namespace for a set of name symbols, such as variable symbols. One scope subdirectory 631, 651 has the same name as its parent directory 621, 641, namely the patch name. This subdirectory contains files pertaining to name symbols that are declared in the outermost block or nest of the patch.

Other subdirectories in the set of scope subdirectories, if present, are named according to the line-number and column-number where the enclosing block-start symbol appears, e.g., a left brace {used by most languages, which are derivatives of the C programming language such as C++, Perl, java, PHP, etc. These subdirectories contain files relating to the name symbols (e.g., variables) declared in these inner blocks.

There is one file in the scope subdirectory for each name symbol belonging to the corresponding scope. These files contain generic descriptive information about the name symbol (e.g., its type, and storage class) and contain a record for each reference to that name symbol appearing anywhere in the module. These records are keys indexing symbol reference statistics data in file <patchname>.gas.

Also in the scope subdirectory may be hash file <scope-name>.gat containing generic and application-specific annotation text associated with name symbols belonging to the scope, and hash file <scope-name>.sat containing manual-specific annotations. TABLE 4 contains the key patterns contained within these hash files.

A plurality of record types is included in file <scope-name>.sat, in one embodiment. TABLE 4 also illustrates one embodiment of a key system used to distinguish between record types in <scope-name>.sat, and used to configure composite annotations associated with name symbols such as variable and function names. The composite annotation text may be assembled from different content sources (e.g., code-to-prose/pseudocode translation, adapted comments, and manually specified annotation text) according to configuration templates assigned to each annotation by web annotator 270.

TABLE 4

| | Name Symbol Description |
|---|---|
| Name Symbol Key | Record Type |
| <variable-name>$<scope> | Auto-generic (G) |
| <variable-name>%<scope> | Auto-specific (A) |
| | (adapted comment) |
| <variable- | Auto-specific (B) |

| | |
|---|---|
| name>%<scope>%MD | more details |

| | |
|---|---|
| <variable-name>˜<scope> | Manual-specific (D) |
| | (Web Annotator) |
| <variable- | Manual-specific |

| | |
|---|---|
| name>˜<scope>˜MD | more details (S) |

| | |
|---|---|
| <patch-name>- | Variable reference |

| | |
|---|---|
| <linenumber><letter>% | Manual-specific |
| | annotation (F) |

| | |
|---|---|
| <patch-name>- | Variable reference |

| | |
|---|---|
| <linenumber><letter>%MD | Manual-specific |
| | annotation more details |
| | (M) |

| | |
|---|---|
| <function-name>$ | Auto-generic (G) |
| <function-name>% | Auto-specific (A) |
| | (adapted comment) |
| <function-name>%MD | Auto-specific more |
| | details (B) |
| <function-name>˜ | Manual-specific (D) |
| | (Web Annotator) |
| <function-name>˜MD | Manual-specific |
| | more details (S) |
| <patch-name>- | Function call |

| | |
|---|---|
| <linenumber><letter># | Manual-specific |
| | annotation (F) |

| | |
|---|---|
| <patch-name>- | Function-call Manual- |

| | |
|---|---|
| <linenumber><letter>#MD | specific annotation more |
| | details (M) |

Global metatree 670 is a directory _EXTERN_ 671, containing a subdirectory 673, 676 . . . for each of the other metatrees, i.e., each of the modules, in source file 105B, in this example. Global metatree 670 represents the namespace of the global name symbols, such as global variables, which may be referenced from any of the modules making up the program. As any given global name symbol must actually be statically allocated in the outer container (file) patch of one of the other metatrees, a set of files 672 named for each global name symbol with extension .loc contain the symbol type and the name of the metatree patch where the global name symbol is actually allocated—its residence scope.

Inside directories 673, 676, . . . pertaining to the other metatrees, are the corresponding reference statistics hash files 674, 677, . . . named for the respective metatrees containing the actual references with extension gas. These are hash %annostat 215EE (FIG. 5A) related hash files, in which the scope entry is $$EXTERN$$ in this embodiment.

Also in directories 673, 676, . . . pertaining to the other metatrees, are hash %symbol related hash files 675, 678,. . . (see FIG. 5A, structure 215CC) where scope key S₂ is also $$EXTERN$$ in this embodiment. These files correspond to name symbols, such as variables, actually allocated within the outer container (file) patches of the respective metatrees. Symbol reference keys R₃ (see FIG. 5A, structure 215DD) contained within these symbol hash files only include the references that occur within their particular metatrees.

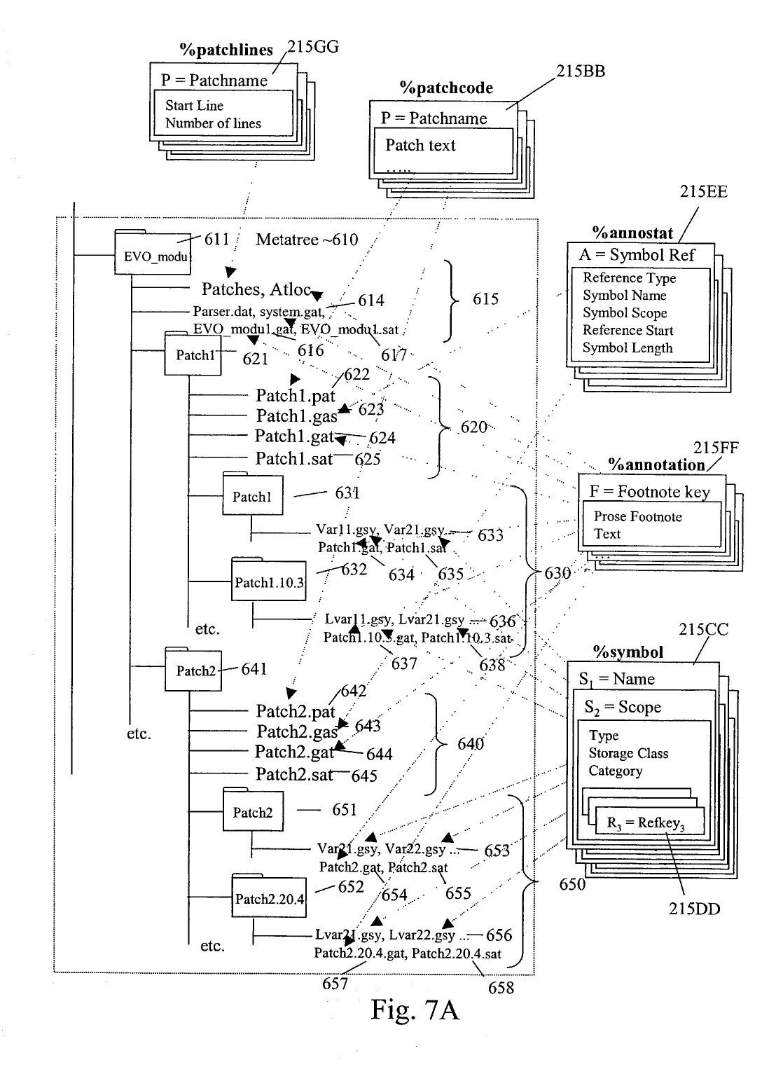

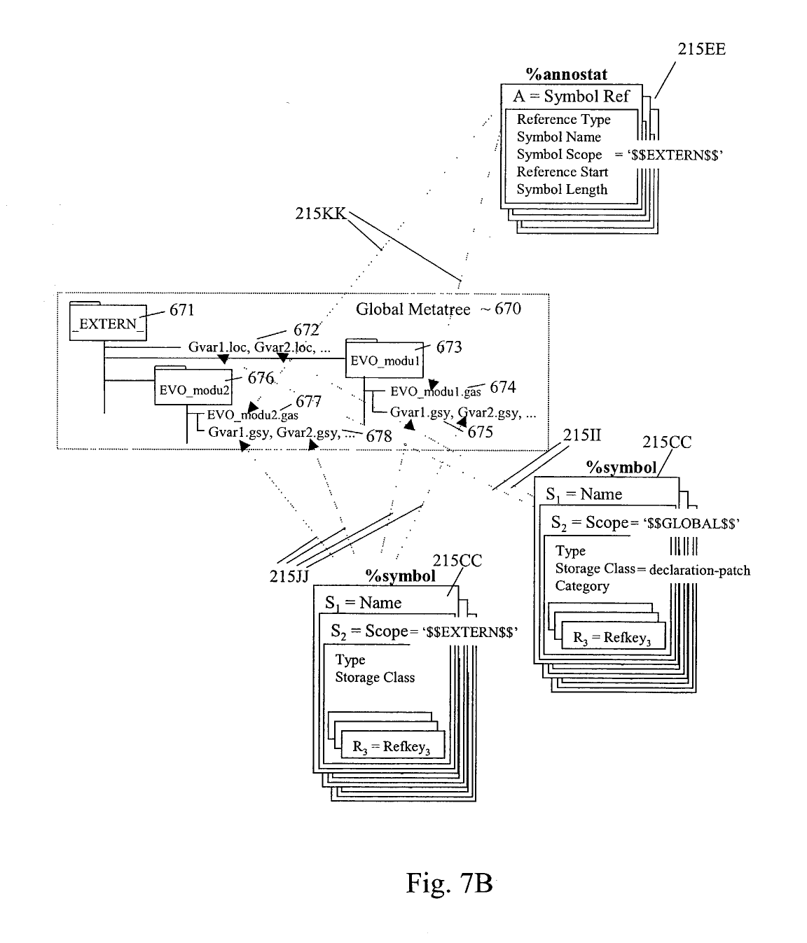

With this background on cradle file system 115, the disposition of the data in the various structures in patch-hash buffer memory 215B that are generated by operations 415 and 418 is considered further. Specifically, explode module data into cradle metatree operation 419 moves the data in structures 215GG, 215BB, 215CC, 215EE, and 215FF in patch-hash buffer memory 215B into metatree 610, as illustrated in FIG. 7A.

In this embodiment, structures 215GG, 215BB, 215CC, 215EE, and 215FF are associative arrays, which are called hashes in the programming language Perl, because indexing is by name, i.e., keys rather than by numbers, and hash-addressing, a fast 2-dimensional form of content-based-associative-addressing, is employed. In one embodiment, the first dimensional index is a number, i.e., hash address, computed by a numeric encoding of the keys, and this is used to index an array of linked lists searched linearly, or pointers to sorted linear arrays which are binary searched to match the key. Each linked list or sorted array contains all symbols whose encoding results in the hash address. For example, records abc, acb, bac, bca, cab, and cba all have the same hash address if the encoding is summation, so these records would all be members of the same linked or sorted array.

Structure %linepatches 215AA (FIG. 5A) is a hash in which each element is an array of five elements. Structure %linepatches 215AA is a temporary, i.e., non-persistent, hash created by source-code patching operation 415 (FIGS. 4A and 4B), and used by parsing and data assimilation operation 418. Structure %patchlines 215GG (FIG. 7A) is an array of two elements, also created as a non-persistent temporary hash by source-code patching operation 415 to be used to define patches in explode module data into cradle metatree operation 419. Hash %patchcode 215BB, and all other hashes 215CC, 215EE, and 215FF are persistent aggregates, meaning that together hashes 215BB, 215CC, 215EE and 215FF constitute a memory-resident aggregate database of source computer program module file 206 that is made persistent by explode module data into cradle metatree operation 419 that generates the data files constituting metatree 610.

When the data in hashes 215BB, 215CC, 215EE and 215FF are written to non-volatile storage, typically disk storage, the data is exploded patchwise and scopewise into separate files of metatree EVO_<module-file>, which for source computer program file Modu1 is metatree 610, in operation 419.

The only simple hash is hash %annotation 215FF (FIG. 7A), which, as described above, contains the annotation text and other text such as subroutine subtitle descriptions and variable-descriptions. In operation 419, hash %annotation 215FF (FIG. 7A) is exploded into files <patchname>.gat (e.g., file patch1.gat 624, file patch2.gat 644, etc.) that are stored in the corresponding <metatree>/<patchname> directory, e.g., EVO_modu1/patch1, EVO_modu1/patch2 . . . respectively.

Hash %annostat 215EE has elements, which are arrays of five elements, as explained above. In operation 419, hash %annostat 215EE is exploded into files <patchname>.gas, e.g., file patch1.gas 623, file patch2.gas 643, etc., that are stored in the corresponding <metatree>/<patchname>directory, e.g., EVO_modu1/patch1, EVO_modu1/patch2, . . . , respectively.

Hash %symbol 215CC (FIG. 7A), as explained above, is the most complex. Hash %symbol 215CC is a two-dimensional hash, in which each record is a four-element array where the fourth element is an array of indeterminate size. This indeterminate-sized array 215DD contains keys R₃ to entries in hash %annostat 215EE, which contains the statistics of each name symbol reference. Thus, keys R₃ in the fourth element are called reference keys.

Each symbol record in hash %symbol 215CC (FIG. 7A) is exploded, in operation 419, into a file <symbol-name>.gsy that is stored in the corresponding <metatree>/<patchname>/<scope> directory. For example, data for variables Var11, Var21 . . . , are exploded into files Var11.gsy, Var21.gsy respectively, in directory EVO_modu1/Patch1/Patch1, while local variables Lvar11, Lvar21 . . . that are in the scope that starts at line 10, column 3 are exploded into files Lvar11.gsy, Lvar21.gsy . . . , respectively, in directory EVO_modu1/Patch1/Patch1.10.3.

Interleaved with operation 419, operation 420 is performed to add global (external) variable data to global metatree 670. See FIG. 7B. A subdirectory (e.g., subdirectory 673 or 676 or . . . of directory _EXTERN_ 671 corresponding to the current metatree is created, and all global variables 215KK referenced in the module parsed in operation 418 (i.e., the contents of hash %annostat with scope $$EXTERN$$) are stored in the respective hash files 674, 676, or . . . . For all global variables 215II declared within the outer container (file) patch of the metatree, i.e., all hash %symbol entries with scope $$GLOBAL$$ and storage class set to the container patch where the global variable was declared, a corresponding hash file with extension loc is stored in directory 671. This information identifies the actual residence patch of the globally referenced variable, referring again to FIG. 7A, this identifies the patch directory 631, 651, . . . , where a hash file with extension .gsy has been stored during operation 419. A global variable is used above as an example of a global name symbol.

A further task of operation 419 is the storage of global data 215JJ in hash %symbol 215CC having scope equal to $$EXTERN$$ into hash file <symbol>.gsy 675, 678, . . . in the subdirectory 674, 677, . . . corresponding to the metatree being processed.

The above description pertains to an undifferentiated metatree in the circumstances where such a metatree can be successfully generated by the techniques described. In cases where an undifferentiated metatree cannot be successfully generated by the techniques described, the undifferentiated module text must be converted to one or more diversion modules by evaluating conditional compilation directives, as explained above.

In this circumstance, the undifferentiated module text cannot be partitioned and parsed in its pristine state, but can be parsed in a plurality of diversion states. The intent of parsing and hashing by source code adapter 210B is to produce annotation text keyed to the original text. To achieve this intent, in one embodiment, the keyed annotation text generated by parsing and hashing the plurality of diversion modules is related to the pristine undifferentiated text. A process of key mapping is used where only the line-numbers embedded in the diversion keys are correlated to the line numbers of the pristine text. The line numbers of the pristine text are then substituted into the diversion keys to create corresponding undifferentiated keys. Hence, additional cradle file structures are required to treat the whole (undifferentiated) text as a plurality of deterministic diversion metatrees, which by an aggregating process may be employed to sequentially approximate a non-deterministic undifferentiated metatree.

FIG. 6B illustrates variations in cradle structure 115 pertaining to diversion metatrees. Diversion metatrees have directory names in which the prefix EVO_ is extended to include a unique diversion code (divcode). As illustrated in FIG. 6B, the diversion codes are #div1, . . . (other diversions are implied). In one embodiment, the actual diversion codes are unique alphanumeric identifiers, initially computed using an epoch-date-time algorithm, e.g., a date-time to millisecond precision expressed as a modulo-64 alphanumeric integer to shorten its size.

The hierarchical structure of diversion metatree 610DIV includes the same hierarchical structure as illustrated and described with respect to FIG. 6A. Hence, a structure in FIG. 6B corresponding with a structure in FIG. 6A has the same reference numeral with DIVi added where i is the diversion number. Exploding the data in the hashes in memory 215B into a diversion metatree is the same operations as described above and that description is incorporated herein by reference.

In one embodiment, a user may choose to generate the diversion form for each and every module file and associated include files in a source computer program 105B. In this case, a diversion program is stored in a diversion program subdirectory of directory EVOWORK 602, where the name of the subdirectory is EVO#<divcode>, as illustrated in FIG. 6C that shows two modules.

By changing the conditional criterion in one or more conditional compilation directives in the undifferentiated text, another diversion program is generated and stored in a subdirectory of directory EVOWORK 602. By further changing conditional criteria, still another directory may be generated, and so on until in principle all conditional criteria combinations are exhausted, resulting in a plurality of diversion program directories.

Using hypertext page generator 230, as explained below, these diversion cradle metatree structures are converted into a corresponding plurality of diversion rapid comprehension documents, which may be browsed independently. Using a multi-threaded form of hypertext page generator 230, for example, links are inserted from patches in one diversion rapid comprehension document to like patches in any of the other diversion rapid comprehension documents in the plurality of diversion rapid comprehension documents. Via these links, a browser user may concurrently access corresponding patches in any of the diversion rapid comprehension documents in another framed browser window.

Such links may be differentiated (multi-forked) using a popup menu to designate which diversion rapid comprehension document is being linked, or a menu assigning keys to individual diversion rapid comprehension documents so that a mouse click while pressing a particular key links to the corresponding patch in the diversion rapid comprehension document assigned to that key.

Since the undifferentiated form rapid comprehension document, as the form in which the text is externally edited, is preferred in general, diversion rapid comprehension documents are only necessary in the event that partitioning of undifferentiated text fails, and are used as an intermediate means to produce undifferentiated rapid comprehension documents incrementally.

Even if the partitioning of undifferentiated text fails for either a module or a patch, an undifferentiated metatree is generated. The undifferentiated metatree is created even if only the container patch (the whole module file) was the only resolvable patch. In this case, the undifferentiated metatree is not parsed. Only the diversion metatrees are parsed, and the annotations for the undifferentiated metatree is fleshed out by inserting diversion annotation at the positions in the undifferentiated metatrees determined by key mapping, as described more completely below. Thus, the undifferentiated metatree would be fleshed out in a process of successive approximation. Ultimately, the patches of the undifferentiated metatree are discerned in this process.

In the embodiment associated with FIG. 4A, whenever pass-fail test operation 416 fails, diversion text is created only for the module in which the failure occurred. Other undifferentiated modules in the same program that passed this test are left in undifferentiated form and the metatrees generated from them are undifferentiated.

However, if at least one module results in a diversion metatree being generated, the entire program is regarded as a diversion, and a diversion program directory whose name is EVO#<divcode>is created under directory EVOWORK 602. Directory EVO#<divcode>represents the diversion program. Any diversion metatrees generated are stored in this directory. Directories for other (undifferentiated) metatrees in the same program are created as symbolic links 690 to the undifferentiated metatree directories in directory EVOWORK 602.

An example of this cradle file structure is illustrated in FIG. 6C. The undifferentiated program, which is the textual parent of all of the diversion programs, is contained within directory EVOWORK 602, and its directory subsystems, i.e., metatrees and global-metatree subdirectories, belonging to the plurality of diversion modules are included in these modules by the mechanism of symbolic links.

In addition to the naming of the diversion metatree directories using the divcode to extend the EVO prefix, an additional file Divspec 691 is added to the diversion metatree root files of diversion metatrees. File 691 contains a list of conditional compilation conditions, which specify the sequence of content lines in the diversion text, interleaved with an equivalence table of the line numbers in the diversion text paired with the corresponding line numbers of the original undifferentiated text.

A simple example of content of file Divspec 691 is as follows:

0-24:0-24

UNIX

25-36:26-37

37-107:49-119

DEBUG=0

108-115:121-128

116-130:135-149

UNIX

131-135:151-155

136-206:161-231

DEBUG=0

207-219:233-245

The numbers to the left of the colon are the line numbers in the differentiated text, while the number to the right of the colon are the line numbers in the undifferentiated text.

In this example, the first 25 lines of the diversion text and the undifferentiated text are identical. A condition appearing in an #ifdef directive on line 25 of the original text is satisfied by the prior definition of the string “UNIX” causing lines 25 to 36 of the diversion text to be taken from lines 26-37 of the original text. Lines 37-107 of the diversion text are taken from lines 49-119 of the original text (following an #endif directive on line 48 of the original text).

Next, a condition appearing in an #if directive on line 120 of the original text is satisfied by the value of the defined macro “DEBUG” being zero, causing lines 108-115 of the differentiated text to be taken from lines 121-128 of the original text. Lines 116-130 of the diversion text are taken from lines 135-149 of the original text following an #endif directive on line 134. Next, another condition appearing on line 150 of the original text is satisfied by the string “UNIX” causing lines 131-135 if the diversion text to be taken from lines 151-155 of the original text. Lines 136-206 of the diversion text are taken from lines 161-231 of the original text following an #endif directive on line 160. Another condition appearing on line 232 of the original text is satisfied by the value of the defined macro “DEBUG” being zero, causing lines 207-219 of the diversion text to be taken from lines 233-245 of the original text.

File Divspec 691 provides a means for mapping metatree annotation keys from one or more diversions into corresponding annotation keys in the associated undifferentiated metatree. Given hashes %patchlines for each of the diversion metatrees, the annotation keys for each patch are first converted from patch-relative to module-relative by substituting the module-relative line numbers into each key for the corresponding patch-relative line numbers.

Using the line-number correspondence table of file Divspec 691 for a given diversion module, the diversion annotation keys may be converted into undifferentiated module-relative annotation keys by substituting the undifferentiated module line numbers for the corresponding diversion line numbers. This enables the undifferentiated module to be annotated as a single patch, in those text areas corresponding to the diversion text. After a corresponding mapping for each diversion, more of the text of the undifferentiated module is thereby covered for annotation.

After any such diversion module to undifferentiated module mapping, the resulting undifferentiated-module annotation keys may be further mapped into patch-relative keys using hash %patchlines for the undifferentiated module file obtained by partitioning the undifferentiated module into patches. The information in hash %patchlines depends on the number of patches that had indeterminate boundaries. Typically, one or more patches in the undifferentiated module are defined, and so hash %patchlines is not empty. Even if no patches in a module are recognized, the module itself is the undifferentiated container patch.

Upon completion of operation 410 for all module files in a source computer program 105B, the entire program is stored in a form on cradle file system 115 so that rapid comprehension source code documentation 240B can be created as described below and so that original computer source code can be recreated for revision, or other use, if desired. As illustrated in FIGS. 1A and 1B, the data stored on cradle file system 115 is utilized by each of the managers of this invention.

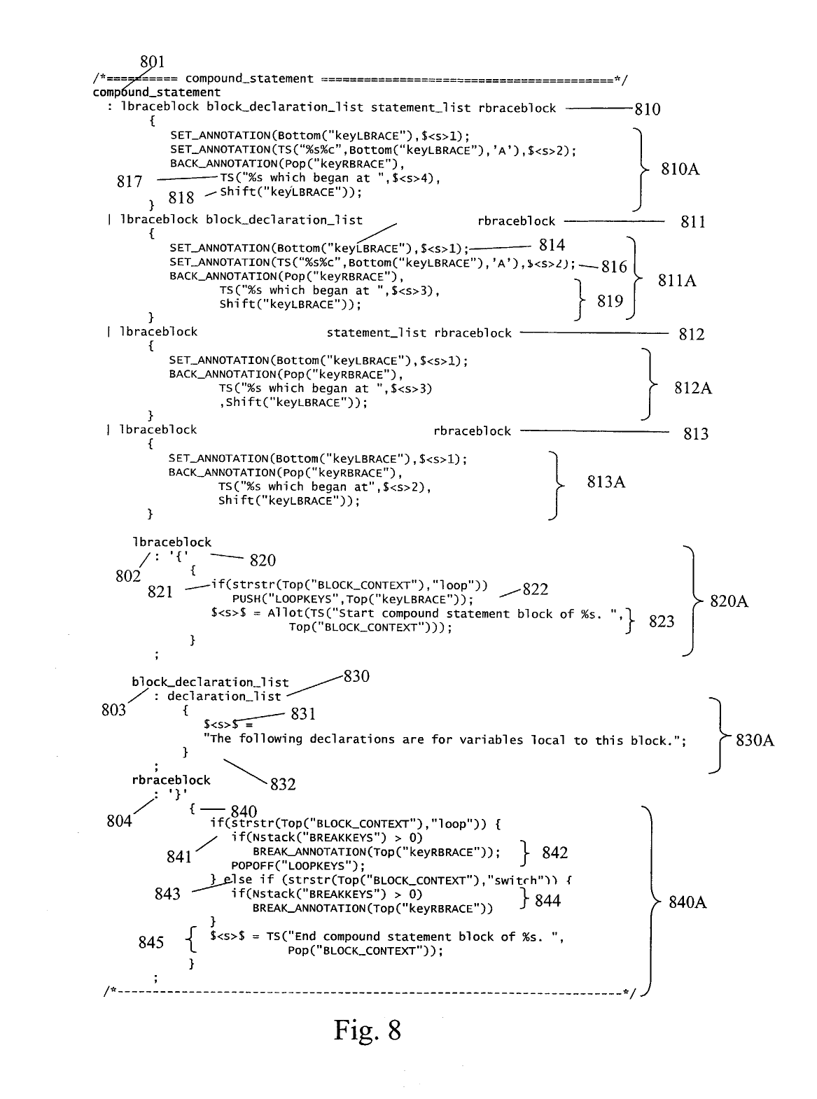

To illustrate the auto-generic annotation capability of the present invention, a specific example is considered more completely below. FIG. 8 is an excerpt from one embodiment of parser meta program 212B (FIG. 2B), which generates a portion of parser-hasher 214B that performs recognition events and data assimilation associated with the parsing of compound statement blocks of the C programming language, sometimes referred to as the C-language. FIG. 8 is a set of YACC-derivative (PCYACC or BISON) rules of the form:

<rule-name>

: <language-pattern-alternative_1>

{

<action-process_1>

}

| <language-pattern-alternative_2>

{

<action-process_2>

}
.
.
.

| <language-pattern-alternative_N>

{

<action-process_N>

}

;

The language pattern alternatives that are represented by <language-pattern-alternative_i>, where i goes from 1 to N, above are patterns containing references to rule-names and tokens, e.g., punctuation characters, names, and numbers appearing in the input text stream.

The action processes, which are represented by <action-process_i> above, are segments of code which perform the action mandated upon the successful recognition of the corresponding language pattern alternative <language-pattern-alternative_i>. These action processes, in this embodiment, are C-language statements (lower-case and title-case symbols) and macro calls (all uppercase symbols). The macro calls are shorthand forms for calls to lower level processing functions, which are implemented in the C and Perl programming languages, in this embodiment. The action processes are used to generate automatically the generic annotations described above.

The tokens appearing in the language pattern alternatives are recognized by a sub-process of the parser in parser-hasher 214B called a lexical analyzer, or sometimes simply a lexer, which reads the input text stream, character-by-character, and groups the characters into tokens, which are returned to the parser as integer-references to an enumerated set of token types. The tokens, which are individual characters (e.g., punctuation) are represented by the integers associated with their position in the ASCII character set.

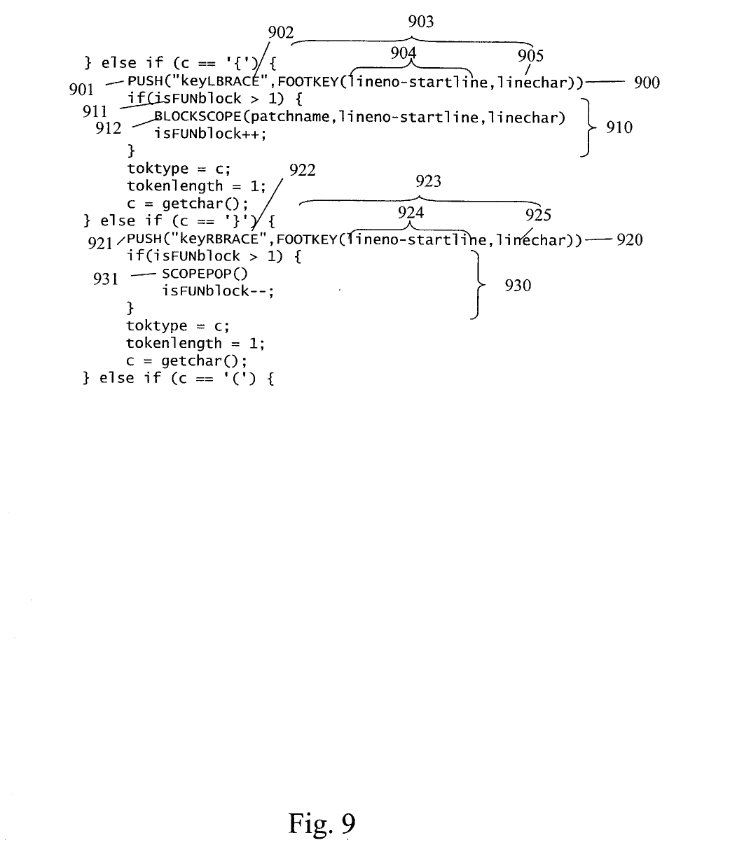

FIG. 9 is an excerpt of the lexer, showing the processes associated with recognition of the left brace {and the right brace} that are used to delimit a C-language compound statement block.

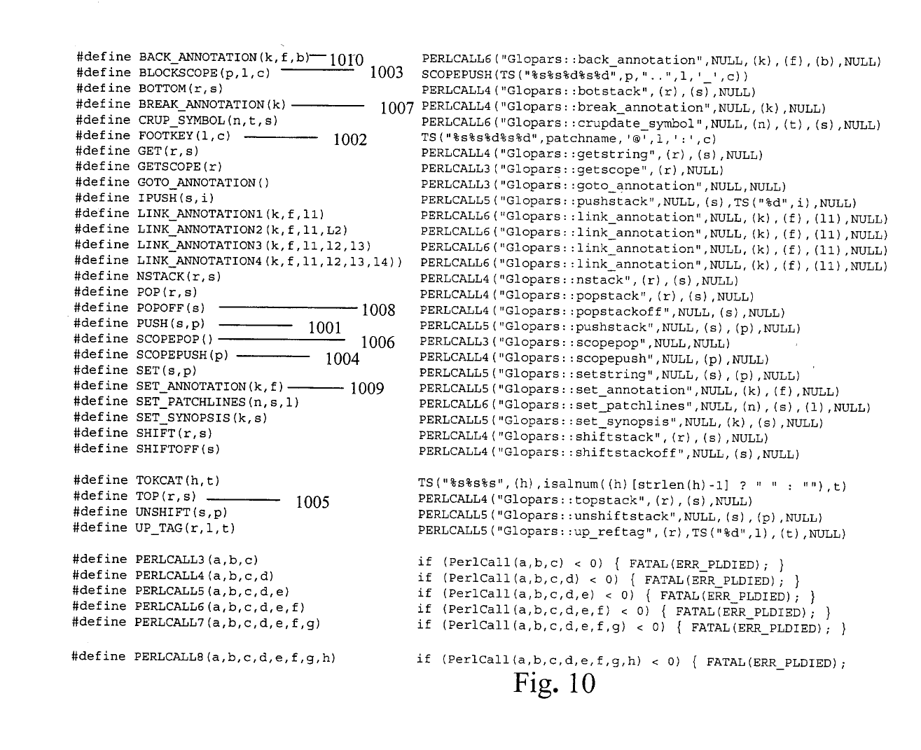

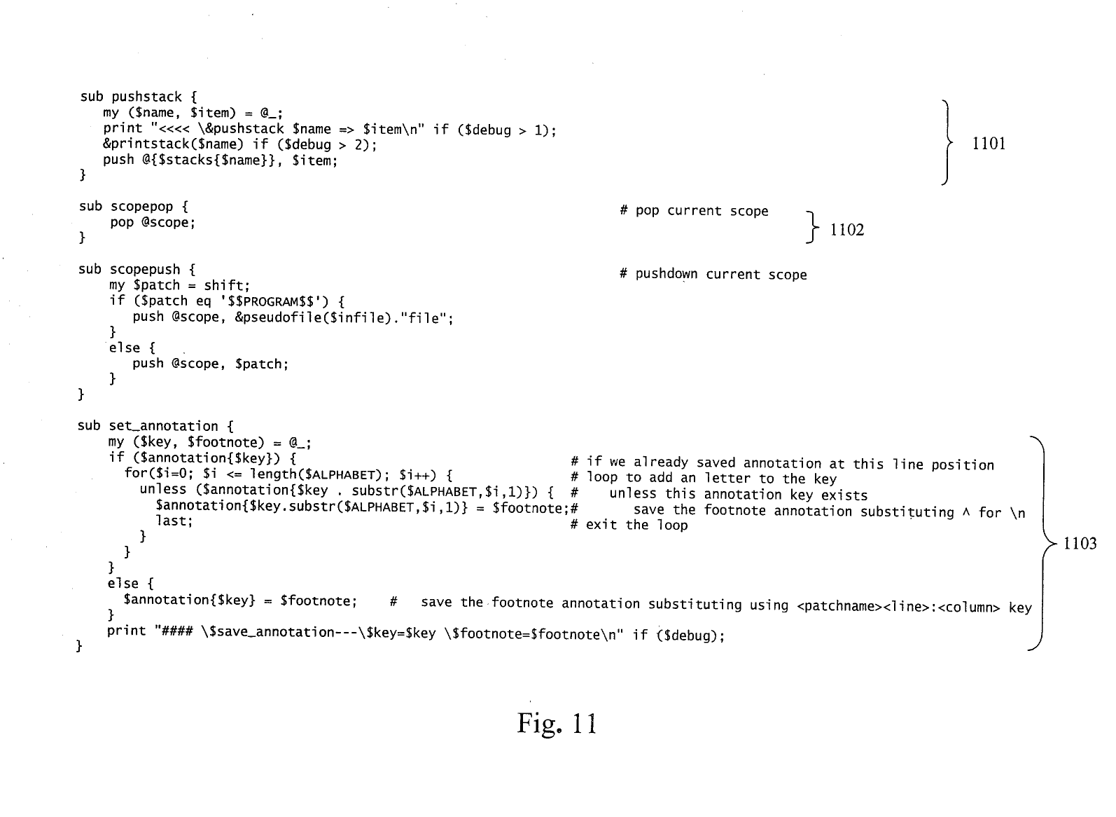

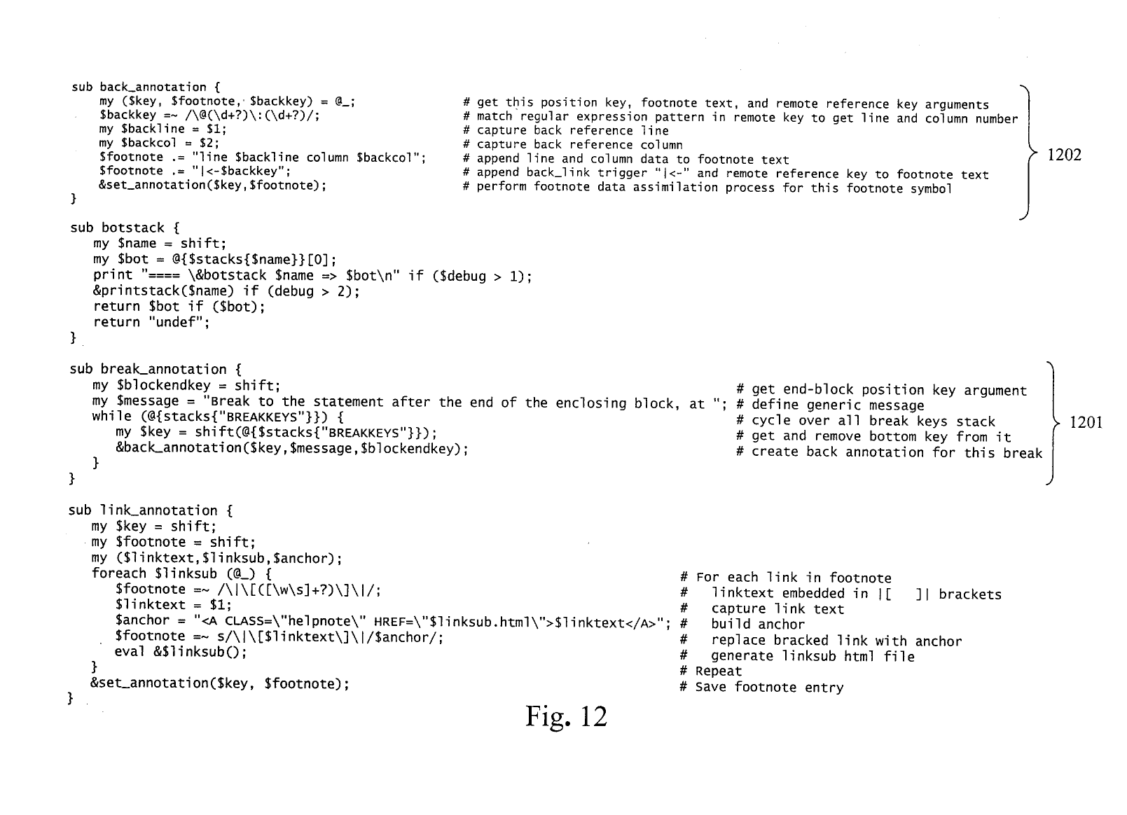

FIG. 10 is an excerpt of the parser code showing the macro definitions referenced in FIGS. 11 and 12. Most of these macros translate into calls to Perl subroutines in a Perl library module named Glopars.pm. FIGS. 11 and 12 are excerpts from Perl library module Glopars.pm showing some of the Perl subroutines involved. The interface to Perl subroutines is through a C-language function PerlCall, which is part of an implementation of embedding a Perl interpreter in a C-language program, as described in Chapters 19 and 20 of Advanced Perl Programming, by Sriram Srinivasan, O'Reilly & Associates, Inc. 1997, which are incorporated herein by reference to demonstrate the knowledge of one of skill in the art.

FIG. 8 contains several examples of event processing in statement code-to prose/pseudocode translation process 540 (FIG. 5A). This excerpt includes four rules: (i) rule compound_statement, hereinafter compound statement rule 801; (ii) rule lbraceblock 802, hereinafter left brace block rule 802; (iii) rule block_declaration_list 803, hereinafter block declaration list rule 803; and (iv) rule rbraceblock 804, hereinafter right bracket block rule 804.

Compound statement rule 801 includes four language pattern alternatives 810 to 813 and corresponding action processes, i.e., processes 810A to 813A, respectively. Left brace block rule 802 includes a single language pattern alternative 820 and a corresponding action process 820A. Block declaration list rule 803 includes a single language pattern alternative 830 and a corresponding action process 830A. Right brace block rule 804 includes a single language pattern alternative 840 and a corresponding action process 840A.

Upon detection of a left brace token in the input stream, a left brace {token is returned from the lexer to the parser. Upon supplying this token to the parser, the lexer marks its absolute position within the code for use as a footnote annotation trigger symbol.

In the embodiment including the lexer excerpt of FIG. 9, this marking is achieved by execution of statement 900. Specifically, the execution of PUSH 901 results in a call to macro PUSH 1001 (FIG. 10) that in turn results in a call to a Perl subroutine pushstack 1101 (FIG. 11) with a stack array name keyLBRACE 902 and footnote position key 903.

Execution of subroutine pushstack 1101 adds footnote position key 903 to the top of the stack array called keyLBRACE 902. Footnote position key 903 is constructed via a call to a macro FOOTKEY 1002 (FIG. 10), which employs a text string formatting function TS (similar to the C-library routine sprintf) to format a concatenation of the current patch name with the current line number, as represented by argument lineno-startline 904 that is the line number relative to the current patch, and the character position of the left brace within the current patch, as represented by argument linechar 905.

Next, if statement 910 tests counter isFUNblock 911 for the condition that counter isFUNblock 911 has a value greater than one. Counter isFUNblock 911 is set to one by the parser when the compound statement delimits the body of a function. Hence, a value greater than one denotes a block scope internal to the function body. In this case, BLOCKSCOPE 912 is a call to macro BLOCKSCOPE 1003 (FIG. 10), which is executed resulting in the invocation of macro SCOPEPUSH 1004 (FIG. 10). Macro SCOPEPUSH 1004 uses formatting function TS to create an internal scope name

<patchname> . . . <line_number>_<column_number>

signifying scope initiated at the position of its opening brace. Next, counter isFUNblock 911 is incremented to denote the level of the inner scope nesting.

After receipt of the left brace {token from the lexer when the parser makes a call to left brace block rule 802, rule 802 recognizes the left brace {token that is initiating a compound-statement block context and so action process 820A of rule 802 is executed. A first statement 821 in process 820A checks to see if top of stack BLOCK_CONTEXT is loop, i.e., if the compound-statement block was preceded by a for, while or do. If top of stack BLOCK_CONTEXT is loop, the execution of PUSH in line 822 results in a call to macro PUSH 1001 (FIG. 10) that in turn results in a call to a Perl subroutine pushstack 1101 (FIG. 11) (FIG. 11) with a stack array name LOOPKEYS, pushing the footnote position key from the top of stack keyLBRACE onto stack LOOPKEYS, for use by other rules scanning statements within the loop, which need to know the position of the beginning of the loop. Again, it is noted that when it is stated that a statement takes or does some action, those of skill in the art will understand that this means the action that results upon execution of the statement.

Top is a call to a macro TOP 1005 that in turn calls a Perl subroutine topstack. Subroutine topstack returns the footnote position key that is on top of stack array keyLBRACE. Hence, the execution of statement 822 pushes the top of stack keyLBRACE, i.e., the footnote position key just added to stack keyLBRACE by the lexer, onto another stack, stack LOOPKEYS, which thereby marks the origin of the current loop, for use by statements appearing in the loop which might need to reference this loop origin symbol, such as a continue statement.

Finally, statement 823 in action process 820A calls formatting function TS that in turn formats the return message of rule 820, which supplies the prose/pseudocode for the beginning content of the compound statement. For example, if the compound statement is for ( . . . ) { . . . , the annotation supplied in prose/pseudocode is “Start compound statement block of for loop.”

In this example, it is assumed that the parser successfully detects a declaration list via call 830 to the declaration-list rule (not shown) and so action process 830A of rule 803 is executed. The statement in action process 830A assigns the message 832 to the return argument 831, which supplies the prose/pseudocode footnote created by statement 816. Specifically, the footnote message 832 is:

The following declarations are for variables local to this block.

The declaration statements making up the declaration list this message introduces are merely the next group of statements (parsed by the declaration_list rule call 830). Parsing these statements also generates footnote and symbol reference annotation to be associated with annotation trigger symbols in those statements.

In this example, the lexer next detects a right brace in the input stream, and so a right brace token is returned from the lexer to the parser. Upon supplying this token to the parser, the lexer marks its absolute position within the code for use as a footnote trigger symbol.

In the embodiment of FIG. 9, this marking is achieved by execution of statement 920. Specifically, the execution of PUSH 921 results in a call to macro PUSH 1001 (FIG. 10) that in turn results in a call to a Perl subroutine pushstack 1101 (FIG. 11) with a stack array name keyRBRACE 922 and end-of-block position key 923. Execution of subroutine pushstack 1101 adds end-of-block position key 923 to the top of the stack array called keyRBRACE 922. End-of-block position key 923 is constructed via a call to a macro FOOTKEY 1002 (FIG. 10), which employs text string formatting function TS to format a concatenation of the current patch name with the current line number, as represented by argument lineno-startline 924 that is the line number relative to the current patch, and the character position of the right brace within the current patch, as represented by the argument linechar 925.

Next, if statement 930 tests counter isFUNblock 911 for the condition that counter isFUNblock has a value greater than one to determine whether the block is internal to a function body, i.e., a higher level-internal scope. If counter isFUNblock has a value greater than one, ( ) 931 is executed resulting in the invocation of macro SCOPEPOP 1006 (FIG. 10) that in turn calls Perl subroutine scopepop 1102 (FIG. 11). Execution of Perl subroutine scopepop 1102 in turn pops the internal scope off the scope stack. Finally, counter iSFUNblock is decremented. This sets the conditions necessary to support action process 811A.

After receipt of the right brace token from the lexer when the parser makes a call to right brace block rule 804, rule 804 recognizes the right brace token that is closing the compound-statement block context and so action process 840A of rule 804 is executed.

Action process 840A begins with an if test 841 to check whether the current block context contains loop. If test 841 is the same as if test 821 that was described above and that description is incorporated herein by reference.

If the current block context does contain loop, if statement 842 makes another test to see if the number of elements in stack BREAKKEYS is greater than zero, which means that break statements were present in the compound statement block. If break statements were present in the compound statement block, a higher level of generate back reference link annotation operation 525 is performed by a call to macro BREAK_ANNOTATION 1007 with the end-of-block position key Top(keyRBRACE), which the top value on stack keyRBRACE, as an argument. Macro BREAK_ANNOTATION 1007 in turn calls Perl subroutine break_annotation 1201 (FIG. 12) with the end-of-block position key as an argument.

The presence of break statements in the compound statement block results in their associated position keys being stored in stack BREAKKEYS. Subroutine break_annotation 1201 creates a message:

Break to the statement after the end of the enclosing block, at

and then cycles through all elements on stack BREAKKEYS. Specifically, the bottom break key element is shifted into a variable $key and then Perl subroutine back_annotation 1202 (FIG. 12) is called with this break key, the message, and the end-of-block-key as arguments.

Subroutine back_annotation 1202 unpacks the line number and column number from the end-of-block-key and appends this information to the footnote message. Next, a back-link trigger symbol |<- and the back-link key, which here is the end-of-block-key, is appended to the footnote message. As explained more completely below, the back-link trigger symbol and the back-link key are used to generate a phrase in a webpage in the rapid comprehension source documentation.

Perl subroutine set_annotation 1103 (FIG. 11) is called with the break key and the modified footnote as arguments to complete the footnote data assimilation process. Subroutine set_annotation 1103 first determines whether there is already an annotation saved for the line position of this annotation. If there is a saved annotation, the next unused redundancy letter is appended to annotation key and the annotation is saved in hash %annotation. If there is not an annotation saved for the line position, the annotation is saved in hash %annotation for this line position.

Upon completion of subroutine set_annotation 1103, macro POPOFF 1008 (FIG. 10) is called for stack LOOPKEYS. Execution of macro POPOFF removes the top item of stack LOOPKEYS.

Whenever if test 841 is false, a subsequent else if test 843 is made to see if the context of the compound statement block is a switch statement. If the context is a switch statement, if statement 844 is executed. If statement 844 is the same as if statement 842 and so the description of if statement 842 is incorporated herein by reference.

Final operation 845 of action process 840A formats the return string from rule 804 with the substring:

End compound statement block of which is pre-pended to the value popped from the top of stack BLOCK_CONTEXT stack (e.g., for loop, while loop, switch statement, function getpart, etc.).

At this point, when the parser attempts to reduce the parse stack, the tokens on the stack satisfy rule 811 and so action process 811A is executed. The execution of statements 814 and 816 complete a generic annotation data assimilation process 528 for the trigger symbol represented by the left brace, by first calling macro SET_ANNOTATION 1009 that in turn calls Perl subroutine set_annotation 1103 (FIG. 11). This call passes a key and footnote text to be stored in hash %annotation. The key is the entry at the bottom of the stack keyLBRACE, and the generic annotation text is the string returned from the call to rule 802. Next macro SET_ANNOTATION 1009 is called again in statement 816, where the key is the same as before but with a redundancy-letter ‘A’ appended to the key, and the generic annotation text is the string returned from the call to rule 803. Thus, in this case two footnotes are associated with the left brace. The first footnote triggers on the left brace, and the second footnote triggers on a Greek letter offset from the left brace in the resulting webpage.

The execution of subsequent statement 819 of action process 811A is associated with the terminating right brace of the compound-statement block that was recognized by rule 804. The execution of statement 819 performs a generate back reference link annotation operation 526.

The execution of statement 819 generates a back-link annotation from the block-terminating right brace to the block-originating left brace, by performing a call to macro BACK_ANNNOTATION 1010 (FIG. 10) that in turn calls the Perl subroutine back_annotation 1202, as previously described. The first argument in the call, the position key, is popped from stack keyRBRACE. The second argument in the call is an annotation that is formatted by appending “which began at” to the string returned from rule 804. As illustrated in Perl subroutine back_annotation 1202, this annotation is completed with the message “line mm column nn” by the action of the subroutine. Note that not only has parser-hasher 214B generated the auto-generic annotation in this example, but also has embedded annotation symbols that are used in generating webpages to create commands for accessing the annotation.

Although, bottom-up parsers (finite state machines) such those generated by YACC derivative metacompilers can be very efficient, bottom-up parsers are quite limited in the language grammars that can be parsed. In particular, bottom-up parsers cannot deal with ambiguous grammars that need more than one token of lookahead to tell whether a rule has been matched. Alternatively, recursive-descent (top-down) metacompilers are far more robust in their metalanguage features that allow such ambiguities to be dealt with via the use of multiple lookahead, or even backup methods, and the recursive descent process allows greater use of context-sensitivity in parsing.

However, recursive-descent methods are considerably slower than finite-state machines. As a result, YACC derivative metacompilers are used in the implementation of most modern compilers and other parsing applications. When ambiguities were present, the usual approach was to expand the role of the lexer to make up for the shortcomings of the parser. This approach was used in the Perl compiler, for example.

In compilers of the C-genre (C, C++, Objective-C, Java, etc.), a macro preprocessor, employing a standard grammar independent of the base language, is virtually always employed, affording the great convenience of macro definition and substitution to the program designer, together with inclusion and conditional compilation directives. The resulting merge of the preprocessor grammar (e.g., a second grammar) and the base-language grammar (e.g., a first grammar) creates a combined grammar that is beyond the parsing capabilities of YACC-generated parsers, working alone. Thus, a preprocessing pass is necessary for compiler implementation, where the combined grammar is translated, by the preprocessor, into the more limited grammar of the base language, which is then translated by the YACC-generated parser, augmented, if necessary by specialized coding of the lexer (as mentioned above).

In this embodiment, the purpose is not to perform this two stage translation, but to parse the two grammars to create documentation. Hence, in this embodiment, a novel approach is employed to parse the two grammars without translating the second grammar into the first grammar. In this embodiment, using YACC-derivative metacompilers, the standard grammars of language preprocessors are parsed “in situ” under control of the lexer. When the parser calls the lexer for its next token, and the lexer finds that the next token is the initiating token of a construct of the second grammar (e.g., a preprocessor grammar) instead of the first grammar (e.g., a base-language grammar) the lexer calls a second grammar-based parser-hasher to handle the second grammar constructs, thus bypassing the YACC-generated parser-hasher that handles the first grammar constructs. When the parsing of the second grammar construct is complete, and the next token is one of the first grammar constructs, the lexer returns the base-language token to the YACC-generated parser-hasher, as if this had been the next token following the last token it previously parsed. As a result, the combined grammar is parsed and hashed by interleaving YACC-compatible first grammar parser-hashing with the second grammar parser-hashing.

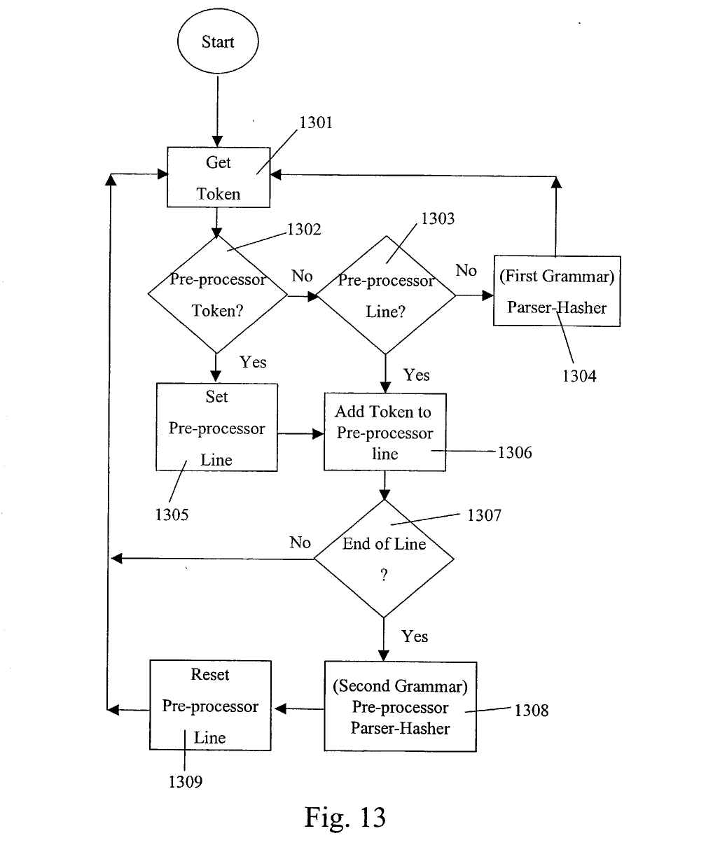

FIG. 13 is a process flow diagram for one embodiment of a parser-hasher that uses a preprocessor like parser-hasher, the second grammar parser-hasher, in combination with the parser-hasher described above, the first grammar parsher-hasher. Get token operation 1301 gets a token from the lexer, which is called the current token, and transfers to preprocessor token check operation 1302. If the current token is a preprocessor token, such as a pound sign for the C-programming language, check operation 1302 transfers to set preprocessor line 1305 and otherwise to preprocessor line check operation 1303.

Assuming the current token is a preprocessor token, set preprocessor line operation 1305 sets a preprocessor line flag to indicate that a preprocessor line is being parsed. Operation 1305 transfers to add token to preprocessor line operation 1306.

Operation 1306 adds the current token to a preprocessor line in a temporary buffer and transfers to end-of-line check operation 1307. Since the current token is not an end-of-line token, check operation transfers to get token operation 1301.

When the next token is available from the lexer, get token operation 1301 again transfers to preprocessor token check operation 1302. Since the current token is not a preprocessor token, check operation 1302 transfers to preprocessor line check operation 1303.

Preprocessor line check operation 1303 checks the state of the preprocessor line flag. Since the flag is set, check operation 1303 transfers processing to add token to preprocessor line operation 1306. Operation 1306 adds the current token to the preprocessor line in the temporary buffer and transfers to end-of-line check operation 1307 that in turn transfers get token operation 1301.

Operations 1301, 1302, 1303, 1306, and 1307 are repeated for each token in the preprocessor line until the current token is an end-of-line token, in which case, check operation 1307 transfers to preprocessor parser-hasher operation 1308.

Preprocessor parser-hasher operation 1308 calls a Perl subroutine identified by the preprocessor token, passing the Perl subroutine the preprocessor line in the temporary buffer. The Perl subroutine parses the line of code and generates annotations for the line.

Upon completion, operation 1308 transfers processing to reset preprocessor line operation 1309 that in turn resets the preprocessor line flag. Operation 1309 transfers to get token operation 1301.

If the next token received in get token operation 1301 is not a preprocessor line token, check operation 1302 transfers to check operation 1303. Since the preprocessor line flag is not set, check operation 1303 transfers to parser operation 1304 that processes the token as described above.

In this embodiment, only preprocessor statements were of interest. However, for a tagged language embodiment, the tagged language module may include elements invoking other than the tagged computer language. For these embodiments, tests are inserted to determine whether the current token is for a language other than the tagged language, and if it is, an appropriate parser-hasher is called to handle the token. The process is equivalent to that illustrated in FIG. 13. Moreover, the process of FIG. 13 can be expanded to include more than two different grammars. Hence, the use of two grammars is illustrative only and is not intended to limit the invention to this specific number of grammars.

Interface for Displaying the Rapid Comprehension Source Documentation

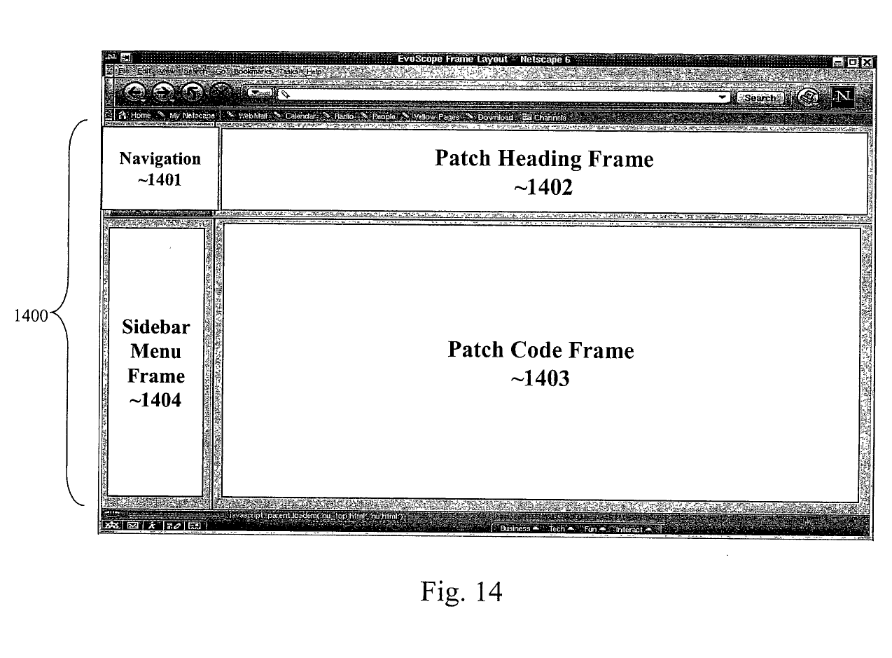

In one embodiment, rapid comprehension source documentation 240B is a website that includes a plurality of webpages for display on a display device 250. FIG. 14 is a more detailed illustration of one embodiment 1400 of display interface 260 (FIGS. 2A and 2B). In this embodiment, display interface 1400 includes four frames 1401 to 1404.

Frame 1401 is a navigation frame. Frame 1402 is a patch heading frame that includes a title of the patch displayed in frame 1403, and optionally can include a synopsis of the patch. Frame 1403 is a patch code frame that includes the computer source code making up the patch. Frame 1404 is a sidebar menu frame that is described more completely below.

As explained more completely below, the displayed computer source code for the patch in frame 1403 includes links, footnotes, and symbol annotations. These features assist in providing an understanding of the program source code that cannot be or is not easily obtained for example using program flow charts. However, these features are hidden from view until accessed by a user.

The webpages displayed in display interface 1400 provide information that characterizes the patch and information associated with the patch in a way that is easily understood and utilized by those of varying skills. The following description of hypertext page generator 230 generates webpages in the website for display using display interface 1400. However, this is illustrative only and is not intended to limit the invention to use of hypertext page generator 230 to create websites for this specific interface. In view of this disclosure, those of skill in the art can use hypertext page generator 230 to create a website for use with any display interface of interest.

Hypertext Page Generator

One embodiment of a website generation process 1500 for hypertext page generator 230 is illustrated in FIG. 15. Initially, a top-level menu file is generated in generate program menu operation 1501 using information from cradle 115. For example, see FIG. 16. The auxiliary information contained in this menu (e.g., descriptions) may be stored in a global information file in any of a number of directories (FIG. 6A), such as directories 601, 602, or 671, depending on the embodiment and/or installation parameter settings. The program name may be given in this global information file, or by default may be the same as the base name of working directory 601.

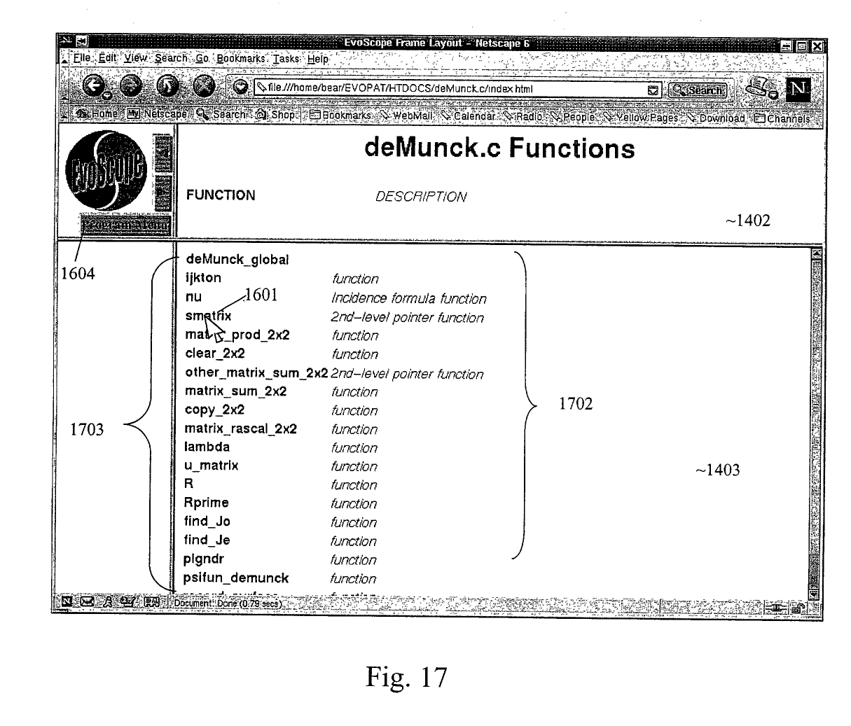

Next, operation 1502 loops over all module metatrees contained in directory 602. Operation 1503 generates a module menu for each metatree. The module menu contains an entry for each patch in the metatree. For example for metatree 610, the module menu contains an entry for each of patches 621, 641 . . . FIG. 17 shows an example.

In one embodiment, the remaining operations to generate the web-subdocument for a given metatree are grouped into a single volatile memory-resident program 1550. The first two operations 1504 and 1505 are interleaved to aggregate all of the data from the hash files in cradle file system 115 pertinent to a given metatree 610 and its global information contained in global metatree 670 into memory-resident hashes from which subsequent operations can generate HTML files completely documenting module modu1.

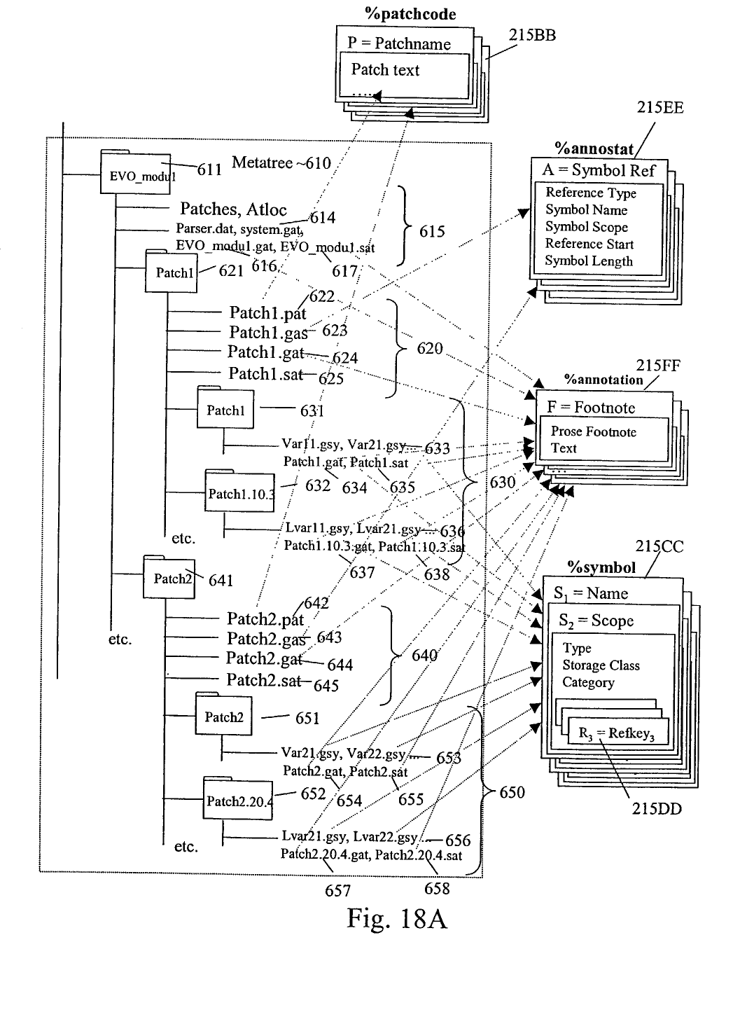

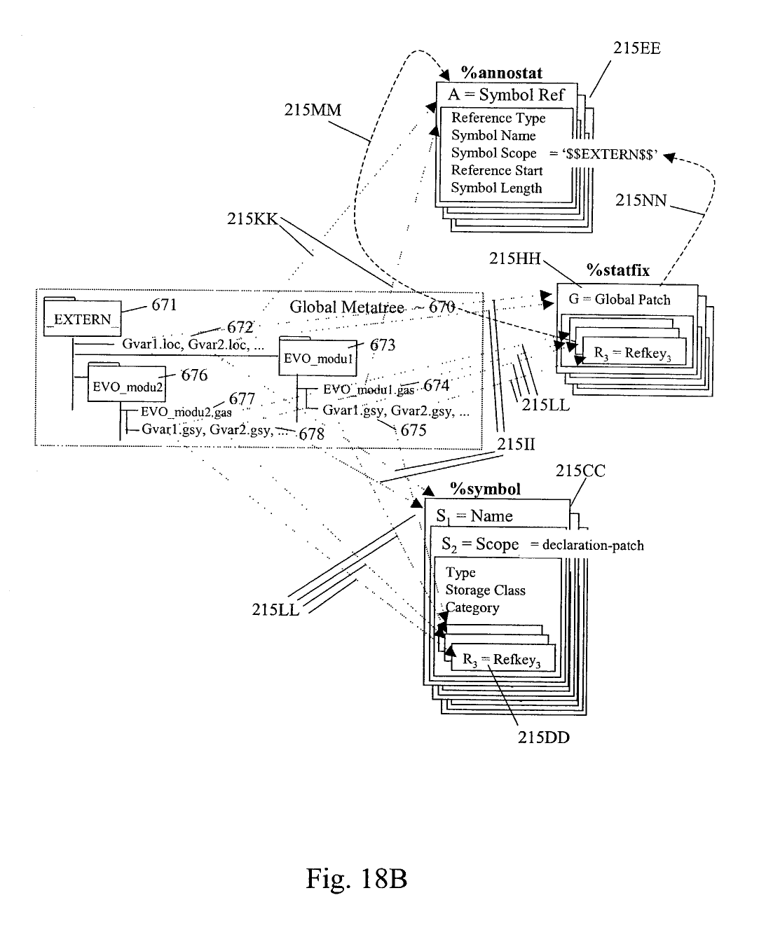

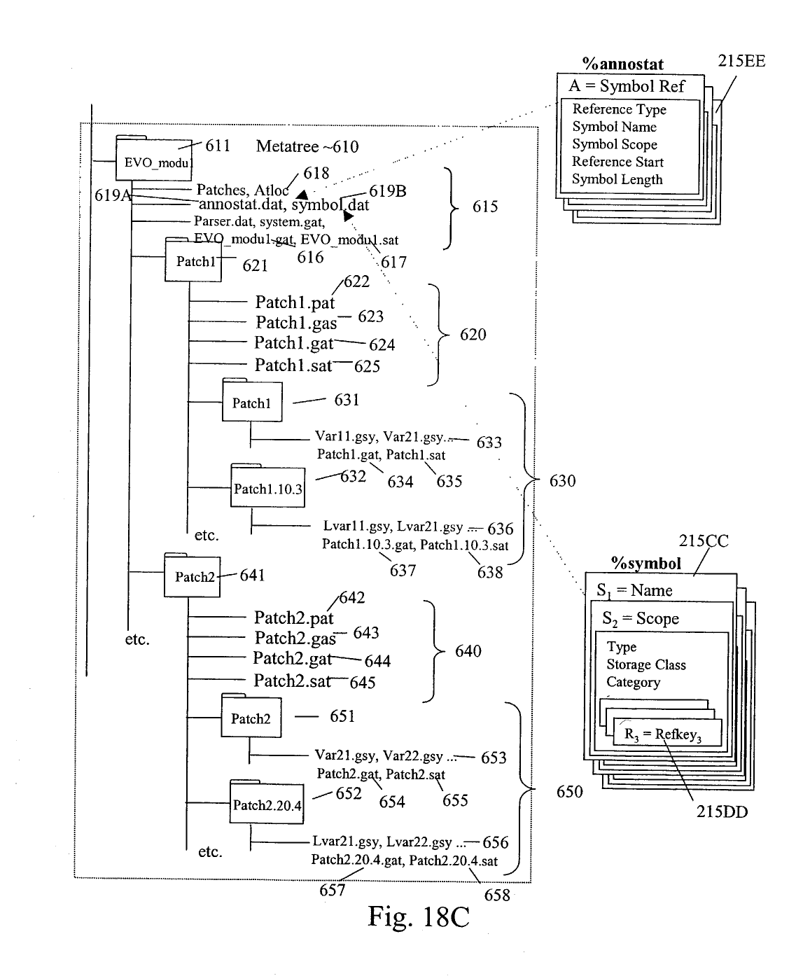

In this embodiment, operation 1504 aggregates metatree 610 data into the hashes (FIG. 18A) including data aggregated into hash %patchcode 215BB from hash files 622, 642, . . . ; data aggregated into hash %annostat 215EE from hash files 623, 643, . . . ; data aggregated into hash %annotation 215FF from hash files 614, 616, 617, 624, 625, 634, 635, 644, 645, 654, 655, 657, 658, etc; and data aggregated into hash %symbol 215CC from hash files 633, 636, 653, 656, . . . .

Operation 1505 operating as a subprocess of operation 1504 for the metatree assigned in loop 1502, cycles over all of the other metatrees that share global symbol names (e.g., global variables) with the assigned metatree as represented by the subdirectories in global metatree 670. Operation 1505 first aggregates data 215II and 215LL into hash %symbol 215CC (FIG. 18B) from hash files 675, 678, . . . , with the qualification that the scope key in hash 215CC is updated to that read from data 215II, while the reference keys are read from hash files 675, 678, . . . which all have scope keys of value $$EXTERN$$.

Operation 1505, therefore, corrects the scope of the globally referenced name symbols to point to the patch where the storage for the name symbol is actually allocated, i.e., where the name symbol was declared, declaration patch obtained from data 215II(FIG. 18B). During this same process, reference keys 215LL are also aggregated as values into hash %statfix 215HH distributed in entries indexed by the global declaration patch names 215II. Once this inner cycle processes files 672 and the subdirectories 673, 676, . . . and is complete, hash %statfix 215HH contains the necessary fixes to all of the global symbol name references in hash %annostat 215EE associated with the currently assigned metatree in loop 1502.

A final pass is then made, cycling through each global patch entry 215NN of hash %statfix 215HH, and all of reference keys 215MM in hash %annostat 215EE, using the reference keys to select hash %annostat entries and replace the symbol scope value in each entry with the corresponding global patch entry 215NN. When this final pass is complete for loop 1502 assigned metatree, the result is that all globally referenced name symbols in hash %symbol 215CC have been updated (globalized) to point to the patches where the global name symbols were declared and where normally their storage is allocated by the language compiler; and the array of reference keys 215DD in each global hash %symbol entry points to all of the entries in hash %annostat 215EE where these name symbols are referenced in the entire program.

Upon completion of operation 1504, all of the (now globalized) entries in hash %annostat 215EE and hash %symbol 215CC are written to a globalized statistics hash file annostat.dat 619A and a globalized symbol reference statistics hash file symbol.dat 619B in the metatree root (see FIG. 18C). File 619A contains all of the name symbol references occurring in the metatree, containing the statistics of each reference (its reference type, its location and size, the symbol name, and its actual scope—where the program element represented by the name symbol resides). This file is subsequently used by web annotator agent programs to regenerate webpages impacted by annotation changes.

File 619B contains data representing all of the name symbols residing in metatree patches and containing all of the reference keys 215DD now globalized to represent all references to these name symbols throughout all metatrees in the program. This file is subsequently used by web annotator 270 to determine the change impact of name symbol updates (e.g., variable and function annotation updates) i.e. which patches contain references to the name symbols and thereby require updating when the name symbol annotation is changed.

Moreover, the scope values in these entries of hash %annostat 215EE also point to the patches where the global name symbols were declared and their storage is allocated by the language compiler. Thus, volatile memory hashes, %patchcode 215BB, %symbol 215CC, %annostat 215EE, and %annotation 215FF now contain all of the data needed to generate HTML files for all of the webpages to be displayed in frames 1402, 1403, and 1404 of FIG. 14, for the assigned metatree in loop 1502.

Next operation 1506 (FIG. 15) begins a loop cycling over each patch in the loop 1502 assigned metatree, in which operation 1507 generates patch-code files, as explained more fully below, for display in frame 1403 and operation 1508 generates patch heading files for display in frame 1402. Loop 1506 is followed by loop 1509, cycling over each name symbol (e.g., each variable) resident in the metatree.

In loop 1509, operation 1510 generates a sidebar menu webpage file for display in frame 1404 for each resident name symbol, as explained more fully below using a variable as an example. The items of each sidebar menu include links to the (hash %annostat-contained) locations of references to the resident name symbol occurring anywhere, in any patch in any metatree, in whole application program 105B. As indicated above, this set of files generated by process 1500 make-up a website that in this embodiment is rapid comprehension source code documentation 240B.

Initially, when a user wants to access rapid comprehension source code documentation 240B, frames 1402 to 1404 are empty and only navigation frame 1401 is displayed with a forward button, a back button and a program menu button 1604 (FIG. 16). In another embodiment, a mouseover of the logo generates two main subdivision buttons of a menu. Clicking on either subdivision button makes submenu buttons appear floating over the other frames. These buttons can be used for example to access the revision control system that is described more completely below.

When, in this embodiment, a user selects program menu button 1604, the title of the selected source program is displayed in heading frame 1402. In this embodiment, heading frame 1402 also includes headings, MODULE FILE and DESCRIPTION, for columns 1603 and 1602 of information that appear in code frame 1403.

Column 1603 is a list of module files (metatrees), which, in this example, are modules that are found in source computer program Application1. Column 1602 is a list of descriptions of the modules in column 1603. Each-module name in column 1603 is a link to a webpage that includes the menu of the patches for the module with the displayed name.

When a user selects one of the modules (e.g., module deMunck.c containing a main function and utilities) by (for example) positioning cursor 1601 over deMunck.c and clicking a mouse button, or perhaps speaking deMunck.c into a voice recognition system, the display changes to that illustrated in FIG. 17. The title of the selected source module file is displayed in patch heading frame 1402. In this embodiment, heading frame 1402 also includes headings, FUNCTION and DESCRIPTION, for columns 1703 and 1702 of information that appear in code frame 1403.

Column 1703 is a list of functions (patches), which in this example are functions that are found in source module deMunck.c. Column 1702 is a list of descriptions of the patches in column 1703. Each patch name in column 1703 is a link to a webpage, i.e., one of the files created by generator 230, which includes the program source code for the patch with the displayed name. In this embodiment, the patches are displayed in the order that the patches physically exist in module file deMunck.c. Although a main function patch was indicated, its position in the file is below the function psifun_demunck, shown at the bottom of the frame.

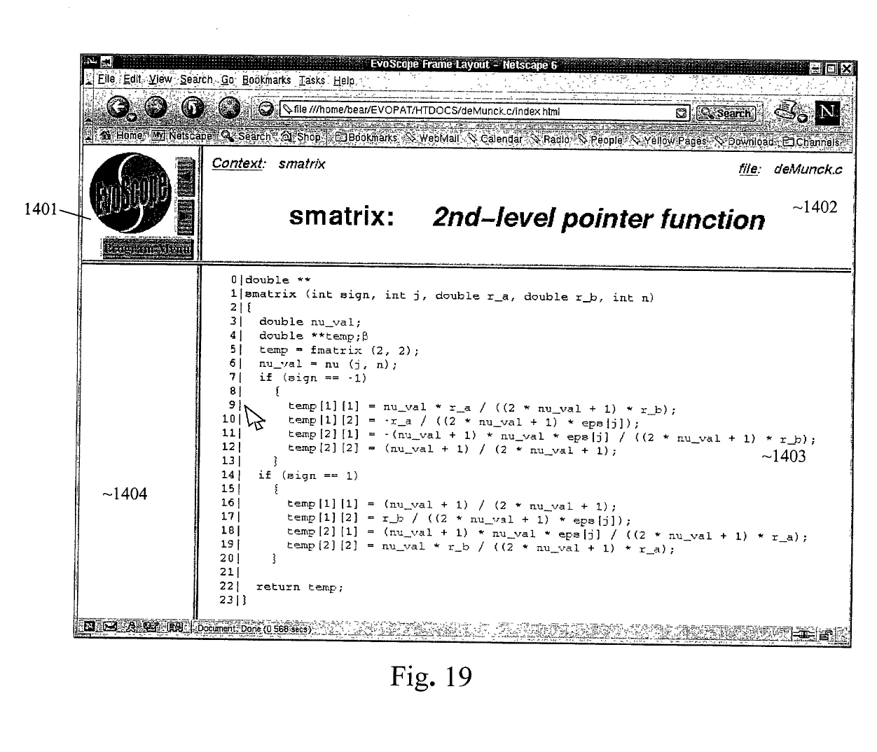

In this menu display, when the user selects function smatrix in column 1703 (e.g., positions cursor 1601 over smatrix and clicks a mouse button, or perhaps speaks smatrix into a voice recognition system) the display changes to that illustrated in FIG. 19. Patch heading frame 1402 includes the name of the patch selected, e.g., smatrix, and a description of patch smatrix. Frame 1403 displays twenty-three lines of source program code statements that make up function smatrix.

Each program-element identifier symbol, i.e., each name symbol, in the displayed source program code statements embodies a hypertext anchor and link, in this embodiment. Herein, as examples, function and variable program-element identifier symbols are considered in more detail. In view of this disclosure, those of skill in the art can implement the features described for any name symbol.

When the cursor is placed over a program-element identifier symbol, an onMouseOver event occurs that results in display of a tooltip message. The tooltip message includes an annotation that describes the program-element identifier symbol. When the cursor is placed over a program-element identifier symbol and the program-element identifier symbol is selected, an onClick event occurs that results in a more detailed display of information about that name symbol, as described more completely below.

Function(Subroutine) Program-Element Identifier Symbols

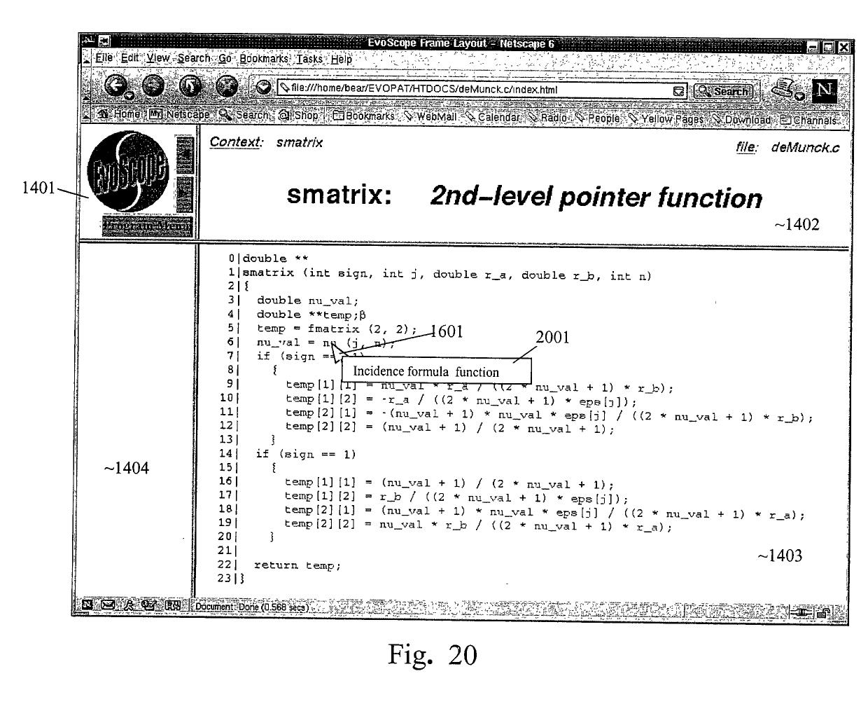

In FIG. 20, cursor 1601 is positioned over a function program-element identifier symbol nu, which is another function. In response to the onMouseOver event, a tooltip annotation message 2001 that gives a description of function symbol nu (e.g., “incidence formula function”) is displayed. Notice that the user did not need to use the back button in navigation frame 1401 to return to the listing of patches in column 1703 of FIG. 17, and study the listing to determine whether symbol nu represented a function or was a variable.

Tooltip 2001 gives the user a meaningful description, while the source computer program code is displayed, as illustrated in FIG. 20. Similarly, the user did not need to access some other window with an index of functions to obtain a description of function program-element identifier symbol nu, sometimes called function symbol nu, or function annotation trigger symbol nu. If the program-element identifier symbol was for a variable instead of a function, a similar tooltip annotation message is provided. The annotation messages are part of the auto-generic documentation in this example.

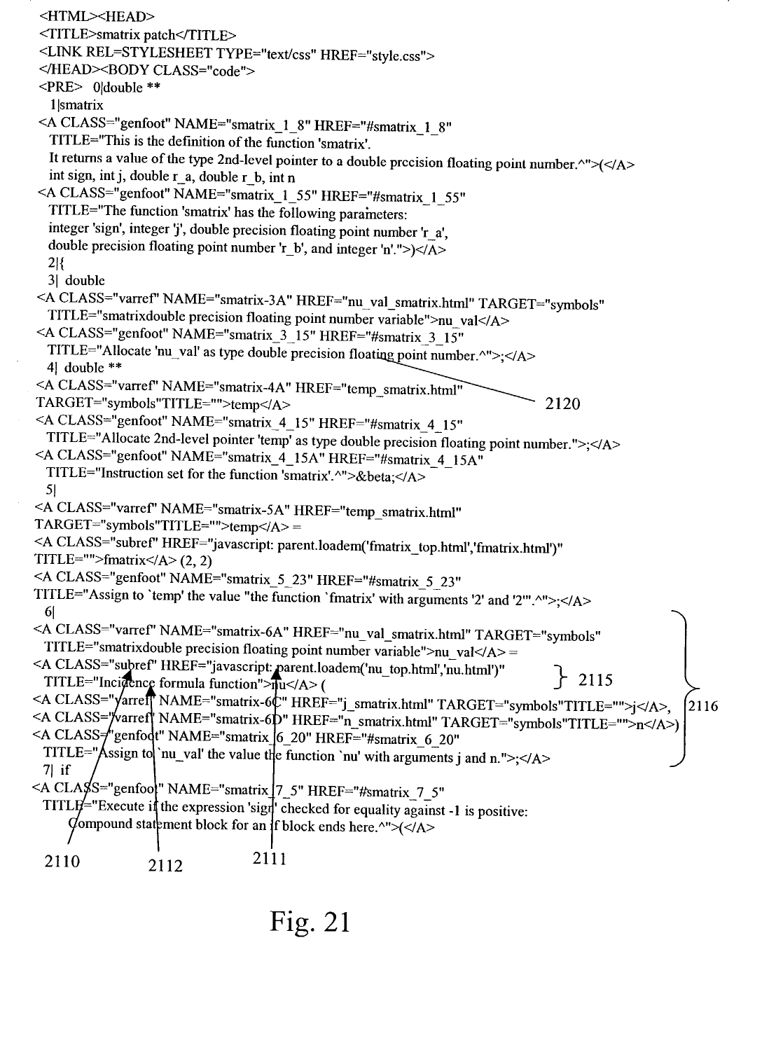

FIG. 21 is a portion of HTML source file, which was produced by hypertext page generator 230, displayed in frame 1403, as illustrated in FIGS. 19 and 20. Lines 2116 (FIG. 21) are associated with line 6 of the program source code displayed in FIGS. 19 and 20. In particular, line 2115 is associated with program-element identifier symbol nu in line 6 of the displayed source code of FIGS. 19 and 20.

Line 6 includes four program-element identifier symbols, nu_val, nu, j, and n. As illustrated in FIG. 21, there is an anchor tag for each of the four program-element identifier symbols. The general format for an anchor tag for a program element identifier symbol that is a call to another patch is:

<A CLASS=“subref” HREF =“javascipt: patent.loadem

(‘symbolidentifier_top.html’, ‘symbolidentifier.htm

l’)” TITLE=“symbol identifier annotation”>

symbolidentifier</A>

where symbolidentifer is the program-element identifier symbol. The general format for an anchor tag for a program element identifier symbol that is a variable is:

<A CLASS=“varref” NAME=patchname_line#redundancy

letter, HREF=“symbolidentifier_patchname.html”

TARGET=“symbols”, TITLE =“symbol identifier

annotation”>symbol identifier</A>

The first attribute included within each anchor tag is attribute CLASS, which is used to identify a stylesheet reference for the symbol reference type. Hence, symbols nu_val, j, and n are variable references and so identify a variable reference stylesheet, while symbol nu is a subroutine or function reference and so identifies a subroutine reference style sheet via subref 2110. In general, attribute CLASS, in this embodiment, is used to identify a particular style that is used for the symbol reference type.

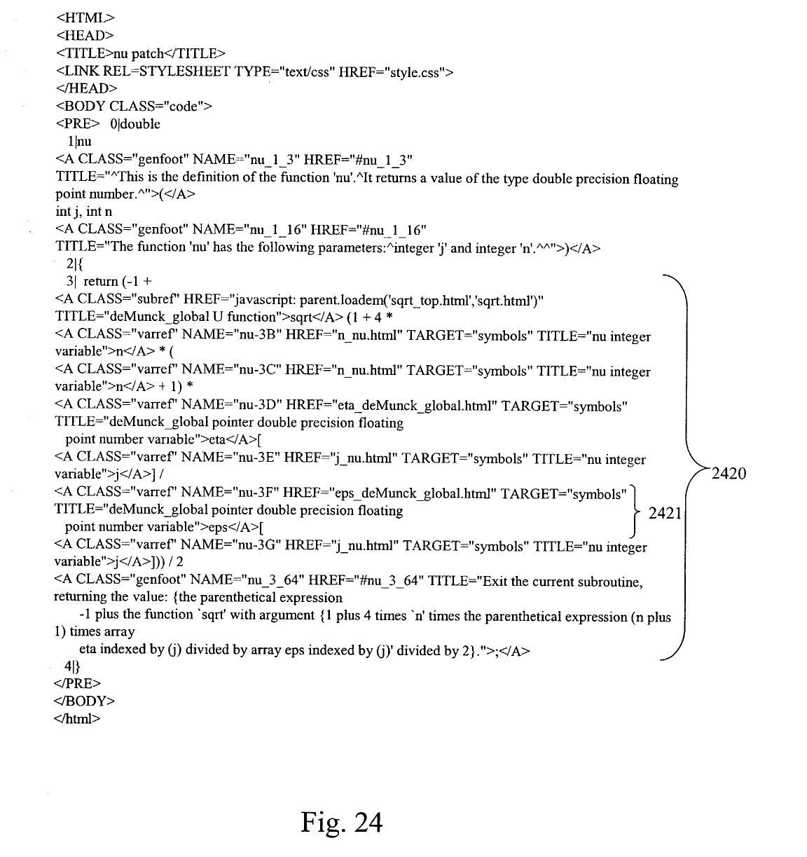

Following attribute CLASS in the anchor tags is attribute NAME for the symbol identifiers that represent variables. Attribute NAME is described more completely below with respect to FIG. 24. Attribute HREF identifies the file that is displayed if the program-element identifier symbol is selected, e.g., identifies the webpage that is displayed in response to an onClick event. For line 2115 (FIG. 21), attribute HREF 2111 employs a JavaScript function to simultaneously load two HTML pages pertaining to symbol nu. A first page, nu_top.html, is loaded into upper right frame 1402 and a second page, nu.html, is loaded into lower right frame 1403, whenever, for example, cursor 1601 references symbol nu in line 6 of FIG. 20 and a mouse button is clicked.

Attribute TITLE contains a description of the program-element identifier symbol, which is displayed when cursor 1601 is positioned on the program element identifier symbol. Hence, in the anchor tag for symbol nu attribute TITLE 2112 contains “Incidence formula function,” which was displayed as illustrated in FIG. 20.

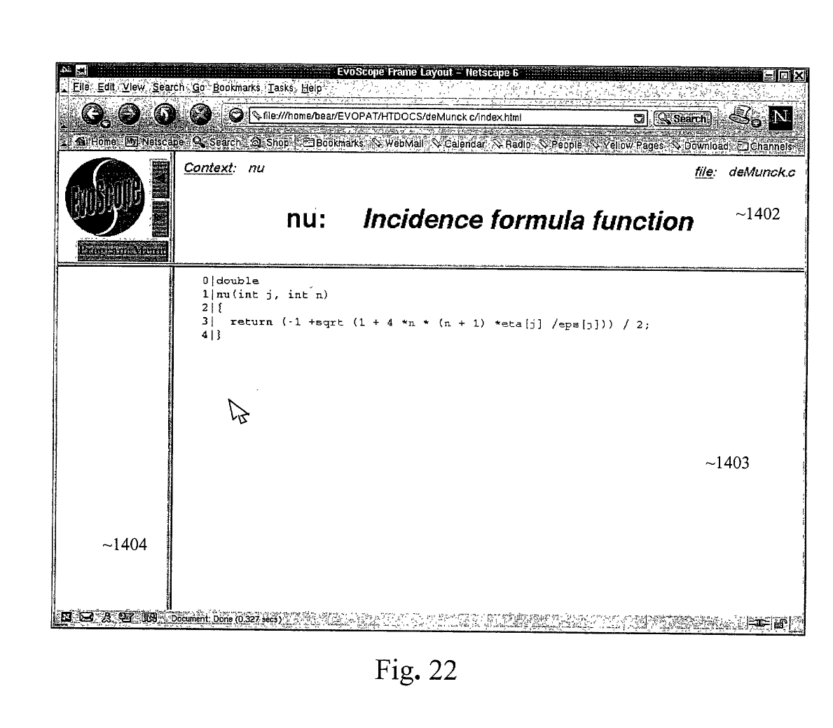

FIG. 22 shows the result when the user clicks the mouse when, as illustrated in FIG. 20, the mouse is referencing symbol nu. Two HTML files nu_top.html and nu.html, which were referenced in attribute HREF 2111 (FIG. 21), have been loaded into upper right frame 1402 and lower right frame 1403, respectively. This action simulates the actual run-time call of the subroutine (function) nu for the purposes of understanding the logical flow of the program.

Variable Program-Element Identifiers

Another feature of this invention is that a dynamically annotated display pertaining to a variable program element identifier symbol, sometimes called variable symbol, representing a program variable is generated upon selection of the variable symbol in frame 1403. In one embodiment, the dynamically annotated display for the selected variable symbol describes the type of the variable and/or the structure of the variable, the scope of visibility from other program elements, and contains a menu of annotated references with hypertext links to all anchors for the variable in other statements in all of the program source-code.

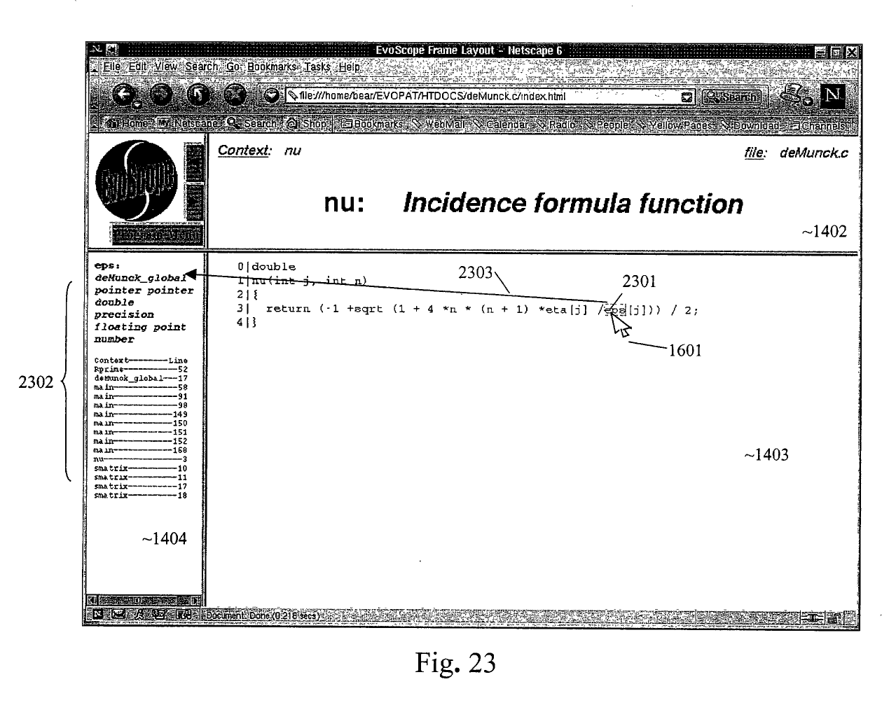

For example, assume a user places cursor 1601 on variable symbol eps 2301 in FIG. 23, and selects variable symbol eps, e.g., selects variable symbol eps by the action of clicking the mouse while referencing variable program element identifier symbol eps. Selection of variable symbol eps invokes a sidebar cross-reference menu 2302 for variable eps in the lower left sidebar menu frame 1404. This action is represented by arrow 2303.

The information in sidebar cross-reference menu 2302 is typical of that presented in frame 1404. A default description of variable eps is given in the subheading of frame 1404, and is followed by a list of anchor link entries denoting the patch, i.e., context, and line number of all of the references to variable symbol eps within the full scope of the variable, which, in this example, is source computer program file deMunck.c.

FIG. 24 is the HTML source file of patch nu for the display in frame 1403 of FIGS. 22 and 23. Lines 2420 are associated with line 3 of the source computer program code statements as displayed in FIGS. 22 and 23. Again, there is an anchor tag for each program-element identifier symbol in line 3 of the program source code. Attribute CLASS in the anchor tag was described above and that description is incorporated herein by reference.

In this embodiment, attribute NAME in the anchor tag has a format

<patchname>-<line-number><symbol-sequence-letter>.

In this example, the patch name is nu, and the program line number within patch nu is three. Hence, the name for each program-element identifier symbol starts with nu-3. To distinguish between the various program-element identifier symbols in line 3, a different sequence letter is appended to each name as a line position indicator.

Each attribute NAME functions has up to three kinds of referents:

i) a link target referent by an anchor in a cross-reference menu (attribute NAME is a relative goto label of an anchor tag within an HTML file, which is linked to as an appendage of a URL, preceded by a pound sign);

ii) an absolute symbol reference locator within the source-code program (e.g., symbol eps symbol is referenced as nu-3G) meaning the sixth (G^{th}) symbol reference on line 3 of patch nu; and

iii) a lookup key to the reference statistics.

As explained above, the lookup key (reference keys 215 DD) is aggregated from hash file symbol-name.gsy 650 in metatree 610 into memory hash %symbol 215 CC from which the lookup key is used to lookup symbol references contained in hash %annostat 215 EE aggregated from hash file <patchname>.gas. Every program element identifier symbol in hash %symbol 215 CC thus carries every reference (keys 215 DD into hash 215 EE) to that program-element identifier symbol within the program. Hypertext page generator 230 (specifically operations 1509 and 1510 in FIG. 15) cycles through keys 215 DD for each symbol in hash 215 CC to construct the sidebar cross-reference menu for that symbol, which may be statically or dynamically generated to accommodate run-time editing, in frame 1404.

Attribute HREF, within the anchor tags for the program identifier symbols in line 3 of the program source code for function nu and in general, is a hyperlink to an HTML file, in this embodiment. The HTML file name used in attribute HREF is a concatenation of the variable name and the scope of the variable (combining the two keys of hash %symbol). Generally, the scope is the name of the containing patch where the variable resides (where its storage is allocated, either statically by the compiler, or dynamically on a run-time stack when the patch is invoked at run-time). However, sometimes a variable is a member of a scope that is an internal block within a patch. In this case, the name of the scope has the form <patchname>_<line-number>_<column-number>, denoting the position of the beginning of a block, e.g., an opening brace in C-derivative languages.

As is known to those of skill in the art, attribute TARGET specifies the frame in which the HTML file specified by attribute HREF is displayed.

Hence, when the user places cursor 1601 on variable eps 2301 (FIG. 23), anchor tag 2421 (FIG. 24) is executed. File eps_deMunck_global.html is loaded as sidebar menu 2302 in frame 1404, as illustrated in FIG. 23.

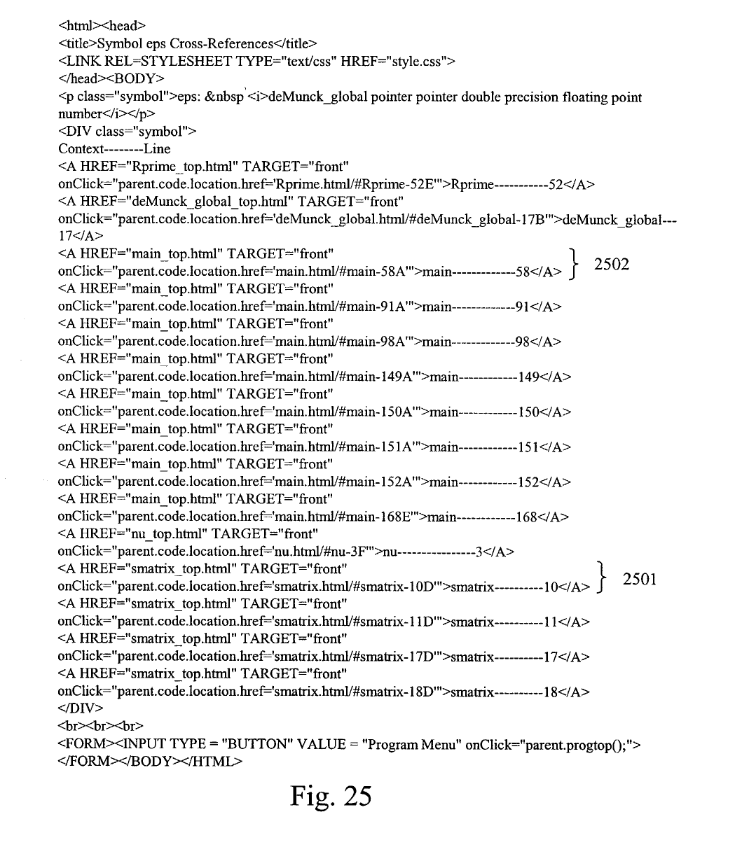

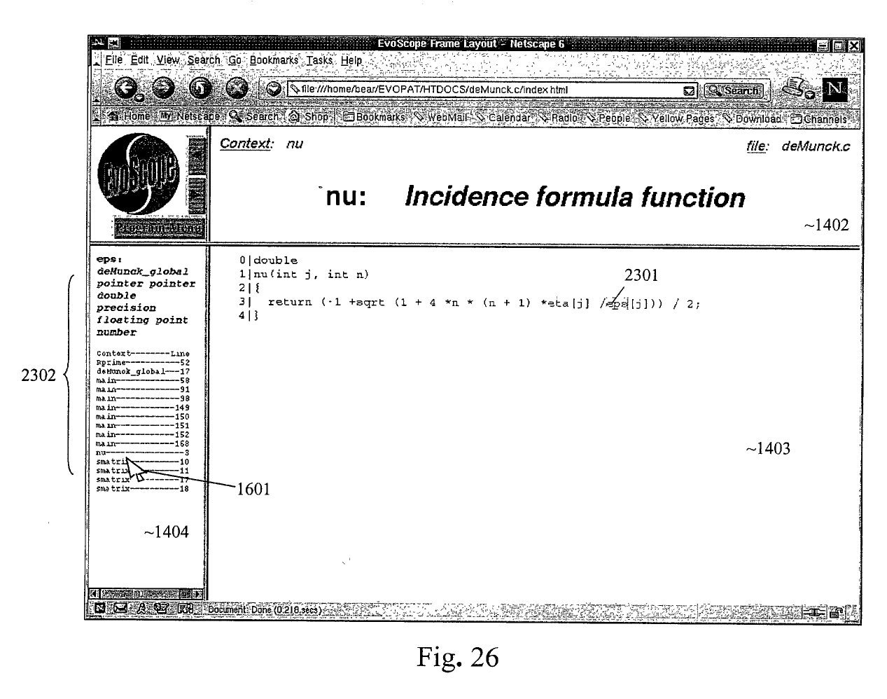

FIG. 25 shows the HTML code in file eps_deMunck_global.html for variable eps sidebar menu 2302 as illustrated in FIG. 23. When the user places cursor 1601 over the first occurrence of smatrix in sidebar menu 2302 (FIG. 26) and invokes the anchor associated with that occurrence via a mouse click, line 2501 (FIG. 25) is executed. In this case, two webpages, i.e., two files created by generator 230, must be loaded in the right frames, top title frame 1402 and bottom patch code frame 1403. Hence, attribute HREF is augmented by an onClick event-function call.

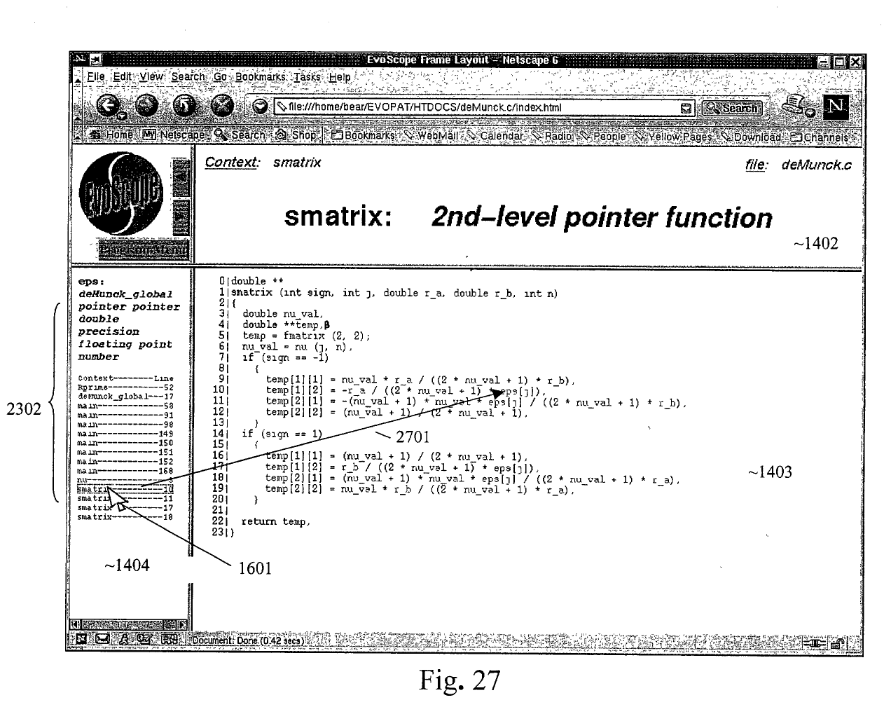

FIG. 27 illustrates the result of execution of line 2501 (FIG. 25 ) following clicking the mouse on entry smatrix in sidebar menu 2302 displayed in frame 1404 (FIG. 26). Hence, in general, selecting an entry in the sidebar menu retrieves and loads in frame 1403 a webpage containing the entry selected.

With the use of static HTML, when the entire webpage associated with the selected entry in sidebar menu 2302 is contained within frame 1403, the whole webpage is displayed. In this case, the program symbol identifier associated with the actual anchor referenced by the mouse click is not specifically indicated by the browser within the webpage displayed in frame 1403 (See FIG. 27). The user can simply look at the line number in sidebar menu 2302 and find the corresponding line number in the program source code displayed in frame 1403, which in this example is line 10. Arrow 2701 represents the visual transition that must be made by the user and is not a part of the display. In another embodiment, employing dynamic HTML as described below, the program element symbol identifier is highlighted in the display in frame 1403.

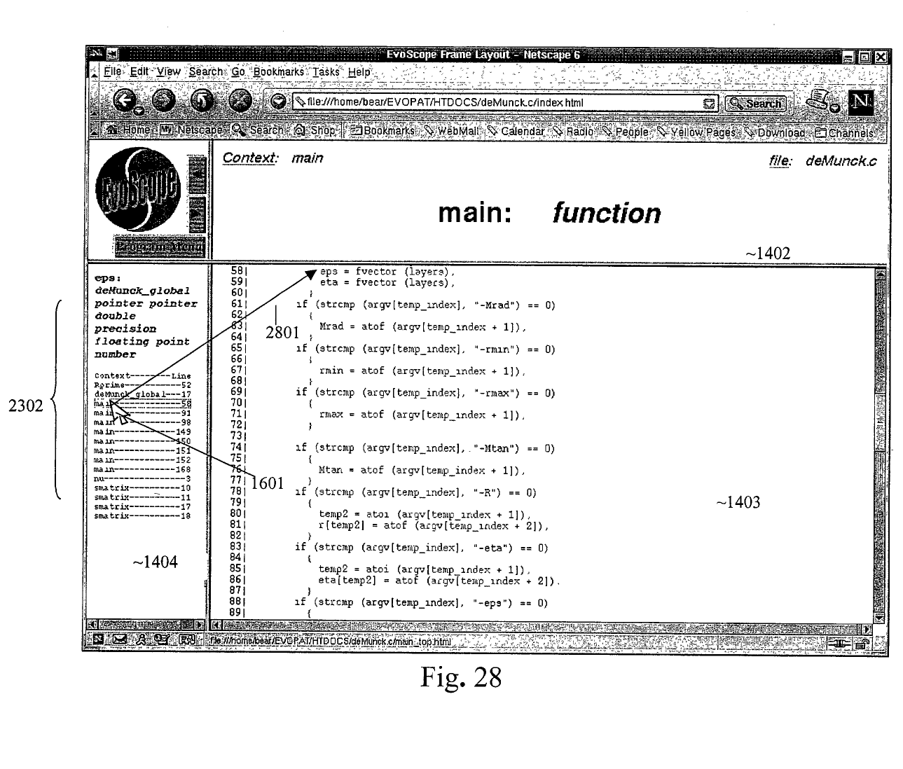

Assume that instead of placing cursor 1601 on the first occurrence of smatrix in sidebar menu 2302 and clicking the mouse as in FIG. 26, the user places cursor 1601 on the first occurrence of main (FIG. 28) in sidebar menu 2302 and clicks the mouse. This results in executing the anchor associated with the first occurrence of main in sidebar menu 2302, i.e., line 2502 in FIG. 25 is executed. Execution of line 2502 results in frames 1402 and 1403 being loaded with the title and program source code for patch main, respectively, as illustrated in FIG. 28.

In this case, the program source-code for patch main is too large to be displayed completely in frame 1403. The browser positions the source code for patch main within frame 1403 such that the referenced anchor (e.g., the line in patch main containing the target symbol reference, e.g., variable eps, selected in sidebar menu 2302 ) is on the first line displayed. Arrow 2801, which is not a part of the display, is used to highlight the positioning of the line.

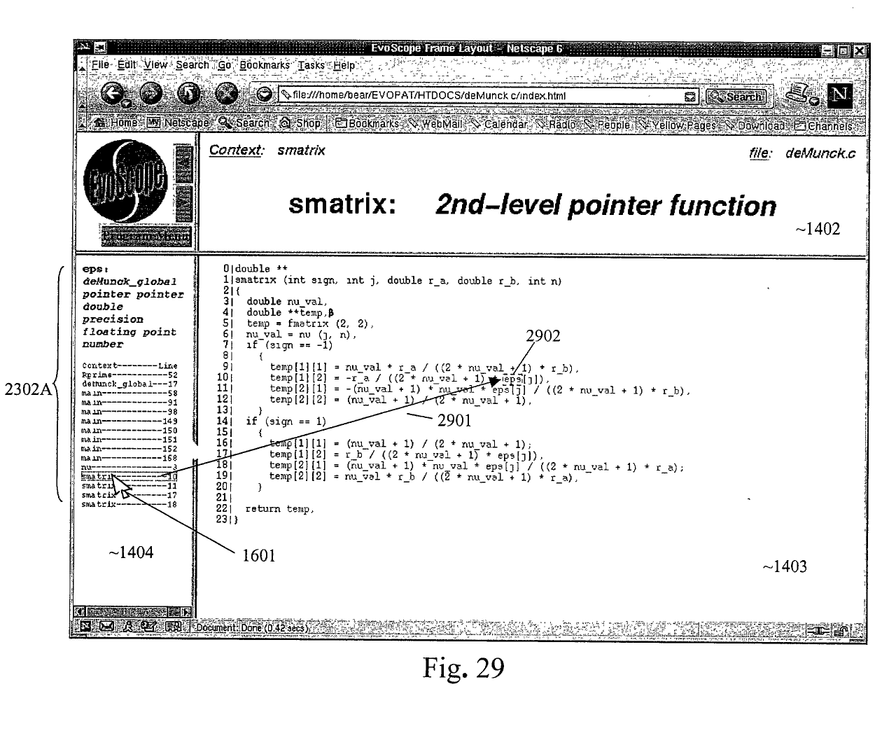

In another embodiment, employing dynamic HTML, when a link is selected in sidebar menu 2302 A (FIG. 29), the referenced anchor is highlighted, for example in a special color, and perhaps with blinking animation in patch code frame 1403. FIG. 29 is similar to FIG. 28, except in this embodiment, the webpage displayed in sidebar menu frame 1404 is written in dynamic HTML.

Again, when the entire webpage associated with the selected entry in sidebar menu 2302 A is contained within frame 1403, the whole webpage is displayed. In this case, the program symbol identifier associated with the actual anchor referenced by the mouse click is specifically indicated by the browser within the webpage displayed in frame 1403 (See FIG. 29). The user can simply look for symbol 2902 that is highlighted, in this example.

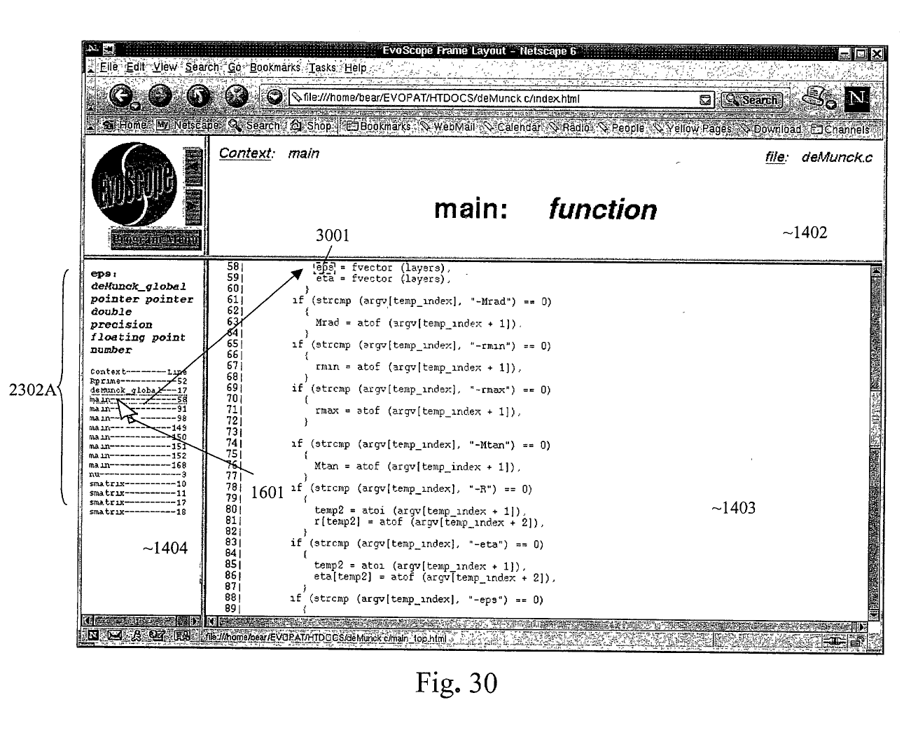

When the user places cursor 1601 on the first occurrence of main in sidebar menu 2302 A, and clicks the mouse, the program source-code for patch main is loaded in patch code frame 1403. Again, the program source code for patch main is too large to be displayed completely in frame 1403. The browser positions the source code for patch main within frame 1403 such that the referenced anchor (e.g., the line in patch main containing the target symbol reference, e.g., variable eps, selected in sidebar menu 2302 ) is on the first line displayed and in this embodiment, variable eps 3001 is highlighted as illustrated in FIG. 30.

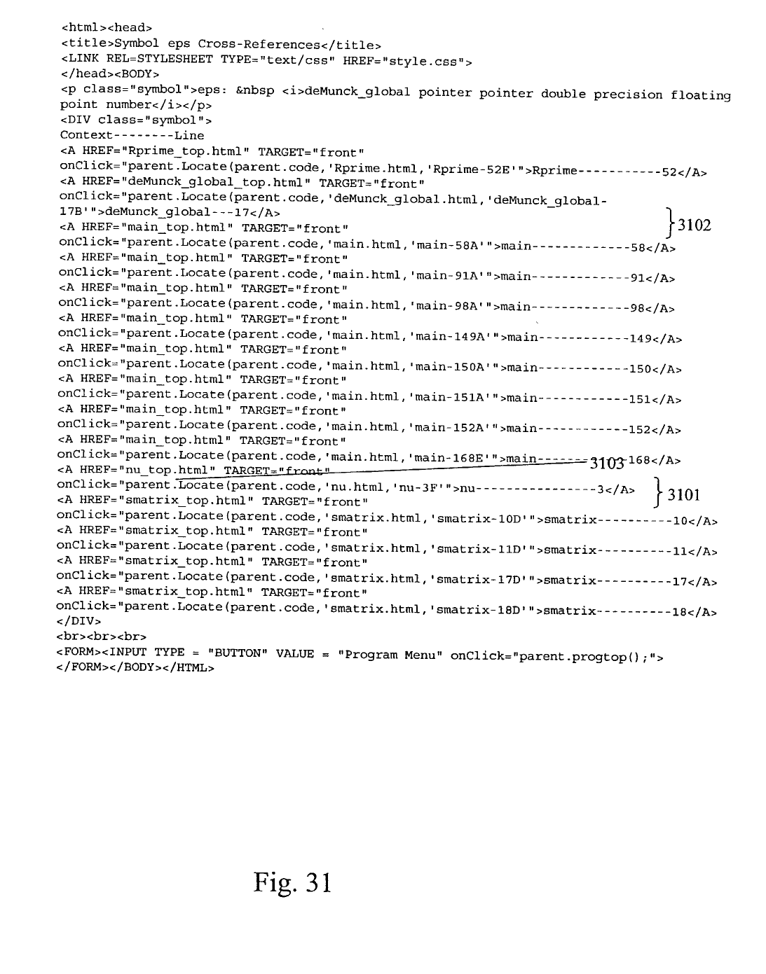

Hence, FIGS. 29 and 30 illustrate the affect of highlighting the target symbols 2902 and 3001 respectively. FIG. 31 is an example of dynamic HTML scripting to achieve this affect. FIG. 31 shows the alternate HTML source of sidebar menu 2302 A showing the respective anchor tags 3101 and 3102 whose execution is illustrated in FIGS. 29 and 30, respectively.

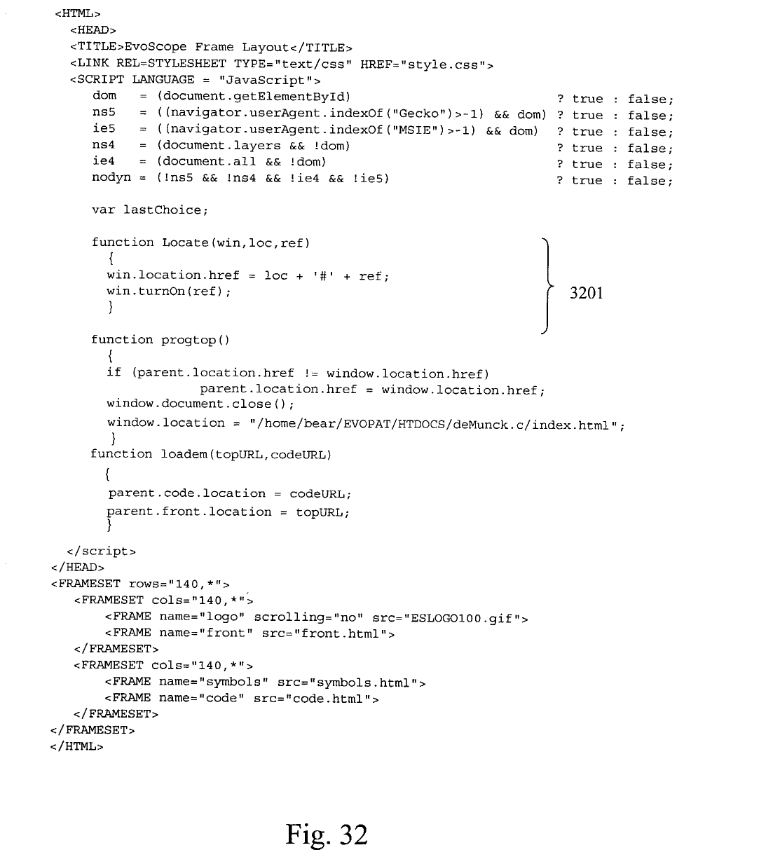

In this embodiment the onClick event results in a call 3103 to a JavaScript function Locate 3201, shown in FIG. 32, passing function Locate 3201 the window frame parent.code, the URL (HTML file), and the link target (anchor name). Function Locate 3201 performs the hypertext link to the target anchor, by assigning the window frame HREF to the anchor reference formed by concatenating the URL to the anchor name prepended with a pound sign #. This window frame HREF causes the browser to load the selected webpage into the code frame, as before, and then further calls function turnON (TABLE 5), which resides in tag HEAD of frame CODE, passing function turnON the anchor name object.

TABLE 5

<script LANGUAGE = “JavaScript”> var lastChoice

function turnON (obj)

{
var curLnk = document.getElementById (obj);
if (lastChoice == curLnk) return;
else if (lastChoice) lastChoice.className = “off”;

curLnk.className = “on”;
LastChoice = curLnk;

}

</script>

Function turnON gets the document reference to the anchor using document method getElementById, and assigns the document reference to global variable curLnk. Function turnON then checks to see if global variable curLnk has been assigned to local state variable lastChoice (meaning that highlighting has already been turned on for this anchor), and if so exits, allowing the anchor's highlighting to continue. However, if variable lastChoice has a value other than curlnk, another anchor is highlighted meaning that its stylesheet className property is assigned to the style .on (TABLE 6), in which case the other anchor is reset to style .off, killing highlighting for the other anchor. Next, property className of the current anchor is assigned to style on, causing the anchor text to become highlighted, and state variable lastChoice is assigned to the current anchor reference.

TABLE 6

| | |
|---|---|
| .off | {font-family: courier, lucinda, monospace; |
| | font-size: 11pt; color: blue; text- |
| | decoration: none} |
| .on | {font-family: courier, lucinda, monospace; |
| | font-size: 11pt; color: white; background- |
| | color:blue; text-decoration: blink) |

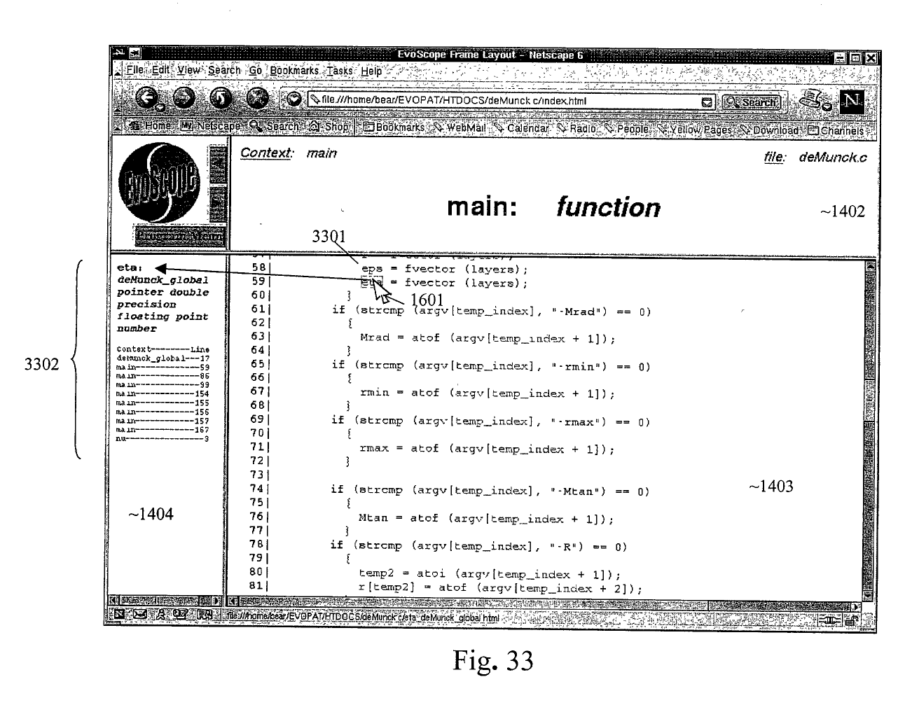

In reviewing, program element identifier symbol eps in patch main, the user observes program element identifier symbol eta 3301 (FIG. 33). The user places cursor 1601 over symbol eta 3301 and selects symbol eta 3301, e.g., clicks a mouse. As explained above, the anchor associated with symbol eta 3301 is executed, which results in sidebar menu 3302 being loaded in frame 1404 (FIG. 33). Hence, the user continues surfing from the patch code for function main to another sidebar cross-reference menu of another symbol. This is a further example of the utility of having each symbol in a program associated with an anchor, which can be used to launch a menu that permits the user to navigate and explore the symbol's logic and data paths.

Footnote Annotations

In one embodiment, as described above, each program statement of a patch has an associated annotation description, e.g., prose/pseudocode for the statement. The purpose of the annotation is to aid a layman or programmer unfamiliar with the source-language to understand the nature of the statement or reference. When the program source code for a patch is displayed in frame 1403, and the user positions cursor 1601 over a footnote annotation trigger symbol (e.g., a footnote symbol, a text delimiter, or a blank space, adjacent to the displayed statement) the annotation for the displayed statement is presented as a tooltip.

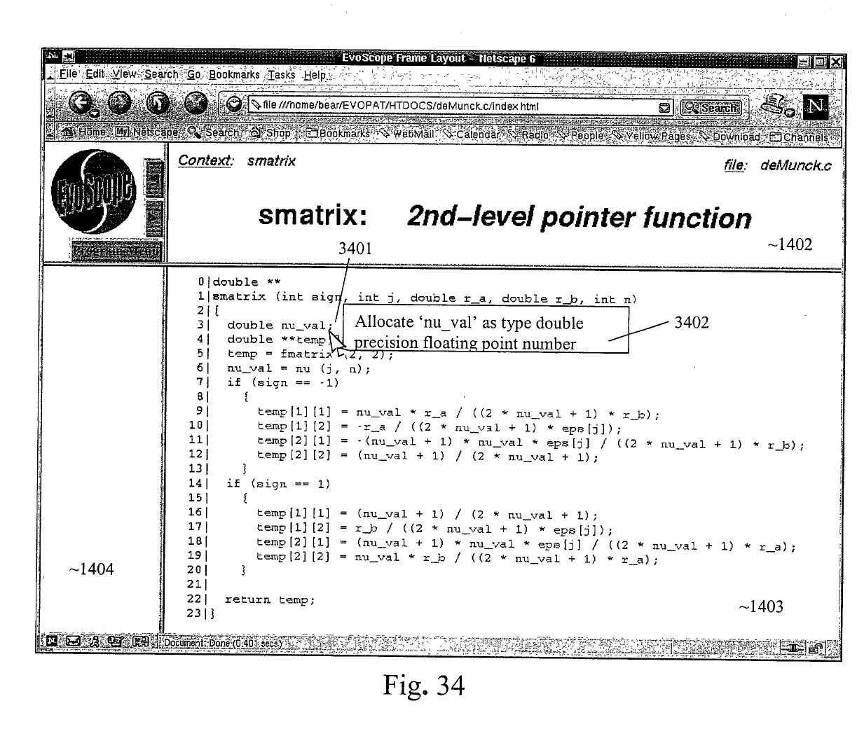

In FIG. 34, footnote annotation trigger symbol 3401 is a semi-colon, which is one example of a text delimiter. Hence, when cursor 1601 is placed over footnote annotation trigger symbol 3401, annotation 3402 is displayed. Annotation 3402 gives a description of line 3 of function (patch) smatrix. Hence, the user is able to view simultaneously both the program statement and the prose/pseudocode description of the program statement.

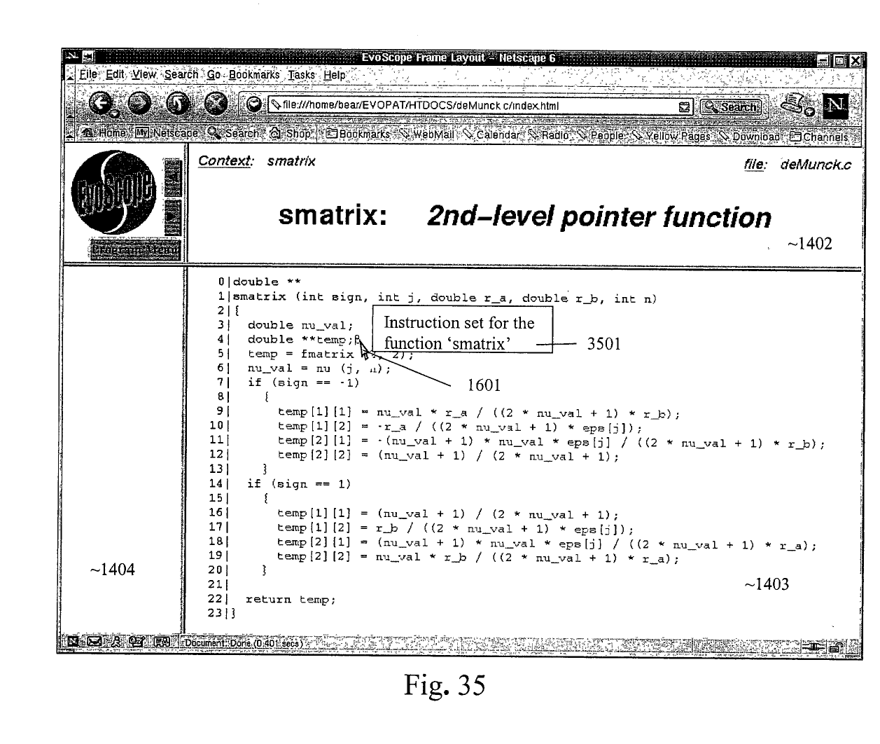

Notice that in FIG. 35, there is a Greek character β at the end of line 4 in patch smatrix. Typically, when there is more than one footnote associated with a line, a unique footnote annotation trigger symbol is added to the end of the line for each additional footnote. In this example, there is a first annotation associated with the semicolon at the end of line 4 and a second annotation associated with the Greek character β.

Also, in one embodiment, the semicolon and the Greek character β have a size larger than the normal character size used in the display of the program statements making up function smatrix. According to this embodiment of the invention, an annotation trigger symbol has a size or width greater than the standard character size or width for the characters making up the program statement. Here, a character can be an alphanumeric character, a space, a number, a punctuation symbol, or a mathematical symbol or operator, or any other character appearing in the line. Making the annotation trigger symbol have a larger character width facilitates positioning cursor 1601 to view the annotation for the program statement.

In FIG. 35, when cursor 1601 is placed over footnote annotation trigger symbol β, annotation 3501 is displayed, which gives a description of the subsequent lines of function smatrix. Annotation 3501 indicates the start of the instruction set, i.e., the executable statements. Hence, the user is able to view simultaneously both the program statement and the prose/pseudocode description of the program statement.

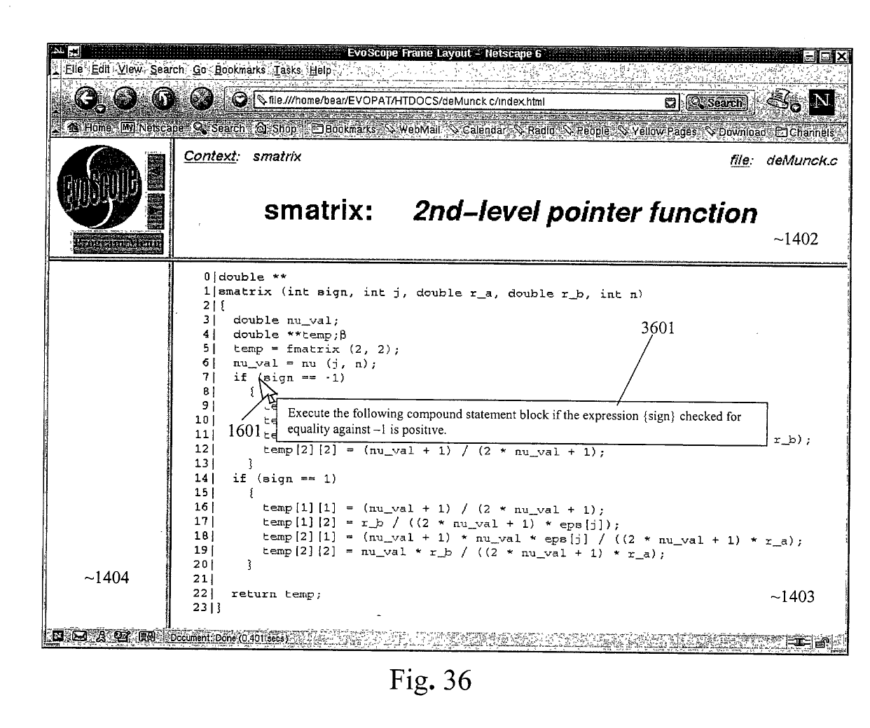

Another use of the annotations of this invention is illustrated in FIG. 36, cursor 1601 is positioned over the left parenthesis (e.g., over a text delimiter) following the if in line 7 of function smatrix. Annotation 3601 is displayed, which again describes the program statement in line 7.

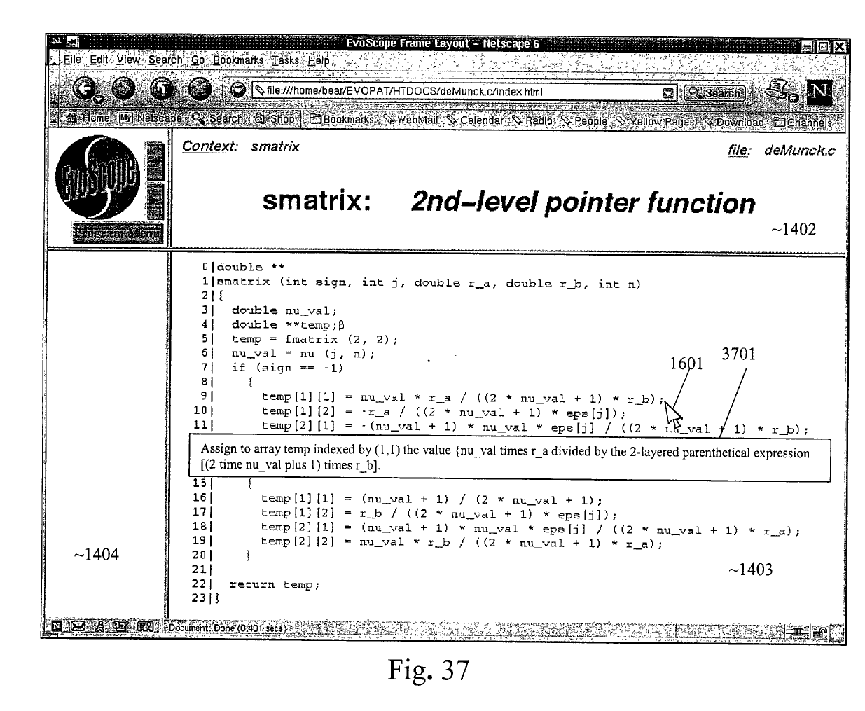

In FIG. 37, cursor 1601 is positioned over the semicolon at the end of line 9. Annotation 3701 is displayed, which describes the program statement in line 9.

Hence, each footnote annotation trigger symbol (e.g., a footnote symbol, a text delimiter, or a blank space) is an anchor for a footnote annotation, sometimes called a tooltip. An example of a template for a footnote annotation anchor, according to one embodiment of the present invention, is:

<A CLASS=“genfoot” NAME=“patch_line#_col#”

HREF=“#patch_line#_col#” TITLE=“Displayed

Annotation”>annotation_trigger_symbol </A>.

Attribute CLASS is set to genfoot, which indicates a generic annotation style anchor. An identifier symbol patch_line#_col# is used as the anchor name in attribute NAME. The identifier symbol is a location pointer key that is used both as an absolute symbol pointer and as an associative array lookup key.

As an absolute symbol pointer, the identifier symbol contains three fields, separated by an underscore, and potentially a fourth field if an alphabetic character is attached. In the identifier symbol, the first of the fields, patch, is the patchname. The second field is the line number, line#, and third field is the column number col#. If there is more that one footnote associated with the same column, in the anchor for the second and any subsequent footnotes, the column number is followed by a letter, i.e., an alphabetic sequence character field denoting the sequence of extra footnotes emanating from the same column position. In this case, the actual footnote symbol is offset from the original column position, which is occupied by the symbol identified by the key without an alphabetic character.

As a lookup key, identifier symbol patch_line#_col# is used to reference the footnote text stored in the metatree in cradle file system 115. The footnote text is stored either in a hash file (e.g., hash file <patchname>.gat or <patchname>.sat) or the memory associative array %annotation, which these files aggregate into for data processing. The footnote text callout (e.g., the identifier symbol) points to the text to be displayed, which is contained in the TITLE attribute of the anchor tags.

Attribute TITLE contains the text that is displayed when the footnote annotation trigger symbol annotation_trigger_symbol is selected by the user. In FIG. 21, each anchor with attribute CLASS set to genfoot is an example of the use of the above template. In addition, this HTML code was used in generating the annotations displayed in FIGS. 34 to 37.

In the previous examples, the footnote annotation was composed of HTML anchor tags surrounding punctuation symbols in the source text, which display footnote text whenever the punctuation symbol (or appended footnote symbol) was covered by cursor 1601 such that an onMouseOver event occurred. The displayed footnote text appears in the form of a tooltip message that was contained in the TITLE attribute of the anchor tag.

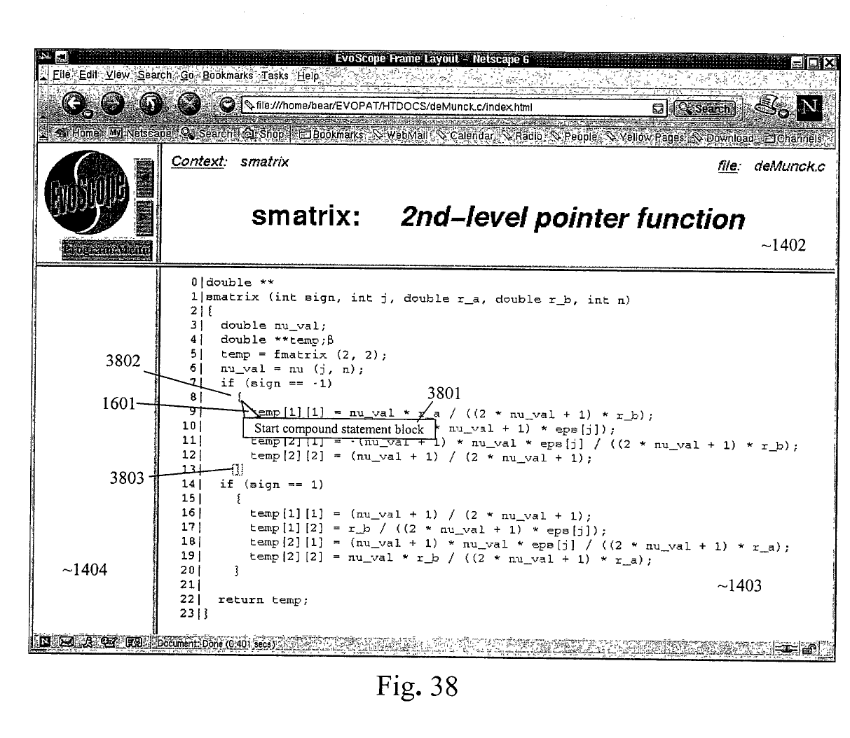

In cases where an annotation trigger symbol is one of a pair or other multiple symbols from which a footnote emanates due to an onMouseOver event, such as the beginning brace {, which initiates a context block, or an ending brace}, which terminates such a block, clicking the mouse causes the highlighting of the outlying symbol. For example, in FIG. 38, placing mouse cursor 1601 over left brace 3802 on line 8 following the if statement results in the footnote tooltip display 3801, and clicking the mouse causes highlighting 3803 of the associated closing brace on line 13.

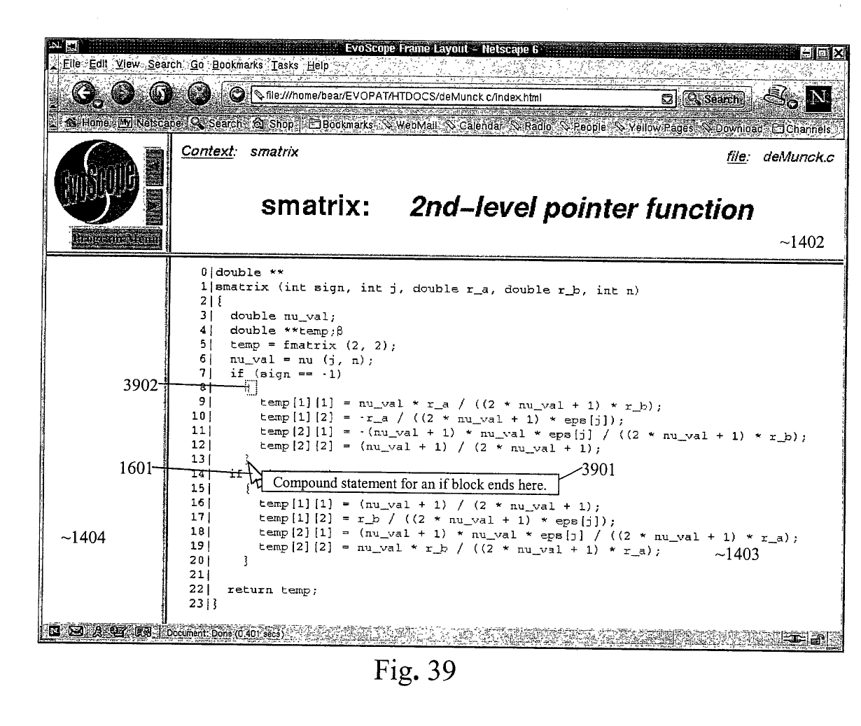

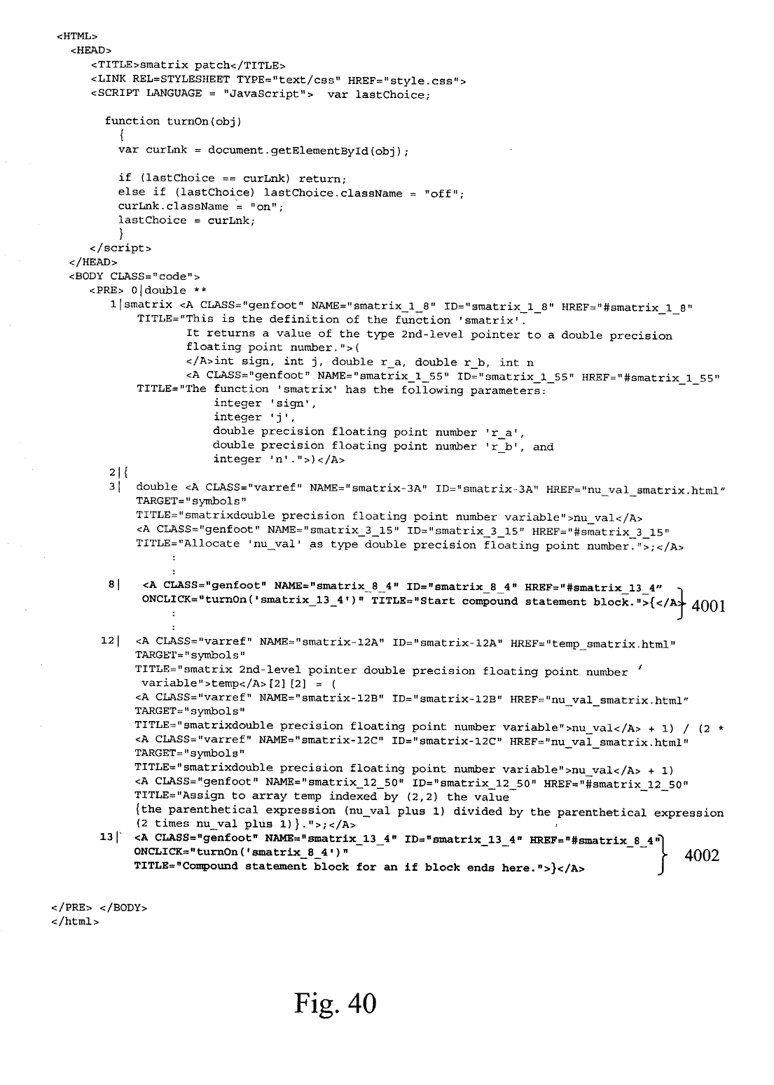

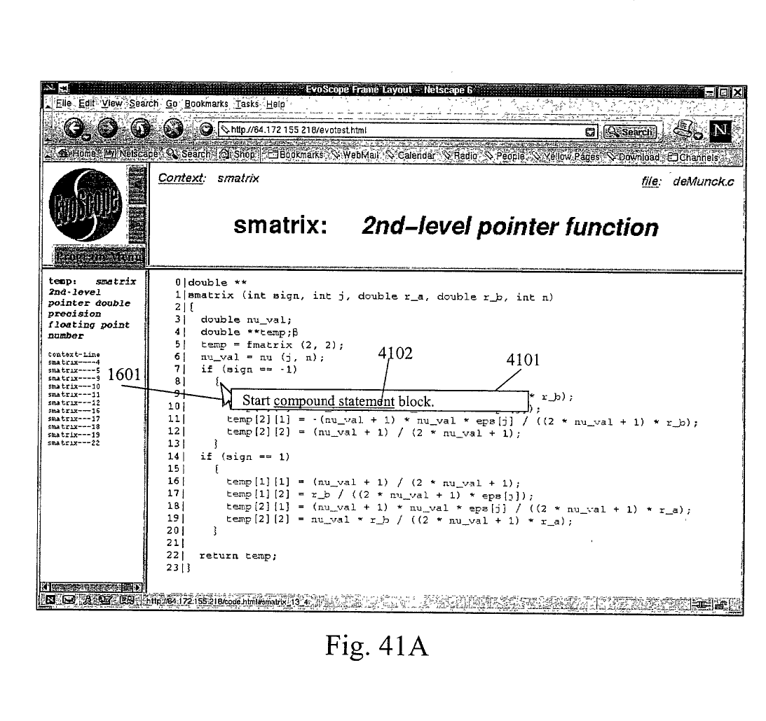

Similarly, in FIG. 39, placing mouse cursor 1601 over the right brace on line 13 results in the footnote tooltip display 3901, and clicking the mouse causes highlighting 3902 of the associated opening brace on line 8. The dynamic HTML tags for these effects are illustrated as anchors 4001, and 4002, respectively, in FIG. 40.

Whereas onMouseOver events are implied by placing the messages in attribute TITLE, default behavior in advanced browsers, the highlighting is effected by an onClick event calling function turnON with the anchor name of the remote symbol as its argument. Thus in anchor 4001, the phrase

onClick=“turnON(‘smatrix_13_4’)”

highlights the symbol in anchor 4002, whose name is “smatrix_13_4”, and in anchor 4002, the phrase

onClick=“turnON(‘smatrix_8_4 ’)”

highlights the symbol in anchor 4001, whose name is “smatrix_8_4”.

In another embodiment, a popup sub-window is displayed by a script language function invoked by the onMouseOver event. The popup sub-window may contain further anchor tags invoking further sub-footnote text via onMouseOver event tooltips, onMouseOver event popup sub-sub-window events, or even mouse clicked links to further popups, web frames, or webpages.

FIG. 41A illustrates a tooltip 4101 containing a hypertext link 4102 that is invoked in response to an onMouseOver event associated with placing cursor 1601 over the left brace in line 8. Pressing a predefined key (e.g., control key 4110 as illustrated in FIG. 41B) allows cursor 1601 to be moved into the tooltip to activate link 4102 resulting in appearance of a popup help window 4120, as illustrated in FIG. 41C. In this case, the HTML anchor tag associated with the left brace annotation trigger symbol has the form:

8|<a CLASS=“genfoot” NAME=“smatrix_8_4”ID=“smatrix_8_4”HREF=“#smatrix_13_4”onClick=“turnON(\‘smatrix_13_4\’)”

ONMOUSEOVER=“Tip.Show(event, ‘Start <A HREF=\‘lexical_scope.html\’>compound statement</A>block.’);”>{</a>

In this embodiment, the onMouseOver event handler is a JavaScript method function Show of an object class Tip, designed for tooltip special effects, such as this. The first argument of function Tip.Show is the event that invokes the tooltip, in this case ONMOUSEOVER, and the second argument is the message to be displayed in the tooltip. In this case, the message “Start compound statement block” contains hyperlink 4102 which invokes file lexical_scope.html when clicked, resulting in the popup window shown in FIG. 41C.

With the aid of the descriptive information in upper right frame 1402, which in a fully populated implementation includes a synopsis manually entered by the program designer as descriptive documentation, and the annotation accessible in lower right frame 1403, providing descriptive details to the layman as well as the professional programmer, any person reviewing the program can rapidly comprehend its operation and use without having to understand the source code.

He or she can rapidly comprehend the overall behavior and method of a program by merely scanning the upper-right frames, while surfing though all of the patches in the program. This is especially important for management personnel and persons responsible for the software, who are not cognizant of the nuances of the programming languages being employed.

Once a person has perused the synopsis or more detailed annotation in a patch, a mouseover of the symbol referencing the patch provides a short description (the same as in the title line of the upper patch display), which acts as a summary reminder that mentally integrates into the person's overview of the whole program. If the reminder is insufficient for comprehension of its role in the integration of the whole, the click of the mouse brings up whatever level of detail that is necessary to assist in the comprehension.

This idea is taken even below the programmer's visual surface of the code in the case of macro expansions. FIG. 41D illustrates a tooltip 4130 resulting from an original mouseover covering symbol mac 4131 of line 19. Tooltip 4130 contains the definition of the macro in the first two lines 4132 followed by two links [FULL EXPANSION] 4133 and [EXPANSION BY STAGES] 4134.

When a user places cursor 1601 on link [FULL EXPANSION] 4133 and generates a click event, a popup window 4140 is generated. Popup window 4140 contains the full inline expansion of the macro call of line 19 where all of the cascaded macro expansions contained within the nested macro definitions have been expanded following substitution of the argument ino for the macro parameter A and argument j12_ for macro parameter B.

When a user places cursor 1601 on link [EXPANSION BY STAGES] 4134 and generates a click event, a popup window 4150 (FIG. 41E) is generated. Popup window 4150 contains a first macro expansion showing a call 4151 to first nested macro sub 3 from the body of the outer macro definition with argument ino substituted for outer argument A. Macro sub3 (A) is defined as (A-3) and expansion 4152 is (ino-3) after substitution of ino for A.

Popup window 4150 also includes a link [NEXT EXPANSION STAGE] 4153. Upon placement of cursor 1601 as shown by the dotted cursor symbol in window 4150 and generation of a mouse click, popup window 4160 (FIG. 41F) is generated.

Window 4160 displays contains a second macro expansion showing a call 4161 to a second nested macro add5 from the body of the outer macro definition with argument j12_substituted for outer argument B. Macro add5 has a body of (B+5), which after the indicated substitution is (j12_{—}+5). This value is presented in expansion 4162.

Popup window 4160 also includes a link [NEXT EXPANSION STAGE] 4163. Upon placement of cursor 1601 as shown in window 4160 and generation of a mouse click, popup window 4170 (FIG. 41 G) is generated.

Window 4170 displays contains a third macro expansion showing a call 4171 to a third nested macro max with an inner argument A of sub3(ino) and an outer argument B of add5 (j12_). The definition of macro max(A, B) is (A>=B)?A:B. Using the substitutions from windows 4150 and 4160 and this definition, expansion 4172 is

(((ino-3)>=(j12_{—}+5))?(ino-3):(j12_{—}+5),

which is the full expansion as shown in FIG. 41D.

FIG. 41H illustrates tooltip display combinations associated with documentation of system library symbols, e.g., functions and macros. In FIG. 41H, cursor 1601 is positioned on symbol printf, which is a function in library stdio.h. As explained previously, positioning cursor 1601 over a function symbol results in a tooltip 4180 that explains library function printf. The explanation ends with a link [MORE] 4181.

As previously explained, link 4181 becomes accessible to the mouse by the user first pushing control key 4110 and moving mouse pointer 1601 into tooltip 4180. Once pointer 1601 is inside tooltip 4180 (FIG. 41I), tooltip 4180 remains stationary, and control key 4110 can be released. Next, by clicking the mouse with pointer 1610 on link [MORE] 4181, popup window 4190 is displayed giving more details about function printf. Popup window 4190 could alternatively contain any webpage information, including images and links to other webpages.

Hypertext page generator 230 can be implemented in a wide variety of ways to implement the functionality associated with rapid comprehension source documentation of this invention.

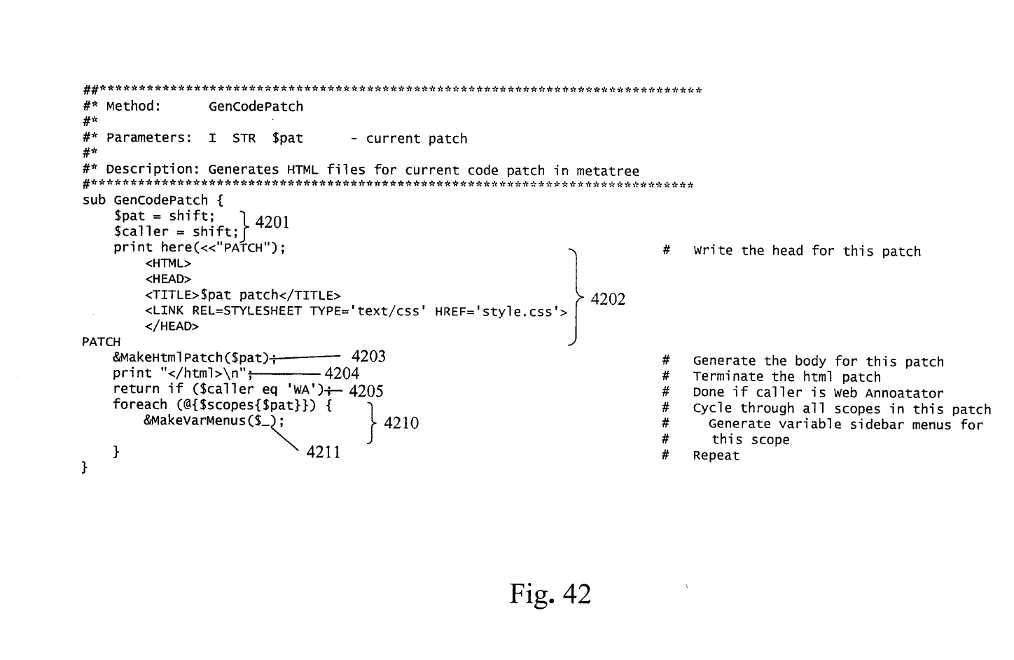

The following description is a more detailed treatment of operation 1507 (FIG. 15), in one embodiment, using the Perl computer programming language, sometimes referred to herein as the Perl language. In one embodiment, operation 1507 is implemented using a primary subroutine GenCodePatch (FIG. 42). Subroutine GenCodePatch and the subroutines called by subroutine GenCodePatch reside in a Perl library module EvoGen.pm, which may be employed by a plurality of higher-order processes in this embodiment.

In this embodiment, subroutine GenCodePatch receives two arguments in lines 4201. Variable $pat receives the first argument, which is the patch name to be generated. A second variable $caller receives the second argument, which is a code string denoting the process which is calling subroutine GenCodePatch. In this embodiment, this may be one of two processes: (i) website generation process 1500 for hypertext page generator 230; or a web annotator process, as described more completely below.

Write the head for this patch statements 4202 contain a here document command, which are the statements occurring between the print statement and keyword PATCH, non-inclusive. The here document command is familiar to those of skill in the art. This command prints the lines following the invocation of the command as the lines appear in the print statement.

In the print statement, delimiting keyword PATCH is enclosed in double quotes, which causes any variable names (e.g., variable $pat) appearing in the here document command to be interpolated, which substitutes the value of the variable in place of the variable name. Thus, write head for this patch, statements 4202, result in printing the preamble tags of the HTML document. Note that the destination file of the information printed is not specified, but is directed by default to a destination specified by the calling process, which is this embodiment is via a Perl select statement.

In the case of operation 1507, the destination is a file resident in the HTML documents directory of the server disk. In the case where the caller is the web annotator process, subroutine GenCodePatch may be called twice for the same patch: (i) once with the destination being the standard output stream (stdout) to route the output from the server to the client browser to refresh the page currently displayed in patch code frame 1403 with an updated version; and (ii) once with the destination as the corresponding HTML file residing on the server disk.

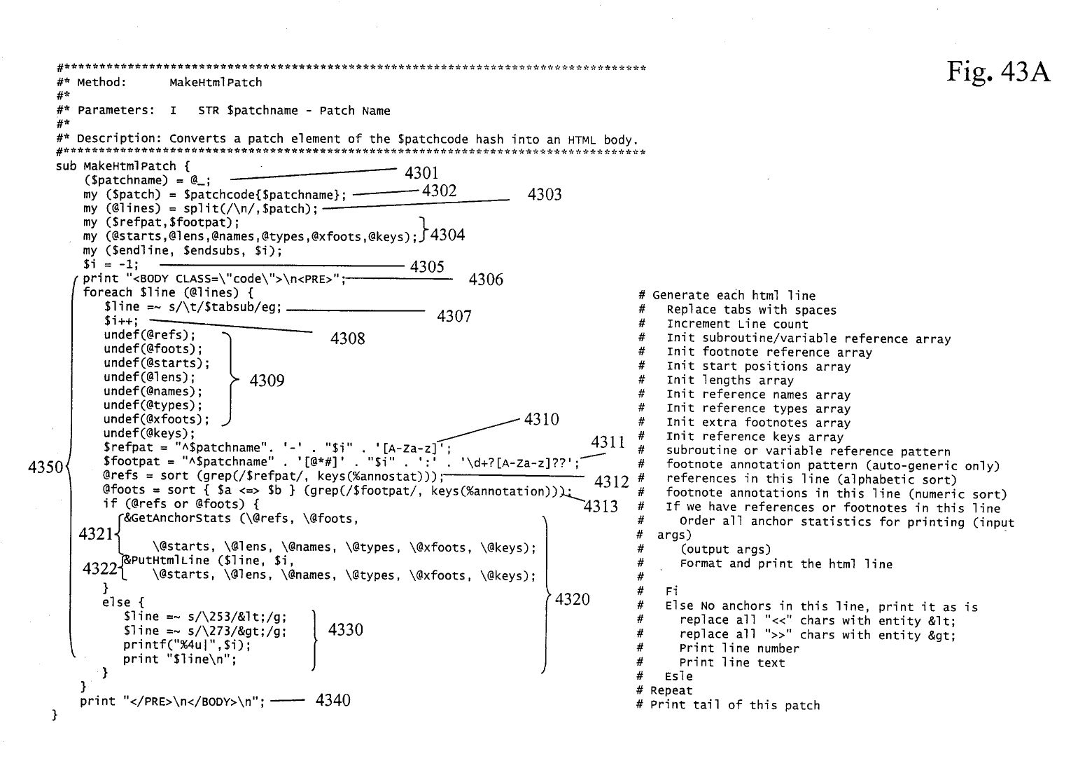

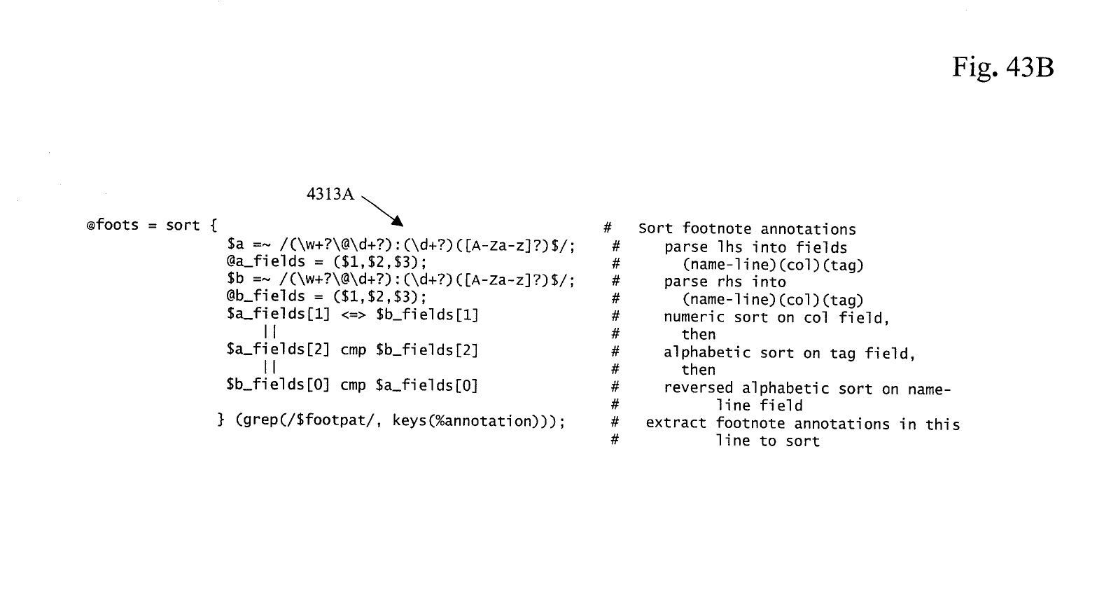

Following keyword PATCH in subroutine GenCodePatch, subroutine MakeHtmlPatch is called in statement 4203. One embodiment of subroutine MakeHtmlPatch is presented in FIG. 43A. In general, this subroutine converts a patch element in hash %patchcode into an HTML body.

A first statement 4301 of subroutine MakeHtmlPatch receives argument $patchname from its caller. Statement 4302 creates a lexically scoped, i.e., defined only between the enclosed braces of the current compound statement delimited by the containing left brace and right brace pair, variable $patch and assigns the text of this patch from hash %patchcode, which is indexed by key $patchname, as a scalar string.

Statement 4303 defines an lexically-scoped array @lines and fills array @lines with the line-text strings obtained by splitting scalar string $patch at each new line character, which is this embodiment is at each \n. Next, statements 4304 define further lexically scoped scalars and arrays that are used in the rest of the subroutine.

Statement 4305 initializes a line counter $i, which is incremented in a subsequent loop 4350. Statement 4306 prints an opening HTML tag BODY for a body that is fleshed out in loop 4350. In each cycle, loop 4350 assigns each successive line from array @lines to lexical variable $line.

Within loop 4350, statement 4307 removes tab characters from each line, replacing each tab character with a pre-specified string of blank characters contained in a global variable $tabsub. Statement 4308 increments line counter $i.

Next, statements 4309 initialize, e.g., reset to undefined, a set of arrays used to accumulate statistics for the annotation container tags to be inserted in each marked-up version of the display lines. In this embodiment, the annotation container tags are HTML anchors (<A>. . . </A>)for symbol-reference annotations, and HTML divisions (<DIV>. . . </DIV>) for footnote annotations,

Array @refs accumulates the symbol reference keys for each variable symbol or function symbol appearing in the line. Array @foots accumulates the footnote keys for each footnote-trigger symbol appearing in the line. The coded keys that accumulate in arrays @refs and @foot enable these arrays to be filled by regular-expression searching (e.g., grepping—see statements 4312 and 4313) through the global hash %annostat 215EE, containing symbol reference statistics, and hash %annotation 215FF, containing footnote information.

In this embodiment, the coded keys contain the patchname and line number, and other data denoting the order in which the annotation trigger symbols occur within the line. This other data includes sequence characters for symbol references, column-position and possibly redundancy letters for footnote references. The ordering of the annotations sequence for the line are bifurcated (unmerged) in arrays @refs and @foot, and must be interleaved by merging before the annotation tags can be generated. This is accomplished via statement 4321, as explained below.

The data in the remaining arrays that are initialized to undefined are ordered according to the merged annotations sequence for the line. Array @starts accumulates the start column positions of each annotated symbol, and array @lens accumulates the corresponding lengths of the symbols. Array @names accumulates the names of symbols that are used as key for symbol description in hash %annotation 215 FF and the keys for footnotes in hash %annotation 215 FF. Array @types contains type codes designating the no-longer bifurcated annotation types, i.e., symbol or footnote, etc. Array @xfoots contains extended footnote HTML entities (e.g., Greek letters) for footnote entries containing redundancy letters. Array @keys contains symbol reference keys into hash %annostat 215EE.

Statement 4310 creates a regular-expression pattern for grepping symbol references from hash %annostat 215EE. Statement 4311 creates a regular-expression pattern for grepping footnote references from hash %annotation 215FF.

Statement 4312 performs a grep operation on hash %annostat 215EE. The grep operation sorts the data alphabetically to order the data in the sequence in which the data occur in the line, i.e., according to the sequence character at the end of each key, as the prefixes of all of the resulting keys are a concatenation of the same patch name and same line number. Following the grep operation, which extracts a subset of the data, the data subset is sorted.

Statement 4313 performs a similar grep operation on hash %annotation 215FF. This grep operation sorts the results numerically in this case, as the distinguishing part of the keys is the column position and redundancy character (if any). In some situations, statement 4313 fails. Hence, FIG. 43B presents an alternative statement 4313 A that is substituted for statement 4313 in FIG. 43A. Statement 4313 A is more general than statement 4313.

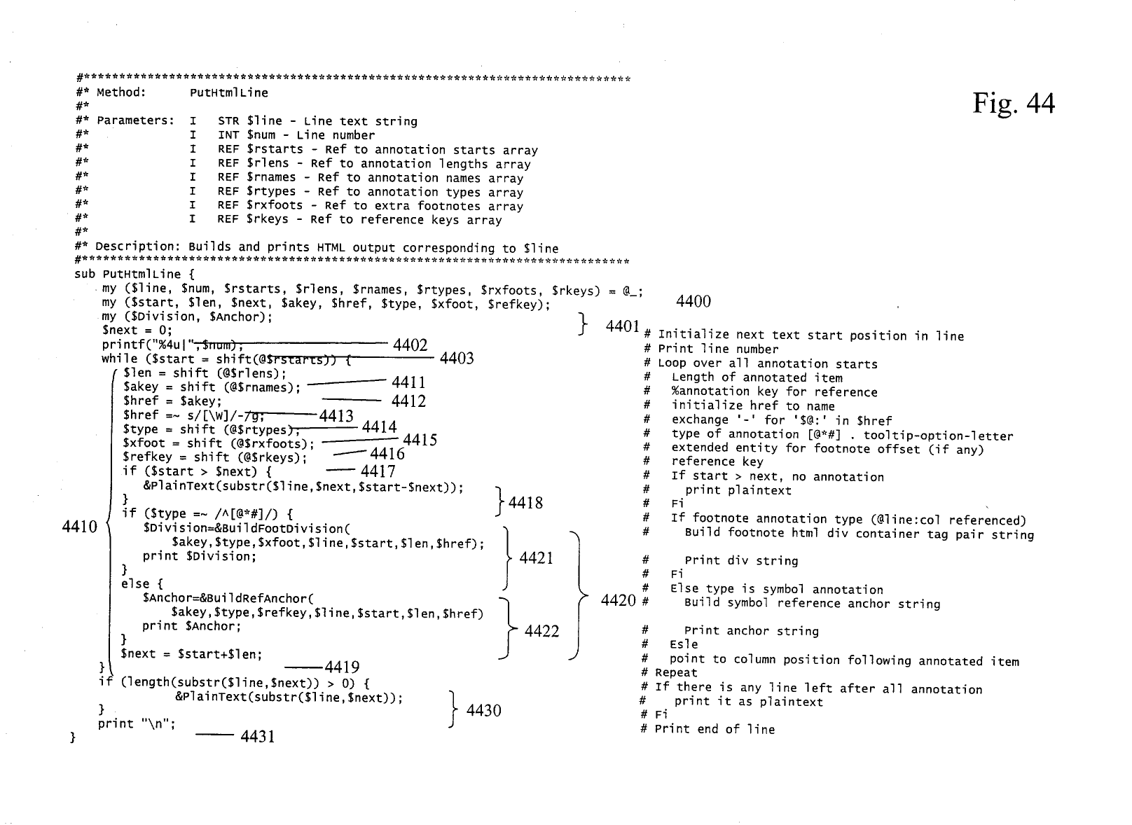

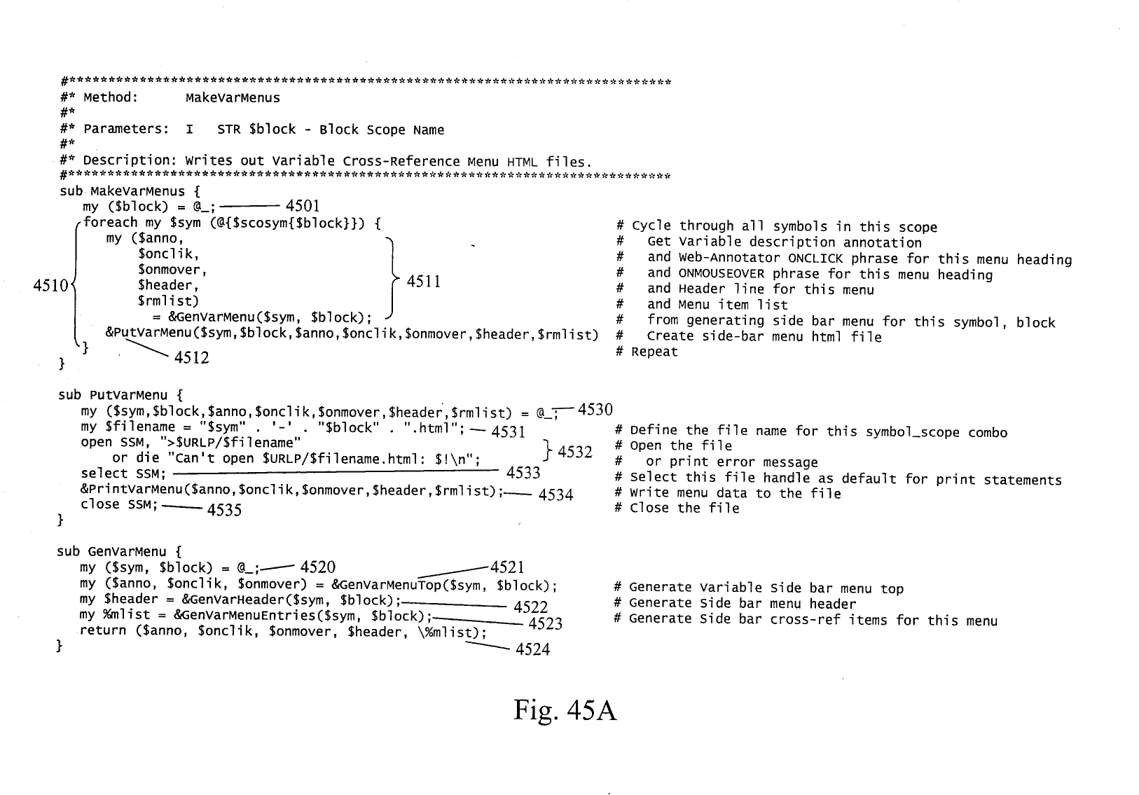

Compound if statement 4320 determines whether either array @ref or array @foots is defined, i.e., whether either array accumulated any data in the grepping operation. If either array @ref or array @foots is defined, statement 4321 calls a subroutine GetAnchorStats, passing the references to arrays @refs and @foots as input, and receiving references to the merged arrays @starts, @lens, @names, @types, @xfoots, and @keys as output. This orders all annotations in the sequence in which the annotations must be printed. Next, statement 4322 calls subroutine PutHtmlLine (FIG. 44) to format and print the HTML marked-up line.

In FIG. 44, statement 4400 receives the arguments in the call to subroutine PutHtmlLine. Statements 4401 declare lexically-scoped temporary variables used in subroutine PutHtmlLine. Statement 4402 initializes the running plaintext boundary within the line. Statement 4403 formats and prints the line number.

While loop 4410 cycles over each annotation container start position within the line, assigning variable $start to the shifted (removed) leftmost start position in the array referenced by input argument $rstarts. Statement 4411 likewise removes and assigns the leftmost annotation length to variable $len and statement 4412 likewise removes and assigns the leftmost key to hash %annotation 215FF to current key $akey. Statement 4413 assigns current key $akey to variable $href, and then statement 4414 substitutes a dash character for any n 6 n-word character in the current key.

Statement 4415 removes and assigns the leftmost annotation type code in array @types to variable $type. Statement 4416 removes and assigns the leftmost extended footnote entity in array @xfoots to variable $xfoot. Statement 4417 removes and assigns the leftmost reference key in array @keys to variable $refkey.

Next, if statement 4418 tests to see if the current start position is greater than the current left boundary of the plaintext. If so, the intervening plaintext is written to the output buffer by the call to subroutine PlainText.

Compound if statement 4420 checks the first character of variable $type to see if the current annotation is a footnote. If the current annotation is a footnote, statement block 4421 first calls subroutine BuildFootDivision.

Subroutine BuildFootDivision creates a string $Division, and then string $Division is printed. If the current annotation is not a footnote, statement block 4422 of compound if statement 4420 is executed to build a symbol reference anchor string $Anchor, which is immediately written to the output buffer.

The final statement in while loop 4410 is statement 4419 which advances the plaintext leftmost boundary variable $next to the first character in the line text following the symbol just annotated.

After exiting while loop 4410, all of the annotation markup text and intervening plaintext has been written to the output buffer. If statement 4430 checks to see if there is line text left over at the end of the line. If so, the remaining line text is written to the output buffer as blanks. Finally, statement 4431 writes an end-of-line character to the output buffer, completing the HTML version of the original line text and processing returns to subroutine MakeHtmlPatch (FIG. 44) to process the next line in the current patch.

The above description assumed that there were annotations in the current line and so statements 4321 and 4322 (FIG. 43A) were executed. If there were no annotations in the current line, compound if statement 4320 (FIG. 43A) returns false, and statement block 4330 is executed, which prints the line as is.

Finally, after all lines in current patch $patch are printed, statement 4340 prints the string completing the patch body, and returns to the calling subroutine GenCodePatch (FIG. 42). In subroutine GenCodePatch immediately thereafter, statement 4204 prints tag </html>terminating the patch content.

Statement 4205 exits subroutine GenCodePatch if argument $caller is ‘WA’ signifying that web annotator 270 called subroutine GenCodePatch. If argument $caller is not ‘WA’, foreach loop 4210 is executed, cycling through each scope in the patch.

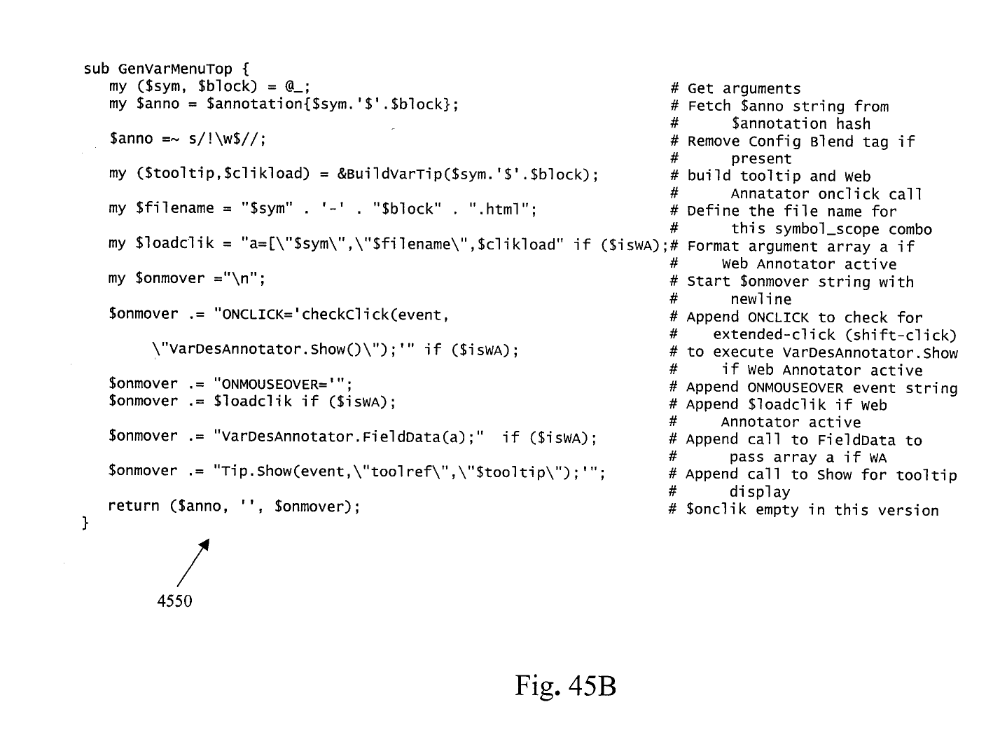

In each cycle of foreach loop 4210, each successive scope in patch $pat is assigned by default to variable $_, which, in turn, is used as an argument of a call to subroutine MakeVarMenus (FIG. 45A).

The argument in the call to subroutine MakeVarMenus (FIG. 45A) is received by statement 4501 into lexical variable $block. Foreach loop 4510 cycles over all symbols contained in the scope block defined by lexical variable $block.

Statement 4511 generates a variable menu for this symbol by calling subroutine GenVarMenu (FIG. 45A). A first statement 4520 of subroutine GenVarMenu receives the symbol and scope arguments from the call in statement 4511. Statement 4521 calls subroutine GenVarMenuTop 4550 (FIG. 45B) that in turn returns annotation text $anno, onclick phrase $onclik, and onMouseOver phrase $onmover.

Subroutine GenVarMenuTop 4550 takes the symbol name and scope as input arguments. Subroutine GenVarMenuTop 4550 combines these two arguments into a key name$scope. Key name$scope is used to retrieve string $anno from hash %annotation. Subroutine GenVarMenuTop 4550 next builds event strings $onclik and $onmover. In this embodiment, string $onclik is empty, but string $onmover begins with ONMOUSEOVER=. . . String $onmover contains a call to function Tip.Show(event, <tooltip style>, <tooltip message>. In the case where web annotator 270 is active, further text is prepended to string $onmover and to the substring that calls function Tip.Show.

Next, statement 4522 creates the header line for the sidebar menus by calling subroutine GenVarHeader. Finally, hash %mlist, containing all of the cross-reference menu entries, is created by calling subroutine GenVarMenuEntries. Return statement 4524 then outputs the formatted strings and menu-entries hash back to the corresponding assign output variable in statement 4511.

Statement 4512 calls subroutine PutVarMenu, which is a wrapper subroutine for subroutine PrintVarMenu. Subroutine PrintVarMenu does the final formatting and printing of the HTML menus, given the constituent items as arguments.

In subroutine PutVarMenu, statement 4530 receives all of the constituent items, and statement 4531 formats a file name in which the persistent copy of the menu is stored. Statement 4532 opens the file. Next, statement 4533 sets a default file handle corresponding to the file just opened. Statement 4534 writes the menu to this file and statement 4535 closes the file.

The subroutines in FIG. 45A are configured in such a way that the subroutines may be also called in slightly different sequences by server-side programs of web annotator 270.

Web Annotator

Follow-up work by application programmers and user-peer technicians fleshes out the documentation of contained application 105B in the generated website, i.e., in rapid comprehension source code documentation 240B (FIG. 2B). This is achieved via direct editing of webpages that make up documentation 240B in a special restricted-access web annotator version of the website.

In particular, when hypertext page generator 230 creates the pages for this special website, the instructions to respond to an extended-click event, described more completely below, are included in the webpages. Also, the first webpage includes the annotator entry-edit form functions that are called in response to an extended-click event.

In one embodiment, to modify the annotations for content of a displayed webpage in one of frames 1402 to 1404, the user selects the element for which the user wishes to modify the annotation. For example, the user positions the cursor over an element in the display and issues an extended click event. Elements in the display include text, a variable symbol, a function symbol, a footnote annotation trigger symbol, an ancillary trigger symbol including single letters within a name, a line-number, or a blank line before or after lines of text, for example.

In one embodiment, an extended click event is generated via a right-button mouse-click, or a mouse-click while simultaneously pressing a specific keyboard key such as the control key. The combination of placing the cursor over an element and issuing an extended click selects the content for which the user wants to modify, or at least view, the annotations in an annotator popup entry-edit form.

Specifically, the extended click event calls an annotator entry-edit form function, which in one embodiment is a JavaScript function. The annotator entry-edit form function copies the annotations associated with the selected element into windows of an annotator entry-edit form 4601, which is presented in a popup window and so is called an annotator popup entry-edit form. Herein, in this embodiment, each annotator popup entry-edit form described is presented in a popup window.

Annotator popup entry-edit form 4601, in this embodiment, is associated with a function symbol smatrix. As explained more completely below, each element that is associated with an annotator popup entry-edit form includes an annotator entry-edit form function that upon occurrence of an extend click event generates an annotator popup entry-edit form that is appropriate for the particular element.

The annotator form-presentation function enables selected fields in form 4601 to be modified by the user. As explained more completely below, entry-edit form 4601 enables addition or editing of annotation text pertaining to the selected element in these selected fields, and, in one embodiment, enables the user to specify a display configuration blend of the annotation text for the selected element.

Annotator popup entry-edit form 4601 includes three regions: a code translation region 4610, a modify annotations region 4620, and a display configuration blend region 4630 in this embodiment. With the exceptions noted below, any information displayed in code translation region 4610 is read-only and so cannot be modified by a user.

Any information displayed in modify annotations region 4620 can be deleted, modified, or if none is displayed, entered. Hence modify annotations region 4620 is a read/write region. Finally, display configuration blend region 4630 provides a user with a plurality of options 4631 to 4635 for configuring how the content in form 4601 is presented in rapid comprehension source code documentation 240B.

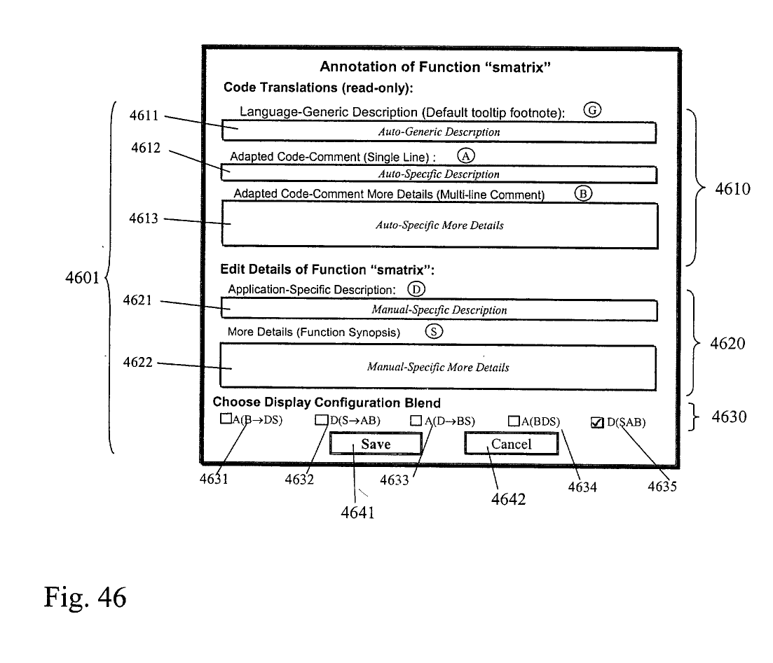

As explained more completely below, the windows displayed and the information displayed in the windows of annotator popup entry-edit form 4601, sometimes called entry-edit form 4601 depend on an annotation display context and the content classes associated with the particular type of element annotations being processed. In the example of FIG. 46, entry-edit form 4601 is for the annotations associated with an element that is a function symbol in the webpage displayed in frame 1403.

In general, each window in an annotator popup entry-edit form is associated with a specific content class. In this embodiment, TABLE 6 defines the content classes.

TABLE 6
Definition of Content Classes According to One
Embodiment of the Invention

| Content | | |
|---|---|---|
| Class | Content | |
| Identifier | Class Name | Content Class Description |
| G | Auto-Generic | Information derived from |
| | Description | auto-generic code-to |
| | | prose/pseudocode translation |
| A | Auto- | Single line comment derived |
| | Specific | from auto-specific comment |
| | Description | translation |
| B | Auto- | Multiple line comment |
| | Specific | derived from auto-specific |
| | Description | comment translation |
| | More Details | |
| D | Manual- | Single line description |
| | Specific | manually entered via web |
| | Description | annotator 270 |
| S | Manual- | Multiple line description |
| | Specific | manually entered via web |
| | More Details | annotator 270 |
| F | Manual- | Summary footnote description |
| | Specific | manually entered via web |
| | Footnote | annotator 270 |
| M | Manual- | Detailed footnote |
| | Specific | description manually entered |
| | Footnote | via web annotator 270 |
| | More Details | |

The content class identifiers are used in the figures to designate the content of a particular window in entry-edit form 4601 and to characterize the display configuration blend options. Each configuration blend options specifics content configuration of at least one context.

Code translation region 4610 displays any auto-generic description content in generic language description window 4611 and any auto-specific description content in adapted code-comment (Single line) window 4612 and adapted code-comment more details (Multi-line Comment) window 4613. The content displayed in windows 4611 to 4613 is read-only.

Modify annotations region 4620, in this example, includes an application-specific description window 4621 and a more details window 4622. If there are any application-specific annotations stored in metatree 610 (FIG. 6A), these annotations are displayed in windows 4621 and 4622. The user can edit any existing application-specific annotations, or alternatively can enter application-specific annotations.

The specific combination of content classes in each of plurality of options 4631 to 4635 in display configuration blend region 4630 depends on the annotation display contexts associated with the element selected for annotation editing as well as the usefulness of the auto-generic descriptions. The display configuration blend options described herein are illustrative only and are not intended to limit the invention to the specific options described herein. In view of this disclosure, those of skill in the art can provide display configuration blend options that are appropriate for the information in the original source document of interest.

If after entering or modifying the manual-specific content, and selecting a display configuration blend option, the user presses a form-submission button in form 4601 (e.g., save button 4641 in this embodiment) the contents of windows 4621 and 4622 are sent to a server-side CGI-agent program, which is one example of a server-side annotation agent update function. The server-side CGI-agent program corresponds to the annotator form-presentation function executing on the client device.

Execution of the CGI-agent program first formats the annotation content and stores the formatted data in the appropriate metatree files for the patch being displayed. Next, the CGI-Agent program calls functions to regenerate the displayed webpage or webpages, e.g., the HTML file or files currently displayed in the frames in which the element selected was displayed. The regenerated webpages are sent to the client device for display and are stored in the website for rapid comprehension source code documentation 240B. The CGI-agent program also updates any other files in the metatree that are affected by the change in the annotation content, and generates new webpages as required.

Hence, in this embodiment, web annotator 270 provides means to add and edit the manual-specific information and to change the display configuration blend. The manual annotation changes and configuration blends wrought by web annotator 270 become a permanent part of the metatree for the module.

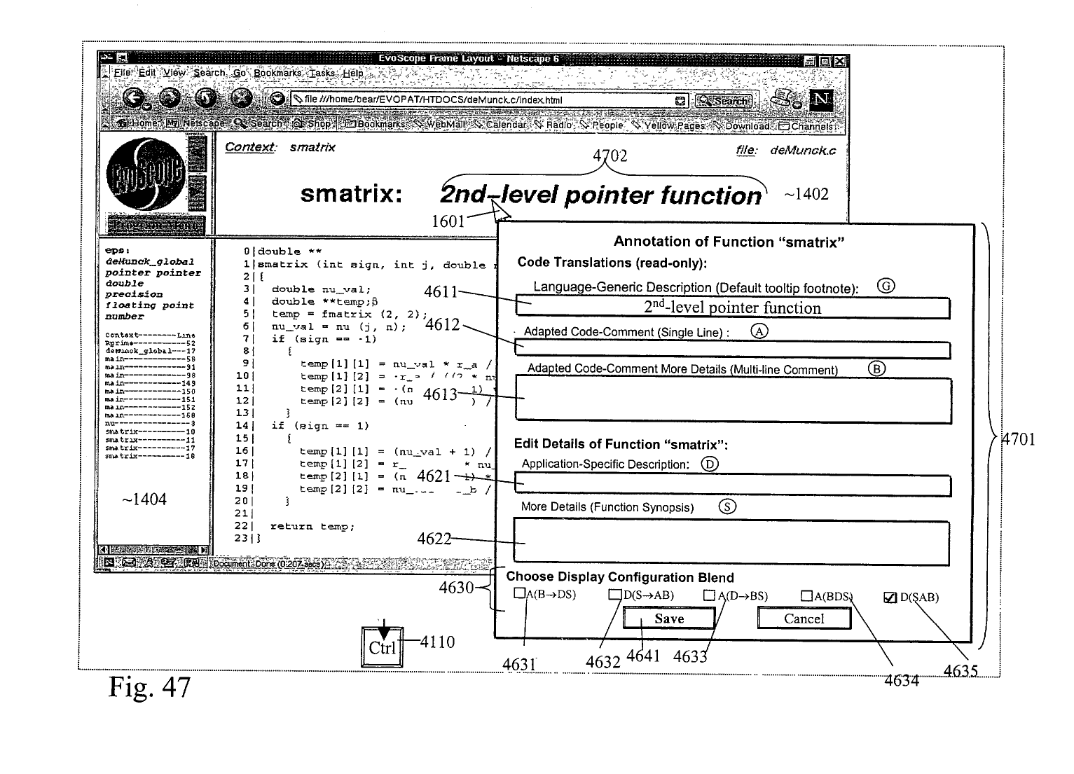

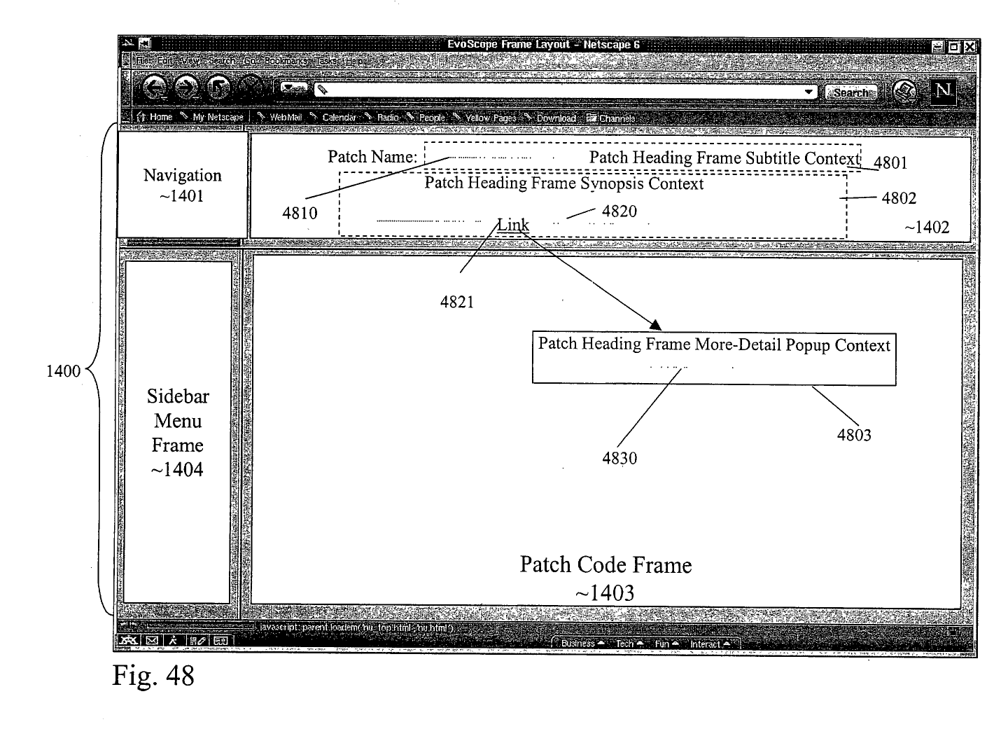

FIG. 47 illustrates one embodiment of an annotator popup patch heading frame entry-edit form 4701 that is displayed upon the user placing cursor 1601 on subtitle 4702 and clicking a mouse key while depressing control key 4110, e.g., the user generates an extended click event. This illustrates the user requesting the ability to edit the contents for a plurality of contexts associated with patch heading frame 1402. In this embodiment, three contexts 4801, 4802 and 4803 (FIG. 48) are associated with patch heading frame 1402:

1. Patch Heading Frame Subtitle Context 4801;

2. Patch Heading Frame Synopsis Context 4802; and

3. Patch Heading More-Detail Popup Context 4803.

Initial content 4810 for patch head frame subtitle context 4801 is generated by the auto-generic annotation process described above. This content also is displayed, by default, as a tooltip annotation, in response to an onMouseOver event associated with the patch name in patch code frame 1403.

Content 4810 that is associated with the patch heading frame subtitle context 4801 and content 4820 that is associated with patch heading frame synopsis context 4802 are displayed in frame 1402. Content 4830 that is associated with patch heading frame more-detail popup context 4803 is displayed upon selection of a link 4821 within content 4820 of patch heading frame synopsis context 4802.

Returning to FIG. 47, language generic description window 4611 contains the auto-generically generated annotation “2nd-level pointer function.” Adapted code-comment window 4612 and adapted code-comment more details window 4613 are empty because function smatrix, in this example, did not include any comments describing the function. As indicated above, the user can only view the contents of generic language description window 4611, adapted code-comment window 4612, and adapted code-comment more details window 4613.

In this example, the user also views the empty contents of application-specific description window 4621 and more details window 4622. However, the user can enter a single line description of function smatrix in window 4621 and a multiple line description in window 4622.

With form 4701, the user can choose the display configuration blend only for contexts 4801 to 4803. Each display configuration blend option specifies the content for one or more of contexts 4801 to 4803. In the example of FIG. 47, the display configuration blend options in plurality of options 4631 to 4635 in display configuration blend region 4630 are defined in TABLE 7.

TABLE 7

| | Contexts 4801, 4802 and 4803 |
|---|---|
| 1 | i(j) |
| 2 | i(j − >k) |

In TABLE 7, an underscore in combination with -> represents a link. In Table 7, content i is content 4810 of patch heading frame subtitle context 4810. Content j is content 4820 of patch heading frame synopsis context 4803. Content k is content 4830 of patch heading frame more-detail popup context 4803. In TABLE 7, and similar tables below, while content is shown as a link, it is not required that all of the content be marked as a link. As described above, either all of the content or a portion of the content, or appended text may be marked as a link.

In FIG. 47, the particular content associated with each of options 4631 to 4635 is identified by a content class identifier from TABLE 6. In addition, the content class identifier is displayed in form 4701 next to the window that contains the content so the user can easily visualize the content associated with each display configuration blend option.

If the user does not select one of options 4631 to 4635, the content of language generic description window 4611 remains as content 4810 of patch heading frame subtitle context 4801. Any content in windows adapted code-comment window 4612, adapted code-comment more details window 4613, application-specific description window 4621, or more details window 4622 is not displayed. However, in this embodiment, if the user entered or modified content, the content is saved in the metatree.

Herein, in the text, the content class identifiers are enclosed in parentheses to assist in identifying them. In the drawings, the content class identifiers are enclosed in a circle when next to a window, and are capital letters in the display configuration blend options.

If option 4631 (FIG. 47) is chosen, auto-specific description content (A) in adapted code-comment window 4612 becomes content 4810 in patch heading frame subtitle context 4801. Auto-specific description more details content (B) in adapted code-comment more details window 4613 becomes content 4820 in patch heading frame synopsis context 4802. Content 4820 or a part of content 4820 is marked as a link 4821 to a popup containing a concatenation of manual-specific description content (D) in application-specific description window 4621 and manual-specific more details content (S) in more details window 4622 as content 4830 of patch heading frame more-detail context 4803.

If option 4632 is chosen, manual-specific description content (D) in application-specific description window 4621 becomes content 4810 in patch heading frame subtitle context 4801. Manual-specific more details content (S) in more details window 4622 becomes content 4820 in patch heading frame synopsis context 4802. Content 4820 or a part of content 4820 is marked as link 4821 to a popup containing a concatenation of auto-specific description content (A) in adapted code-comment window 4612 and auto-specific description more details content (S) in adapted code-comment more details window 4613 as content 4830 of patch heading frame more-detail context 4803.

The interpretation of option 4633 is similar to that of options 4631 and 4632. However, option 4633 uses different information for the subtitle, synopsis, and popup content.

If option 4634 is chosen, auto-specific description content (A) in adapted code-comment window 4612 becomes content 4810 in patch heading frame subtitle context 4801. Content 4820 of patch heading frame synopsis context 4802 is a concatenation of auto-specific more details content (B) in adapted code-comment more details window 4613, manual-specific description content (D) in application specific description window 4621 and manual-specific more details content (S) in more details window 4622.

If option 4635 is chosen, manual-specific description content (D) in application-specific description window 4621 becomes content 4810 in patch heading frame subtitle context 4801. Content 4820 of patch heading frame synopsis context 4802 is a concatenation of manual-specific more details content (S) in more details window 4622, auto-specific description content (A) in adapted code-comment window 4612 and auto-specific description more details content (B) in adapted code-comment more details window 4613. Web annotator 270, in one embodiment, provides a separate style (e.g., font, text-color, etc.) for each of the content classes (selected by administration options), so the way the contents are blended can be-revealed to the user, if required.

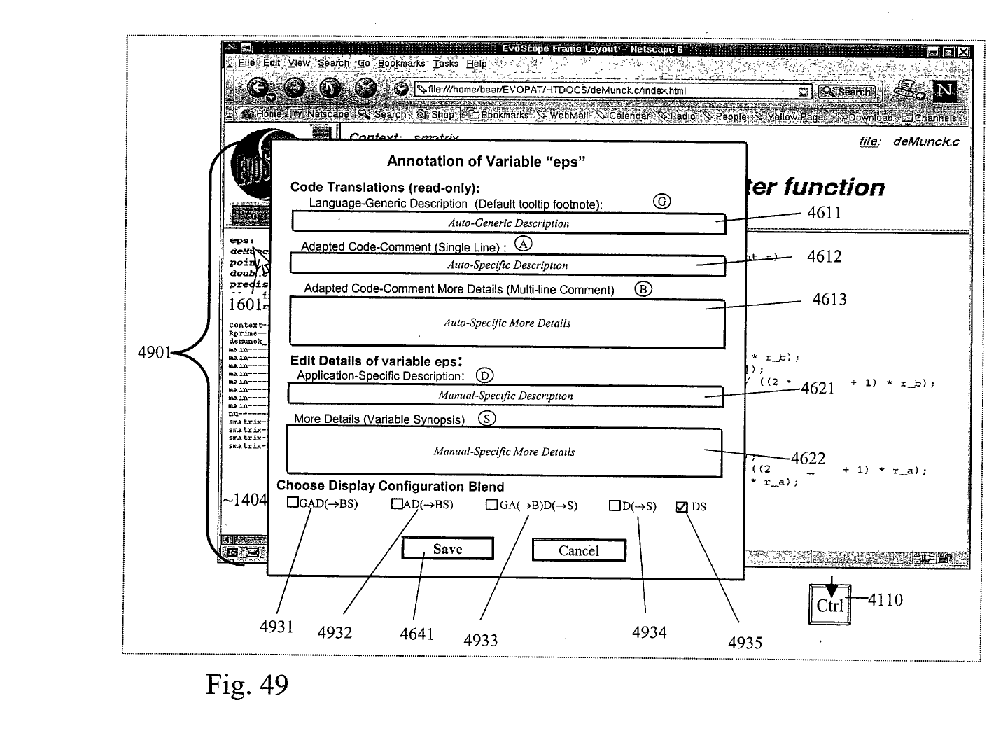

FIG. 49 illustrates an annotator popup sidebar menu frame entry-edit form 4901 that is displayed upon the user placing cursor 1601 on the description of variable eps in sidebar menu frame 1404 and clicking a mouse key while depressing control key 4110, e.g., the user generates an extended click event. As indicated above, use of a variable is one example of a name symbol that can appear in sidebar menu frame 1404.

Those of skill in the art will appreciate that a different function is called to generate form 4901 on the client device and a different function is used on the server to process the new data from form 4901 on the client device. Typically, each type of name symbol has its own set of functions. Accordingly, the examples given herein for variables and functions are illustrative only of handling name symbols and are not intended to limit the invention to the specific name symbols considered. In view of this disclosure, those of skill in the art can implement the features described for other name symbols.

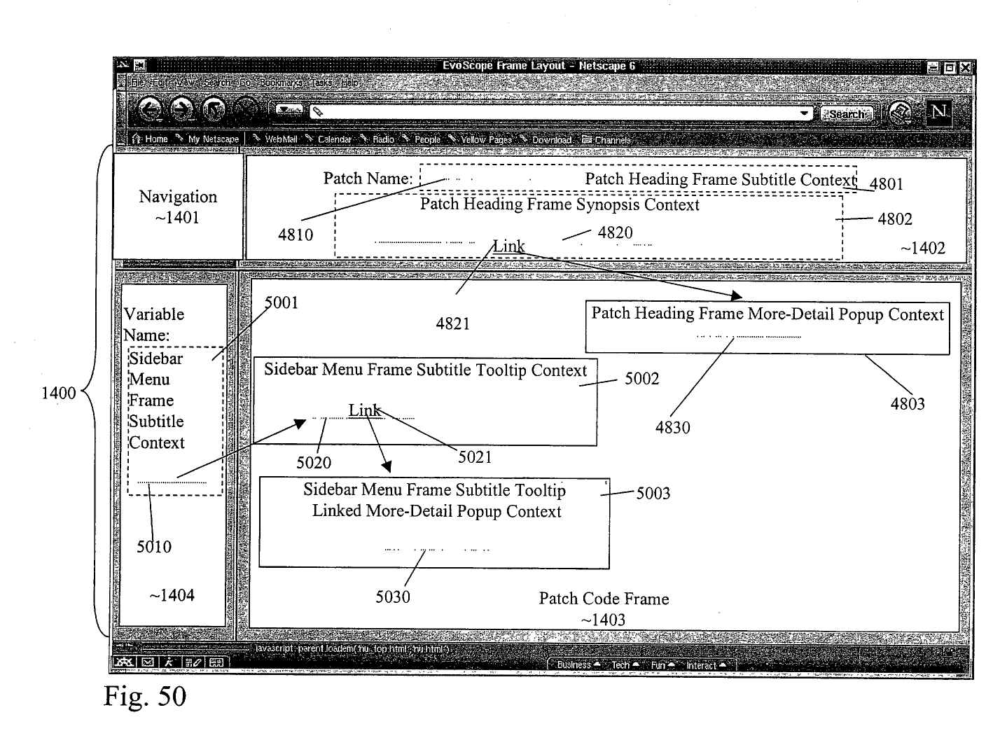

FIG. 49 illustrates the user requesting the ability to edit the contents for a plurality of contexts associated with sidebar menu frame 1404. In this embodiment, three contexts 5001, 5002 and 5003 (FIG. 50) are associated with sidebar menu frame 1404:

4. Sidebar Menu Frame Subtitle Context 5001;

5. Sidebar Menu Frame Subtitle Tooltip Context 5002; and

6. Sidebar Menu Frame Subtitle Tooltip Linked More-Detail Popup Context 5003.

Herein, the various contexts are numbered sequentially to demonstrate the total number of contexts considered in one embodiment of the invention.

Initial content 5010 for patch head frame subtitle context 5001 is generated by the auto-generic annotation process described above. This content is also displayed, by default, as a tooltip annotation, in response to an onMouseOver event associated with the variable symbol in patch code frame 1403.

Content 5010 is a synopsis for variable symbol eps displayed in sidebar menu frame 1404 and is displayed automatically in sidebar menu frame 1404 upon the user clicking on variable symbol eps in patch code frame 1403. Content 5020 that is associated with sidebar menu frame subtitle tooltip context 5002 is displayed upon occurrence of an onMouseOver event associated with content 5010 of sidebar menu frame subtitle context 5001. Content 5030 that is associated with sidebar menu frame subtitle tooltip linked more-detail popup context 5003 is displayed upon selection of a link 5021 within content 5020 of sidebar menu frame subtitle tooltip context 5002.

Returning to FIG. 49, language generic description window 4611 contains the auto-generically generated annotation. However, for convenience, rather than illustrating the actual content, windows 4611 to 4613 and 4621 to 4622 contain a description of the content normally found in the windows.

Again, the contents of windows 4611 to 4613 (FIG. 49) are read-only, since their content was automatically generated by parser-hasher 214B. The user may add or edit text in the two lower windows 4621 and 4622, providing application-specific information. The user may also choose the display configuration blend, by checking one or none of options 4931 to 4935.

With form 4901, the user can choose the display configuration blend only for contexts 5001 to 5003. Each display configuration blend option specifies the contents for one or more of contexts 5001 to 5003. In the example of FIG. 49, the display configuration blend options in plurality of options 4931 to 4935 are defined in TABLE 8.

TABLE 8

| | Contexts 5002 & 5003 |
|---|---|
| 1 | i |
| 2 | i(->j) |
| 3 | i(->j)k(->1) |

In TABLE 8, an underscore in combination with -> represents a link.

Content i is content 5020 of sidebar menu frame tooltip context 5002. Content j is content 5030 in a first linked popup having sidebar menu frame subtitle tooltip linked more-detail popup context 5003. Content k is additional content in content 5020 of sidebar menu frame tooltip context 5002. Content 1 is content 5030 of a second linked popup having menu frame subtitle tooltip linked more-detail popup context 5003. In FIG. 50, only a single link 5021 is illustrated in context 5002. However, link 5021, in a first embodiment, represents a single link, and in a second embodiment represents a plurality of links.

The content for each of contexts 5001, 5002, and 5003 can be defined based upon user preferences, the quality of the auto-generic and/or auto-specific annotations, the particular type of source information, or any desired combination of these or other criteria. Alternatively, the plurality of display configuration blend options in annotator popup sidebar menu frame entry-edit form 4901 could include one or more options that permitted defining custom content for context 5001 including links to popup annotations, as well as contexts 5002 and 5003.

In the embodiment of FIG. 49, the particular content associated with each of options 4931 to 4935 is identified by a content class identifier from TABLE 6. In addition, the content class identifier is displayed in form 4901 next to the window that contains the content so the user can easily visualize the content associated with each display configuration blend option.

In this embodiment, if the user does not select one of options 4931 to 4935, generic language description (G) of generic language description window 4611 is selected as content 5010 for context 5001. Any content in adapted code-comment window 4612, adapted code-comment more details window 4613, application-specific description window 4621, or more details window 4622 is not displayed in any of the tooltips.

Herein, in the text, the content class identifiers are enclosed in parentheses to assist in identifying them. In the drawings, the content class identifiers are enclosed in a circle when next to a window, and are capital letters in the display configuration blend options.

In this embodiment, for each of options 4931 to 4935, generic language description (G) is selected as content 5010 for context 5001. If option 4931 is chosen, a concatenation of generic language description (G), auto-specific description content (A) in adapted code-comment window 4612 (FIG. 49), and manual-specific description content (D) in application-specific description window 4621 (FIG. 49) becomes content 5020 in sidebar menu subtitle tooltip context 5002. Content 5020, a part of content 5020, or appended text is marked as a link 5021 to a popup window having sidebar menu frame subtitle tooltip linked more-detail popup context 5003 with a concatenation of auto-specific description more details content (B) in adapted code-comment more details window 4613 (FIG. 49) and manual-specific more details content (S) in more details window 4622 (FIG. 49) as content 5030.

If option 4932 is chosen, a concatenation of auto-specific description content (A) and manual-specific description content (D) becomes content 5020 in sidebar menu subtitle tooltip context 5002. Content 5020, a part of content 5020, or appended text is marked as a link 5021 to a popup window having sidebar menu frame subtitle tooltip linked more-detail popup context 5003 with a concatenation of auto-specific description more details content (B) and manual-specific more details content (S) as content 5030.

If option 4933 is chosen, a concatenation of generic language description (G) and auto-specific description content (A) in adapted code-comment window 4612 (FIG. 49) becomes a first portion of content 5020 in sidebar menu subtitle tooltip context 5002. This first portion of content 5020, a part this first portion of content 5020, or appended text is marked as a first link 5021 to a first popup having a first sidebar menu frame subtitle tooltip linked more-detail popup context 5003 with auto-specific description more details content (B) in adapted code-comment more details window 4613 (FIG. 49) as content 5030.

Also, in option 4933, manual-specific description content (D) in application-specific description window 4621 (FIG. 49) becomes a second portion of content 5020 in sidebar menu subtitle tooltip context 5002. This second portion of content 5020, a part of this second portion of content 5020, or appended text is marked as a second link 5021 to a second popup having a second sidebar menu frame subtitle tooltip linked more-detail popup context 5003 with manual-specific more details content (S) in more details window 4622 (FIG. 49) as content 5030.

If option 4934 is chosen, manual-specific description content (D) (FIG. 49) becomes content 5020 in sidebar menu subtitle tooltip context 5002. Content 5020, a part of content 5020, or appended text is marked as a link 5021 to a popup having sidebar menu frame subtitle tooltip linked more-detail popup context 5003 with manual-specific more details content (S) as content 5030.

If option 4935 is chosen, a concatenation of manual-specific description content (D) and manual-specific more details content (S) becomes content 5020 in sidebar menu subtitle tooltip context 5002.

After clicking on button Save 4641, the content in form 4901 along with the chosen display configuration blend is transmitted to a corresponding server-side CGI-agent program associated with form 4901. This CGI-agent program updates the metatree files, and the display frames are immediately refreshed. The CGI-agent program also updates all metatrees and patch files and corresponding HTML files, for patches, which contain references to the variable for which form 4901 was generated.

In this embodiment, the resulting information entered via form 4901 may be accessed in either of two methods, depending on whether mouse cursor 1601 is in sidebar menu frame 1404 or in patch code frame 1403. In the former case, the auto-generic description is displayed as before as content 5010 in context 5001, and the application-specific description appears in a tooltip whenever mouse cursor 1601 covers the symbol name or the auto-generic description in sidebar menu frame 1404. As indicated above this tooltip may contain one or more hyperlinks, which when clicked, display popup windows displaying the synoptic information in the various configuration blends.

In the latter case (patch code frame), the same tooltip associated with context 5002 is displayed whenever the symbol reference (variable name) is covered by mouse cursor 1601 in patch code frame 1403. The auto-generic information no longer appears in the tooltip displayed in patch code frame 1403, but only appears in the heading of sidebar menu frame 1404.

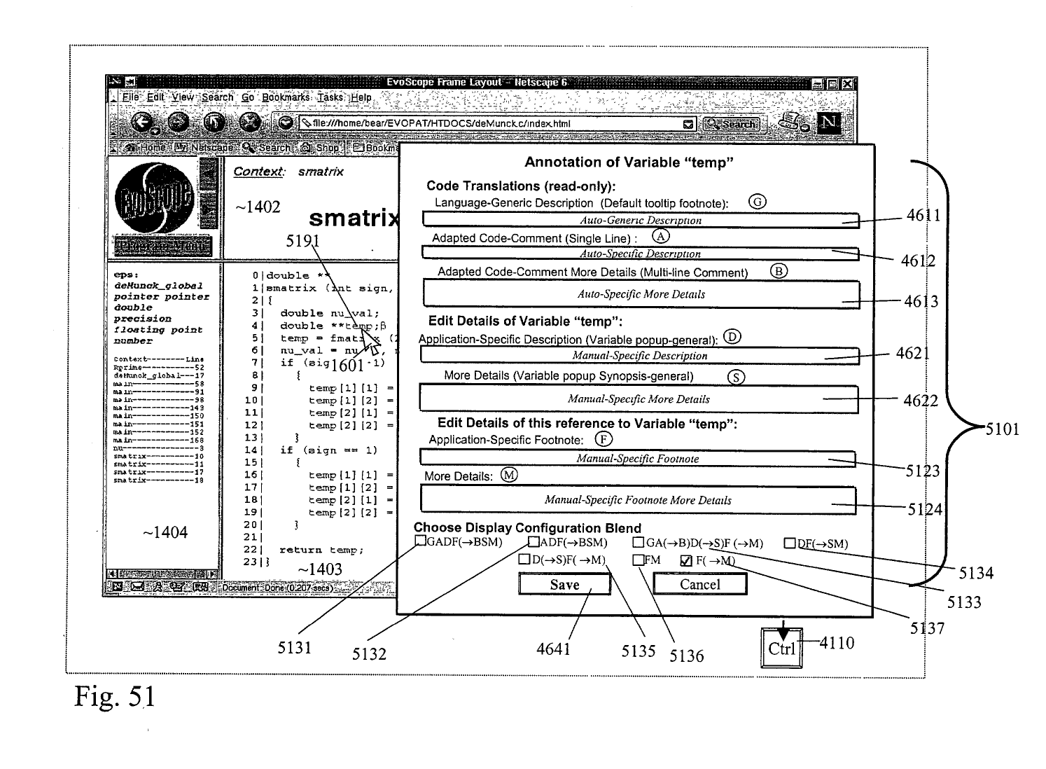

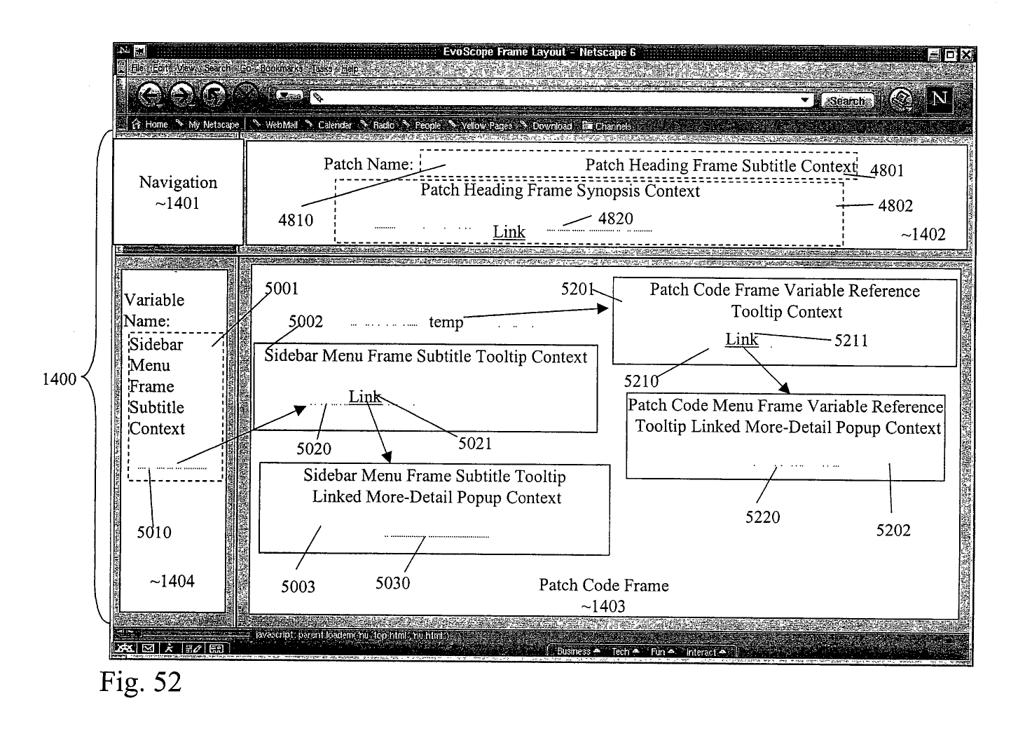

FIG. 51 illustrates an annotator popup patch code frame variable reference entry-edit form 5101 that is displayed upon the user placing cursor 1601 on variable symbol temp 5191 in patch code frame 1403 and clicking a mouse key while depressing control key 4110, e.g., the user generates an extended click event. Those of skill in the art will appreciate that a different function is called to generate form 5101 on the client device and a different function is used on the server to process the new data from the client device than in the previous examples.

The consideration of web annotator functionality for variables and functions in patch code frame 1403 is illustrative only of the functionality of name symbols, and is not intended to limit the invention to the specific name symbols considered. In view of this disclosure, those of skill in the art can implement the features described for other name symbols in patch code frame 1403.

FIG. 51 illustrates the user requesting the ability to edit the contents for a plurality of contexts associated with a variable in patch code frame 1403. In this embodiment, two contexts 5201 and 5202, i.e.,

7. Patch Code Frame Variable Reference Tooltip Context 5201; and

8. Patch Code Frame Variable Reference Tooltip Linked More-Detail Popup Context 5202.

(FIG. 52) are associated with a variable symbol in patch code frame 1403, and consequently form 5101.

However, as indicated above, if a user generates an onClick event for a variable symbol in patch code frame 1403, information about that variable is presented in sidebar menu frame 1404. Consequently, to maintain consistency in the annotations for a particular variable symbol, form 5101 is also associated with contexts 5001, 5002 and 5003 that were discussed above. Hence, form 5101 is associated with a total of five different contexts.

Returning to FIG. 51, form 5101 includes windows 4611 to 4613, and windows 4621 and 4622. The content associated with each of these windows and the functionality of each of these windows is the same as described above for form 4901 (FIG. 49).

However, form 5101 includes two additional windows, an application-specific footnote window 5123 and a second more details window 5124. The user may add or edit text in windows 5123 and 5124, i.e., the content of windows 5123 and 5124 is read/write. In this embodiment, text is entered in windows 5123 and 5124 to provide annotations concerning the specific reference to the variable symbol in the patch displayed in patch code frame 1403. Any text in windows 5123 and 5124 is limited to supplying annotations for the specific variable reference and is not applied to a reference to the variable symbol in other locations of the patch or in other patches. This allows a user to provide specific annotations for each reference to (instance of use of) a variable.

In form 5101, the user may also choose the display configuration blend, by checking one or none of options 5131 to 5137. In the example of FIG. 51, an option in plurality of options 5131 to 5135 affects both contexts 5002 and 5003 and contexts 5201 and 5202. However, the information in windows 5123 and 5124 is not applicable to contexts 5002 and 5003. Consequently, a display configuration blend option is applied differently depending upon the applicable contexts.

Hence, selection of a particular display configuration blend option in form 5101, in general, is defined in TABLE 9.

TABLE 9

| Contexts 5002 & 5003 | Contexts 5201 & 5202 |
|---|---|
| I | I |
| I(->j) | I(->J) |
| I(->j)k(->1) | I(->J)K(->L) |
| I(->j)k(->1) | I(->J)K(->L)M(->N) |

In TABLE 9, an underscore in combination with -> represents a link.

Content I is content 5020 of sidebar menu frame tooltip context 5002, and content 5210 of patch code frame variable reference tooltip context 5201. Content j is content 5030 in a first linked popup having sidebar menu frame subtitle tooltip linked more-detail popup context 5003. Content J is content 5220 in a first linked popup having patch code frame variable reference tooltip linked more-detail popup context 5202. Content k is additional content in content 5020 of sidebar menu frame tooltip context 5002. Content K is additional content in patch code frame variable reference tooltip context 5201. Content 1 is content 5030 of a second linked popup having menu frame subtitle tooltip linked more-detail popup context 5003. Content L is content 5220 of a second linked popup having patch code frame variable reference tooltip linked more-detail popup context 5202. Content M is additional content in patch code frame variable reference tooltip context 5201. Content N is content 5220 of a third linked popup having patch code frame variable reference tooltip linked more-detail popup context 5202.

Herein, in this embodiment of TABLE 9, content defined by a lowercase letter may be either identical to or a subset of the content defined by an uppercase letter. Contents for contexts 5201 and 5202 in patch code frame 1403 can include manual-specific footnote data and manual-specific footnote more details data that is specific to the reference to (use of) the variable in patch code frame 1403. This data is appropriate only for the specific occurrence of the variable in patch code frame 1403 and so is not used for the contexts 5002 and 5003 associated with sidebar menu frame 1404. Consequently, if the content associated with an uppercase letter in TABLE 9 includes either manual-specific footnote data or manual-specific footnote more details data, the data is not included in the content for the corresponding lowercase letter. In this case, the content associated with the lowercase letter is a subset of the content associated with the uppercase letter. The subset can be an empty set for some display configuration blends.

In FIG. 52, only a single link is illustrated in context 5002 and in context 5201 for clarity. Those of skill in the art will appreciate, as just described that each of these contexts can contain multiple links where each of the links is associated with different content in contexts 5003 and 5202, respectively.

The content for each of contexts 5001, 5002, 5003, 5201 and 5202 can be defined based upon user preferences, the quality of the auto-generic and/or auto-specific annotations, the particular type of source information, or any desired combination of these or other criteria. Alternatively, the plurality of display configuration blend options in sidebar variable form 4901 and form 5101 could include one or more options that permitted defining custom content for context 5001 including links to popup annotations, as well as contexts 5002 and 5003.

In the embodiment of FIG. 51, the particular content associated with each of options 5131 to 5137 is identified by a content class identifier from TABLE 6. In addition, the content class identifier is displayed in form 5101 next to the window that contains the content so the user can easily visualize the content associated with each display configuration blend option.

In this embodiment, if the user does not select one of options 5131 to 5137, generic language description (G) of generic language description window 4611 is selected as content 5010 for context 5001 and content 5210 for context 5201. Any content in windows adapted code-comment window 4612, adapted code-comment more details window 4613, application-specific description window 4621, more details window 4622, application-specific footnote window 5123, or more details window 5124 is not displayed in any of the tooltips.

Herein, in the text, the content class identifiers are enclosed in parentheses to assist in identifying them. In the drawings, the content class identifiers are enclosed in a circle when next to a window, and are capital letters in the display configuration blend options.

In this embodiment, for each of options 5131 to 5137, generic language description (G) is selected as content 5010 for context 5001. If option 5131 is chosen, a concatenation of generic language description (G), auto-specific description content (A) in adapted code-comment window 4612 (FIG. 51), and manual-specific description content (D) in application-specific description window 4621 (FIG. 51) becomes content 5020 in sidebar menu subtitle tooltip context 5002. Content 5020, a part of content 5020, or appended text is marked as a link 5021 to popup having sidebar menu frame subtitle tooltip linked more-detail popup context 5003 with a concatenation of auto-specific description more details content (B) in adapted code-comment more details window 4613 (FIG. 51) and manual-specific more details content (S) in more details window 4622 (FIG. 49) as content 5030.

Also for option 5131, a concatenation of generic language description (G), auto-specific description content (A) in adapted code-comment window 4612 (FIG. 51), manual-specific description content (D) in application-specific description window 4621 (FIG. 51) and manual-specific footnote content (F) in application-specific footnote window 5123 becomes content 5210 in patch code frame variable reference tooltip context 5201. Content 5210, a part of content 5210, or appended text is marked as a link 5211 to a popup having patch code frame variable reference tooltip linked more-detail popup context 5202 with a concatenation of auto-specific description more details content (B) in adapted code-comment more details window 4613 (FIG. 51), manual-specific more details content (S) in more details window 4622 (FIG. 51), and manual-specific footnote more details content (M) in more details window 5124 as content 5220.

If option 5132 is chosen, a concatenation of auto-specific description content (A) and manual-specific description content (D) becomes content 5020 in sidebar menu subtitle tooltip context 5002. Content 5020, a part of content 5020, or appended text is marked as a link 5021 to a popup having sidebar menu frame subtitle tooltip linked more-detail popup context 5003 with a concatenation of auto-specific description more details content (B) (FIG. 51), and manual-specific more details content (S) (FIG. 51) as content 5030.

Also, for option 5132, a concatenation of auto-specific description content (A), manual-specific description content (D) and manual-specific footnote content (F) in application-specific footnote window 5123 becomes content 5210 in patch code frame variable reference tooltip context 5201. Content 5210, a part of content 5210, or appended text is marked as a link 5211 to a popup having patch code menu frame variable reference tooltip linked more-detail popup context 5202 with a concatenation of auto-specific description more details content (B), manual-specific more details content (S) and manual-specific footnote more details content (M) in more details window 5124 as content 5220.

If option 5133 is chosen, a concatenation of generic language description (G), auto-specific description content (A) in adapted code-comment window 4612 (FIG. 51) becomes a first portion of content 5020 in sidebar menu subtitle tooltip context 5002. This first portion of content 5020, a part of this first portion of content 5020, or appended text is marked as a first link 5021 to a first popup having sidebar menu frame subtitle tooltip linked more-detail popup context 5003 with auto-specific description more details content (B) in adapted code-comment more details window 4613 (FIG. 51) as content 5030.

Also, in option 5133, manual-specific description content (D) in application-specific description window 4621 (FIG. 51) becomes a second portion of content 5020 in sidebar menu subtitle tooltip context 5002. This second portion of content 5020, a part of this second portion of content 5020, or appended text is marked as a second link 5021 to a second popup having sidebar menu frame subtitle tooltip linked more-detail popup context 5003 with manual-specific more details content (S) in more details window 4622 (FIG. 51) as content 5030.

Further for option 5133, a concatenation of generic language description (G), auto-specific description content (A) in adapted code-comment window 4612 (FIG. 51) becomes a first portion of content 5210 in patch code frame variable reference tooltip context 5201. This first portion of content 5210, a part of content 5210, or appended text is marked as a first link 5211 to a first popup having patch code frame variable reference tooltip linked more-detail popup context 5202 with auto-specific description more details content (B) in adapted code-comment more details window 4613 (FIG. 51) as content 5220.

Also, in option 5133, manual-specific description content (D) in application-specific description window 4621 (FIG. 51) becomes a second portion of content 5210 in patch code frame variable reference tooltip context 5201. This second portion of content 5210, a part of this second portion of content 5210, or appended text is marked as a second link 5211 to a second popup having patch code frame variable reference tooltip linked more-detail popup context 5202 with manual-specific more details content (S) in more details window 4622 (FIG. 51) as content 5220.

Finally, in option 5133, manual-specific footnote content (F) in application-specific footnote window 5123 (FIG. 51) becomes a third portion of content 5210 in patch code frame variable reference tooltip context 5201. This third portion of content 5210, a part of content 5210, or appended text is marked as a third link 5211 to a third popup having patch code frame variable reference tooltip linked more-detail popup context 5202 with manual-specific footnote more details content (M) in more details window 5124 (FIG. 51) as content 5220.

If option 5134 is chosen, manual-specific description content (D) (FIG. 51) becomes content 5020 in sidebar menu subtitle tooltip context 5002. Content 5020, a part of content 5020, or appended text is marked as a link 5021 to a popup having sidebar menu frame subtitle tooltip linked more-detail popup context 5003 with manual-specific more details content (S) as content 5030.

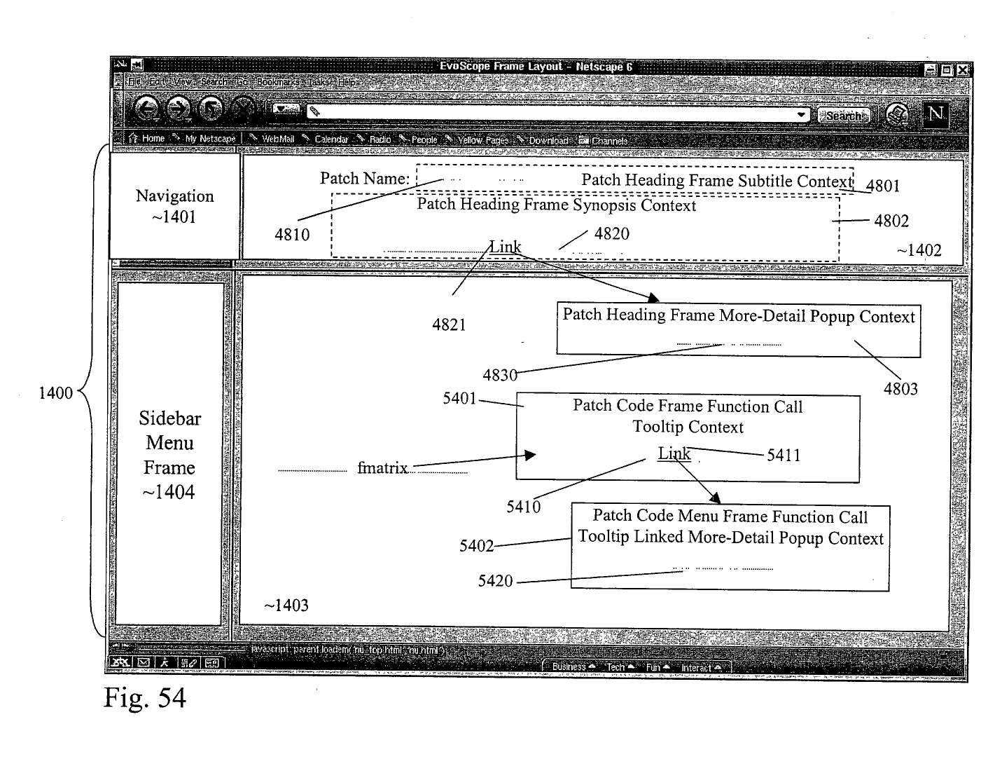

Also, for option 5134, a concatenation of manual-specific description content (D) (FIG. 54) and manual-specific footnote content (F) in application-specific footnote window 5123 becomes content 5210 in patch code frame variable reference tooltip context 5201. Content 5210, a part of content 5210, or appended text is marked as a link 5211 to a popup having patch code menu frame variable reference tooltip linked more-detail popup context 5202 with a concatenation of manual-specific more details content (S) and manual-specific footnote more details content (M) in more details window 5124 (FIG. 51) as content 5220.

If option 5135 is chosen, manual-specific description content (D) (FIG. 51) becomes content 5020 in sidebar menu subtitle tooltip context 5002. Content 5020, a part of content 5020, or appended text is marked a link 5021 to a popup having sidebar menu frame subtitle tooltip linked more-detail popup context 5003 with manual-specific more details content (S) as content 5030.

Also, for option 5135, manual-specific description content (D) in application-specific description window 4621 (FIG. 51) becomes a first portion of content 5210 in patch code frame variable reference tooltip context 5201. This first portion of content 5210, a part of content 5210, or appended text is marked as a first link 5211 to a first popup having patch code frame variable reference tooltip linked more-detail popup context 5202 with manual-specific more details content (S) in more details window 4622 (FIG. 51) as content 5220.

Finally, in option 5135, manual-specific footnote content (F) in application-specific footnote window 5123 (FIG. 51) becomes a second portion of content 5210 in patch code frame variable reference tooltip context 5201. This second portion of content 5210, a part of this second portion of content 5210, or appended text is marked as a second link 5211 to a second popup having patch code frame variable reference tooltip linked more-detail popup context 5202 with manual-specific footnote more details content (M) in more details window 5124 (FIG. 51) as content 5220.

Options 5136 and 5137 have no affect on sidebar menu contexts 5010, 5020 and 5030 and so these contexts are not considered for these options. Note that the last two options only apply to the individual (particular) variable symbol reference, providing footnotes to explain the particular use of the variable within the statement context in which the variable symbol reference occurs.

If option 5136 is chosen, a concatenation of manual-specific footnote content (F) in application-specific footnote window 5123 (FIG. 51) and manual-specific footnote more details content (M) in more details window 5124 (FIG. 51) becomes content 5210 in patch code frame variable reference tooltip context 5201.

In option 5137, manual-specific footnote content (F) in application-specific footnote window 5123 (FIG. 51) becomes content 5210 in patch code frame variable reference tooltip context 5201. Content 5210, a part of content 5210, or appended text is marked as a link 5211 to a popup having patch code frame variable reference tooltip linked more-detail popup context 5202 with manual-specific footnote more details content (M) in more details window 5124 (FIG. 51) as content 5220.

After clicking on button Save 4641, the content in form 5101 along with the chosen display configuration blend is transmitted to a server-side CGI-agent program associated with form 5101. This CGI-agent program updates the metatree files, and the display frames are immediately refreshed. The CGI-agent program also updates all metatrees and patch files and corresponding HTML files, for patches, which contain references to the variable for which form 5101 was generated.

In another embodiment, the contents of windows 4621 and 4622 in form 5101 are made read only. Hence, in this embodiment, form 4901 is used to edit annotations for sidebar menu frame 1404. Any manual-specific descriptions entered via form 4901 are presented in form 5101 and used in the display configuration blend options of form 5101. In this embodiment, as well as in the first embodiment, form 5101 enriches the annotation of variable references in patch code frame 1403, allowing the localized blending of information from the other sources, e.g., form 4901 with localized footnote and more detailed information specific to the context of the variable reference.

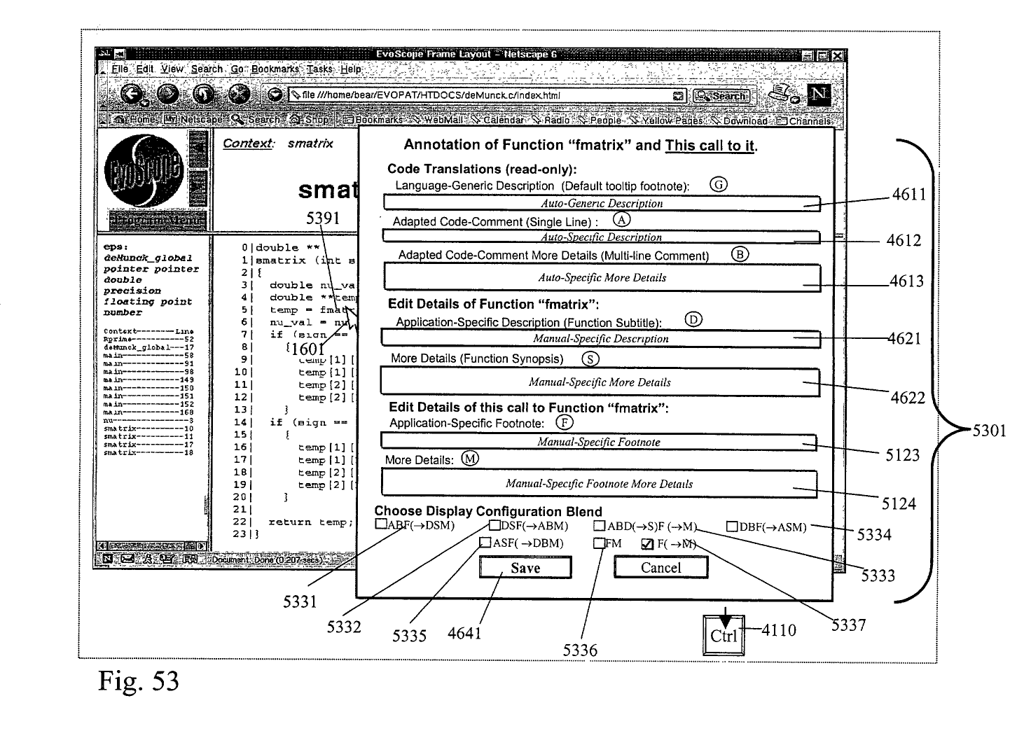

FIG. 53 illustrates annotator popup patch code frame function reference entry-edit form 5301 that is displayed upon the user placing cursor 1601 on a function symbol, e.g., function fmatrix 5391, in patch code frame 1403 and clicking a mouse key while depressing control key 4110, e.g., the user generates an extended click event. Those of skill in the art will appreciate that a different function is called to generate form 5301 on the client device and a different function is used on the server to process the new data from form 5301 on the client device than in the previous examples.

FIG. 53 illustrates the user requesting the ability to edit the contents for a plurality of contexts associated with a reference to a function, e.g., a function call, in patch code frame 1403. In this embodiment, two contexts 5401 and 5402, i.e.,

9. Patch Code Frame Function Call Tooltip Context 5401; and

10. Patch Code Frame Function Call Tooltip Linked More-Detail Popup Context 5402.

(FIG. 54) are associated with a reference to a function in patch code frame 1403, and consequently form 5301.

However, as indicated above, if a user generates an onClick event for a function symbol in patch code frame 1403, the code for the function is displayed in patch code 1403 and contents 4810 and 4820 for the function are presented in patch heading frame 1402. Consequently, to maintain consistency in the annotations for a particular function, form 5301 is also associated with contexts 4801, 4802 and 4803 that were discussed above with respect to FIG. 48. Hence, form 5301 is associated with a total of five different contexts.

Returning to FIG. 53, form 5301 includes generic language description window 4611, adapted code-comment window 4612, adapted code-comment more details window 4613, application specific description window 4621, and more details window 4622. The content associated with each of these windows and the functionality of each of these windows is the same as described above.

Form 5301 also includes application-specific footnote window 5123 and second more details window 5124. The user may add or edit text in of windows 5123 and 5124, i.e., the contents of windows 5123 and 5124 are read/write. In this embodiment, text is entered in windows 5123 and 5124 to provide annotations concerning the specific reference to the function (function call) in the patch displayed in patch code frame 1403.

Any text in windows 5123 and 5124 is limited to supplying annotations for the specific function call and is not applied to a reference to the function (function call) in other locations of the patch or in other patches. This allows a user to provide specific annotations for each instance of a function call in a program.

In form 5301, the user may also choose the display configuration blend by checking one or none of options 5331 to 5337. In the example of FIG. 53, an option in plurality of options 5331 to 5335 in display configuration blend regions affects both contexts 4801 to 4803 and contexts 5401 and 5402. However, the information in windows 5123 and 5124 (FIG. 53) is not applicable to contexts 4801 to 4803. Hence, selection of a particular option, in general, is defined in TABLE 10.

TABLE 10

| | Contexts 4801, 4802, & 4803 | Contexts 5401 & 5402 |
|---|---|---|
| 1 | I(j) | IJ |
| 2 | I(j->k) | IJ(->K) |
| 3 | I(j->k) | IJ(->K)L(->M) |
| 4 | — | LM |
| 5 | — | L->M |

In TABLE 10, an underscore in combination with -> represents a link. Also, while the underscore is associated with a letter, i.e., a content identifier, representing particular content, as explained above, the content, a part of the content, or appended text may constitute the link. Consequently, an underscore of a content identifier in any of the Tables herein and the related description thereof is not to be interpreted as requiring all the content associated with the content identifier to be included in the link. In general herein, when it is stated that content is marked as a link, those of skill in the art will understand that the content, a part of the content, or appended text may be marked as the link. To avoid redundant repetition, in some of the description herein, it is stated only that the content is marked as link, but in each such instance, this also includes the embodiments where a part of the content, or appended text is marked as the link.

Further, herein the -> or some other associated symbol combination representing a link, may not mean necessarily a hypertext link, but may mean a mouseover tooltip display triggered in the text. In some cases hypertext link text and tooltip trigger text may be interchanged.

Content I represents a first content indicator in a display blend configuration option. Content J represent all content indicators between content I and a first delimiter (e.g., a left parenthesis) in the display blend configuration option. Content K represents all content indicators enclosed by the first delimiter and a second delimiter. Contents L and M are contents that as associated with contexts 5401 and 5402 only.

Hence, in example 1 of TABLE 10, content I is content 4810 of patch heading frame subtitle context 4801. Content j is content 4820 in patch heading frame synopsis context 4802. A concatenation of contents I and J is content 5410 of patch code frame function call tooltip context 5401.

In example 2 of TABLE 10, content I is content 4810 of patch heading frame subtitle context 4801. Content j is content 4820 in patch heading frame synopsis context 4802. Content j is marked as a link to content k that is content 4830 of a popup having content patch heading frame more-detail context 4803. A concatenation of contents I and J is content 5410 of patch code frame function call tooltip context 5401. The concatenation of contents I and J is marked as a link to content K that is content 5420 of patch code frame function call tooltip linked more-detail context 5402.

In example 3 of TABLE 10, content I is content 4810 of patch heading frame subtitle context 4801. Content j is content 4820 in patch heading frame synopsis context 4802. Content j is marked as a link to content k that is content 4830 of content patch heading frame more-detail context 4803. A concatenation of contents I and J is content 5410 of patch code frame function call tooltip context 5401. The concatenation of contents I and J is marked as a link to content K that is content 5420 of patch code frame function call tooltip linked more-detail context 5402. Content L is additional content in content 5410 of patch code frame function call tooltip context patch code frame function call tooltip context 5401. Content L is marked as a link to content M that is content 5420 of a second popup having patch code frame function call tooltip linked more-detail context 5402.

In example 4 of TABLE 10, a concatenation of content L and content M is content 5410 that is associated only with patch code frame function call tooltip context 5401. In example 5 of TABLE 10, content L is content 5410 that is associated only with patch code frame function call tooltip context 5401. Content L is marked as a link to content M that is content 5420 of patch code frame function call tooltip linked more-detail context 5402

Herein, in this embodiment, content defined by a lowercase letter may be either identical to or a subset of the content defined by an uppercase letter. Contents for contexts 5401 and 5402 in patch code frame 1403 can include manual-specific footnote data (F) and manual-specific footnote more details data (M) that is specific to the function call in patch code frame 1403. This data is appropriate only for the specific function call in patch code frame 1403 and so is not used for context patch heading frame subtitle context 4801, patch heading frame synopsis context 4802, and patch heading frame more-detail context 4803 that are associated with patch heading frame 1402.

Consequently, if the content associated with an uppercase letter in TABLE 10 includes either manual-specific footnote data or manual-specific footnote more details data, the data is not included in the content for the corresponding lowercase letter. In this case, the content associated with the lowercase letter is a subset of the content associated with the uppercase letter. The subset can be an empty set for some display configuration blends as indicated for examples 4 and 5 in TABLE 10.

In FIG. 54, only a single link 5411 is illustrated in context 5401 for clarity. Those of skill in the art will appreciate, as just described, that each of these contexts can contain multiple links where each of the links is associated with different content in context 5401. Hence, link 5411 can represent either a single link or a plurality of links.

The content for each of contexts 4801, 4802, 4803, 5401 and 5402 can be defined based upon user preferences, the quality of the auto-generic and/or auto-specific annotations, the particular type of source information, or any desired combination of these or other criteria.

In the embodiment of FIG. 53, the particular content associated with each of options 5331 to 5337 is identified by a content class identifier from TABLE 6. In addition, the content class identifier is displayed in form 5301 next to the window that contains the content so the user can easily visualize the content associated with each display configuration blend option.

In this embodiment, if the user does not select one of options 5331 to 5337, generic language description (G) of generic language description window 4611 concatenated with any content (A) in adapted code comment window 4612 is selected as content 4810 for context 4801 and content 5410 for context 5401. Any content (B) in adapted code-comment more details window 4613 is used as content 4820 in context 4802, and as content 5420 in context 5402. In this case, link 5411 is appended text MORE at the end of content 5410 in context 5401. Any content in application-specific description window 4621, more details window 4622, application-specific footnote window 5123, or more details window 5124 is not displayed in any of the tooltips.

Herein, in the text, the content class identifiers are enclosed in parentheses to assist in identifying them. In the drawings, the content class identifiers are enclosed in a circle when next to a window, and are capital letters in the display configuration blend options.

In this embodiment, if option 5331 is chosen, auto-specific description content (A) in adapted code-comment window 4612 becomes content 4810 in patch heading frame subtitle context 4801. Auto-specific description more details content (B) in adapted code-comment more details window 4613 becomes content 4820 in patch heading frame synopsis context 4802. Content 4820, a part of content 4820, or appended text is marked as a link 4821 to a popup containing a concatenation of manual-specific description content (D) in application-specific description window 4621 and manual-specific more details content (S) in more details window 4622 as content 4830 of patch heading frame more-detail context 4803.

Also for option 5331, auto-specific description content (A) in adapted code-comment window 4612 (FIG. 53), auto-specific description more details content (B) in adapted code-comment more details window 4613 (FIG. 53) and manual-specific footnote content (F) in application-specific footnote window 5123 becomes content 5410 in patch code frame function call tooltip context 5401. Content 5410, a part of content 5410, or appended text is marked as a link 5411 to a popup having patch code frame function call tooltip linked more-detail context 5402 with a concatenation of manual-specific description content (D) in application-specific description window 4621 (FIG. 53), manual-specific more details content (S) in more details window 4622 (FIG. 51), and manual-specific footnote more details content (M) in more details window 5124 as content 5420.

If option 5332 is chosen, manual-specific description content (D) in application-specific description window 4621 becomes content 4810 in patch heading frame subtitle context 4801. Manual-specific more details content (S) in more details window 4622 becomes content 4820 in patch heading frame synopsis context 4802. Content 4820, a part of content 4820, or appended text is marked as link 4821 to a popup containing a concatenation of auto-specific description content (A) in adapted code-comment window 4612 and auto-specific description more details content (S) in adapted code-comment more details window 4613 as content 4830 of patch heading frame more-detail context 4803.

Also for option 5332, a concatenation of manual-specific description content (D) in application-specific description window 4621 (FIG. 53), manual-specific more details content (S) in more details window 4622 (FIG. 53), and manual-specific footnote content (F) in application-specific footnote window 5123 becomes content 5410 in patch code frame function call tooltip context 5401. Content 5410, a part of content 5410, or appended text is marked as a link 5411 to a popup having patch code frame function call tooltip linked more-detail context 5402 with a concatenation of auto-specific description content (A) in adapted code-comment window 4612 (FIG. 53), auto-specific description more details content (B) in adapted code-comment more details window 4613 (FIG. 53) and manual-specific footnote more details content (M) in more details window 5124 as content 5420.

If option 5333 is chosen, auto-specific description content (A) in adapted code-comment window 4612 becomes content 4810 in patch heading frame subtitle context 4801. A concatenation of auto-specific description more details content (B) in adapted code-comment more details window 4613 and, manual-specific description content (D) in application-specific description window 4621 becomes content 4820 in patch heading frame synopsis context 4802. Content 4820, a part of content 4820, or appended text is marked as a link 4821 to a popup containing manual-specific more details content (S) in more details window 4622 as content 4830 of patch heading frame more-detail context 4803.

Also for option 5333, a concatenation of auto-specific description content (A) in adapted code-comment window 4612 (FIG. 53), auto-specific description more details content (B) in adapted code-comment more details window 4613 (FIG. 53) and manual-specific description content (D) in application-specific description window 4621 (FIG. 53) becomes a first portion of content 5410 in patch code frame function call tooltip context 5401. The first portion of content 5410, a part of content 5410, or appended text is marked as a first link 5411 to a first popup having patch code frame function call tooltip linked more-detail context 5402 with manual-specific more details content (S) in more details window 4622 (FIG. 53) as content 5420. Manual-specific footnote content (F) in application-specific footnote window 5123 becomes a second portion of content 5410 in patch code frame function call tooltip context 5401. This second portion of content 5410, a part of this second portion of content 5410, or appended text is marked as a second link 5411 to a second popup having patch code frame function call tooltip linked more-detail context 5402 with manual-specific footnote more details content (M) in more details window 5124 as content 5420.

If option 5334 is chosen, manual-specific description content (D) in application-specific description window 4621 becomes content 4810 in patch heading frame subtitle context 4801. Content 4820 of patch heading frame synopsis context 4802 is auto-specific description more details content (B) in adapted code-comment more details window 4613. Content 4820, a part of content 4820, or appended text is marked as a link 4821 to a popup containing a concatenation of auto-specific description content (A) in adapted code-comment window 4612 and manual-specific more details content (S) in more details window 4622 as content 4830 of patch heading frame more-detail popup context 4803.

Also, if option 5334 is chosen, a concatenation of manual-specific description content (D) in application-specific description window 4621, auto-specific description more details content (B) in adapted code-comment more details window 4613, and manual-specific footnote content (F) in application-specific footnote window 5123 becomes content 5410 in patch code frame function call tooltip context 5401. Content 5410, a part of content 5410, or appended text is marked as a link 5411 to a popup containing a concatenation of auto-specific description content (A) in adapted code-comment window 4612, manual-specific more details content (S) in more details window 4622, and manual-specific footnote more details content (M) in more details window 5124 as content 5420 of patch code menu frame function call tooltip linked more-detail popup context 5402.

In this embodiment, if option 5335 is chosen, auto-specific description content (A) in adapted code-comment window 4612 becomes content 4810 in patch heading frame subtitle context 4801. Manual-specific more details content (S) in more details window 4622 becomes content 4820 in patch heading frame synopsis context 4802. Content 4820 is marked as a link 4821 to a popup containing a concatenation of manual-specific description content (D) in application-specific description window 4621 and auto-specific description more details content (B) in adapted code-comment more details window 4613 as content 4830 of patch heading frame more-detail context 4803.

Also for option 5335, auto-specific description content (A) in adapted code-comment window 4612 (FIG. 53), manual-specific more details content (S) in more details window 4622 (FIG. 53), and manual-specific footnote content (F) in application-specific footnote window 5123 becomes content 5410 in patch code frame function call tooltip context 5401. Content 5410, a part of content 5410, or appended text is marked as a link 5411 to a popup having patch code frame function call tooltip linked more-detail context 5402 with a concatenation of manual-specific description content (D) in application-specific description window 4621 (FIG. 53), auto-specific description more details content (B) in adapted code-comment more details window 4613 (FIG. 53), and manual-specific footnote more details content (M) in more details window 5124 as content 5420.

Options 5336 and 5337 have no affect on patch heading frame contexts 4801, 4802 and 4803 and so these contexts are not considered for these options. Note that the last two options 5336 and 5337 only apply to the individual (particular) function call by providing footnotes to explain the particular use of the function within the statement context in which the function call occurs.

If option 5336 is chosen, a concatenation of manual-specific footnote content (F) in application-specific footnote window 5123 (FIG. 53) and manual-specific footnote more details content (M) in more details window 5124 (FIG. 53) becomes content 5410 in patch code frame function call tooltip context 5401.

In option 5337, manual-specific footnote content (F) in application-specific footnote window 5123 (FIG. 53) becomes content 5410 in patch code frame function call tooltip context 5201. Content 5410, a part of content 5410, or appended text is marked as a link 5411 to a patch code frame function call tooltip linked more-detail popup context 5402 with manual-specific footnote more details content (M) in more details window 5124 (FIG. 53) as content 5420.

After clicking on button Save 4641, the content in form 5301 along with the chosen display configuration blend is transmitted to a server-side CGI-agent program associated with form 5301. This CGI-agent program updates the metatree files, and display frames 1402 and 1403 are immediately refreshed. The CGI-agent program also updates all metatrees and patch files and corresponding HTML files, for patches, which contain references to the variable for which form 5301 was generated.

In another embodiment, the contents of windows 4621 and 4622 in form 5301 are made read only. Hence, in this embodiment, form 4701 is used to edit annotations for patch code heading frame 1402. Any manual-specific descriptions entered via form 4701 are presented in form 5301 and used in the display configuration blend options of form 5301. In this embodiment, as well as in the first embodiment, form 5301 enriches the annotation of function call references in patch code frame 1403, allowing the localized blending of information from the other sources, e.g., form 4701 with localized footnote and more detailed information specific to the context of the function call reference.

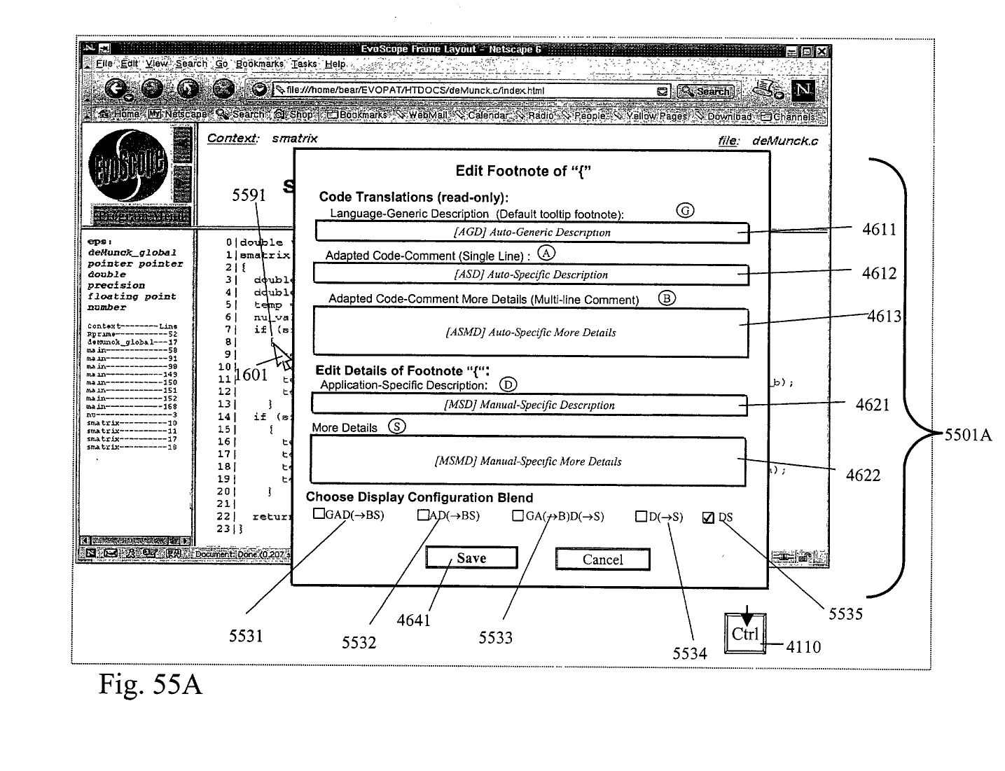

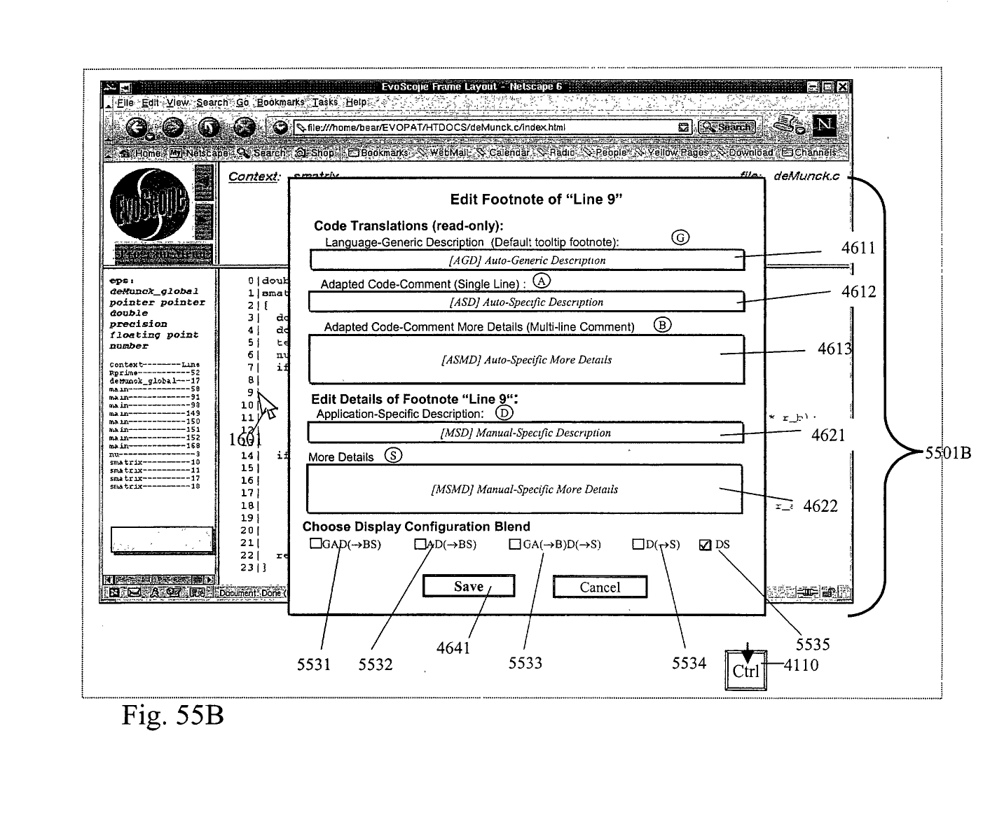

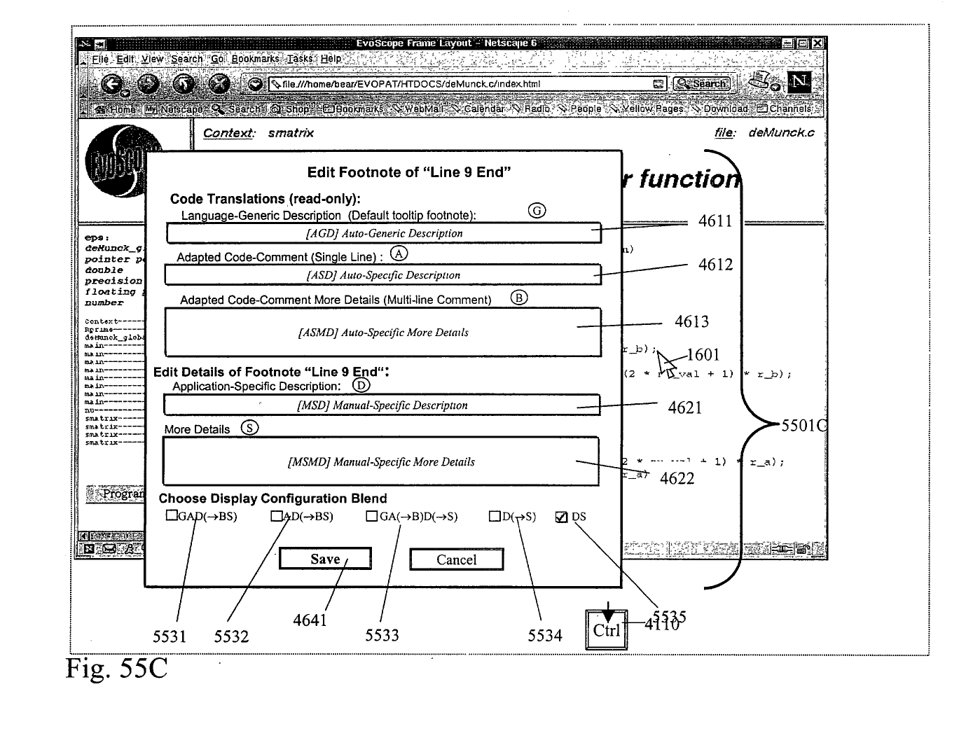

FIG. 55A illustrates an annotator popup footnote annotation trigger symbol entry-edit form 5501A that is displayed upon the user placing cursor 1601 a footnote annotation trigger symbol (e.g., left brace 5591 in patch code frame 1403) and clicking a mouse key while depressing control key 4110, e.g., the user generates an extended click event. Those of skill in the art will appreciate that a different function is called to generate form 5501A on the client device and a different function is used on the server to process the new data from the client device than in the previous examples.

FIG. 55A illustrates the user requesting the ability to edit the contents for a plurality of contexts associated with a footnote annotation trigger symbol in patch code frame 1403. In this embodiment, two contexts 5601 and 5602, i.e.,

11. Patch Code Frame Code-to-Prose/Pseudocode Footnote Tooltip Context 5601; and

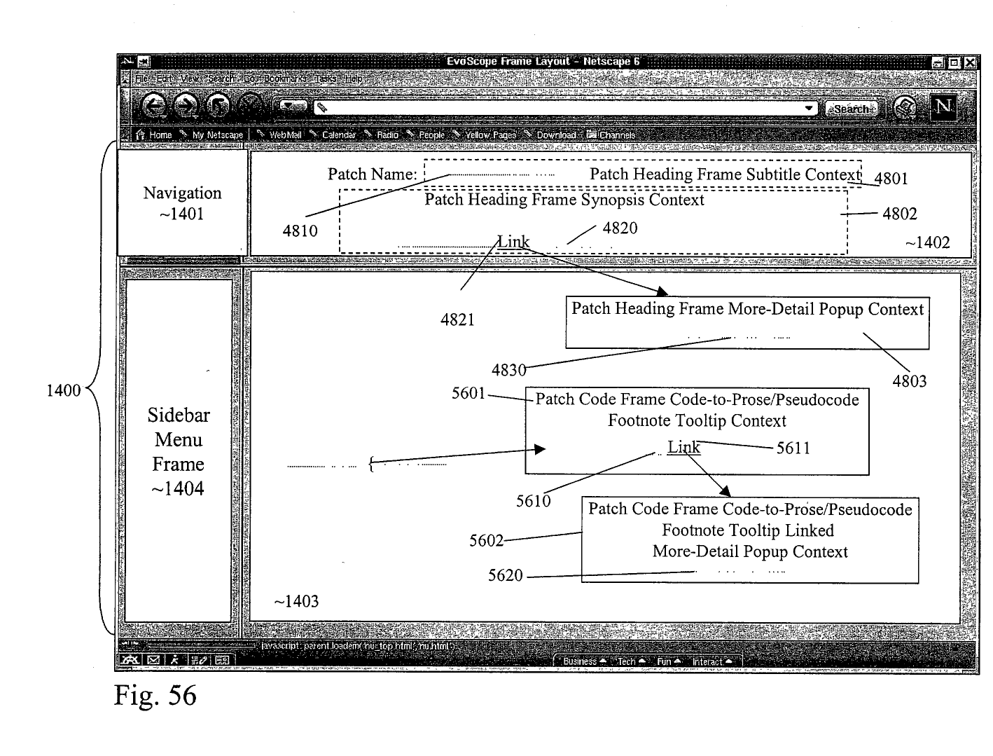

12. Patch Code Frame Code-to-Prose/Pseudocode Footnote Tooltip Linked More-Detail Popup Context 5602. (FIG. 56) are associated with a footnote annotation in patch code frame 1403.

Returning to FIGS. 55A to 55C, forms 5501A to 5501C, respectively, include generic language description window 4611, adapted code-comment window 4612, adapted code-comment more details window 4613, application specific description window 4621, and more details window 4622. The content associated with each of these windows and the functionality of each of these windows is the same as described above.

In forms 5501A to 5501C, the user may also choose the display configuration blend, by checking one or none of options 5531 to 5535. In the examples of FIG. 55A to 55C, the display configuration blend options in plurality of options 5531 to 5535 are defined in TABLE 11.

TABLE 11

| | Contexts 5401 & 5402 |
|---|---|
| 1 | i |
| 2 | i(->j) |
| 3 | i(->j)k(->1) |

In TABLE 11, an underscore in combination with -> represents a link.

Content i represents a concatenation of the contents represented by all content indicators before a first delimiter (e.g., a left parenthesis) in the display blend configuration option. If there is no delimiter, content i represents a concatenation of the contents represented by all content indicators in the display blend configuration option. Content j represents a concatenation of the content associated with all content indicators enclosed by the first delimiter and a second delimiter. Content k represents a concatenation of the contents represented by all content indicators before a third delimiter (e.g., another left parenthesis) in the display blend configuration option. Content 1 represents a concatenation of the contents represented by all content indicators enclosed by the third delimiter and a fourth delimiter.

In example 1 of TABLE 11, content i is content 5610 of patch code frame code-to-prose/pseudocode footnote tooltip context 5601. In this embodiment, content i maybe any one of contents (G), (A), (B), (D), (S), or alternatively a concatenation of any combination of these contents.

In example 2, of TABLE 11, content i is content 5610 of patch code frame code-to-prose/pseudocode footnote tooltip context 5601. Content i is marked as a link to content j that is content 5620 of a popup having patch code frame code-to-prose/pseudocode footnote tooltip linked more-detail popup context 5602.

In example 3 of TABLE 11, content i is a first portion of content 5610 of patch code frame code-to-prose/pseudocode footnote tooltip context 5601. Content i is marked as a link to a first popup that includes content j as content 5620 of patch code frame code-to-prose/pseudocode footnote tooltip linked more-detail popup context 5602. Content k is a second portion of content 5610 of patch code frame code-to-prose/pseudocode footnote tooltip context 5601. Content k is marked as a link to a second popup that includes content l as content 5620 of patch code frame code-to-prose/pseudocode footnote tooltip linked more-detail popup context 5602.

The content for each of contexts 5601 and 5602 can be defined based upon user preferences, the quality of the auto-generic and/or auto-specific annotations, the particular type of source information, or any desired combination of these or other criteria.

In the embodiment of FIG. 55A, the particular content associated with each of options 5531 to 5535 is identified by a content class identifier from TABLE 6. In addition, the content class identifier is displayed in form 5501A next to the window that contains the content so the user can easily visualize the content associated with each display configuration blend option.

In this embodiment, if the user does not select one of options 5531 to 5535, generic language description (G) of generic language description window 4611 is selected as content 5610 for context 5601. Any content in windows adapted code-comment window 4612, adapted code-comment more details window 4613, application-specific description window 4621, or more details window 4622 is not displayed in any of the tooltips.

Herein, in the text, the content class identifiers are enclosed in parentheses to assist in identifying them. In the drawings, the content class identifiers are enclosed in a circle when next to a window, and are capital letters in the display configuration blend options.

If option 5531 is chosen, a concatenation of generic language description (G), auto-specific description content (A) in adapted code-comment window 4612 (FIG. 55A), and manual-specific description content (D) in application-specific description window 4621 (FIG. 55A) becomes content 5610 in patch code frame code-to-prose/pseudocode footnote tooltip context 5601. Content 5610 is marked as a link 5611 to a popup having patch code frame code-to-prose/pseudocode footnote tooltip linked more-detail popup context 5602 with a concatenation of auto-specific description more details content (B) in adapted code-comment more details window adapted code-comment more details window 4613 (FIG. 55A) and manual-specific more details content (S) in more details window 4622 (FIG. 55A) as content 5620.

If option 5532 is chosen, a concatenation of auto-specific description content (A) and manual-specific description content (D) becomes content 5610 in patch code frame code-to-prose/pseudocode footnote tooltip context 5601. Content 5610 is marked as a link 5611 to a popup having patch code frame code-to-prose/pseudocode footnote tooltip linked more-detail popup context 5602 with a concatenation of auto-specific description more details content (B) and manual-specific more details content (S) as content 5620.

If option 5533 is chosen, a concatenation of generic language description (G) and auto-specific description content (A) in adapted code-comment window 4612 (FIG. 55A) becomes a first portion of content 5610 in patch code frame code-to-prose/pseudocode footnote tooltip context 5601. This first portion of content 5610 is marked as a first link 5611 to a first popup having patch code frame code-to-prose/pseudocode footnote tooltip linked more-detail popup context 5602 with auto-specific description more details content (B) in adapted code-comment more details window 4613 (FIG. 55A) as content 5620.

Also, in option 5633, manual-specific description content (D) in application-specific description window 4621 (FIG. 55A) becomes a second portion of content 5610 in patch code frame code-to-prose/pseudocode footnote tooltip context 5601. This second portion of content 5610, a part of this second portion of content 5610, or appended text is marked as a second link 5611 to a second popup having patch code frame code-to-prose/pseudocode footnote tooltip linked more-detail popup context 5602 with manual-specific more details content (S) in more details window 4622 (FIG. 49) as content 5620.

If option 5534 is chosen, manual-specific description content (D) (FIG. 55A) becomes content 5610 in patch code frame code-to-prose/pseudocode footnote tooltip context 5601. Content 5610 is marked as a link 5511 to popup having patch code frame code-to-prose/pseudocode footnote tooltip linked more-detail popup context 5602 with manual-specific more details content (S) as content 5620.

If option 5535 is chosen, a concatenation of manual-specific description content (D) and manual-specific more details content (S) becomes content 5510 in patch code frame code-to-prose/pseudocode footnote tooltip context 5601.

After clicking on button Save 4641, the content in form 5501A along with the chosen display configuration blend is transmitted to a server-side CGI-agent program associated with form 5501A. This CGI-agent program updates the metatree files, and the display frames are immediately refreshed. The CGI-agent program also updates all metatrees and patch files and corresponding HTML files, for patches, which contain references to the variable for which form 5501A was generated.

In one embodiment, comments that are in module 206B of original source computer program 105B (FIG. 2B) are not displayed in patch code frame 1403. If such a comment is the only information in a line and the comment requires only one contiguous line, a blank line appears in patch code frame 1403 with a line number.

However, if there is more than one contiguous comment line that contains only comment information, only the first comment line is displayed as a blank line with a line number in patch code frame 1403. The additional contiguous comments lines are hidden. Hence, the next displayed line in patch code frame 1403 after the blank line is the line following the last comment line. In this case, the line numbers are not continuous and have a gap since the line numbers for the hidden comment lines are missing.

Web annotator 270 is used to edit both single comments lines and a plurality of contiguous comments lines. Specifically, FIG. 55B illustrates an annotator popup line number footnote entry-edit form 5501B that is displayed upon the user placing cursor 1601 on a line number (e.g., line number 9) in patch code frame 1403 and clicking a mouse key while depressing control key 4110, e.g., the user generates an extended click event. FIG. 55B illustrates the user requesting the ability to edit the contents for contexts 5601 and 5602 (FIG. 56) associated with a comment or comments associated with the patch displayed in patch code frame 1403. The extended click event launches a second function that generates form 5501B.

Form 5501B is similar to form 5501A and includes language generic description window 4611, adapted code-comment window 4612, adapted code-comment more details window 4613, application specific description window 4621, and more details window 4622. The content associated with each of these windows is the same as described above.

In form 5501B, the user may also choose the display configuration blend, by checking one or none of options 5531 to 5535, which have the same affect as described above for form 5501A and that description is incorporated herein by reference.

Typically, if the comment is a single line, the comment appears in adapted code-comment window 4612 (FIG. 55B). If the comments are multiple contiguous lines, the first line appears in adapted code-comment window 4612, and any subsequent lines appear in adapted code-comment more details window 4613 (FIG. 55B). Typically, the information in adapted code-comment window 4612 and adapted code-comment more details window 4613 is read-only and so a user can only provide additional information in windows 4621 and/or 4622 and then select a display configuration blend option to control the information displayed in response to an onMouseOver event associated with a line number.

However, in another embodiment, that is controlled via administrative options for web annotator 270, if a user places the cursor on either adapted code-comment window 4612 or adapted code-comment more details window 4613 and generates another extended click event, e.g., presses a pre-defined key other than control key 4110 and clicks the mouse, the content of one or both of adapted code-comment window 4612 and adapted code-comment more details window 4613 is released for editing by the user. This allows the in-code comments to be edited. This may be achieved in a two stage process, since adapted code-comments are auto-generated, the adapted code-comments are maintained separately in the cradle metatrees from the information manually edited via web annotator 270. Both the adapted code-comments, and the manual-specific comments can be used-subsequently for revision of the in-code comments.

After clicking on button Save 4641, the content in form 5501B along with the chosen display configuration blend option is transmitted to a server-side CGI-agent program associated with form 5501B. This CGI-agent program updates the metatree files, and the display frames are immediately refreshed.

In one embodiment, comments that are in module 206B of original source computer program 105B (FIG. 2B) at the end of lines are not displayed in patch code frame 1403. In another embodiment, such comments may appear in patch code frame 1403. In either embodiment, FIG. 55C illustrates another embodiment of annotator popup end of line footnote entry-edit form 5501C that is displayed upon the user placing cursor 1601 at the end of a line in patch code frame 1403 and clicking a mouse key while depressing control key 4110, e.g., the user generates an extended click event. FIG. 55C illustrates the user requesting the ability to edit the contents for contexts 5601 and 5602 (FIG. 56) associated with an end of line comment or comments associated with the patch displayed in patch code frame 1403. The extended click event launches a footnote edit function that generates form 5501C.

Form 5501C is similar to form 5501A and includes generic language description window 4611, adapted code-comment window 4612, adapted code-comment more details window 4613, application specific description window 4621, and more details window 4622. The content associated with each of these windows is the same as described above.

In form 5501C, the user may also choose the display configuration blend, by checking one or none of options 5531 to 5535, which have the same affect as described above for form 5501A and that description is incorporated herein by reference.

Typically, if the end of line comment is a single line, the comment appears in adapted code-comment window 4612 (FIG. 55C). If the end of line comment is multiple contiguous lines, the first line appears in adapted code-comment window 4612, and any subsequent lines appear in adapted code-comment more details window 4613 (FIG. 55C). Typically, the information in adapted code-comment window 4612 and adapted code-comment more details window 4613 is read-only and so a user can only provide additional information in windows 4621 and/or 4622 and then select a display configuration blend option to control the information displayed in response to an onMouseOver event associated with a line number.

However, in another embodiment, that is controlled via administrative options for web annotator 270, if a user places the cursor on either adapted code-comment window 4612 or adapted code-comment more details window 4613 and generates another extended click event (e.g., presses a pre-defined key other than control key 4110 and clicks the mouse) the content of one or both of adapted code-comment window 4612 and adapted code-comment more details window 4613 is released for editing by the user. This allows the in-code end of line comments to be edited. This may be achieved in a two stage process, since adapted code-comments are auto-generated, the adapted code-comments are maintained separately in the cradle metatrees from the information manually edited via web annotator 270. Both the adapted code-comments, and the manual-specific comments can be used subsequently for revision of the in-code comments.

After clicking on button Save 4641, the content in form 5501C along with the chosen display configuration blend option is transmitted to a server-side CGI-agent program associated with form 5501C. This CGI-agent program updates the metatree files, and the display frames are immediately refreshed.

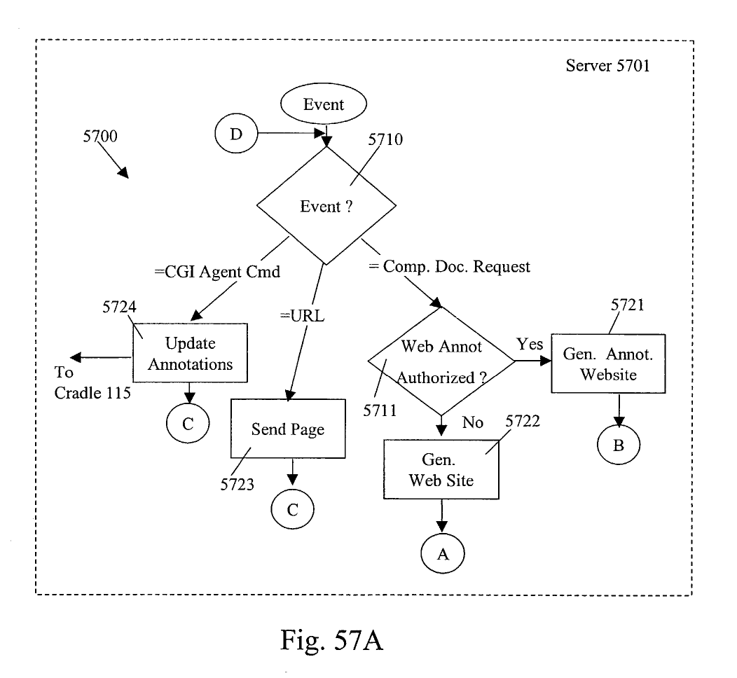

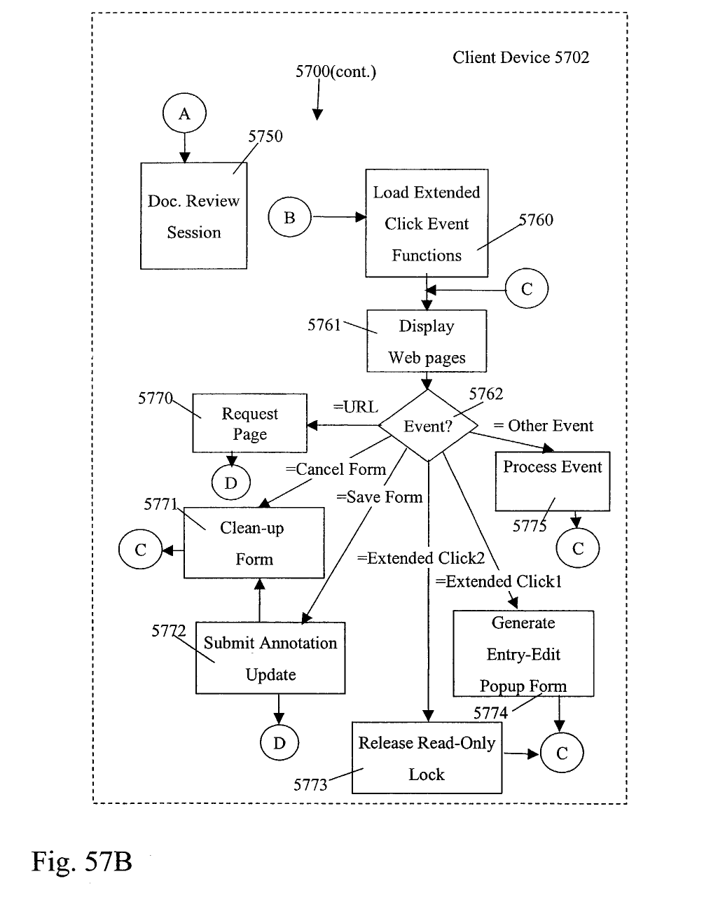

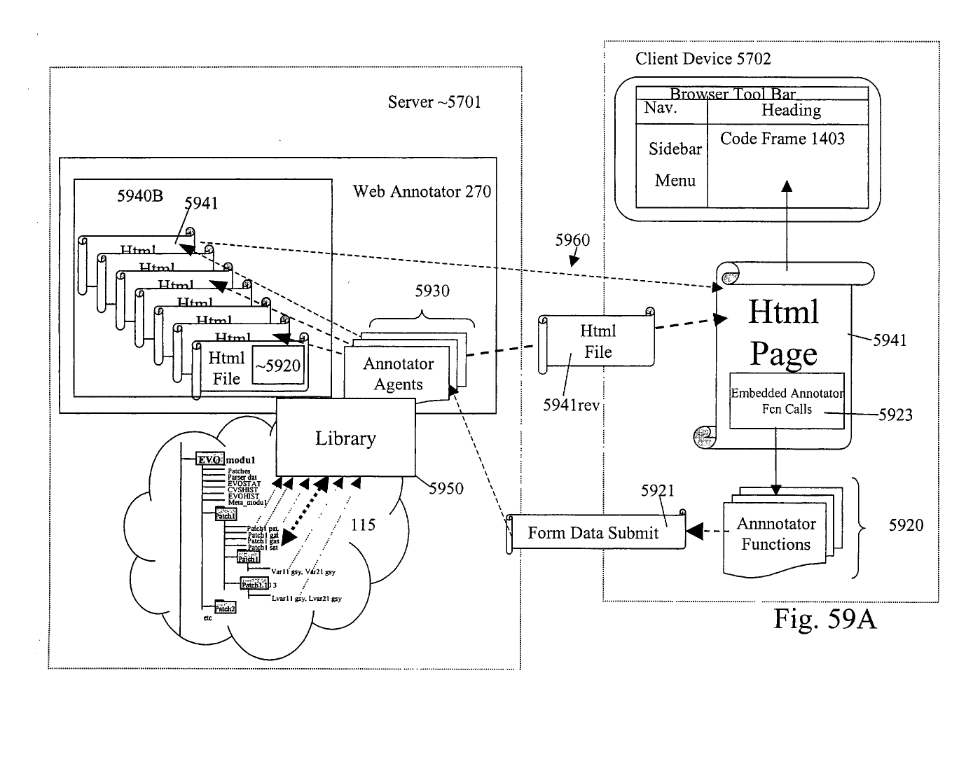

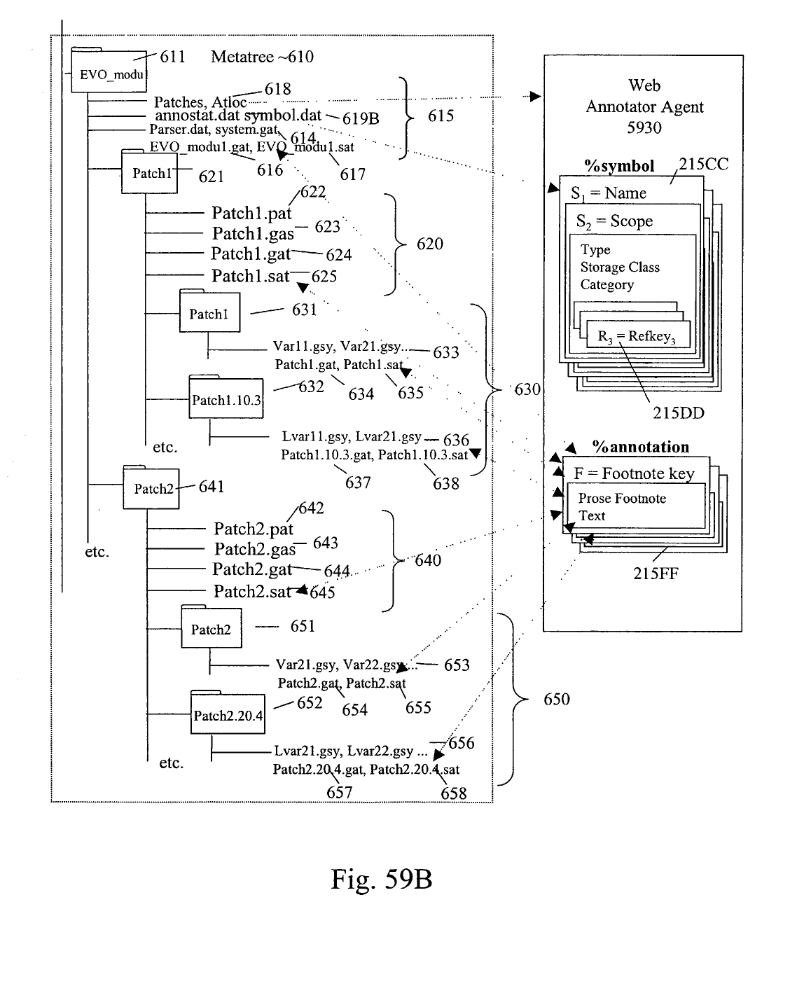

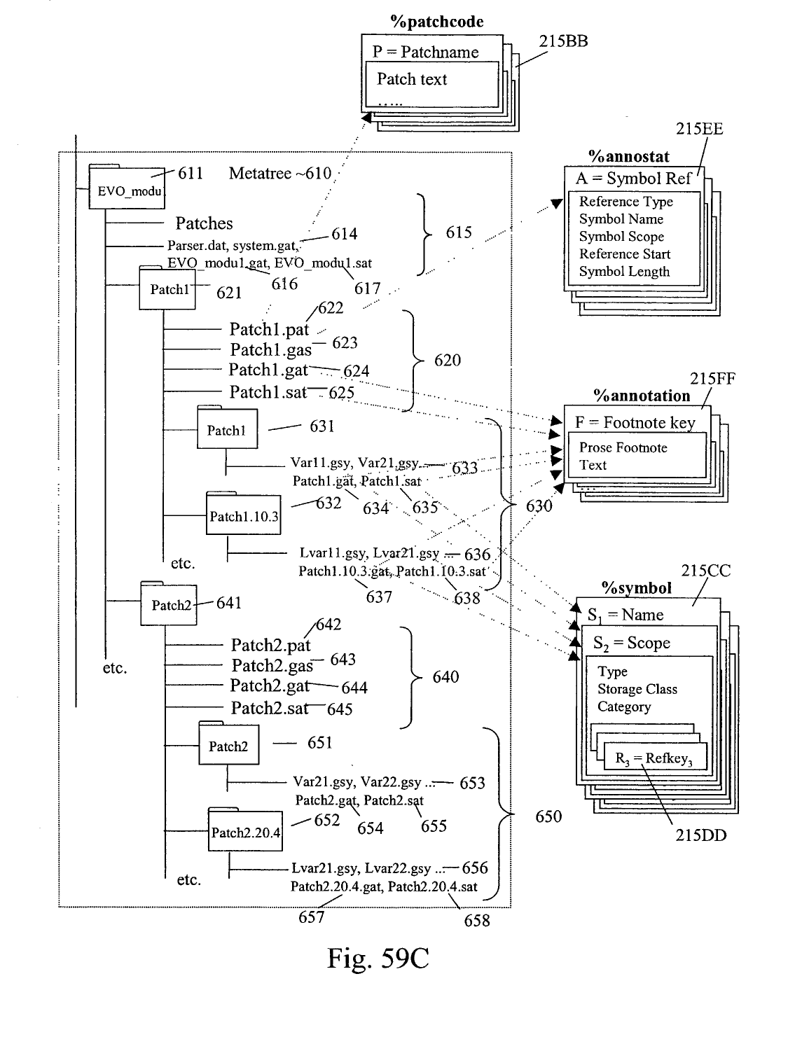

FIGS. 57A and 57B are a web annotator process flow diagram for one embodiment of web annotator 270. FIG. 59A is a more detailed diagram illustrating the structures utilized in this embodiment of web annotator process 5700 (FIGS. 57A and 57B). In this example, server 5701 (FIGS. 57A and 59A) includes a plurality of events to which the server responds. (Note that the use of events is illustrative only. In some instances, an interrupt handler may be used in place of an event handler, or alternatively a combination of an interrupt handler and an event handler could be used to handle the operations illustrated in FIG. 57A.) These events include a request to access rapid comprehension source code documentation 240B, a common gateway interface (CGI) agent command from a corresponding web annotator client function, and a request for a webpage, i.e., a HTML file in rapid comprehension source code documentation 240B. In FIG. 57A, event check operation 5710 determines which of these events has occurred and transfers processing to the appropriate point to handle the event. Events other than those illustrated may also occur and are handled in the normal prior art manner.

When a user requests access to rapid comprehension source code documentation 240B, event check operation 5710 transfers processing to web annotator authorized check operation 5711. Web annotator authorized check operation 5711 determines whether the user is authorized to edit the annotations of rapid comprehension source code documentation 240B and whether the request included a request to access web annotator 270. If the user is authorized and made the request, processing transfers to generate annotator website operation 5721 and otherwise to generate website operation 5722.

The implementation of operations 5721 and 5722 depends upon the particular embodiment implemented. In one embodiment, the website, e.g., rapid comprehension source code documentation 240B is generated only in response to a request. In another embodiment, the website is stored, and operations 5721 and 5722 provide access to the appropriate stored website. Operations 5721 and 5722 are similar except that in operation 5721, the client annotator functions necessary to support the annotation editing are included in the website as well as the extended click instructions to call these functions in each anchor, div, or span tag-pair. The generation of the website from metatree 610 in cradle file system 115, for example, was described above and that description is incorporated herein by reference.

Generate website operation 5722 transfers to document review session 5750 on client device 5702 (FIG. 57B). One embodiment of document review session 5750 was described above with respect to FIGS. 16, 17, 19, 20, 22, 23, 26 to 30, 33 to 39 and 41A to 41C and that description is incorporated herein by reference.

Generate annotator website 5721 transfers to load extended click event function operation 5760 on client device 5702 (FIG. 57B). In this embodiment, web annotator entry-edit form functions 5920 are transferred to client device 5702 with a first webpage from the web annotator version of stored website 5940B (FIG. 59A) representing rapid comprehension source code documentation 240B (FIG. 2B). Hence, load extended click event functions operations 5760 performs any necessary operation required on client device 5702 to permit the user to access functions 5920 and transfers processing to display webpages operation 5761.

Display webpages operation 5761 also is similar to the operations described above with respect to FIGS. 16, 17, 19, 20, 22, 23, 26 to 30, 33 to 39 and 41A to 41C and that description is incorporated herein by reference. If the user clicks on a link to a new webpage, an event is generated. Event handler operation 5762 determines the particular type of event and transfers processing to the appropriate operation.

For example, if the user clicks, in patch code frame 1403, on a link to a new webpage, the event is selection of a uniform resource locator (URL) for a webpage stored in website 5940B on server 5701. For such a URL event, event handler operation 5762 transfers processing to request page operation 5770.

Request page operation 5770 transfers the URL event to event check operation 5710 on server 5701 (FIG. 57A). Event check operation 5710 determines that the request from client device 5702 is a request for a webpage in website 5940B and transfers to send page operation 5723.

Send page operation 5723 transmits the requested webpage 5941 in website 5940B to client device 5702 as represented by path 5960 (FIG. 59A). Upon receiving webpage 5941, display webpages operation 5761 displays webpage 5941 in the appropriate frame, which, in this example, is patch code frame 1403.

In webpages of web annotator rapid comprehension source code documentation 5940B, each annotation anchor, div, or span tag-pair contains an attribute ONCLICK that in turn contains a call to an annotator entry-edit form function in annotator functions 5920 that is appropriate for the element associated with the tag-pair. In this embodiment, attribute ONCLICK includes both click and extended click functionality. In one embodiment, the extended click function calls are included in all versions of the rapid comprehension source documentation, but the functionality of the functions transferred to the client device depends upon the administrative controls authorized for a particular user. If the user is not authorized to use web annotator 270, the annotator entry-edit form functions are defined as no ops on the client device. In either case, annotation text data that is subject to maintenance is embedded in arguments to annotator entry-edit form function calls 5923 of webpage 5941.

If the user delimits a symbol associated with annotation text data that is subject to maintenance and generates an invoke annotation entry-edit form event, which in this embodiment is an extended click one event, event handler 5762 transfer processing to generate entry-edit popup form operation 5774. Operation 5774 calls the annotator entry-edit form function in the annotation anchor, div, or span tag-pair for the element selected by the user.

Execution of the annotator entry-edit form function generates an annotator popup entry-edit form for the selected element, as described above. The annotation data embedded in the call to the annotator entry-edit form function is copied into the appropriate windows of the annotator popup entry-edit form.

The user can review, add, or edit the displayed annotation as described above, and can select a display blend configuration. If the user can edit the annotation data of the read-only windows of the form, the user selects a read-only window, and issues a read-only release event, which is this embodiment is an extended click two event.

In response to the extended click two event, event handler 5762 transfers to release read-only lock operation 5773. Release read-only lock operation 5773 releases the read-only lock on the read-only window or windows of the form.

After the user is finished with the popup form, as described above, the user can either activate the save button or the cancel button on the form. If the user selects the cancel button, a cancel form event is generated and event handler operation 5762 transfers processing clean-up form operation 5771.

Clean-up form operation 5771 closes the popup entry-edit form without taking any action to save the annotation data in the popup entry-edit form. Clean-up form operation 5771 also does any necessary clean-up and returns processing to display webpages operation 5761.

Conversely, if the user selected the save button, a save form event is generated. In response to the save form event, event handler 5762 transfer processing to submit annotation update operation 5772. In submit annotation update operation 5772, the current annotator entry-edit form function copies the modified annotation data and the selected display blend configuration operation into a call (e.g., form data submit 5921) to a CGI agent, corresponding on the current annotator entry-edit form function, in CGI agents 5930 on server 5701.

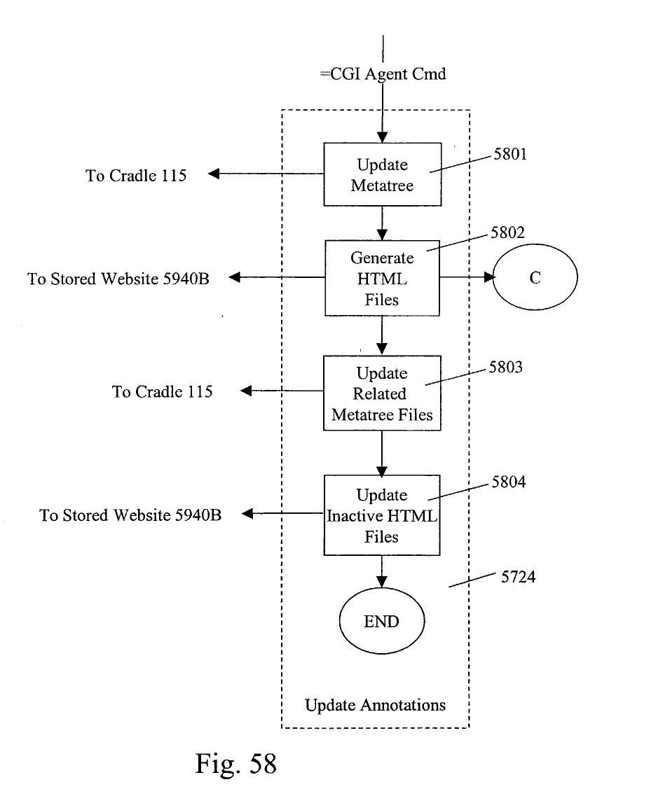

In response to form data submit 5921, the corresponding CGI agent performs update annotations operation 5724 (FIG. 57A). One embodiment of update annotations operation 5724 performed by the CGI agent is presented in FIG. 58.

Update metatree operation 5801 updates the files in metatree 610 for the patch displayed in frame 1403. For example, as illustrated in FIG. 59B, the appropriate <scope>.sat file (See files 617, 625, 635, 638, 645, 655, or 658 in FIG. 59B) in metatree 610 is updated. In one embodiment, the CGI agent calls functions in library 5950 (FIG. 59A) that in turn update the annotations in the <scope>.sat files of metatree 610.

These library functions read (aggregate) the particular <scope>.sat file into hash %annotation 215FF (FIG. 59B) in patch-hash buffer memory 220B, and then replace items in this hash with values sent from client device 5702 via data submit operation 5921. At this point hash %annotation 215FF only contains data from manual-specific content classes (D), (S), (F), and (M) and data from auto-specific adapted comments (A) and (B) that has been edited. Unedited (auto-generated) data from content classes (A) and (B) are stored in the appropriate <scope>.gat files, which are unaffected by web annotator operations.

Upon completion of operation 5801, processing transfers to generate HTML file operation 5802. Generate HTML file operation 5802 uses functionality from hypertext page generator 230 to create a new webpage or webpages (e.g., revised HTML file 5941 rev) using the updated data in the patch directory of metatree 610. Data is aggregated from the patch directory hash files into the hashes in patch-hash buffer memory as illustrated in FIG. 59C.

For a form that updates annotations for more than one HTML file (e.g., the file displayed in frame 1402 and the file displayed in frame 1403) operation 5802 generates two revised files. Operation 5802 transmits file 5941 rev to client device 5702 in display webpages operation 5761 that in turn displays the updated webpage or pages. Operation 5802 also replaces file 5941 in documentation 5940B with file 5941 rev. Upon completion, operation 5802 transfers to update related metatree files operation 5803.

Update related metatree files operation 5803 determines each file in metatree 610 that is affected by the annotation update. For a form that updates a variable symbol annotation (e.g. FIGS. 49 and 51), every patch in every metatree that contains a reference to that variable must be updated. Similarly, for a form that updates a function symbol annotation (e.g. FIGS. 47 and 53), every patch in every metatree that contains a call to that function must be updated.

Operation 5803 locates all of these patches by loading globalized hash file symbol.dat 619B (FIG. 18C) from the root of the metatree containing the variable or function symbol's scope (see FIG. 59B). Loading this file populates hash %symbol from which the symbol's entry record is found. Since this entry record contains all of the reference keys to the symbol throughout the program, and the prefix of each reference key is the patch where the reference occurs, all of the patches needing to be updated are obtained.

Operation 5803 updates of the affected files and stores the updated files in metatree 610 on cradle file system 115. Operation 5803 transfers processing to update inactive HTML files operation 5804. In FIG. 59B, several files are illustrated as being updated. This is illustrative only and is not intended to limit the invention to the specific embodiment illustrated.

In operation 5804, each inactive HTML files in website 5940B that corresponds to one of the files updated in operation 5803 is regenerated. This operation makes use of entries of globalized hash %annostat 215EE that are read from file annostat.dat 619A in each metatree root (see FIG. 18C). Also, since all <scope>.sat file annotation entries (auto-specific manually edited code comments layer, and manually added annotation layer) must be aggregated into the memory-resident hash %annotation after all the auto-generic and auto-specific annotations are loaded from the <scope>.gat files, the order in which the *.gat and *.sat files are aggregated cannot follow the same sequence as the original *.gat file generation.

Consequently, the metatree paths of these files are read from an at location file Atloc 618 file in each metatree, and used to aggregate the files in the order of *.gat files first, *.sat files second, and *.tat files (temporary annotation) last. The regenerated HTML files are stored at the appropriate location in website 5940B.

Hence, follow-up work by the application programmers and user-peer technicians using web annotator 270 fleshes out the documentation of the contained application in generated website 5940B. As described above, this is achieved via direct editing of webpages via an annotator popup entry-edit form enabling the browser user to add or edit annotation text pertaining to the symbol or area of the display selected by the user.

This mechanism, in one embodiment,.adds application-specific annotation of four different types: (1) subroutine synopsis annotation, a multi-line paragraph describing the overall purpose and general description of a subroutine; (2) subroutine subtitle description annotation, a single-line of text that is appended to the subroutine display, and becomes the message displayed upon mouseover covering any call reference to the subroutine; (3) variable-description annotation, a single-line message appended to the heading of the sidebar variable cross-reference menu, and appended to the TITLE-attribute of every variable reference anchor tag so as to display upon mouseover covering any reference to the variable; (4) footnote annotation pertaining to a referenced statement, of any length, which becomes the mouseover annotation for punctuation characters in the statement (if one of these characters is pointed to) or for to-be-added symbols (from a predefined list of footnote symbols) if statement text is pointed to.

As described above, the web annotator, in one embodiment, is a set of dynamic HTML functions to manually edit and add application specific annotation content to cradle file system 115 and to the website associated with documentation 240B. In view of this disclosure, various alternative embodiments can be implemented by those of skill in the art.

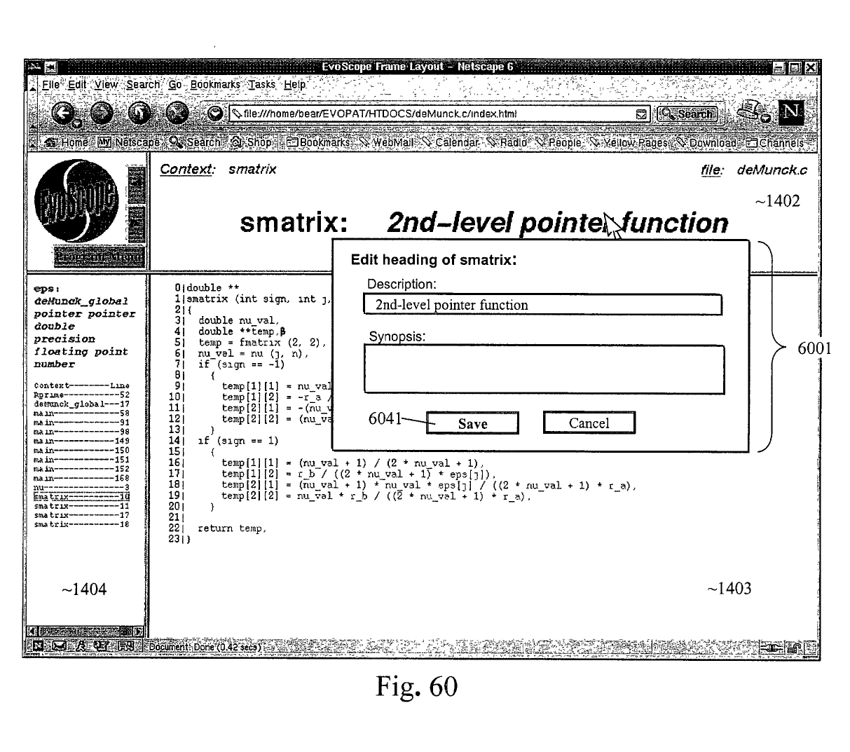

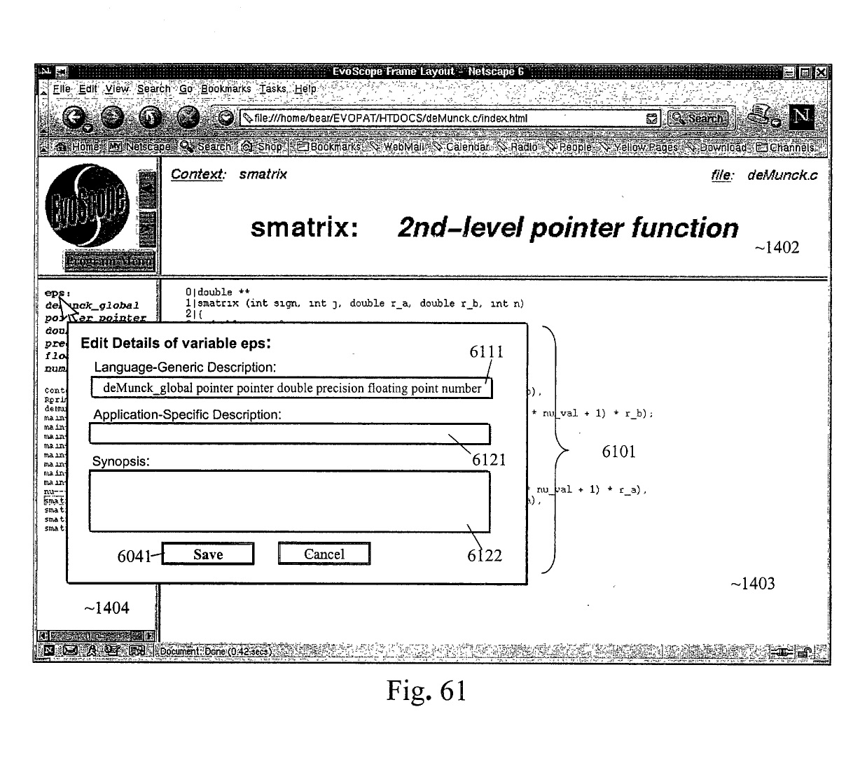

For example, FIG. 60 illustrates entry-editing of subroutine subtitle information (description) and subroutine synopsis information via an annotator popup entry-edit form 6001. The programmer or user-peer technician can edit the description and the synopsis text boxes in this embodiment, and click the mouse on save button 6041. As a result, the information is stored in cradle file system 115, and the frame displays are immediately refreshed to show the changes in the same manner as described above. However, unlike the embodiments described above, this embodiment allows editing of the auto-generic annotations, or alternatively, again windows containing auto-generic annotations can be made read-only.

FIG. 61 illustrates a similar annotator popup entry-edit form 6101 that is used to add or edit details of a variable symbol. In this case, the auto-generic description, shown in upper window 6111 of form 6101 is read-only, since this annotation was automatically generated by parser-hasher 214. The programmer or user-peer technician may add or edit text in two lower windows 6121 and 6122, providing application-specific information. After clicking on Save button 6041, this information is added to the metatree files in cradle file system 115, and the display frames are immediately refreshed.

In this embodiment, as indicated above also, the resulting information may be accessed in two methods, depending on whether mouse cursor 1601 is in sidebar menu frame 1404 or in code frame 1403. In the former case, the auto-generic description is displayed as before, and the application-specific description appears in a tooltip whenever mouse cursor 1601 covers the variable symbol or the auto-generic description in sidebar menu frame 1404. At the end of the tooltip is a hyperlink “[more]” which when clicked, displays a popup window displaying the synopsis information. In the latter case for patch code frame 1403, this same tooltip (e.g., the content in window 6121) is displayed whenever the variable symbol is covered by mouse cursor 1601. The auto-generic information no longer appears in the tooltip for the variable symbol in patch code frame 1403, but only appears in the heading of the sidebar frame.

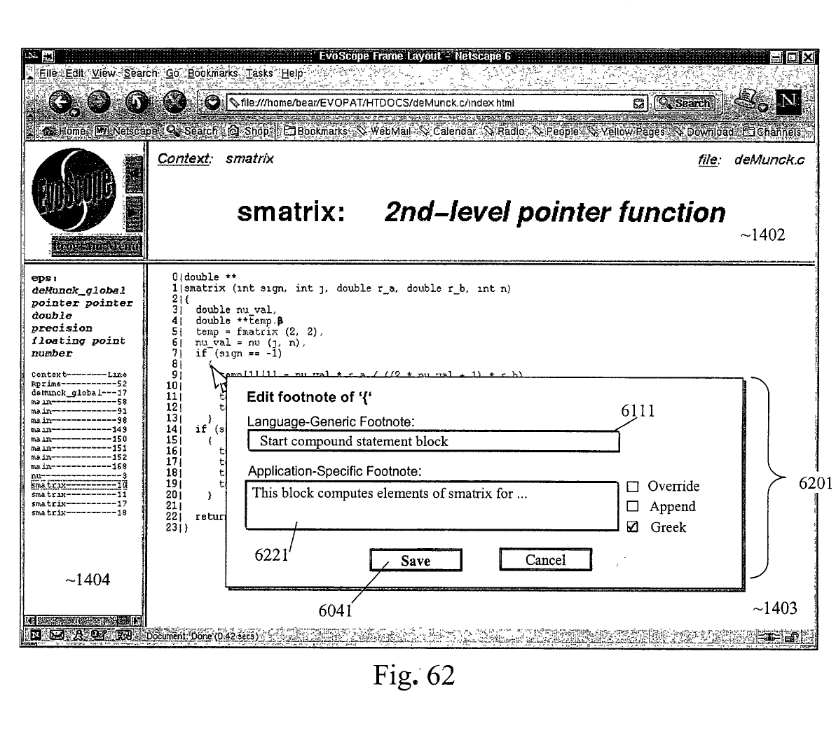

FIG. 62 illustrates annotator popup entry-edit form 6201 for adding application-specific footnote annotation to a punctuation trigger symbol in patch code frame 1403. Upper window 6111 (FIG. 62) containing the auto-generic annotation is read-only. The application-specific footnote, being added or edited via window 6221, may be designated to: (1) replace the auto-generated footnote, (2) be appended to the auto-generated footnote, or (3) made into a separate footnote triggered by a Greek letter following a punctuation symbol.

Other Systems Using Metatrees

A system including a metatree, a generator coupled to read and process the data in the metatree and present the metatree data in a new or different format, and a data annotator follows directly from the above description. The invention is not limited to generating a rapid comprehension document website from the metatree data.

As explained above, the original source information is parsed, hashed, and auto-generic comments generated by the information source adapter. This information is stored in the metatree with a defined hierarchical structure, as described above. Hence, other generators can be built to process the metatree data and create new presentations of the data.

For example, if the original source information is a database, the metatree contains the database data in the hierarchical metatree structure. A new database generator can be coupled to the metatree and can map the data from the metatree to a new database.

Another data mining generator processes the database data in the hierarchical metatree structure to detect predefined patterns or perhaps specific data and generates a website or other file structure that includes only the predefined patterns and/or the specific data.

Alternatively, the data-mining generator accesses multiple metatrees, each representing a particular database, and extracts selected patterns or data satisfying selected relationships. The extracted data is presented as a new database and/or a website.

In another embodiment, metatrees in the cradle file system represent source code for various computer applications. In this embodiment, a new computer application generator extracts modules or patches from the various metatrees and generates a new application using these modules and/or patches. Since as explained above the metatree data includes information characterizing each particular patch, the new application generator can extract the information necessary to assure that each patch in the new application executes properly.

These embodiments relied only upon the metatree data and a generator to present the metatree data, or selected parts of the metatree data in a new format. However, even greater productivity is obtained by using an annotator in conjunction with these embodiments.

For example, as explained more completely below, an annotator is used in porting computer source code in a first programming language to a second programming language. An annotator is used to insert comments that contain the new code in the patches at appropriate points. Since the programmer has the ability to use the rapid comprehension source documentation in conjunction with the annotator, the programmer can determine that all the appropriate information has been considered in writing the new code. The comments are included in hash files in the metatree containing the original computer source code. A comment extraction generator is used to extract the comments from these hash files and to format the comments as computer source code in the second programming language.

In addition, the computer source code in the second programming language is then processed to generate a metatree representing the source code in the second programming language. The metatree representing the source code in the second programming language is used with yet another metatree for another application written in the second programming language by a new computer application generator to create a new application in the second programming language. Hence, the embodiments of this invention facilitate not only porting of computer source code, but also the generation of new computer applications including part or all of the ported computer source code.

Hence, in addition to providing rapid comprehension source documentation with auto-generic, auto-specific, and manual-specific annotations, an annotator is used in a wide variety of applications that can be developed based upon metatrees and corresponding websites. Specifically, functions can be added to the website that allow users to perform a desired task via, for example, popup forms. The information, instructions, or commands embedded in the form and activated by the user are sent as a command to an appropriate agent function on the server.

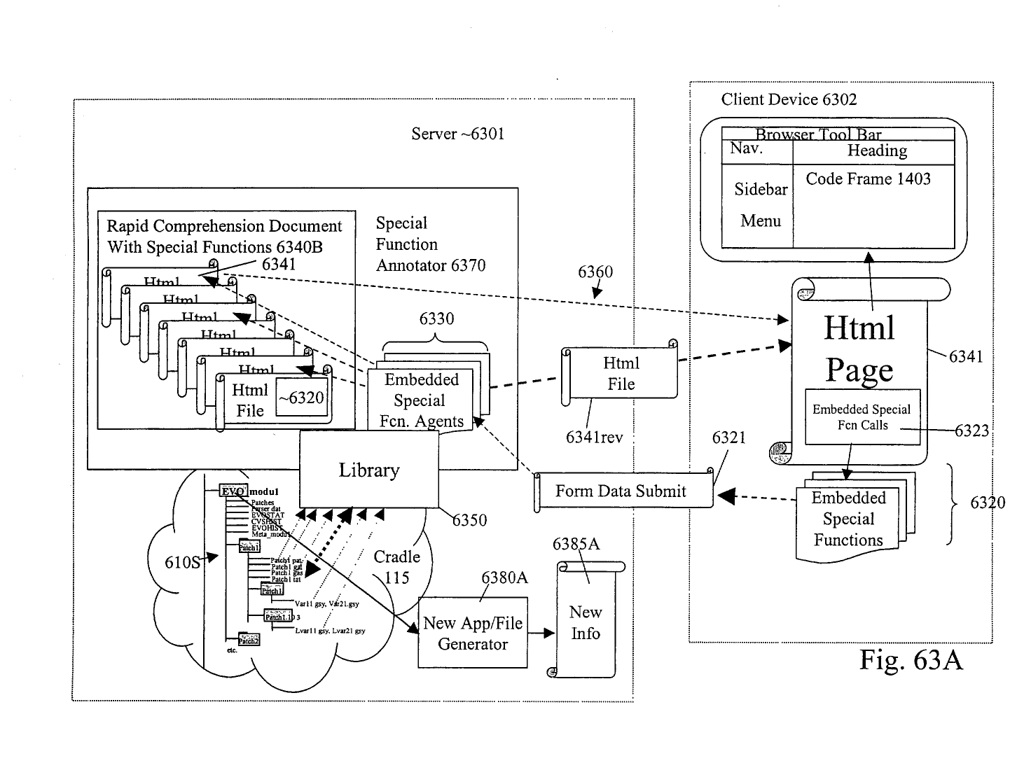

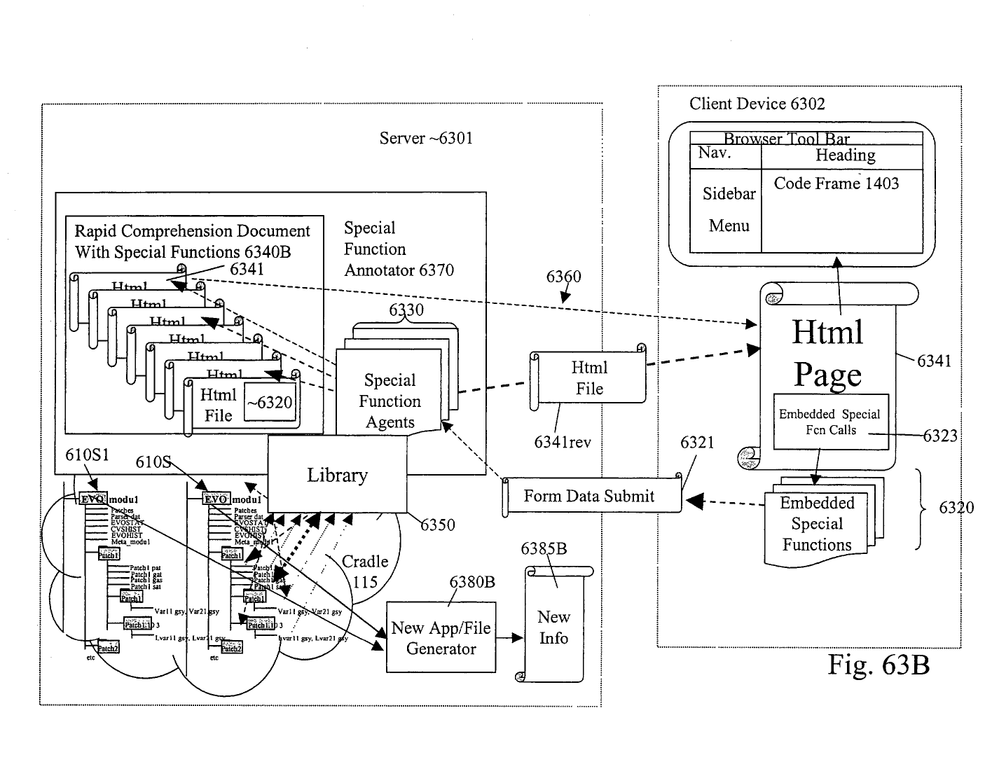

FIG. 63A is a more detailed diagram illustrating the structures utilized in another embodiment of this invention. In this example, upon accessing server 6301 from client device 6302, a user requests access to the website including rapid comprehension source documentation 6340B with special functions. Assuming the user is authorized to access documentation 6340B, documentation 6340B is generated including embedded special functions 6320 that are necessary to support the special functionality included in website 6340B as well as the extended click instructions to call these embedded special functions in each anchor, div, or span tag-pair. The generation of the website including calls to embedded special functions 6320 from metatree 610S in cradle file system 115, for example, is equivalent to the generation of the website that was described above and that description is incorporated herein by reference.

Typically, embedded special functions 6320 are transferred to client device 6302 with a first webpage from website 6340B and loaded into a memory accessible to client device 6302 as illustrated in FIG. 63A. When, for example, the user clicks on a link to a new webpage (e.g., page 6341, stored in website 6340B on server 6301) that page is transferred to client device 6302. Page 6341 that includes embedded special function calls 6323 is stored in memory of client device 6302 and is displayed on the client device. In the webpages of rapid comprehension source documentation 6340B, each annotation anchor, div, or span tag-pair contains an attribute ONCLICK that in turn contains a call to an embedded special function in embedded special functions 6320 that is appropriate for the element associated with the tag-pair.

If the user delimits an element and generates an invoke call to an embedded special function, client device 6302 executes the embedded special function called from the annotation anchor, div, or span tag-pair for the element selected by the user. Execution of the embedded special function generates a special function popup entry-edit form for the selected element.

The user can review, add, or edit the displayed information in the special function popup entry-edit form and select among the various options presented. After the user is finished with the popup form, the user can either activate the save button or the cancel button on the form.

If the user selects the cancel button, the form is closed and no information is conveyed to server 6301 by the executing embedded special function, sometimes called an embedded function. Conversely, if the user selected the save button, the current embedded special function generates a form data submit 6321, to an embedded special function agent, corresponding on the current embedded special function, in embedded special function agents 6330 on server 6301.

In response to form data submit 6321, the embedded special function agent is executed on server 6301. The agent first updates the files in metatree 610S based upon the information in form data submit 6321. For example, in this embodiment, a file <scope>.tat is added, if necessary, in the appropriate module and patch to contain the information. The information with appropriate keys is stored in file <scope>.tat. File <scope>.tat is similar to file <scope>.sat, except that the keys for hash %annotation stored in files <scope>.tat have extensions beyond those in files <scope>.sat, as described in more detail below, and the stored information is the information from the embedded special function popup entry-edit form in place of manual-specific data. In one embodiment, the embedded special function agent calls functions in library 6350 that in turn update the information in the appropriate <scope>.tat files of metatree 610S.

Next, if appropriate, the embedded special function agent uses functionality from hypertext page generator 230 to create a new webpage or webpages (e.g., revised HTML file 6341 rev) using the updated data in metatree 610S. For a form that updates information for more than one HTML file, this operation generates the appropriate revised HTML files.

The embedded special function agent transmits file 6341 rev to the client device that in turn displays the updated webpage or pages. The agent replaces file 6341 in documentation 6340B with file 6341 rev.

Next, the embedded special function agent determines each file in metatree 610S that is affected by the information update. The affected files are updated and the updated files stored in metatree 610S on cradle file system 115. Each inactive HTML file in website 6340B that corresponds to one of the files updated is regenerated. The regenerated HTML files are stored at the appropriate location in website 6340B.

When all the desired information has been added to metatree 601S, new application/file generator 6380A processes the information in files <scope>.tat. Using the information in files <scope>.tat and any other data needed in metatree 610S, generator 6380A creates a new information structure 6385A. New information structure 6385A could be a new database, a new computer program application, a port of the original computer source code in metatrees 610S, or any other structure of interest.

The structure in FIG. 63B is similar to that in FIG. 63A, except the sets of embedded special functions are used for two different metatrees 610S and 610S1, and each metatree includes appropriate information in files <scope>.tat. New application/file generator 6380B uses data from both metatrees to create new information structure 6385B.

As an example of one application of the structure of FIGS. 63A and 63B, in many situations, it is desirable to have the ability to include temporary data (e.g., temporary comments or other information) within the rapid comprehension source documentation while maintaining the one-to-one correspondence of the patches with the original source modules. As explained above, in general, the rapid comprehension source documentation of this invention is a multi-layer document. Accordingly, persons reviewing the rapid comprehension source documentation may insert a comment at a particular point so that when the documentation is subsequently reviewed, the comment can be used to refresh their recollection.

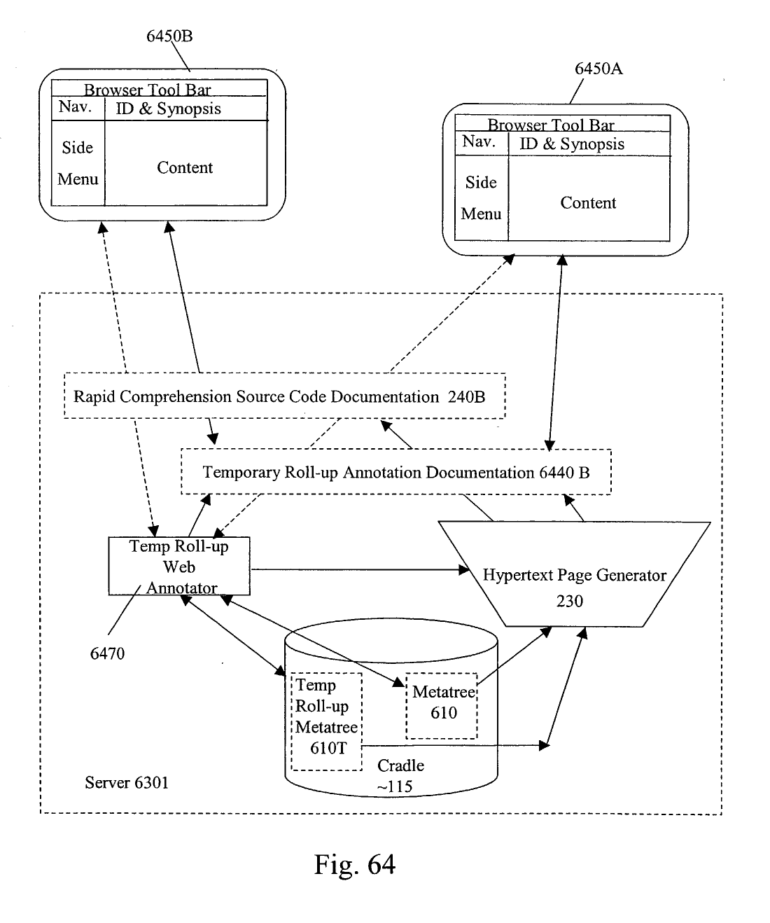

In another embodiment, the website constituting rapid comprehension source documentation 6440B is based upon a metatree that is in a global directory such that multiple users can access rapid comprehension source documentation 6440B (FIG. 64). Access to rapid comprehension source documentation 6440B and access to features associated with rapid comprehension source documentation 6440B is through administrative log-in controls. In addition, a locking mechanism is implemented on server 6301 so that only a single embedded special agent can be executing. In this example, for a first administrative level, a special website is generated that includes a temporary roll-up annotation documentation 6440B (FIG. 64), and embedded functions and function calls of temporary roll-up web annotator 6470.

Specifically, temporary roll-up annotation documentation 6440B includes all of the features of rapid comprehension source code documentation 240B, as described above and that description is incorporated herein by reference. In addition, temporary rapid comprehension source documentation 6440B includes temporary annotation form functions, and commands that are embedded in the webpages of documentation 6440B to call these functions. Hence, here the embedded special functions are temporary annotation form functions.

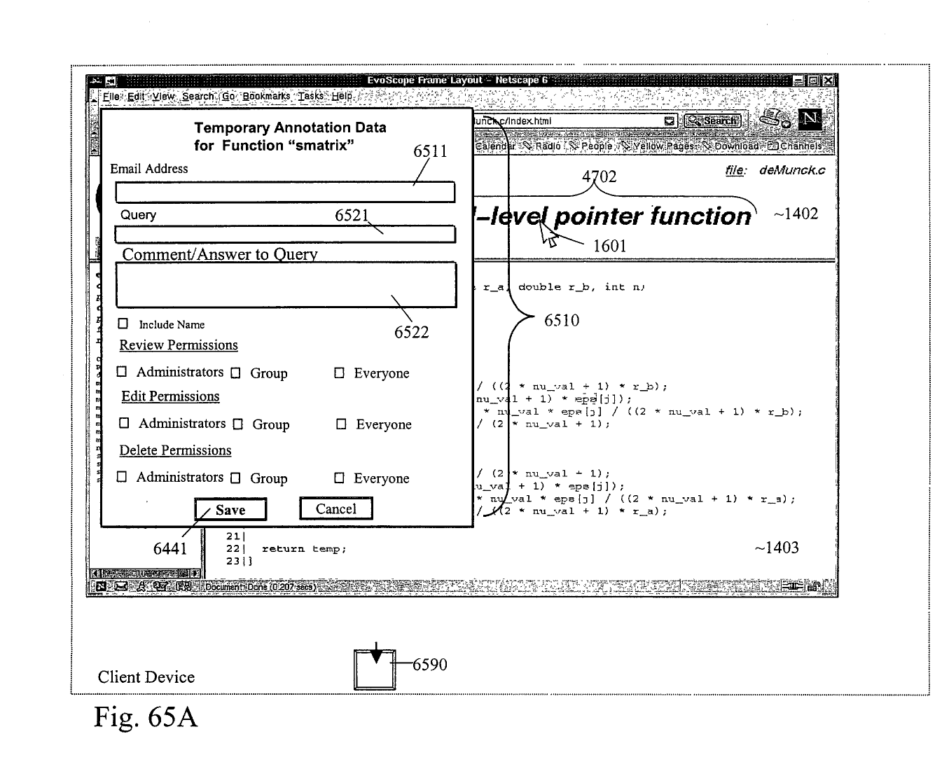

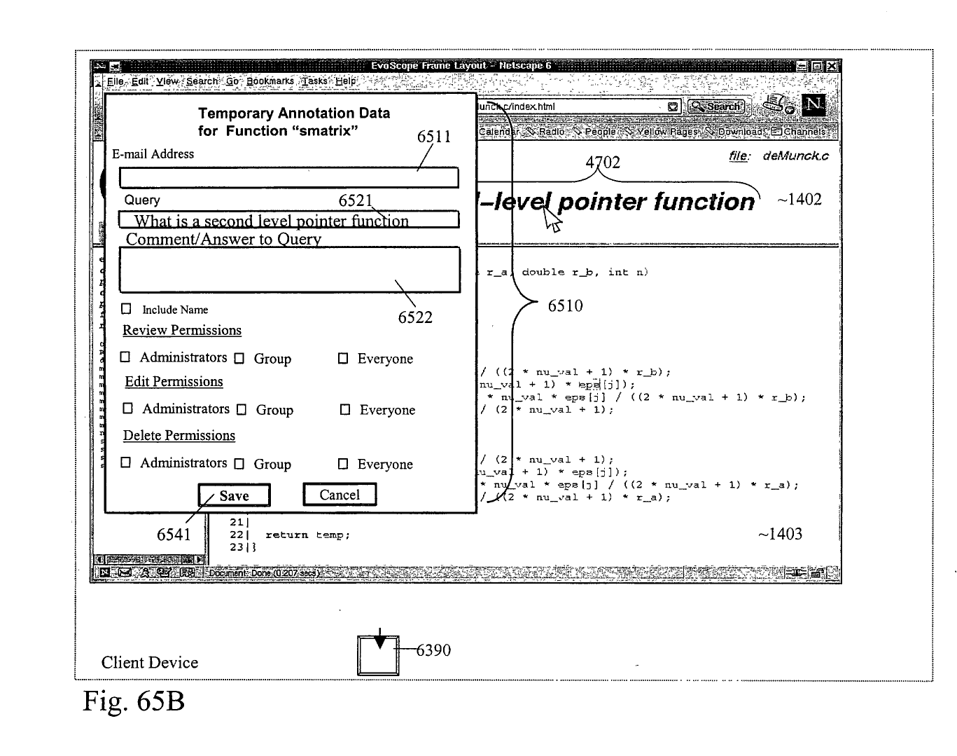

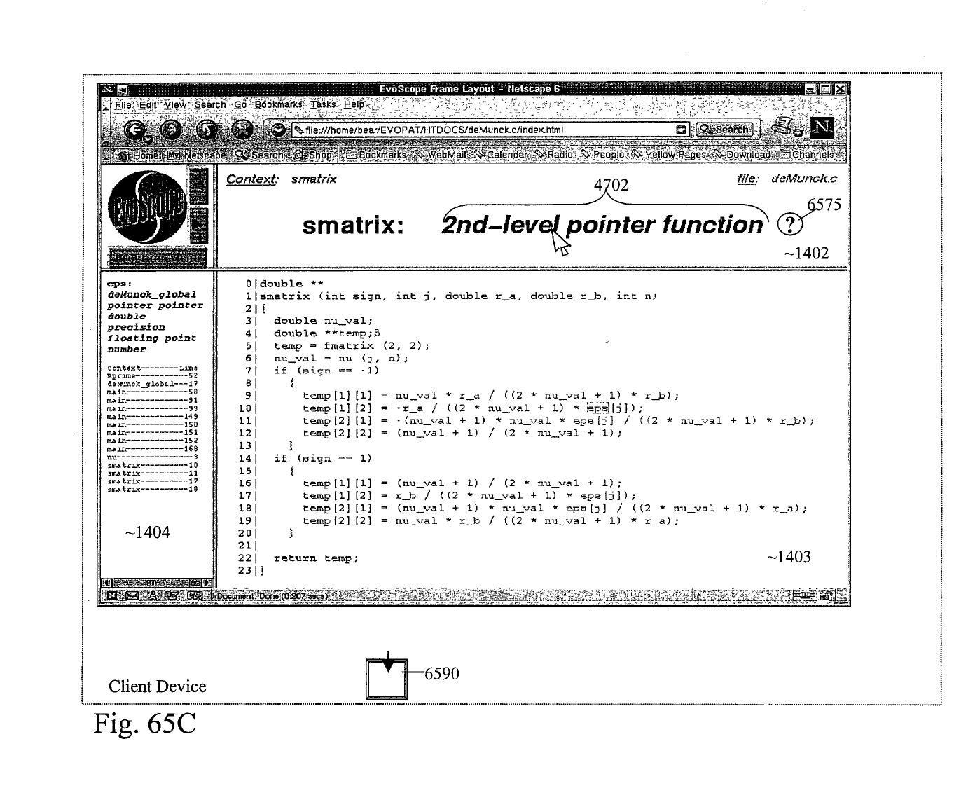

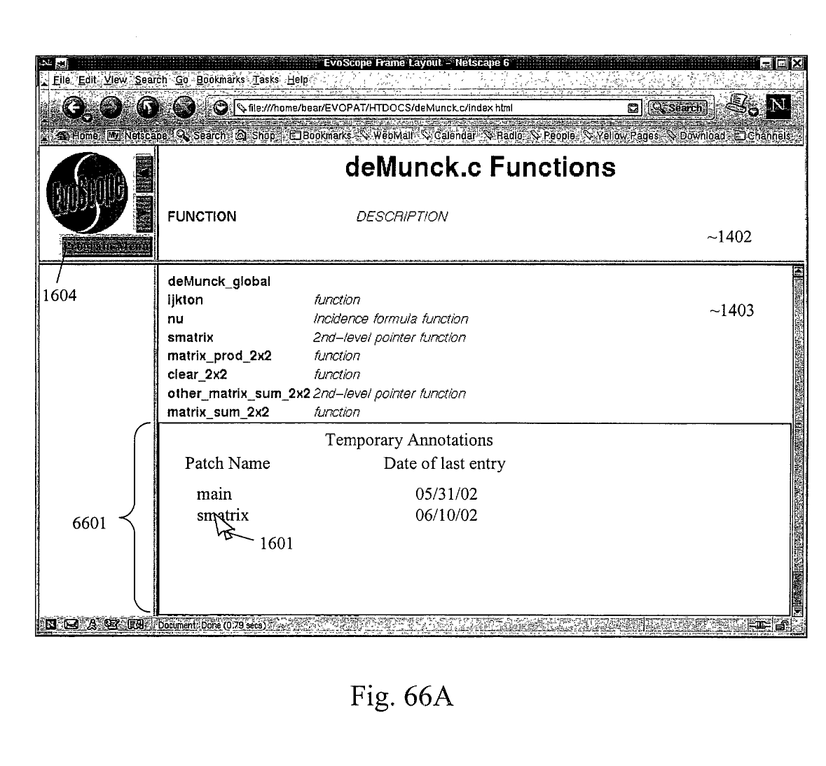

When a user places the cursor on an element in the display and performs a predefined action (e.g., issues an extended click with a predefined key 6590 (FIG. 65A), or perhaps hitting a particular combination of keys) a temporary annotation form function appropriate for that element is called.

In this embodiment, in response to the predefined action, called a comment click action, a comment/query popup entry-edit form 6510 is generated by execution of the temporary annotation form function on the client device, e.g. the device that includes display 6450A. For example, in FIG. 65A, a manager has logged into temporary roll-up annotation documentation 6440B and is reviewing patch smatrix (See FIG. 19) on display 6450A of the client device.

The manager has a question concerning this patch. The manager places cursor 1601 near subtitle 4702 in patch heading frame 1402 and performs the comment click action, which, in this example, is pressing key 6590 and clicking the mouse. This action calls a temporary annotation form function for a patch subtitle that in turn generates comment/query popup function entry-edit form 6510.

As in the embodiments of web annotator 270 described above, in one embodiment, there are a plurality of comment/query popup forms, e.g., forms for variables, footnotes, etc. Accordingly, form 6510 is illustrative only and is not intended to limit the invention to this specific embodiment.

In this embodiment, form 6510 includes a plurality of windows and a plurality of options choices. Window 6511 is an email address window. If the user enters an e-mail address in the window and subsequently activates save button 6541, an e-mail is sent to the e-mail address that includes the webpages displayed in frames 1402 to 1403.

Query window 6521 is used to ask a question concerning function smatrix, in this example, or in more general terms, a question concerning the element selected by the user. Window 6522 serves a dual purpose. Window 6522 also permits another user to provide a response to a query that is shown in query window 6521, and/or to provide comments.

In this example, the user is given the capability to choose who can see the query and/or comments, who can edit the query/or comments, and who can delete the query and/or comments. Also, the user is given the option of choosing whether the user's name is associated with the comments. In one embodiment, a default is provided for each set of options. The options presented in form 6510 are illustrative only. Depending on the particular application of this embodiment of the invention, options are chosen for form 6510 that are appropriate for the particular application.

Assuming that the manager enters a question in window 6511 for a programmer, as illustrated in FIG. 65B, and activates save button 6541, the current temporary annotation form function generates a command to a temporary annotation agent function in temporary roll-up web annotator 6470 (FIG. 64) on server 6301 that corresponds to the current temporary annotation form function. The command includes the data in form 6510.

In this embodiment, the temporary annotation agent function first saves the temporary annotation in temporary metatree 610T in the same manner as described above for a footnote. Specifically, a special temporary query symbol 6575 (FIG. 65C) is added at the end of the line in a manner similar to a footnote symbol, e.g., upon an onMouseOver event a tooltip is displayed that includes the query.

Note that if a comment instead of a query had been entered in form 6510 (e.g., window 6521 was empty and window 6522 contained data) a special temporary comment symbol would be added at the end of the line. If there were multiple comments associated with a particular line, multiple special temporary comment symbols would be added at the end of the line. Upon an onMouseOver event for a particular special temporary comment symbol, a tooltip is displayed that includes the comment.

Various alternatives may be implemented. For example, if the query were associated with a variable in a line of code, special temporary query symbol 6575 would be added to the end of the line containing the variable. In addition, the variable would be highlighted so that a user could quickly identify that (i) a query was associated with the line of code and (ii) to which portion of the line of code the query was directed. A similar approach could be used for a comment. Any information necessary to implement such features would also be saved in temporary metatree 610T by the temporary annotation agent function. In one embodiment, the temporary comments are saved in files that are equivalent to the .sat files (e.g., the .tat files) in the metatree 610T. These files include an equivalent key structure so that the comments and/or queries can be located and inserted appropriately in the webpages in temporary roll-up documentation 6440B, or extracted by a generator other than a hypertext page generator.

In one embodiment, the key structure for file *.tat incorporates, as prefixes, all of the key structures in Table 3 for file *.sat, but has an extension for qualifying the information as temporary and possibly restricted. This extension consists of (1) a user “screen name”, (2) a group or topic name, (3) a permission bitmask, and (4) a date-time stamp. The screen name is a key into a hash (or hash file) containing more details about the user, including his authorized group membership and permission codes, email addresses, pager and phone numbers, notice schedules, etc. The group/topic name is the key into a group/topic hash (or hash file) containing more details about the group/topic, such as, its members' screen names, permission categories and codes (e.g. read only, change, delete, etc.), encryption keys to decode group/topic annotation content, and the date/time when the group/topic expires. The permission bitmask is used to test whether the current user has permission to access the information in the temporary annotation, and what actions are authorized. The date-time stamp is used to report the posting date-time of the temporary annotation (e.g. in the annotation display), and to check this posting time against the expiration date-time of the group/topic. Since the annotation key is also the name/ID or the HTML trigger symbol tag containing the annotation, making up the URL extension of the trigger symbol in the webpage where it appears, it provides the means for accessing the annotation. Whenever a new temporary annotation is posted to the webpage using the web annotator, this URL may be included in roll-up bookmark lists, and may be contained in an email message immediately sent to all group/topic members. Further notices to pagers and telephones may be sent simultaneously according to user notice schedules, notifying users that new temporary annotations have been posted to the website.

Next, the temporary annotation agent function executing on server 6301 uses library functions from hypertext page generator 230 to regenerate the webpage, which is transmitted to the user and which is stored in temporary roll-up annotation documentation 6440B. FIG. 65C is an example of the regenerated page that includes query symbol 6575 in frame 1402 to indicate that a query is associated with subtitle 1402.

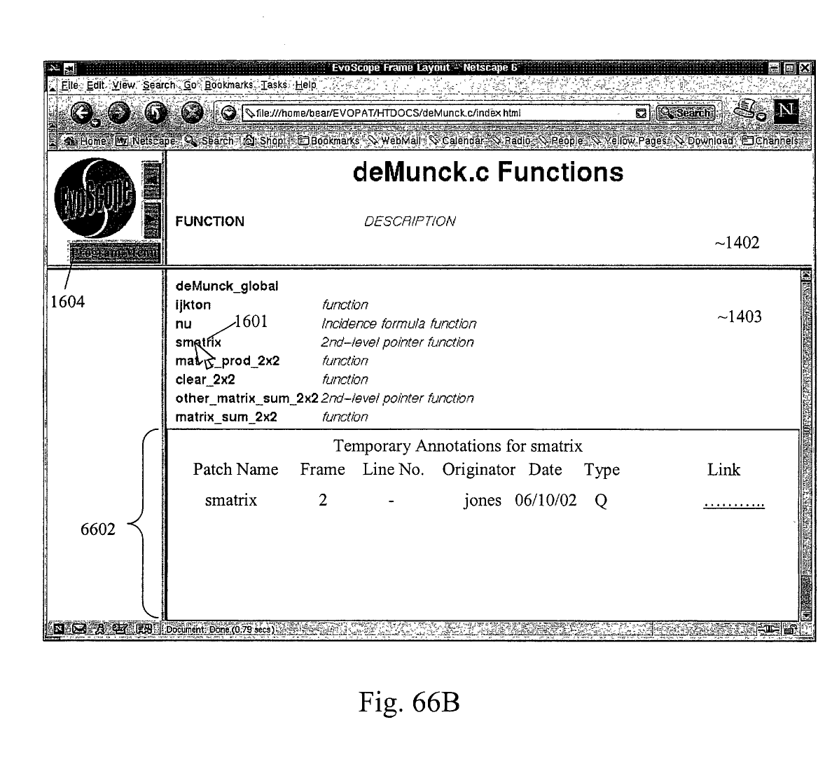

In addition, the temporary annotation agent function updates files in metatree 610T that are affected by the new comment information. In this embodiment, temporary annotation summary webpage(s) are generated to provide an index of the various temporary comments. A first page 6601, i.e., a temporary annotation patch list, includes a list of all the patches that include at least one temporary comment. (See FIG. 66A.) Each patch name is a link to a second page 6602 (FIG. 66B) that is a list of the temporary annotations for that patch. Hence, page 6602 is a list of temporary annotations in patch smatrix. Each entry in the list includes an identifying description that in turn includes information such as the user identification, patch name and date for the comment, and a link to the webpage including the comment.

Accordingly, the temporary annotation agent function regenerates the appropriate webpages in temporary roll-up metatree 610T based upon the file or files that were modified in metatree 610T and saves these webpages in temporary roll-up annotation documentation 6640B. Next, the temporary annotation agent function regenerates the temporary annotation summary webpages using the data in metatree 610T and saves these webpages in temporary roll-up annotation documentation 6640B. Hence, the agents in this embodiment have a functionality that is similar to the agents associated with web annotator 270 and in addition have some additional functionality associated with the particular application in which the agents are used.

When a programmer logs onto temporary roll-up annotation documentation 6440B, the programmer scans page 6601 and determines that based upon the date of the last temporary annotation, patch smatrix includes a temporary annotation that should be reviewed. The programmer clicks on smatrix in page 6601 and page 6602 is loaded from server 6301 into display 6450B of the client device. Clicking on the link in the line with date Jun. 10, 2002 in page 6602 causes the page with the corresponding address to be loaded into display 6450B (See FIGS. 64 and 65C). Hence, the programmer is presented with the display illustrated in FIG. 65C.

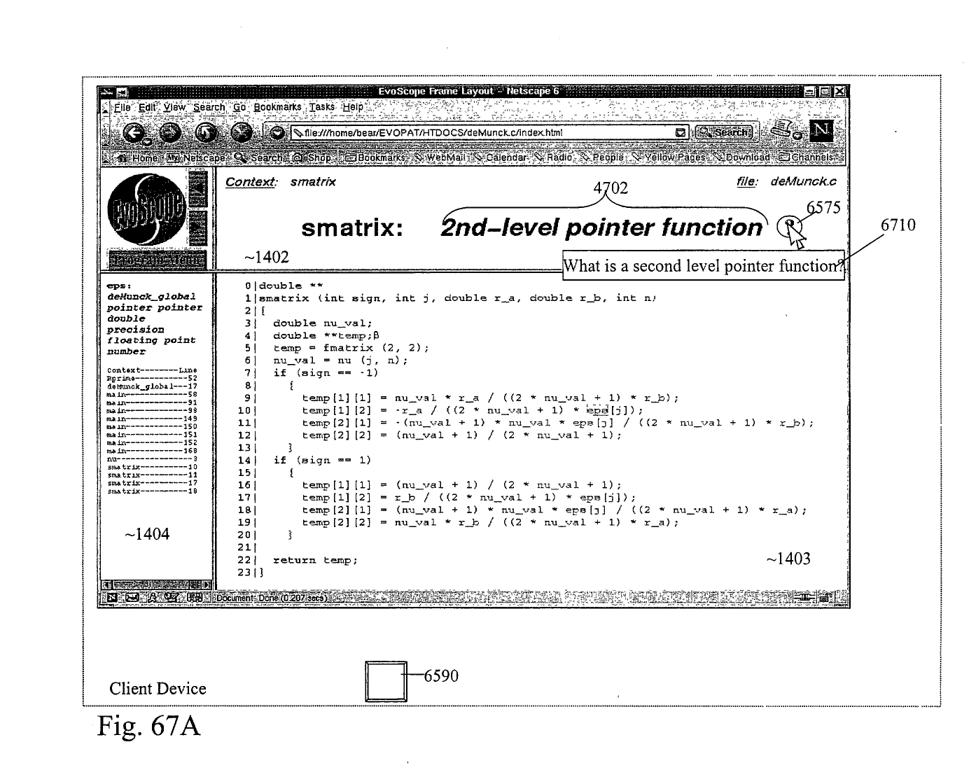

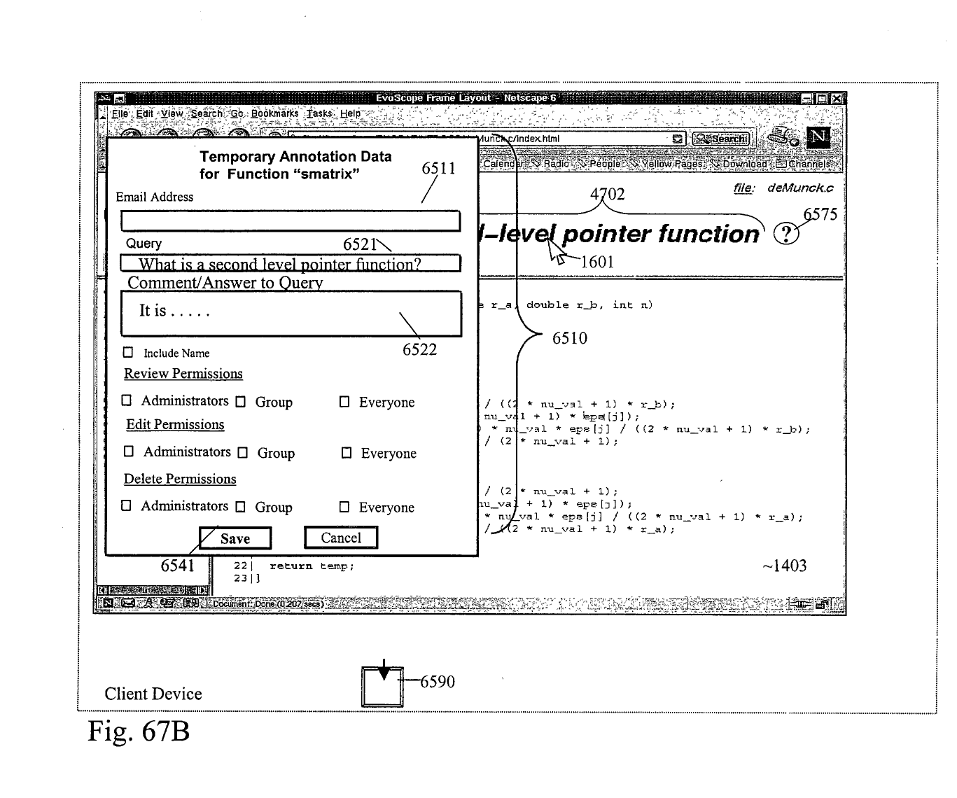

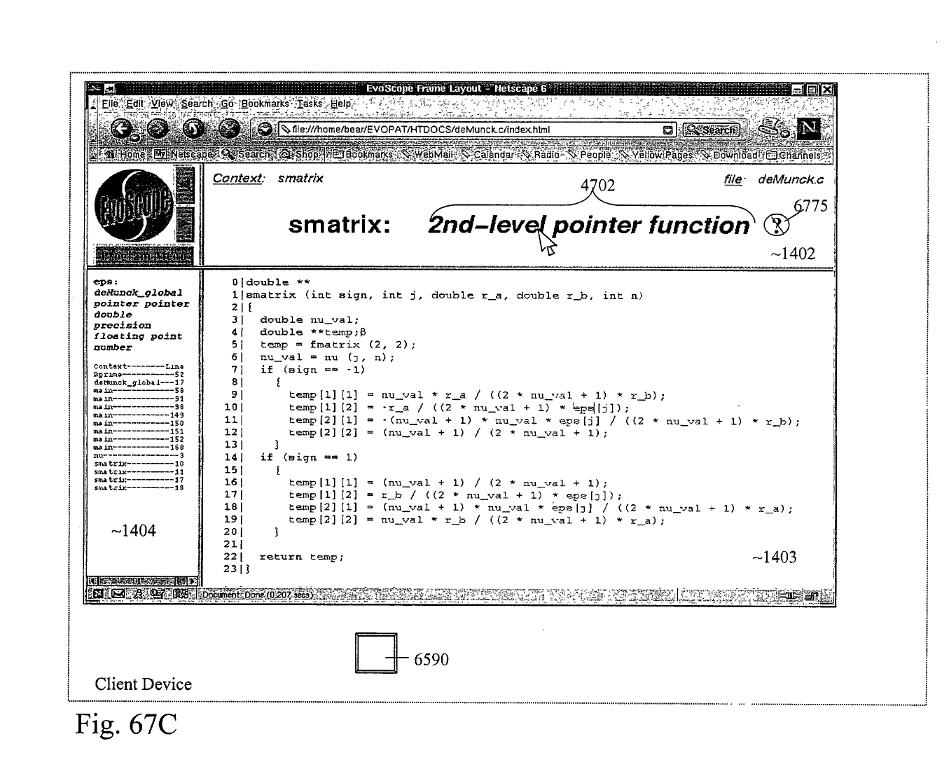

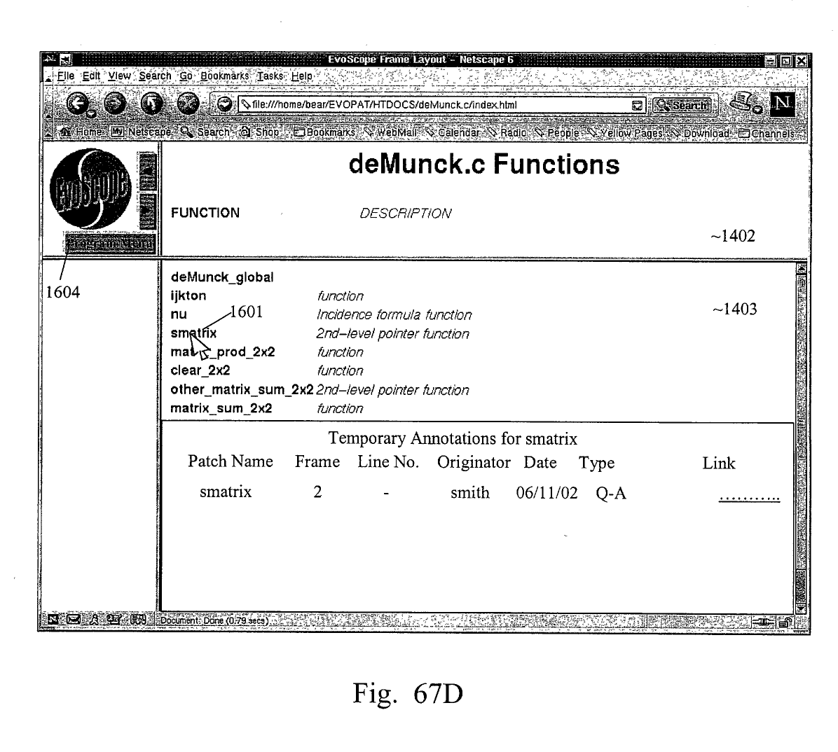

When the programmer does a mouseover of symbol 6575, the programmer can read the query in tooltip 6710 (FIG. 67A). This display still includes all the links and other information associated with documentation 6440B so that if necessary the programmer can follow the documentation before responding to the query.

When the programmer is ready to answer the query, the programmer moves cursor 1601 to the position illustrated in FIG. 67B and hits the key combination required to generate form 6510. However, now the form includes the query in window 6521.

The programmer enters a response in window 6522 and hits save button 6541. The process invoked by the hitting save button 6541 is similar to that described above, except now the temporary annotation agent function inserts a link in the query tooltip that accesses the response. Also, the temporary annotation agent changes the special temporary query symbol from a question symbol to an answer symbol 6775 (FIG. 67C).

Specifically, the temporary annotation agent function makes the changes to temporary roll-up metatree 610T to implement these changes and then regenerates the webpages. The regenerated webpages are sent to display device 250 and saved in documentation 6640B. The data in metatree 610T corresponding to the link and associated description in the temporary annotation summary webpage are updated and then the temporary annotation summary webpages are regenerated. The regenerated summary webpage produces the display in FIG. 67D. The name is that of the programmer that generated the answer to the query and the type is Q-A to indicate that there is now both a query and an answer.

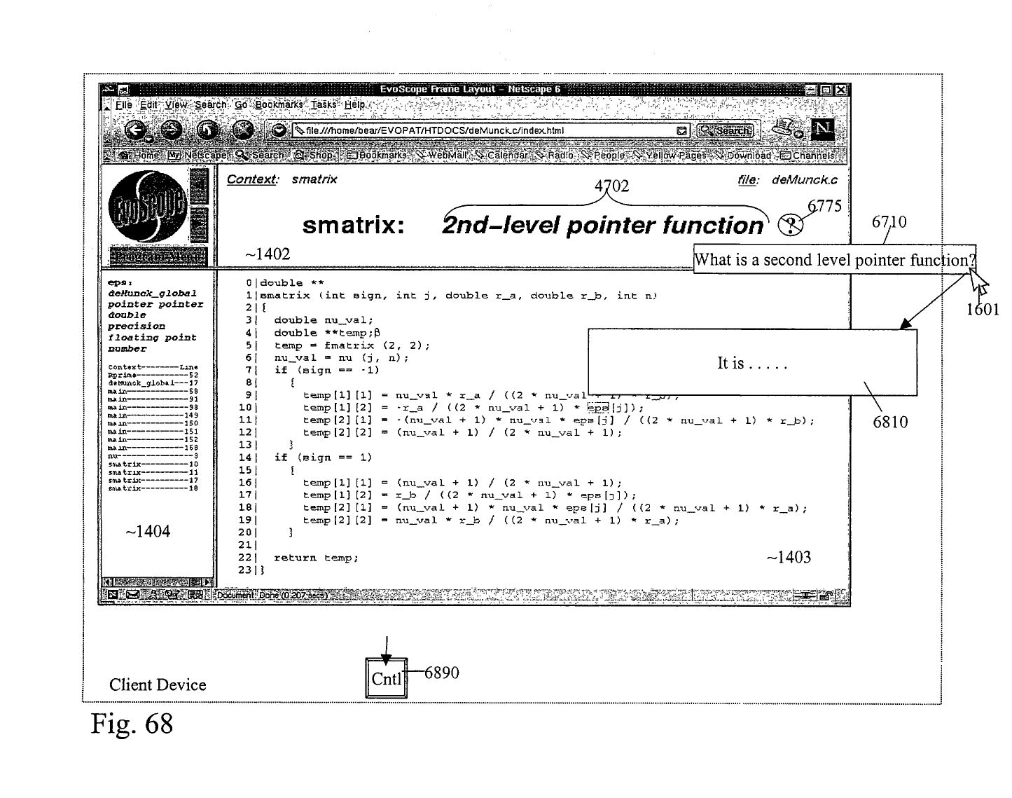

When the manager goes to the display for patch smatrix and does a mouseover of answer symbol 6775 (FIG. 68), tooltip 6710 appears with the original query. However, the question mark at the end of the query is now a link. Hence, if the manager holds control key 6890 down, positions cursor 1601 on the link, and clicks a mouse key, a popup answer window 6810 is presented that contains the answer to the query.

Temporary roll-up web annotator 6470 has many applications in addition to the query/answer application described above. In another example, a user is reviewing rapid comprehension source documentation 6440B and simply wants to insert personal comments to assist the user in the future. For this embodiment, form 6510 could be used as described above, or alternatively, the form could have a single window 6522 with save and cancel buttons. In this case, the user would insert individual notes that would be marked by a comment symbol in the displayed webpage. Administrative controls may be used to limit this type of commenting to using a metatree that is in the user's personal directory structure.

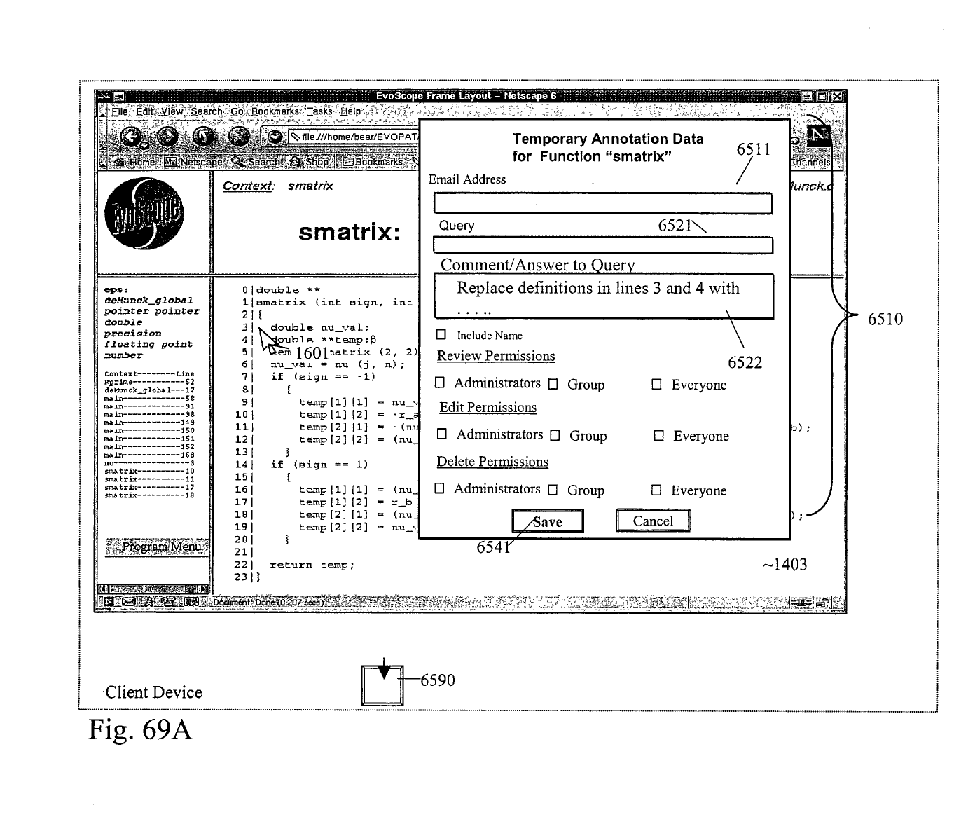

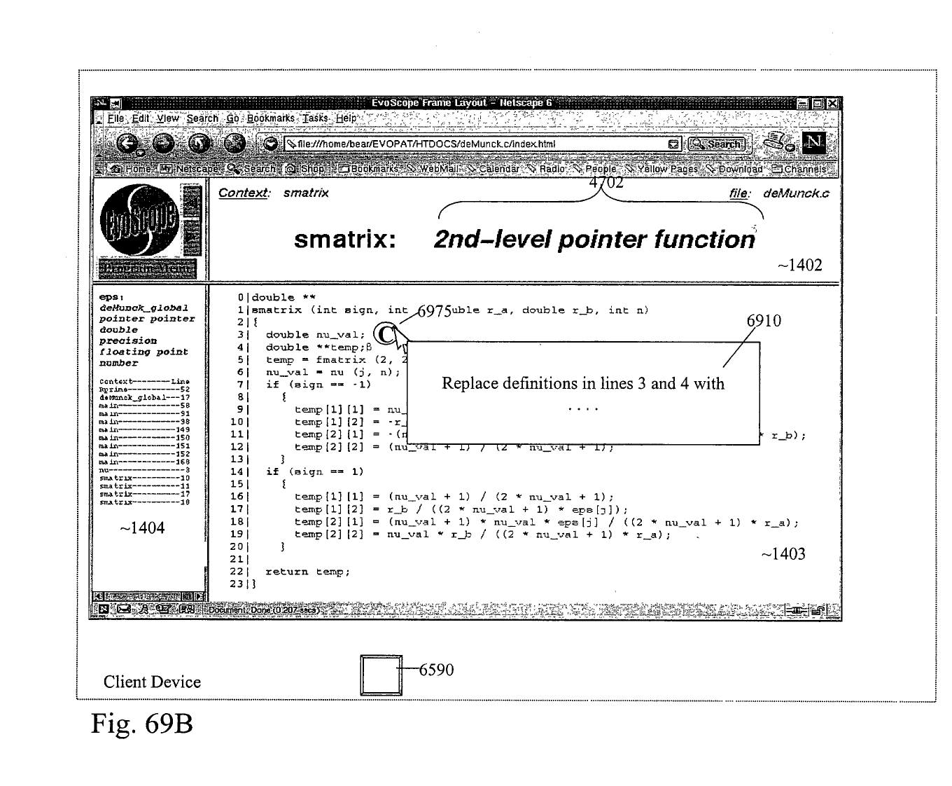

In another example, a programmer is rewriting the program code in temporary roll-up annotation documentation 6440B and is working on patch smatrix. Again, as illustrated in FIG. 69A, the programmer positions cursor 1601 on line 3 and presses the key combination necessary to launch form 6510. Here, only comment window 6522 is used.

The programmer enters comments and lines of new code in another programming language in window 6522. In this instance, the programmer can utilize the documentation features of temporary roll-up annotation documentation 6640B at the same time the user is writing the new code. The documentation features in documentation 6640B are identical to those of rapid comprehension source code documentation 240B that was described above.

When the programmer is satisfied with the new code, the programmer hits save button 6541. The actions of the embedded temporary annotation function and the corresponding temporary annotation agent function on the server are the same as described above and that description is incorporated herein by reference. FIG. 69B illustrates the regenerated webpage that is provided to the programmer. The programmer can view the new code lines for line 3 by doing a mouseover of comment symbol 6975 in line 3, which produces tooltip 6910.

Hence, in this embodiment, all these manual temporary entries are rolled up into metatree 610T. The programmer can extract the comments using new app/file generator 6380A. In this case, new information 6385A is the new computer program source code, which in turn can be processed to generate rapid comprehension source documentation for it.

Various permutations and combinations of these examples are possible. When a number of individuals are editing a rapid comprehension source documentation for a source code file (e.g., a text document, a musical score, or a CAD program) each person may have a different idea regarding the changes to be made. In this case, each person can insert a comment, which is indexed in the comment summary page. A lead editor can choose among the various options, or write a new entry based on the information in the various options.

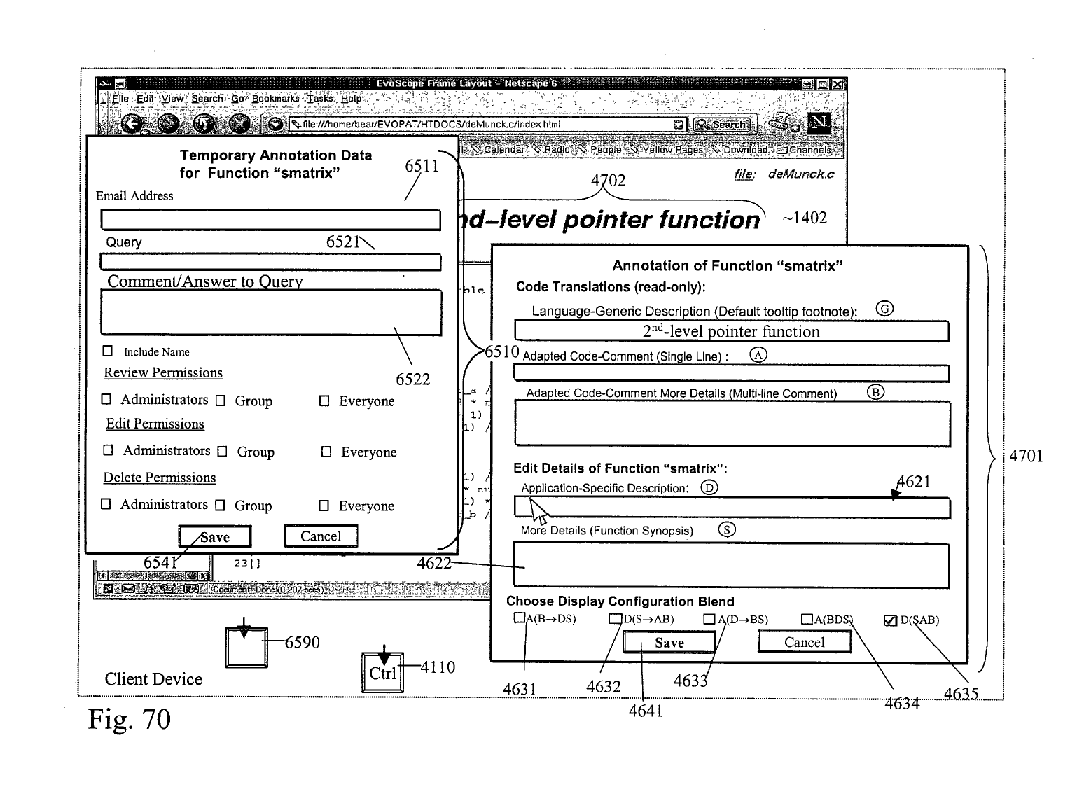

This option is particularly useful when combined with the web annotator capability. In this example, temporary roll-up annotation documentation includes both embedded temporary annotation functions and embedded web-annotation functions. FIG. 70 is a display of such an application on a client device. Web annotator form 4701 is first opened in the same manner as described above. Next, a user enters a manual-specific description, i.e., content (D), in window 4621. The user then hits the key combination to generate temporary annotation form 6510. In this example, the temporary annotation is inserted as a tooltip in the manual-specific annotation associated with content (D) of window 4621. If multiple users insert a comment tooltip within content (D), the lead editor can review each of the comments concerning content (D).

Many of the various features described above are facilitated by the multiple association significance of the key structure for the keys of hashes %annostat and %annotation. The key structure <patchname><line_number><symbol_ordinal> for hash %annostat, and <patchname><line_number><column><redundancy> for hash %annotation as described above, provides unique hash indexes.

In addition, the keys can be used as an identifier symbol for markup tags. As explained above, the identifier symbol for an annotation contains three fields, separated by an underscore, and potentially a fourth field if an alphabetic character is attached. In the identifier symbol, the first of the fields, patch, is the patchname. The second field is the line number, line#, and third field is the column number col#. If there is more that one footnote associated with the same column, in the anchor for the second and any subsequent footnotes, the column number is followed by a letter, i.e., an alphabetic sequence character field denoting the sequence of extra footnotes emanating from the same column position. In this case, the actual footnote symbol is offset from the original column position, which is occupied by the symbol identified by the key without an alphabetic character.

As a lookup key, identifier symbol patch_line#_col# is used to reference the footnote text stored in the metatree in cradle file system 115. The footnote text is stored either in a hash file (e.g., hash file <patchname>.gat or <patchname>.sat) or the memory associative array %annotation, which these files aggregate into for data processing. The footnote text callout (e.g., the identifier symbol) points to the text to be displayed. Consequently, the text can be selected and highlighted.

Also, for the use as unique identifier as markup tags, the keys facilitate use as rollup bookmarks, or as index-hyperlink targets for automatic and semi-automatic index generation methods, which sort all nouns and keywords found in the annotation text (with their respective annotation keys sorted in association to generate alphabetical indexes).

The keys also are location coded references pointing to the physical location of the identifier or footnote column. The keys also are a means for extracting annotations in each line of source code from both hashes and merging the annotations in left-to-right order for generating markup tags by grepping the hashes using the prefix <patchname><line_number><column> and then sorting the resulting keys. Finally, the key structure for hash %annotation provides a mechanism for identifying different content classes, as illustrated for example above in TABLE 2.

While embodiments of the present invention have been described for a client-server configuration, in another embodiment, the various embodiments are implemented on a stand-alone computer system configuration. The client-server embodiments of the present invention may be carried out using any suitable hardware configuration involving a personal computer, a workstation, a portable device, or a network of computer devices.

Herein, a computer program product comprises a medium configured to store or transport computer readable code for a source code patcher, a metacompiler-generated parser-hasher, a hypertext page generator, a web annotator or any desired combination of these elements, or in which computer readable code for a source code patcher, a metacompiler-generated parser-hasher, a hypertext page generator, a web annotator or any desired combination of these modules are stored. Some examples of computer program products are CD-ROM discs, ROM cards, floppy discs, magnetic tapes, computer hard drives, servers on a network and signals transmitted over a network representing computer readable program code.

This storage medium may belong to the computer system itself. However, the storage medium also may be removed from the computer system. For example, a hypertext page generator module may be stored in a memory that is physically located in a location different from the processor that executes the module. The only requirement is that the processor is capable of being coupled to the memory. This could be accomplished in a client-server system, or alternatively via a connection to another computer via modems and analog lines, or digital interfaces and a digital carrier line.

For example, the memory could be in a World Wide Web portal, while display unit 250 and the processor are in personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 110A, in one embodiment, can be a portable computer, a workstation, a two-way pager, a cellular telephone, a digital wireless telephone, a personal digital assistant, a server computer, an Internet appliance, or any other device that includes the components shown and that can execute the components, or that at least can provide the display capability and input responses described herein. Similarly, in another embodiment, computer system 110A can be comprised of multiple different computers, wireless devices, cellular telephones, digital telephones, two-way pagers, or personal digital assistants, server computers, or any desired combination of these devices that are interconnected to perform, the embodiments as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, system 110A and system 110B can be implemented in a wide variety of computer system configurations. In addition, the various components could be stored as different modules in memories of different devices. For example, source information adapter 210A could initially be stored in a server computer, and then as necessary, a portion of adapter 210A could be transferred to a client device and executed on the client device. Consequently, part of adapter 210A would be executed on the server processor, and another part of adapter 210A would be executed on a processor of the client device. In view of this disclosure, those of skill in the art can implement the various embodiments of the invention in a wide-variety of physical hardware configurations using an operating system and computer programming language of interest to the user.

The above embodiments are illustrative only and are not intended to limit the invention to the specific embodiments described. For example, while computer program source code, either tagged or non-tagged, was used as an example, the invention can be applied at other levels, e.g., to documents where the document can be defined in terms of a patch, or perhaps to music composition. In each case, the original source is processed as described and saved as a metatree in cradle. The metatree can be archived in a revision control repository if desired. The rapid comprehension document can be used to provide information about the document or musical composition for example. The website composer can be used to construct over documents or musical compositions using the patches saved in the cradle. The applications of the present invention are limited only by the ability to define and process a patch for the particular application. Upon the definition of a patch for a particular application, one of skill in the art can use any desired combination of the various features described above to achieve a new level of understanding and documentation.

### SOURCE CODE MAINTENANCE CONTROLLER 120B

As illustrated in FIG. 1B, in one embodiment, system 100 includes a source computer program code maintenance controller 120B that maintains in cradle 115 a reversible historical and multi-lineal version lattice via a version control system. This enables concurrent development, maintenance and production in multiple versions and branches of progressive modification of source computer program code, and rapid comprehension source code documentation 240B.

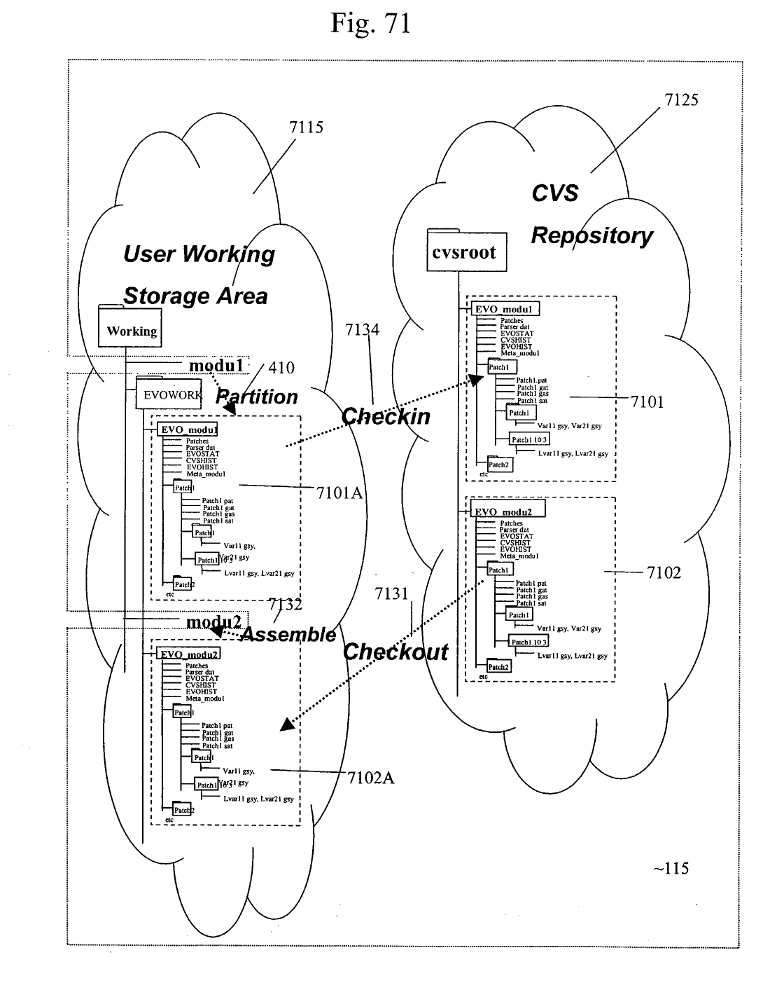

Source computer program code maintenance controller 120B details the historical maintenance and version control of source computer program files modu1, modu2 . . . in lock step with the rapid comprehension source code documentation 240B stored in metatrees 7101, 7102 (FIG. 71) for each of source computer program files modu1, modu2 . . . , respectively. As explained more completely below, source code maintenance controller 120B manages structures internal to cradle 115 including a global historical repository 7125 and a temporary storage area, which are background storage areas.

In one embodiment, source code maintenance controller 120B maintains source computer program files modu1, modu2 . . . in exploded metatrees 7101, 7102 using a version control system. One version control system suitable for use with this invention is an industry-standard Concurrent Versions System (CVS). As is known to those of skill in the art, CVS supports concurrent version control, which means that copies of source computer program file modu1, for example, can be worked on concurrently by multiple programmers.

The CVS unit of maintenance is a CVS module. In this embodiment, the CVS module is a directory-tree of source computer program files or a directory-tree of a single source computer program file. As explained above, a module file is a source computer program file containing one or more program elements, such as subroutines, functions, or tagged containers. Also, as explained above, metatree 7102 includes the source content of module file modu2 and in addition includes documentation for module file modu2.

As explained more completely below, when module file modu2 is checked out via checkout process 7131 for revision by an application programmer, source code maintenance controller 120B copies the most current version of metatree 7102 to user working storage area 7715 as metatree 7102A. Via an assemble process 7132, which is described more completely below, source code maintenance controller 120B assembles metatree 7102A into module file modu2 by stripping out the annotation. However, in one embodiment, the comments in the original source code are left in module file modu2. Module file modu2 is delivered to the application programmer's workspace 7715 for editing, testing, debugging and so forth.

Conversely, when revised module file modul in application programmer's workspace 7715 is checked in by source code maintenance controller 120B, after having been checked out via module checkout process 7131, the text of revised module file modu1 must be partitioned back into the patches (subroutines, functions, markup container tag-pairs, etc.) and associated documentation files that make-up metatree structure 7101. While module check-in process 7134 is complex, as described more completely below, the essential cyclic concept of module checkout process 7131 and module check-in process 7134 is illustrated in FIG. 71.

Thus, while in cradle 115, a module file is stored as a metatree, the programmer need not regard the module file as such, nor even be aware of the metatree. In this sense, the programmer's view of the module file undergoing revision control is as if it were a single file, except that its name is prepended with EVO_ in this embodiment.

Archived metatrees 7101, 7102 . . . are permanently stored in a historical revision control system (RCS) format in CVS repository 7125. All versions of each metatree 7101, 7102, and consequently each module file modul, modu2, . . . , respectively, exist in a retrievable state throughout the history of changes to the module file. CVS repository 7125 is therefore considered a permanent archive of cradle 115.

As indicated above, module checkout process 7131 retrieves a version of one metatree into the user's working directory, and then assembles the metatree into a module file. Likewise, conceptually, module check-in process 7134 does the inverse process, i.e., partitions the module file into its component patches and documentation and copies this information back to CVS repository 7125.

Module check-in process 7134 is the primary ongoing event that provides a means of enforcing documentation in lockstep with program modifications. Whenever a module is checked in via process 7134, in one embodiment, the programmer is required to annotate the source program code according to management-imposed options.

For example, if the module file is new and the programmer checking in this module file is the one who designed the file, a full annotation option is imposed. The full annotation option requires the programmer to annotate every program statement in the module file.

If the programmer was not the originator, a smart annotation option is imposed. The smart annotation option asks the programmer about specific program statements, which are particularly opaque to non-programmers, such as statements containing regular expressions that are prevalent in the Perl, Java, etc. programming languages. Candidate program statements needing annotation are identified and tagged during module check-in process 7134.

During subsequent check-ins, following checkout for modification, rigorous annotation of the changes are elicited from the programmer making the modification. These annotations and their purpose are appended to logs documenting the history of modifications. The requirement of providing documentation for each module check-in process eliminates the source of confusion that often leads to incorrect fixes in troubleshooting by temporary consultants unfamiliar with the source program code.

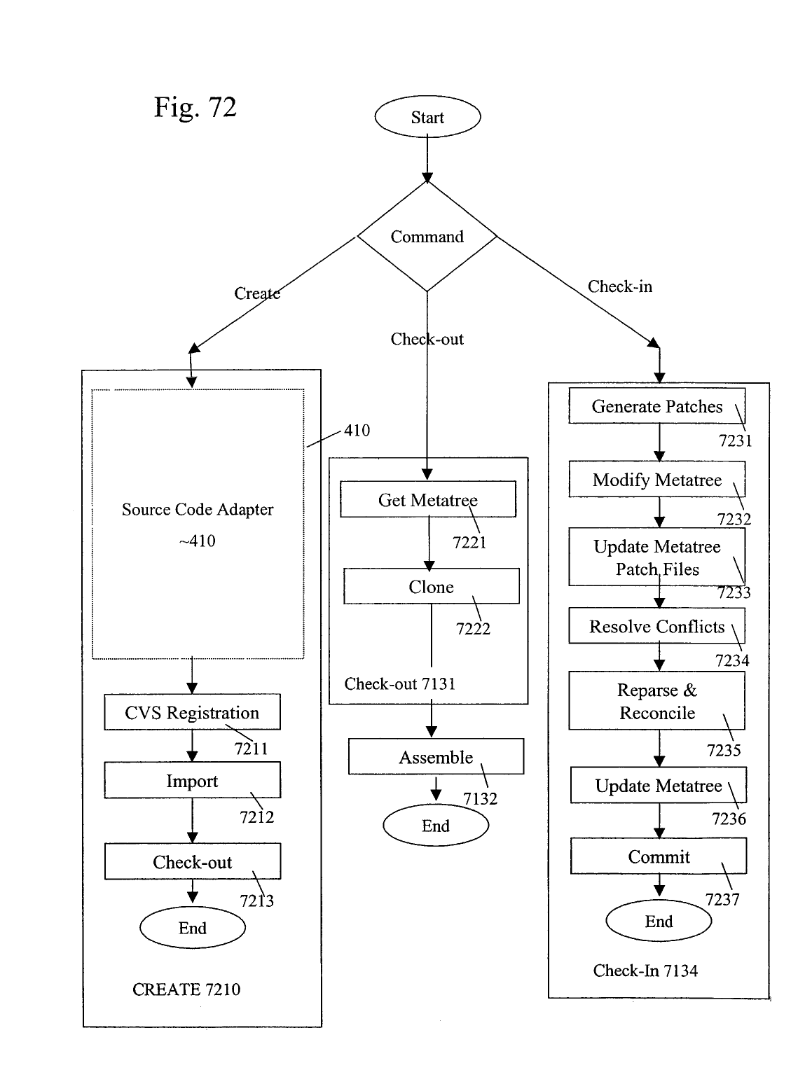

In addition to the check-in and checkout processes, controller 120B implements a create command process. FIG. 72 is a process flow diagram for one embodiment of create command process 7210, module checkout process 7131 and module check-in process 7134 that are performed by controller 120B.

Create Command Process 7210

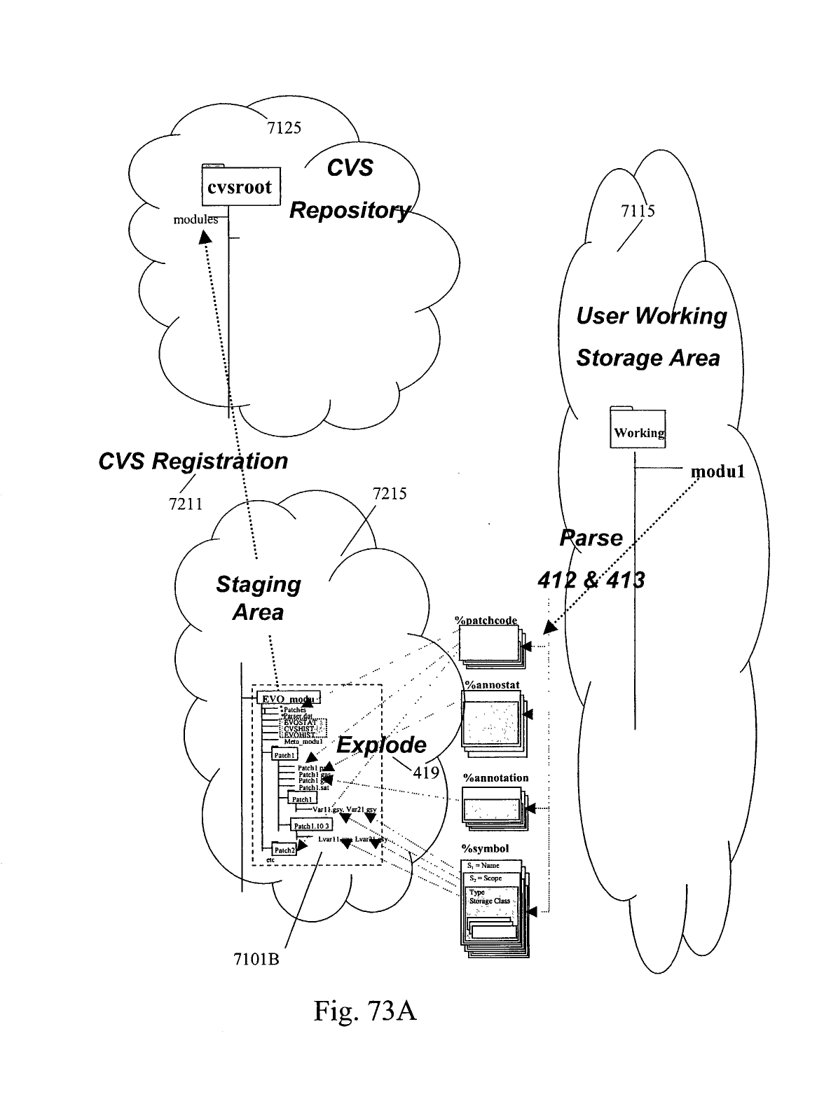

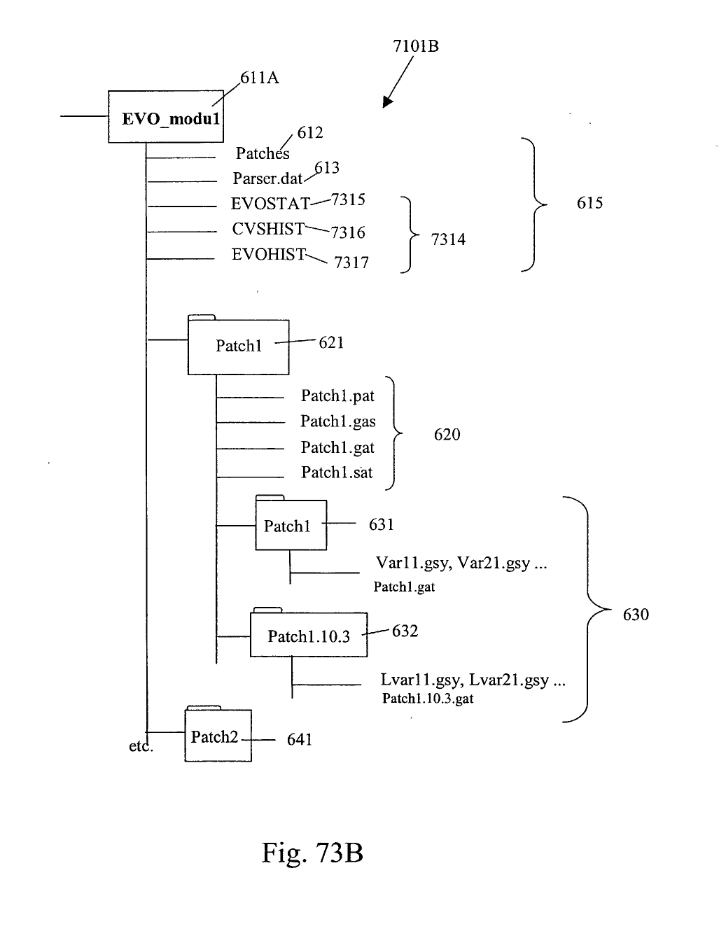

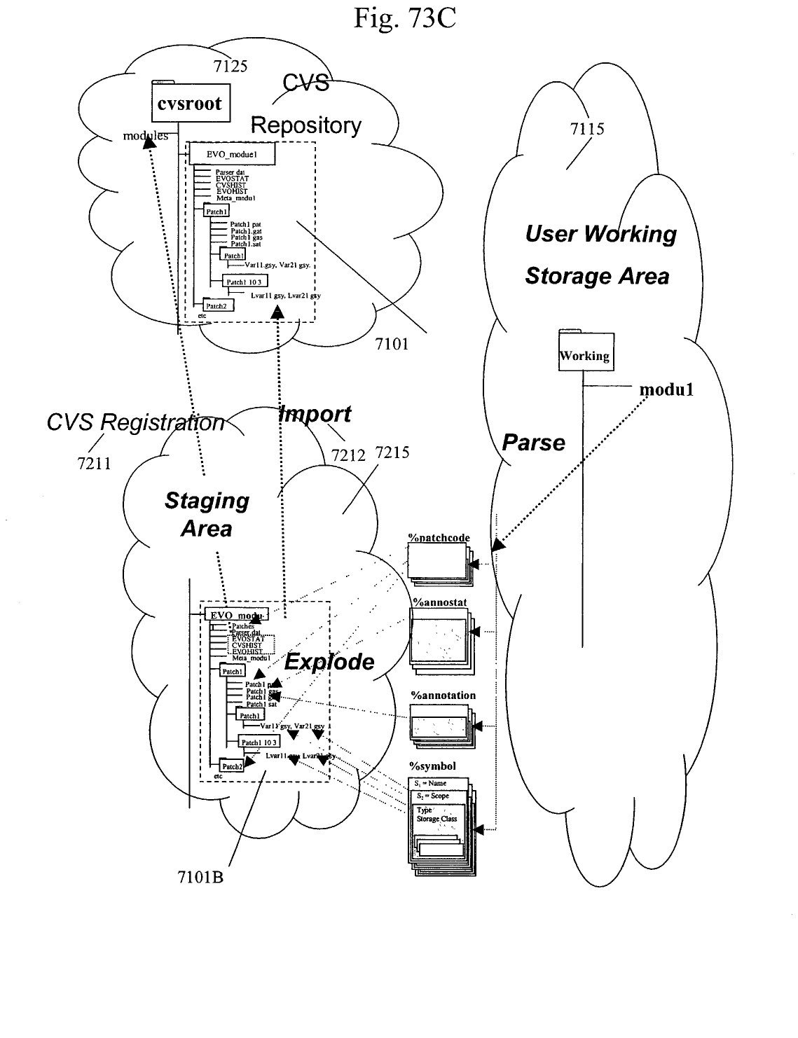

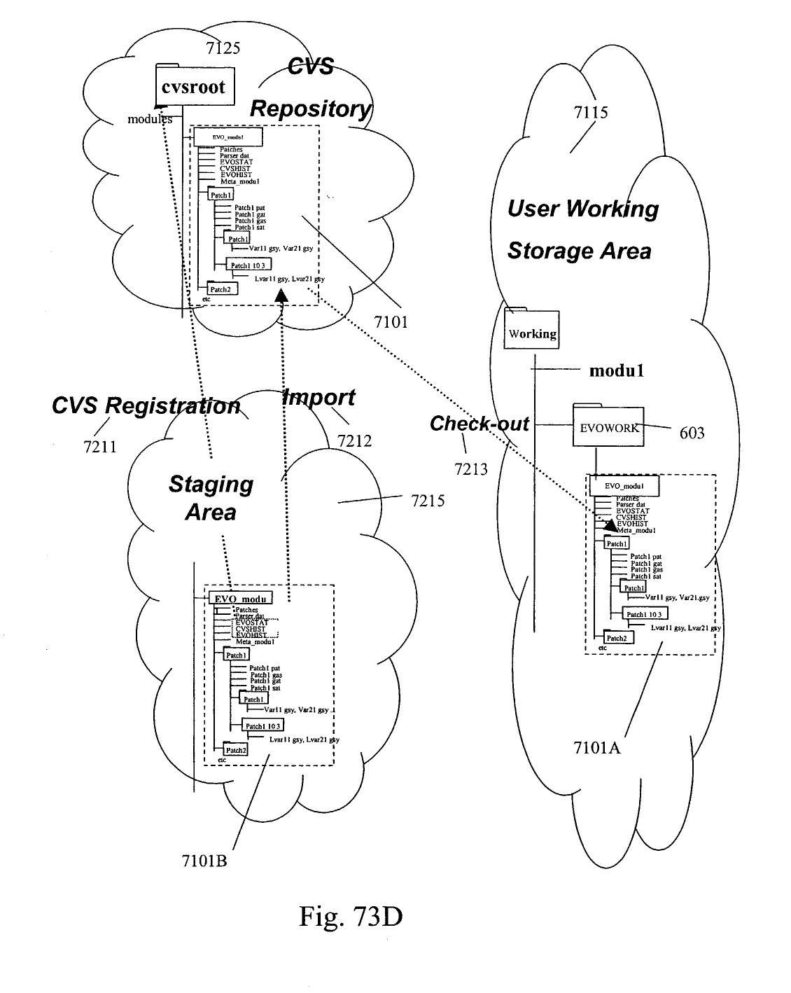

Create command process 7210 (FIG. 72) enters a module file modul into CVS repository 7125 in cradle 115 and generates a metatree 7101A (FIG. 73D) in user working storage area 7115 in cradle 115. In this embodiment, as explained more completely below, create command process 7210 includes four operations: a source code adapter operation 410 that was described above; a CVS registration operation 7211, an import operation 7212; and a check-out operation 7213.

As described above and incorporated herein by reference, source code adapter operation 410 includes a parse operation that in turn includes source-code patching operation 415 and parsing and data assimilation operation 418 (FIG. 4A). In operations 415 and 418, source computer program file modu1 is partitioned into patches, which are assimilated along with symbol references, and statement translations into a memory database of associative array data-structures %patchcode, %annostat, %annotation, and %symbol (FIG. 73A), sometimes called hashes %patchcode, %annostat, %annotation, and %symbol.

Explode module data into cradle metatree operation 419, in this embodiment, creates metatree 7101B in a temporary staging area 7215 (FIG. 73A), which in this embodiment is in cradle 115. As explained above, the list of patches in hash %patchcode is written to metatree-root file patches, and a subdirectory is created for each patch.

Within each patch subdirectory, the statistics of each symbol reference in the patch, i.e., all entries in hash %annostat pertaining to the patch, are written to hash file <patchname>.gas; and all of the code-to-prose/pseudocode translated footnotes in the patch, i.e., all entries in hash %annotation pertaining to the patch, are written to hash file <patchname>.gat. Subdirectories within the patch subdirectories are created for each variable scope within the patch, and the symbol data for each variable symbol defined within that scope are written to a hash file <symbol-name>.gsy in the scope subdirectory.

Auto-generic annotation in hash %annotation regarding the symbols are written to a file <scope>.gat in each said scope directory. Metatree 7101B has the same basic structure as described above for metatree 610.

Upon completion of source code adapter operation 410 (FIG. 72), processing transfers to CVS registration operation 7211. In operation 7211, metatree 7101B is registered as a CVS module in CVS repository 7125. An entry is entered in CVS administration file modules for metatree 7101B. This CVS module entry equates the name of the source computer program file (e.g., modu1) with the name of metatree 7101B, e.g., EVO_modu1.

Next, in CVS registration operation 7211, new metatree state file EVOSTAT 7315 and file CVSHIST 7316 (FIG. 73B) in a set of new files 7314 are inserted in the root section of metatree 7101 in staging area 7215. Files 7315 and 7316 contain keywords, which are later expanded by RCS during each checkout to convey revision control information, such as the revision number, date and time of check-in, etc. Specific formats and keywords in one embodiment of files 7315 and 7316 are given below.

File EVOSTAT 7315 is a marker file used as the carrier of an aggregate revision number of the CVS module, which in this example is module modu1. As revisions are made to individual patch files and hash files, the RCS revision numbers (e.g., internal numeric codes pertaining only to single files) get out of synchronization, because not all files are revised at the same rate.

However, file EVOSTAT 7315 is always updated whenever any other file in metatree 7101, i.e., in the CVS module, is revised in CVS repository 7125. Hence, the RCS revision number of file EVOSTAT 7315 is always the latest revision number of any file in the CVS. module. This revision number, which is the highest revision number of all files in the CVS module, is taken as the module revision number.

In one embodiment, file EVOSTAT 7315 contains four lines. The first line contains RCS keyword $Id$. When module modu1 is checked-out, RCS keyword $Id$ is expanded to give (i) the RCS archive file name, (ii) the current RCS internal revision number, (iii) the date and time, (iv) the user login, and (v) an RCS state code. In general, the current RCS internal revision number is a number pertaining only to a single file —not an aggregate of files —of the form m.n if the revision is on the main trunk of revision progression, or m.n.o.p, m.n.o.p.q.r, etc., if the revision is a branch of revision progression. Here, m.n is the version n in trunk m.

The second line in file EVOSTAT 7315 contains the RCS keyword $Name$, which is expanded, i.e., populated, by RCS on checkout to contain a symbolic tag, if one was used. If a symbolic tag was not used, the expansion is blank.

If this field is populated, the field contains a symbolic tag, e.g., an aggregate revision name for all files in the CVS module, representing either a CVS module release, e.g., a software distribution, or a CVS branch. This tag is sticky, meaning that the tag remains in force as the default for further checkouts and check-ins. If this tag denotes a branch, the tag becomes the default for further check-ins and checkouts on this branch. If the tag does not denote a branch, the tag is a release tag, which allows checkouts but disallows check-ins.

The third line in file EVOSTAT 7315 is a string {Version: version-tag}, where version-tag is a conversion of the RCS revision number into a symbolic tag, with a leading V, and with periods replaced by dashes. This conversion is performed by controller 120B and not the version control system used by controller 120B.

The fourth line in file EVOSTAT 7315 is a string {Branch: branch-tag}, where branch-tag denotes a branch, if the checkout is on a branch, or trunk otherwise. This conversion also is performed by controller 120B and not the version control system used by controller 120B.

File CVSHIST 7315 is used as a summary historical log and an index for the more detailed historical log stored in file EVOHIST 7317 that is produced by controller 120B. File CVSHIST 7315 is initialized to have two lines. The first line contains RCS keyword $Id$, this is expanded by RCS and is the same as that in file EVOSTAT 7315, described above. The second line contains RCS keyword $Log$. This keyword contains the latest log message used to check-in the CVS module. Unlike keyword $Id$, keyword $Log$ does not replace its predecessor, but rather pushes its predecessor down to create a history of logs.

Upon completion of CVS registration operation (FIGS. 72 and 73A), processing transfers to import operation 7212 (FIGS. 72 and 73C). In import operation 7212, new CVS module 7101B is imported into CVS repository 7125 using CVS command import.

In general, CVS command import is used to incorporate a directory-tree into a CVS repository from an outside source, as opposed to a CVS command add, which is used to add a single file to a repository. Execution of CVS command import does not set up the directory from which the command is invoked as a CVS working directory. Thus, the CVS module is imported first into CVS repository 7125 and then the CVS module is checked out from CVS repository 7125.

Hence, import operation 7212 transfers processing to checkout operation 7213. In operation 7213, a CVS command checkout is issued from within subdirectory EVOWORK of the user's directory WORKING with new module name EVO_modu1 as an argument (FIG. 73D). This causes the new CVS module to be copied into subdirectory EVOWORK, which is a private subdirectory of system 100. Checkout operation 7213 also establishes metatree 7101A, which is a working copy of metatree 7101 as a CVS module. CVS does this by inserting a private CVS directory into the root of the metatree, which is subsequently used by CVS to maintain status of all files in the working metatree.

Notice that the configuration of working directory WORKING is similar to that in FIG. 6A, except now metatree 7101A is a part of a revision control system and includes additional files 7314 (FIG. 73B) for use with that system.

Checkout Process 7131

When a programmer wishes to revise computer source program file modu1, the programmer wants to work on the latest version of computer source program file modu1. To assure that the programmer has the latest version, the programmer issues a command CHECKOUT with the program name, e.g., modu1, to obtain the latest version from CVS repository 7125.

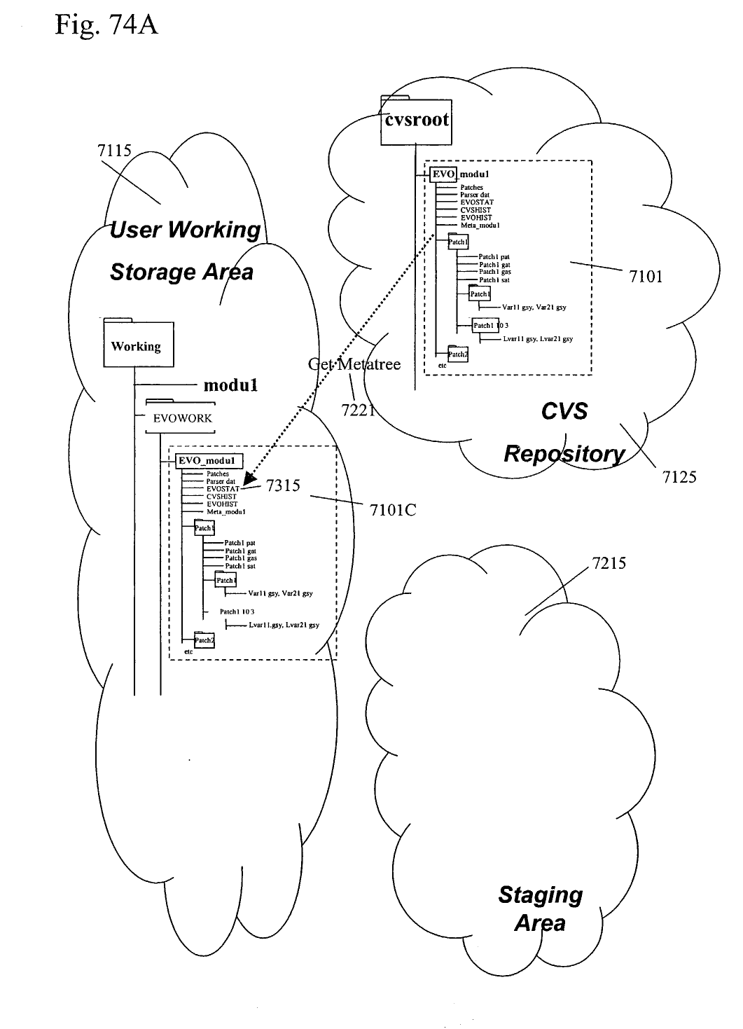

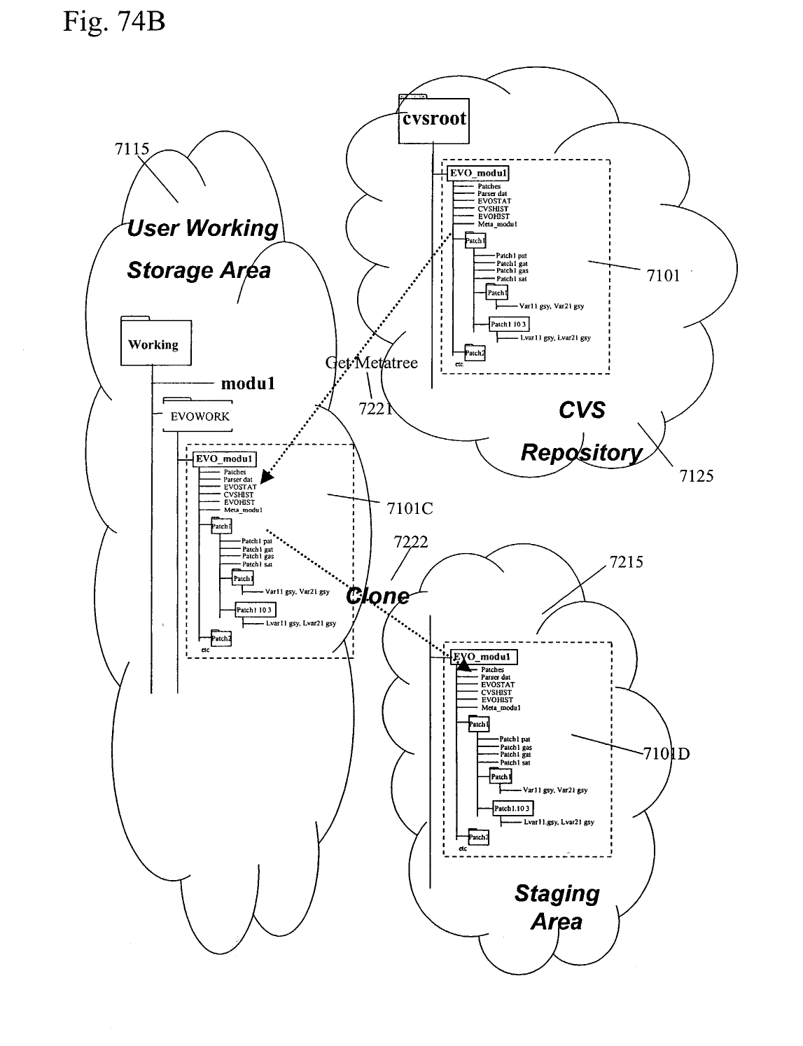

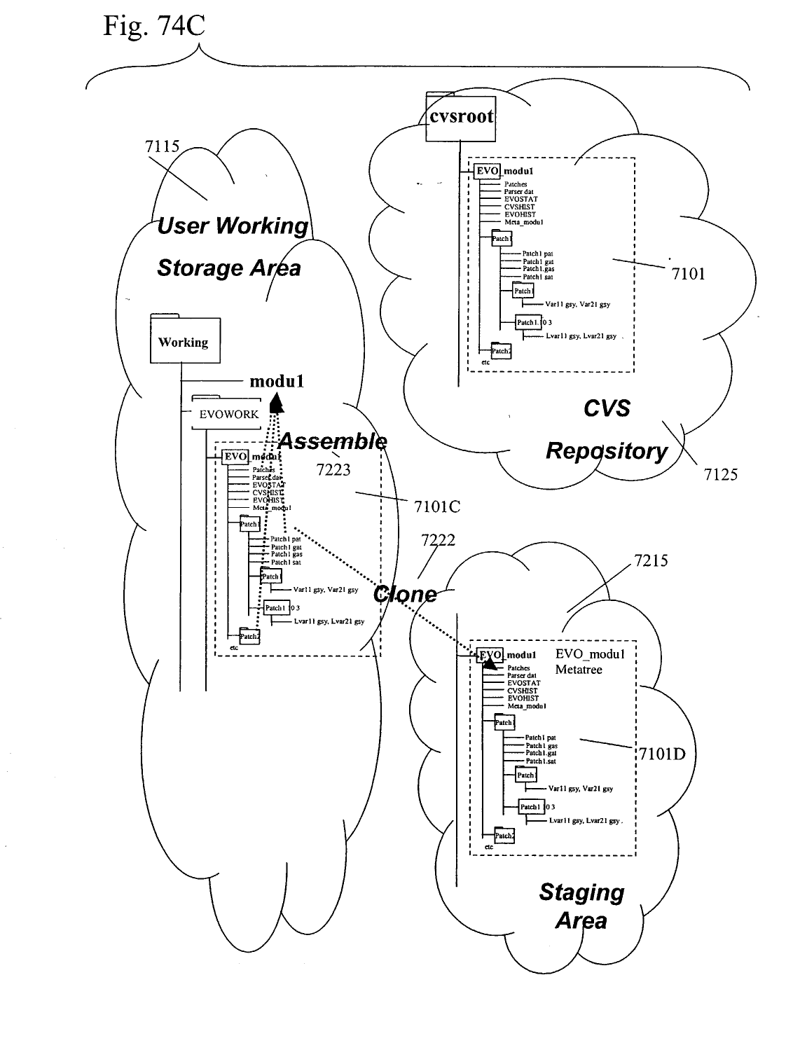

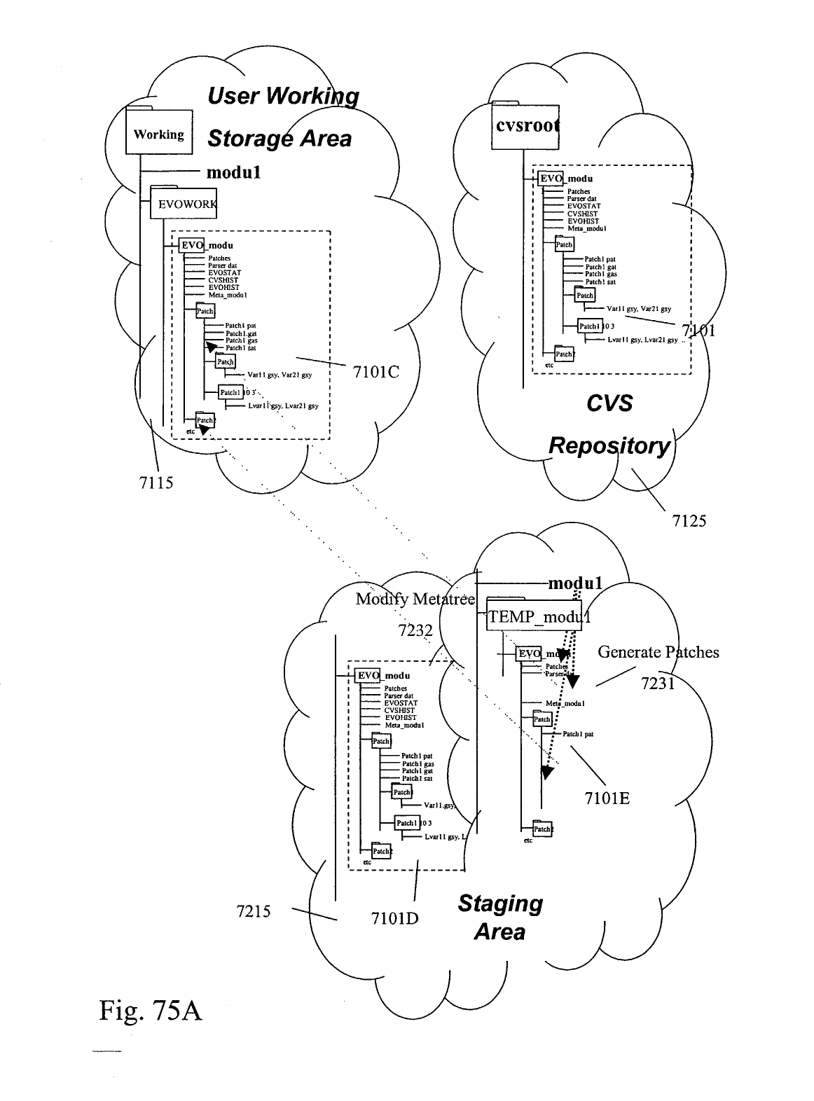

In get metatree operation 7221 (FIGS. 72 and 74A) of checkout process 7131, module file name modul is pre-pended, in this example, with EVO_ to get the name of metatree 7101. The name of metatree 7101 is employed in CVS command CHECKOUT that is used to retrieve metatree 7101 for module file modul from CVS repository 7125 in a retrieve metatree operation. In a store retrieved metatree operation, metatree 7101 is stored as metatree 7101C in private subdirectory EVOWORK of the user's working directory WORKING in user working storage area 7115 (FIG. 74A).

Finally, in get metatree operation 7221, an update file operation converts the version tag, file EVOSTAT 7315 in the metatree root of metatree 7101C from the revision number returned by RCS (CVS). Next, the branch tag is populated to correspond to the current branch from which metatree 7101C was checked out.

Upon completion of get metatree operation 7221, clone operation 7222 (FIGS. 72 and 74B) copies metatree 7101C is into temporary staging area 7215 as metatree 7101D. Metatree 7101D is persistent. Hence, clone operation 7222 generates an as checked out version of metatree 7101C for use following editing.

Upon completion of clone operation 7222, checkout process 7131 transfers processing to assemble process 7132 (FIGS. 72 and 74C). In process 7132, file patches 612 in metatree 7101C is read. All of files <patchname>.pat are assembled into module file modul in the user's working directory WORKING. Hence, assemble process 7132 restores metatree 7101C to the external computer program source form for editing, compiling, testing, etc. by the user.

Module Check-In Process 7134

One embodiment of a module check-in process 7134 performed in response to controller 120B receiving a command CHECK-IN is illustrated in FIG. 72. As described more completely below, module check-in process 7134 incorporates seven operations 7231 to 7237.

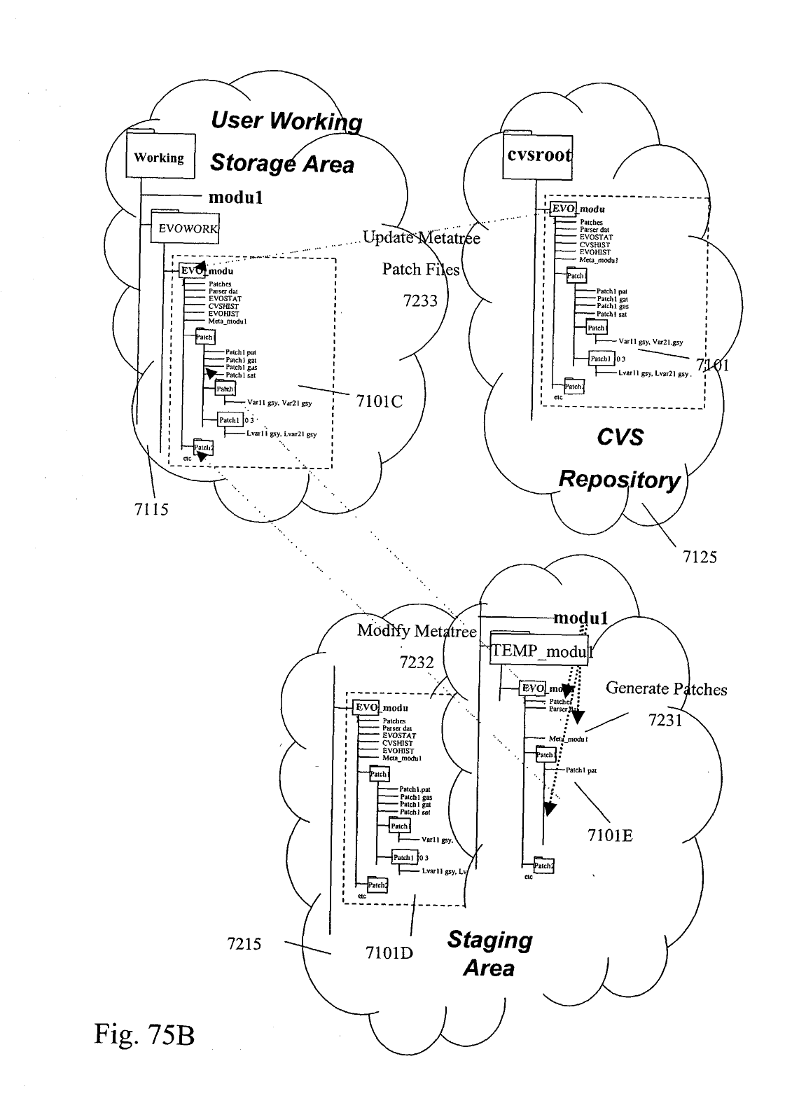

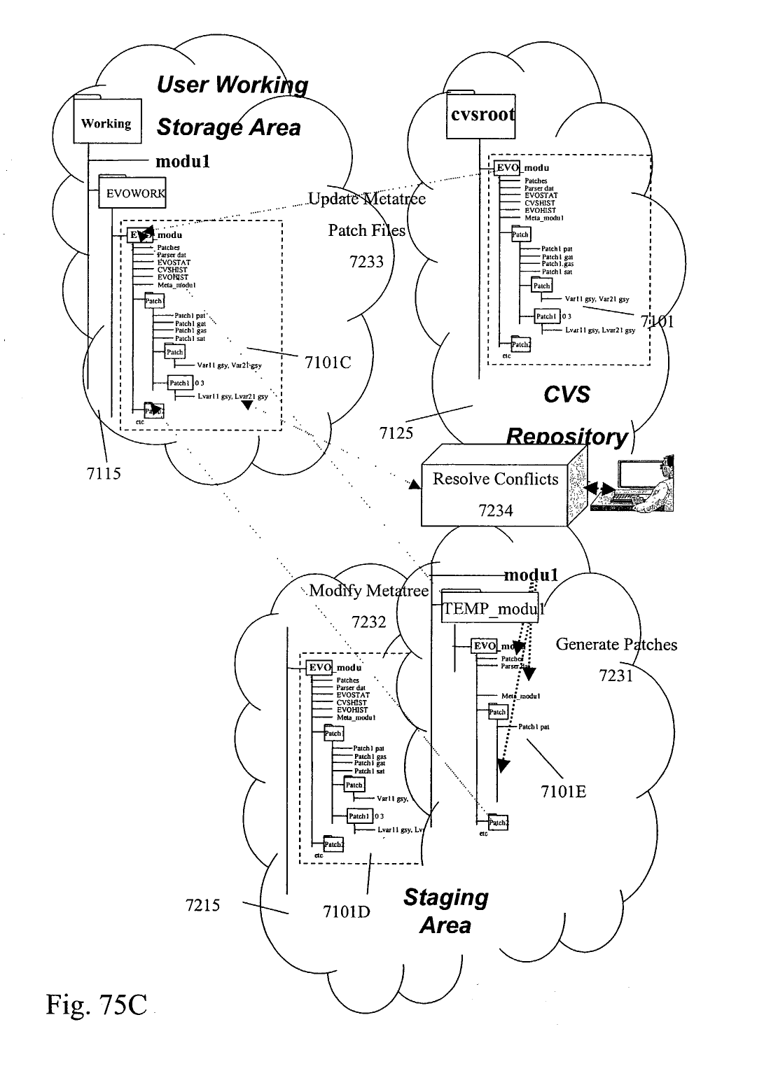

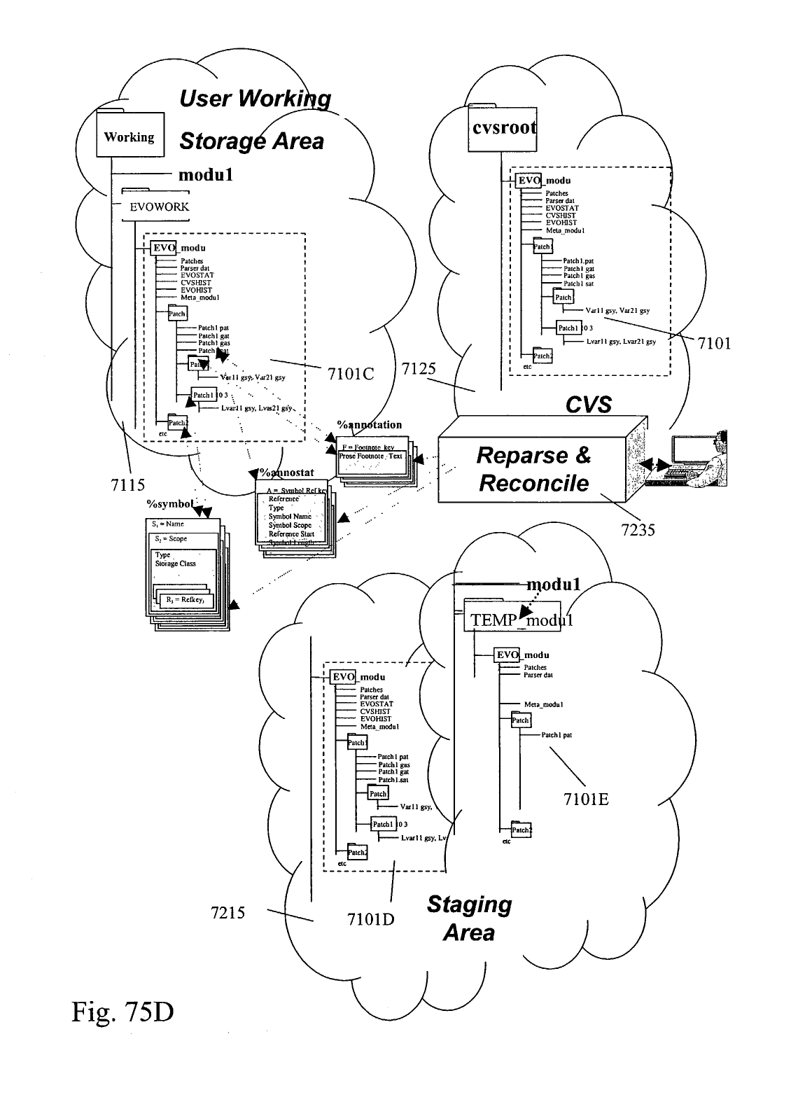

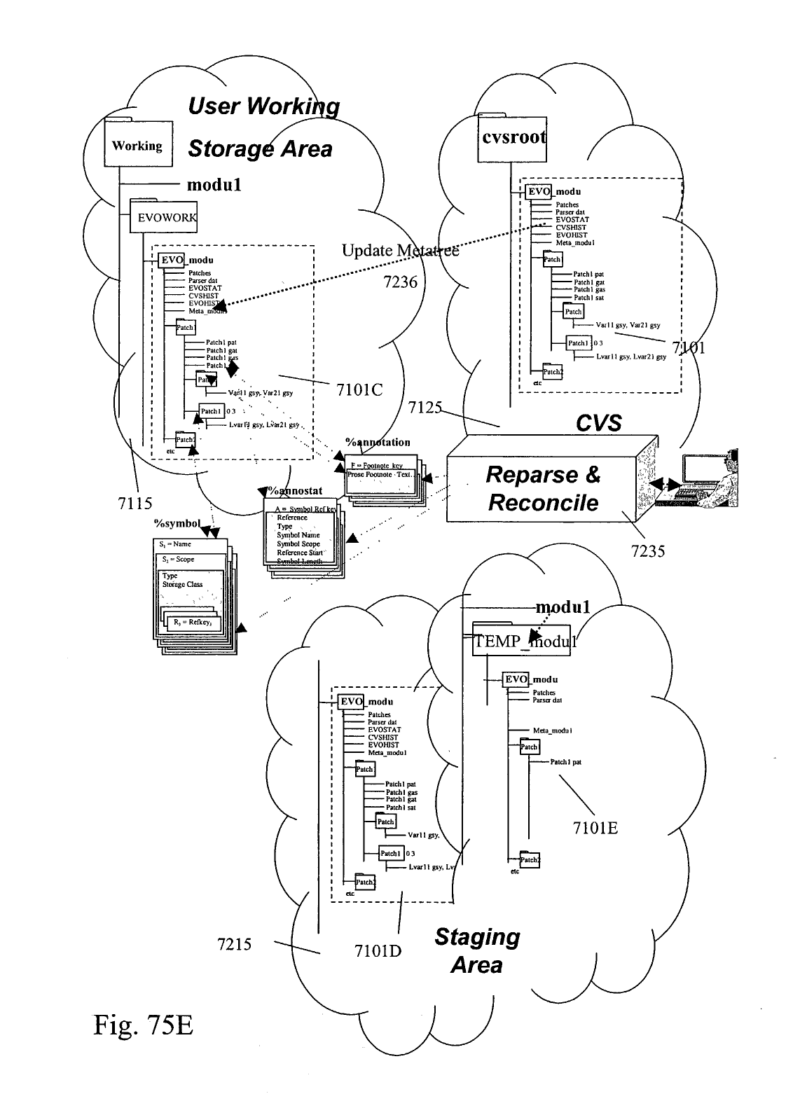

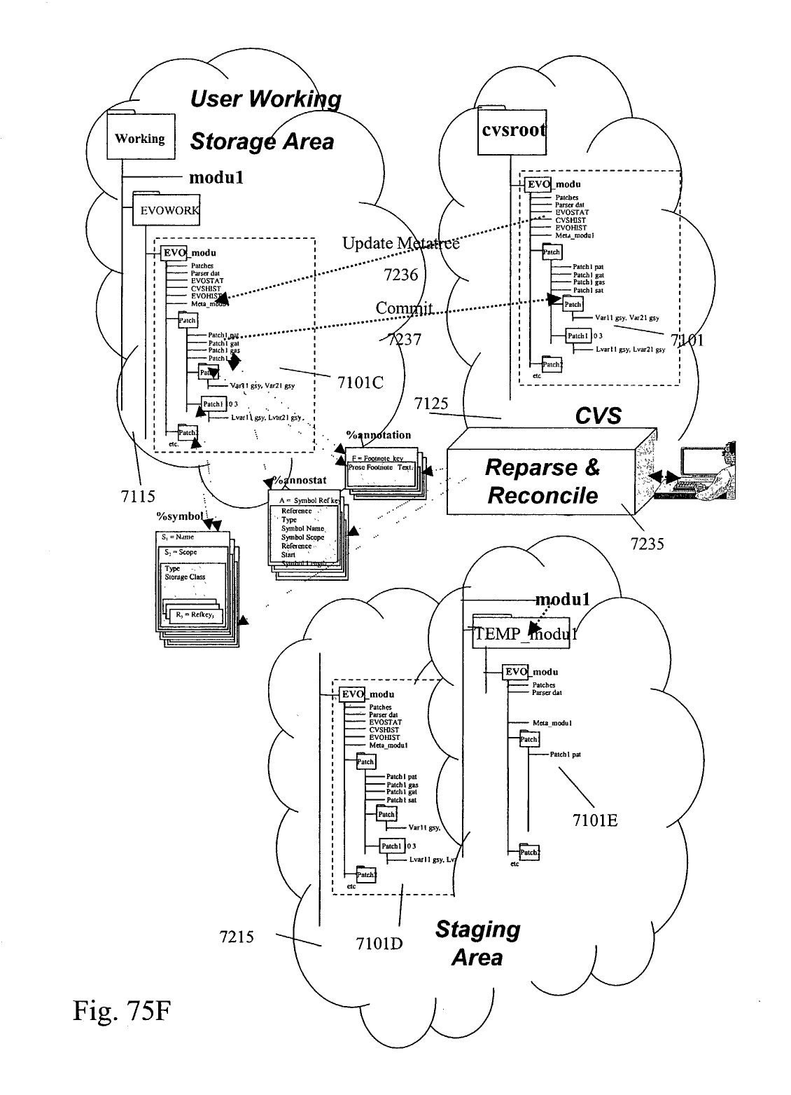

In generate patches operation 7231 (FIGS. 72 and 75A), the modified external program module file modu1 is copied to staging area 7215 and repartitioned into patches, without the assimilation associated with generating annotation. The patch-named subdirectories are created as before, but only files <patchname>.pat are written to denuded metatree 7101E. File patches in the root of denuded metatree 7101E is also updated. Denuded metatree 7101E is produced in a temporary directory TMP_<modu_name> in staging area 7215.

In modify metatree operation 7232, file patches and all of files <patchname>.pat in metatree 7101C, i.e., in the subdirectory EVO_modu1 in directory WORKING, are deleted. New file patches and all files <patchname>.pat are copied from denuded metatree 7101E to working metatree 7101C. Thus, any patches deleted in the revision disappear from working metatree 7101C. Also, since file patches is ordered according to the repartitioning, any patches reordered in source file modu1 from the ordering in metatree 7101 at the time of checkout are reordered in subsequent processing.

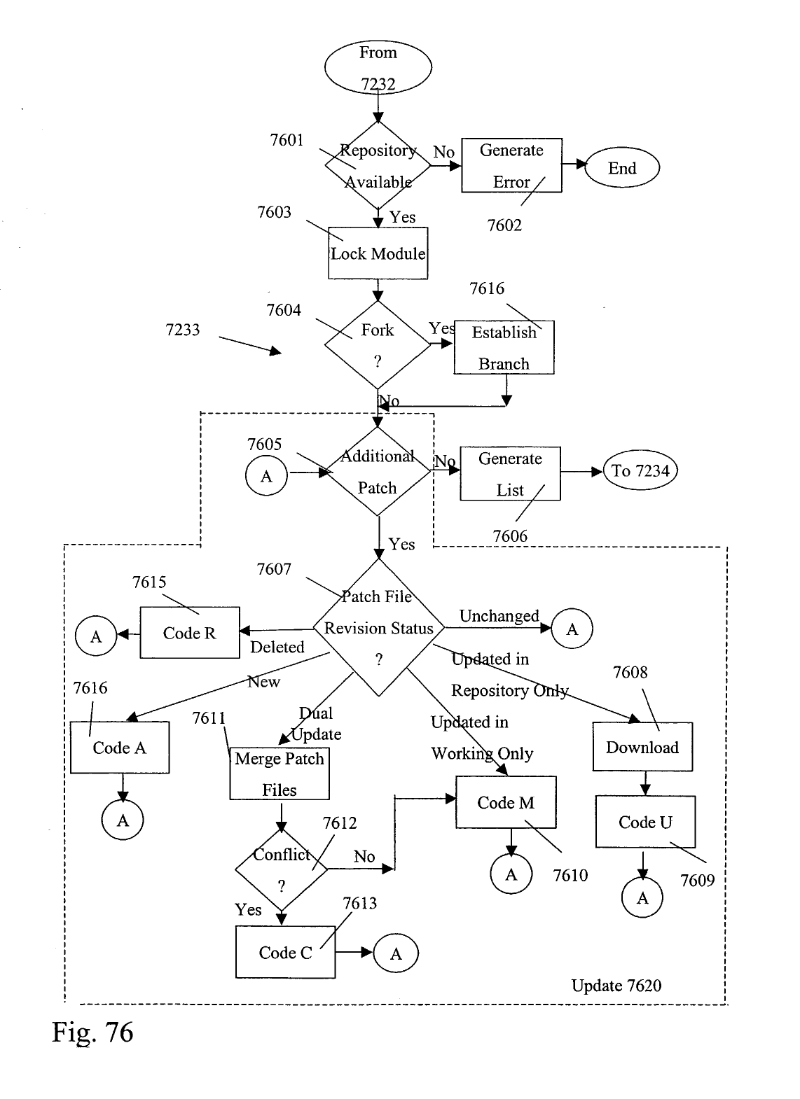

Update metatree patch files operation 7233 is a first of two CVS update operations performed to merge patch files from metatree 7101 in CVS repository 7125 into the equivalent files in metatree 7101C in user's working directory WORKING. The purpose of operation 7233 is to resolve any code change conflicts made by concurrent users. One embodiment of operation 7233 is illustrated in FIG. 76. This process involves five major sub-operations as described below.

In this embodiment, check-in operation 7134 require exclusive access to metatree 7101 in CVS repository 7125 Hence, repository available check operation 7601 determines whether there is a lock on file EVOSTAT in metatree 7101 for module modu1. If there is a lock, another user is in module check-in process 7134, and has exclusive access to metatree 7101 in CVS repository 7125. In this case, check operation 7601 transfers to generate error operation 7602.

In generate error operation 7602, module check-in process 7134 is aborted. A suitable message is generated informing the current user that another specifically named user has control of the CVS module for program source code modu1, and to try again later.

If there is not a lock on metatree 7101 for module modu1, check operation 7601 transfers to lock module operation 7603. In operation 7603, CVS command “cvs admin —1” is executed. This locks all files in metatree 7101 in CVS repository 7125, until CVS command commit is subsequently completed in commit operation 7237, which releases the lock. Operation 7603 transfers processing to fork check operation 7604.

Fork check operation 7604 determines whether command CHECK-IN includes a fork parameter, i.e., a request to create and check-in on a new branch. If command CHECK-IN included a fork parameter, check operation 7604 transfers to establish branch operation 7616 and otherwise to update operation 7620.

In establish branch operation 7616, CVS command cvs tag —b <branch-name> is executed to establish a new branch. This operation obviates the possibility of concurrency conflicts, as check-in operation 7134 now applies to a private branch. Operation 7616 transfers to update operation 7620.

In update operation 7620, a CVS command update is executed from inside subdirectory EVO_modu1 in working directory WORKING, with options set to exclude updating any files except files <patchname>.pat. One embodiment of update operation 7620 is illustrated in FIG. 76. Each file <patchname>.pat in metatree 7101 is sequentially compared with a corresponding file <patchname>.pat in metatree 7101C and actions taken based upon the comparison. Any files left in metatree 7101C are then processed as these are new files that are not found in metatree 7101 and actions taken as described below.

Hence, additional patch check operation 7605 determines whether each file <patchname>.pat has been processed in metatrees 7101 and 7101C. If a file <patchname>.pat remains to be processed, check operation 7605 transfers to patch file status check operation 7607.

Patch file status check operation 7607 compares a file <patchname>.pat in one metatree against files <patchname>.pat in the other metatree. If file <patchname>.pat in metatree 7101 and file <patchname>.pat in metatree 7101C are the same, i.e., file <patchname>.pat in metatree 7101 has not been changed, the file has not been revised. Any file <patchname>.pat that was unchanged in the revision is ignored by CVS and no information is conveyed about that file. Consequently, processing transfers from patch file revision status check operation 7607 to additional patch check operation 7605.

If file <patchname>.pat has been updated in metatree 7101, i.e., updated in CVS repository 7125, but file <patchname>.pat in metatree 7101C is an old version, check operation 7607 transfers to download operation 7608.

Download operation 7608 downloads file <patchname>.pat in metatree 7101 into metatree 7101C thereby overwriting the working copy. Download operation 7608 transfers to code U operation 7609. In code U operation 7609, the CVS returns a code U for file <patchname>.pat.

If file <patchname>.pat has been revised in metatree 7101C but not in metatree 7101 in CVS repository 7125, the revised copy is left untouched in update operation 7620. Hence, patch file revision status check operation 7607 transfers to code M operation 7610. In code M operation 7610, the CVS returns a code M for this file.

If file <patchname>.pat has been updated in metatree 7101 and also in metatree 7101C, check operation transfers to merge patch files operation 7611. In merge patch file operation 7611, file <patchname>.pat in metatree 7101 and is merged in the working copy of file <patchname>.pat in metatree 7101C. If there are no conflicts in the merge, merge operation 7611 simply transfers to conflict check operation 7612. Since no overlap (conflict) arose in the merge, conflict check operation 7612 transfers to code M operation 7610 that was described above.

If an overlap (conflict) arises in merge operation 7611, CVS writes the overlap text to show the differences between the repository version and the working copy version and transfers to conflict check operation 7612. Since there is a conflict, conflict check operation 7612 transfers to code C operation 7613. In code C operation 7613, the CVS returns a code C for this file.

If file <patchname>.pat does not exist in metatree 7101 of CVS repository 7125, but does exist in the working copy of metatree 7101C, patch file revision status check operation 7607 transfers to code A operation 7616. In code A operation 7616, the addition of file <patchname>.pat is acknowledged by the CVS update command returning a code A.

Finally, in update metatree patch files operation 7233, if file <patchname>.pat exists in metatree 7101 of CVS repository 7125, but does not exist in the working copy of metatree 7101C, patch file revision status check operation 7607 transfers to code R operation 7615. In code R operation 7615, the deletion of file <patchname>.pat is acknowledged by the CVS update command returning a code R.

Each of code operations 7609, 7610, 7613, 7615, and 7616 returns to additional patch check operation 7605. When all of the patch files have been processed, additional patch check operation 7605 transfers processing to generate list operation 7606.

In generate list operation 7606, the CVS update command output codes are interpreted to create a list of revised patches that are processed in the subsequent operations of check-in operation 7134. Generate list operation 7606 transfers to resolve conflicts operation 7234 (FIG. 72 and 75C).

If the list of the revised files <patchname>.pat for which conflicts between concurrent revisions must be resolved is empty, conflicts operation 7234 is skipped and processing passes from operation 7606 to reparse and reconcile operation 7235. Otherwise, if the list of the revised files <patchname>.pat for which conflicts between concurrent revisions must be resolved is not empty, operation 7234 presents the user with all the overlapped text formats that must be resolved and the user is required to select one of the following choices before correcting any of the conflicts:

1) Abort module check-in process 7134 for offline study leaving metatree 7101, i.e., the CVS module, unlocked;

2) Abort module check-in process 7134 for offline study leaving metatree 7101, i.e., the CVS module, locked;

3) Fork a new branch from the checked-out version, and perform module check-in process 7134 on this new branch; and

4) Fork an experimental branch from the repository's current version and immediately resolve concurrent conflicts; and

5) Immediately resolve concurrent conflicts.

One embodiment of each of these options is described immediately below.

Abort module check-in process 7134 for offline study leaving metatree 7101 unlocked causes metatree 7101 in CVS repository 7125 to be unlocked so that others are free to access metatree 7101 while the study is ongoing. Current module check-in process 7134 is aborted, and whenever the user decides to continue module check-in process 7134, all of the operations are as if the current module check-in process 7134 had not been attempted. Meanwhile, the user can edit the conflicted patches as dictated by the concurrent changes and test them, before issuing a new command CHECK-IN. Of course, new concurrent changes may occur in the meantime, and the user may elect to continue with this same option, or any of the other options.

Abort module check-in process 7134 for offline study leaving metatree 7101 locked sets a flag (creates a flagfile). The next time module check-in process 7134 is requested for this CVS module, all prior operations in module check-in process 7134, i.e., operations 7231 to 7234 are skipped. After this flag has been set, module check-in process 7134 is aborted. The user can edit the conflicted patches as dictated by the concurrent changes and test them, before issuing a new command CHECK-IN.

Fork a branch from the checked-out version, and perform module check-in process 7134 on this branch causes the concurrent changes that caused the conflict, as well as any concurrent changes that did not conflict, to be disregarded. To remove the effects of update metatree patch files operation 7233, all of files <patchname>.pat in working metatree 7101C are deleted and all files <patchname>.pat from the cloned copy of the metatree in the staging area are copied to the working metatree, effectively nullifying modify metatree operation 7232 (above) and update metatree patch files operation 7233. Then, modify metatree operation 7232 is repeated, but update metatree patch files 7233 is not repeated. Module check-in process 7134 sets up a new branch as requested, and process 7134 is continued.

In fork an experimental branch from the repository's current version of the CVS module and immediately resolve concurrent conflicts is selected, a new branch off the version containing the concurrent conflicts is set up. The user is presented an editing process to resolve the conflicts, after which module check-in process 7134 continue on the experimental branch. The lock on the metatree in CVS repository 7125 is released. If the user later wants to check-in the version on the experimental branch, an operation join is used to merge the two branches.

In immediately resolve concurrent conflicts, the user is presented an editing process in which to resolve the conflicts and then continue the operations in module check-in process 7134.

In the options to resolve conflicts that include a fork, controller 120B issues a CVS command to fork a new branch. A user-supplied branch tag is used, or if none is given, the branch tag is generated by extending the version tag in file EVOSTAT, derived from the EVOSTAT revision. The CVS command “cvs tag —b <branch-name>” is executed to establish a new branch. This new tag becomes sticky, so that future checkouts and check-ins are on this branch by default, until the default is explicitly changed. The third and fourth lines of file EVOSTAT are updated to include this version tag and branch tag.

If no fork is requested, but conflicted patches resulted, controller 120B opens an editing process for the user to resolve the conflicts. This involves the user editing each patch to unify the separated file difference display sections in the files <patchname>.pat in the conflicts list.

Upon completion of resolving the conflicts in operation 7234, processing transfers to reparse and reconcile operation 7235 in module check-in process 7134.

In reparse and reconcile operation 7235 (FIGS. 72 and 75D), controller 120B reconciles all of the changes in annotation brought about by the revisions to the patches. Operation 7235 includes the following operations:

1) Files <patchname>.dif are generated in the staging area 7215 for each revised patch by running a file comparison utility (e.g., Unix operating system utility diff) between the as checked out and the edited (revised) versions of the patch files <patchname>.pat.

2) The metacontext, i.e., the full content of hashes %annotation, %annostat, and %symbol is loaded into memory from the hash files in metatree 7101C in the user's working directory to setup the state of the parser's in-memory database to the condition corresponding to the checkout state of the program module file and its auto-generic and auto-specific annotation, and the current state of the web annotator-supplied application-specific, e.g., manual-specific, annotation. This metacontext is cleaned for all of the revised patches detected in update metatree patch files operation 7233. This cleaning deletes all data entries of hashes %symbol, and %annostat pertaining to the revised patches, and deletes all of the auto-generic and auto-specific entries of hash %annotation pertaining to the revised patches, but leaves the manual-specific entries.

3) Each of the revised patches is reparsed within the cleaned metacontext using the metacompiler-generated parser-hasher referenced in file parser.dat in the metatree root, causing the associative array memory data-structures (hashes) to be updated. This process replenishes the data objects of the metacontext to incorporate all of the auto-generic and auto-specific annotation changes resulting from the revised patches.

Next a reconciliation procedure is executed for each of the revised patches to reconcile all of the application-specific footnote annotation reference keys and values in the metacontext that were impacted by line shifts and source text changes; and to elicit, via a GUI dialog, new auto-specific annotation (from the programmer) with respect to the changes made. This reconciliation procedure is made up of several operations as detailed below.

1) Prior application-specific annotation, manually added via the web annotator, is read from file <patchname>.sat into a temporary patch-specific associative array(hash) %annota, which is a subset of the module-global associative array (hash) %annotation resident in the metacontext.

2) File <patchname>.dif is interpreted to generate reconciliation tables: two table arrays @oldfile and @newfile indexed by the respective line numbers that contain either (i) defined entry rows containing:

a. equivalent line number in the other file (@oldfile or @newfile) or undef if none;

b. revision case: same (not revised), changed, or added;

c. source text content if changed or undef otherwise;

or (ii) undef (no corresponding line in the other file, @oldfile-deleted or @newfile-added).

3) For each old key indexing contents of file <patchname>.sat (each entry in hash %annota), the corresponding metacontext keyed entry in the hash %annotation is deleted and a new keyed entry is constructed and entered as follows:

a. The old-line number, column number, and letter are extracted from the old key;

b. If a row for this line-number is defined in table @oldfile, the new line-number, revision case, and source text, if any, are extracted from table @oldfile entry.

(1) If the revision case is same, a new key is constructed using the patchname, equivalent line number (in the new file), old column number, and the letter tag (if any), and the annotation message from the corresponding entry of file <patchname>.sat is entered into the metacontext in hash %annotation using the new key.

(2) Else (revision case is changed) the changed source text is retrieved from table @newfile indexed by the equivalent line number. A user dialog is then initiated showing the old source text, the new source text replacing it, and the old annotation message (the entry in file <patchname>.sat for the old key), and the user is asked to update the annotation message. A new key is constructed using the patchname, equivalent line number (in the new file), old column number, and the letter tag (if any), and the annotation message from the dialog is entered into the metacontext in hash %annotation using the new key. If no annotation message was returned in the dialog, a suitable comment, such as “none specified” is entered using the new key instead. The results of this dialog (old source text, new source text, old annotation message and new annotation message) are recorded in the metacontext in an associative array (hash) %detailed_log using a key, which is a concatenation of the old key and the new key with an intervening connecting symbol, such as —>. This detailed log is later accumulated and appended to detailed history file EVOHIST. This permanently records for management review the programmers' responses to the opportunity for documentation updating.

4) For each row of table @newfile in which the equivalent line number is undef (e.g., there is no equivalent line in the old file) a user dialog is initiated showing the source text of the new line, and the user is asked to provide a footnote annotation message for the new source text insertion. The result of the dialog, including the column number of the footnote, and the annotation message are used to construct an entry to update the metacontext in hash %annotation. If no annotation message was returned in the dialog, a suitable comment, such as “none specified” is entered using the new key instead. The results of this dialog (new source text and new annotation message) are recorded in hash %detailed_log using a key, which is hash %annotation-key postpended with an “insertion” symbol, such as <—. As above, hash %detailed_log is accumulated and later appended to detailed history file EVOHIST.

Next, a user dialog is initiated for each of the revised patches to elicit a description and synopsis response to update this information for the patch in the metacontext. A summary log of this response also is recorded for later inclusion in the output log file.

Next, the metacontext, now with all reconciliation complete, is written (exploded) into the metatree in the working directory. For all patches in the metatree, the summary logs and detailed logs for this revision are written to a temporary logfile (a hash file) in the staging area, to be subsequently appended to file EVOHIST.

Upon completion of the reconciliation process, operation 7235 transfers processing to update metatree operation 7236. In update metatree operation 7236, (FIGS. 72 and 75E) the CVS update command is executed again from inside the metatree subdirectory of the working directory, with the same arguments as operation 7233 above except with options directing that all files in the metatree are included in the update. This process clears the CVS gate for the final commit operation, completing the CVS portion of module check-in process 7134.

Next, controller 120B consults file EVOSTAT, returned from the last CVS update command. The revision number and tag (if any) from the RCS expansion of the imbedded $Id$ and $Name$ keywords are converted to version tag and branch tag, and rewritten to file EVOSTAT in lines 3 and 4. Upon completion of operation 7236, processing transfers to commit operation 7237.

In commit operation 7237, controller 120B processes the arguments in the command check-in to set the CVS commit options. If a base version number advance is called for (incrementing <base> in revision number <base>.<revision>), a CVS tag command is executed using the current version tag in the third line of file EVOSTAT as the symbolic tag. This permits later checkouts and branch forking from the last revision of the current base, after the base has changed.

In an alternate embodiment, only the pat files, .sat files, and tat files are maintained by CVS in the CVS repository, and the remaining (generated) files are reproduced by performing an assemble operation on the .pat files to reaggregate them into module files; then the module files are reparsed and exploded into the cradle metatree. In this alternate embodiment (applicable to very large modules and web-remote CVS repositories), the CVS processing load is significantly reduced, as it has far fewer files to manage.

Next, the CVS commit command is executed, causing advancement of the revision number, and releasing the lock on the repository version of the current metatree.

If a base version number advancement was made, a CVS command rtag is executed with an advanced version tag corresponding to the advanced CVS revision number. This permits later checkouts and branch forking from the first revision of the new base, after revisions have advanced beyond it.

Next the logfile created, as described above is updated to prepend the new versions number to all of its record keys, and the file is appended to file EVOHIST. This completes the module check-in process 7134.

Permanent and Temporary Annotation Archiving

Manual annotation added to a metatree and its corresponding generated webpages, can be of two categories, as introduced above: (i) permanent annotation, comprising manually-edited auto-specific annotation and manual-specific annotation, which is stored in sat files, and (ii) temporary annotation, comprising collaborative notes posted to the website by user groups for communication about the source information in the website, which are stored in .tat files.

Permanent annotation is historically maintained by unscheduled check-in events to archive changes in the source maintenance controller repository, as required in evolutionary maintenance. As these check-in events may require manual reconciliation of annotation to match code changes, they cannot be fully automatic.

Temporary annotation, being identified by unique keys incorporating user and group/topic names with date-time-stamps, and having limited lifetime, may be archived automatically by the source maintenance controller, as each temporary annotation is an addition, not a replacement for prior temporary annotation. These annotations are checked-in by the source maintenance controller on a fixed periodic basis, usually daily on a worldwide basis (e.g. 00:00 GMT). Immediately following this periodic check-in event, an appropriate web annotator agent is called to compare the expiration time of the group/topic to the current time, and if the current time exceeds the expiration time, the agent removes all of the notes belonging to the group/topic, and regenerates all of the affected webpages.

In general, a revision control system that requires revision control on both annotations for source information and the source information can be implemented in a variety of ways in view of this disclosure. An important aspect is to manage both the revisions and the documentation for the revisions in a way that facilitates the use of the rapid comprehension documentation and the tools described above for use with that documentation.

In particular, the revision control system includes means for detecting changes to said source information, and means for finding annotations corresponding to said changes. The revision control system also includes means for presenting to a user an opportunity for revising said annotations to match the changes. Finally, the revision control system includes maintaining a log of revisions made by said user. The means for providing this functionality is implemented in one embodiment by executing computer program code on one or more computer processors. In another embodiment, a combination of hardware circuitry and executing computer program instructions is utilized. As is known to those of skill in the art, the tradeoffs between circuitry and program execution are based on performance requirements.

The above embodiment for detecting changes, finding annotations, revising annotations and maintaining a log is illustrative only and is not intended to limit the invention to this specific embodiment. In view of this disclosure, those of skill in the art can implement the revision control system in a wide variety of ways.

This application is related to the following commonly assigned and commonly filed U.S. Patent Applications, each of which is incorporated herein by reference in its entirety:

1. U.S. patent application Ser. No. 10/xxx,xxx entitled “COMPUTER-BASED STRUCTURES AND METHODS FOR GENERATING, MAINTAINING, AND MODIFYING A SOURCE DOCUMENT AND RELATED DOCUMENTATION,” of Joseph M. Thames and Steven W. Duckett (Attorney Docket No. META 1001);

2. U.S. patent application Ser. No. 10/xxx,xxx entitled “A SOURCE INFORMATION ADAPTER AND METHOD FOR USE IN GENERATING A COMPUTER MEMORY-RESIDENT HIERARCHICAL STRUCTURE FOR ORIGINAL SOURCE INFORMATION,” of Joseph M. Thames and Steven W. Duckett (Attorney Docket No. META 1002);

3. U.S. patent application Ser. No. 10/xxx,xxx entitled “A COMPUTER-BASED METHOD FOR DEFINING A PATCH IN COMPUTER SOURCE CODE INCLUDING CONDITIONAL COMPILATION CELL GROUPS,” of Joseph M. Thames and Steven W. Duckett (Attorney Docket No. META 1003);

4. U.S. patent application Ser. No. 10/xxx,xxx entitled “A COMPUTER-BASED METHOD FOR PARSING AND HASHING SOURCE INFORMATION INCLUDING A COMBINED GRAMMAR,” of Joseph M. Thames and Steven W. Duckett (Attorney Docket No. META 1004);

5. U.S. patent application Ser. No. 10/xxx,xxx entitled “A HYPERTEXT PAGE GENERATOR FOR A COMPUTER MEMORY-RESIDENT RAPID COMPREHENSION DOCUMENT FOR ORIGINAL SOURCE INFORMATION, AND METHOD,” of Joseph M. Thames and Steven W. Duckett (Attorney Docket No. META 1006);

6. U.S. patent application Ser. No. 10/xxx,xxx entitled “A COMPUTER MEMORY-RESIDENT RAPID COMPREHENSION DOCUMENT FOR ORIGINAL SOURCE INFORMATION, AND METHOD,” of Joseph M. Thames and Steven W. Duckett (Attorney Docket No. META 1007);

7. U.S. patent application Ser. No. 10/xxx,xxx entitled “A COMPUTER-BASED USER INTERFACE FOR A MEMORY-RESIDENT RAPID COMPREHENSION DOCUMENT FOR ORIGINAL SOURCE INFORMATION,” of Joseph M. Thames and Steven W. Duckett (Attorney Docket No. META 1008);

8. U.S. patent application Ser. No. 10/xxx,xxx entitled “A WEBPAGE ANNOTATOR FOR A COMPUTER MEMORY-RESIDENT RAPID COMPREHENSION DOCUMENT FOR ORIGINAL SOURCE INFORMATION, AND METHOD,” of Joseph M. Thames and Steven W. Duckett (Attorney Docket No. META 1009); and

9. U.S. patent application Ser. No. 10/xxx,xxx entitled “A REVISION CONTROL SYSTEM FOR AT LEAST ONE METATREE THAT REQUIRES LOCKSTEP DOCUMENTATION FOR ANY MODIFICATION TO THE INFORMATION IN THE AT LEAST ONE METATREE,” of Joseph M. Thames and Steven W. Duckett (Attorney Docket No. META 1010).

We claim:

1. A computer memory having stored therein a structure comprising:
original source information; and
auto-generically generated interpretative information wherein said auto-generically generated interpretive information is automatically generated upon processing of said original source information.

2. The computer memory of claim 1 wherein said structure comprises a metatree.

3. The computer memory of claim 2 wherein said structure further comprises a global metatree.

4. The computer memory of claim 2 wherein said metatree further comprises:
a root directory for a module in said original source information.

5. The computer memory of claim 4 wherein said metatree further comprises:
a globalized statistics hash file in said root directory.

6. The computer memory of claim 4 wherein said metatree further comprises:
a globalized symbol hash file in said root directory.

7. The computer memory of claim 4 wherein said metatree further comprises:
an at location file in said root directory wherein said at location file includes metatree paths.

8. The computer memory of claim 4 wherein said metatree further comprises:
a plurality of patch subdirectories in said root directory where each patch subdirectory stores source information for that patch, and stores auto-generically generated interpretative information for said source information for that patch.

9. The computer memory of claim 8 wherein said metatree further comprises:
a patch file in one patch subdirectory wherein said patch file comprises original source information of one patch in said module.

10. The computer memory of claim 8 wherein said metatree further comprises:
a symbol reference statistics file in one patch subdirectory wherein said symbol reference statistics file comprises name symbol reference statistics data for name symbols referring to elements in said original source information of one patch in said module.

11. The computer memory of claim 10 wherein said symbol reference statistics file comprises a hash file.

12. The computer memory of claim 8 wherein said metatree further comprises:
a generic annotation file in one patch subdirectory wherein said generic annotation file comprises auto-generically generated interpretative information for said original source information in one patch in said module.

13. The computer memory of claim 12 wherein said generic annotation file further comprises:
specific interpretative information for said original source information in one patch in said module wherein said specific interpretative information was included in said original source information in one patch in said module.

14. The computer memory of claim 12 wherein said generic annotation file comprises a hash file.

15. The computer memory of claim 8 wherein said metatree further comprises:
an application specific annotation file in one patch subdirectory wherein said application specific annotation file comprises specific interpretative information for said original source information in one patch in said module.

16. The computer memory of claim 15 wherein said specific interpretative information for said original source information in one patch in said module was added by a user of said metatree.

17. The computer memory of claim 15 wherein said application specific annotation file comprises a hash file.

18. The computer memory of claim 8 wherein said metatree further comprises:
a set of scope subdirectories in one patch subdirectory wherein each scope subdirectory in said set is defined by a namespace for a set of name symbols.

19. The computer memory of claim 18 wherein said each scope subdirectory includes a file for each name symbol belonging to a scope for said each scope subdirectory.

20. The computer memory of claim 18 wherein each scope subdirectory includes:
a scope generic annotation file wherein said scope generic annotation file comprises auto-generically generated interpretative information for said name symbols.

21. The computer memory of claim 20 wherein said scope generic annotation file further comprises interpretative information for at least one of said name symbols wherein said interpretative information was included in said original source information in said module.

22. The computer memory of claim 20 wherein said scope generic annotation file comprises a hash file.

23. The computer memory of claim 18 wherein each scope subdirectory includes:
a scope application specific annotation file wherein said scope application specific annotation file comprises specific interpretative information for said name symbols.

24. The computer memory of claim 23 wherein said specific interpretative information for said name symbols was added by a user of said metatree.

25. The computer memory of claim 8 wherein said metatree further comprises:
a set of scope subdirectories in one patch subdirectory wherein each scope subdirectory in said set is defined by a namespace for a set of variable symbols.

26. The computer memory of claim 25 wherein said each scope subdirectory includes a file for each symbol belonging to a scope for said each scope subdirectory.

27. The computer memory of claim 25 wherein each scope subdirectory includes:
a scope generic annotation file wherein said scope generic annotation file comprises auto-generically generated interpretative information for said variable symbols.

28. The computer memory of claim 27 wherein said scope generic annotation file further comprises interpretative information for at least one of said variable symbols wherein said interpretative information was included in said original source information in said module.

29. The computer memory of claim 27 wherein said scope generic annotation file comprises a hash file.

30. The computer memory of claim 25 wherein each scope subdirectory includes:
a scope application specific annotation file wherein said scope application specific annotation file comprises specific interpretative information for said variable symbols.

31. The computer memory of claim 30 wherein said specific interpretative information for said variable symbols was added by a user of said metatree.

32. The computer memory as in any one of claims 4 to 31 wherein said metatree is an undifferentiated metatree.

33. The computer memory as in any one of claims 4 to 31 wherein said metatree is a diversion metatree.

34. The computer memory of claim 3 wherein said global metatree further comprises a plurality of module subdirectories.

35. The computer memory of claim 3 wherein said global metatree further comprises a set of files including one file for each global name symbol contained in said original source information.

36. The computer memory as in any one of claims 34 and 35 wherein said global metatree is an undifferentiated global metatree.

37. The computer memory as in any one of claims 34 to 35 wherein said global metatree is a diversion global metatree.

38. A computer memory having stored therein a structure comprising:
a metatree further comprising:
a root directory for a module in said original source information; and
a plurality of patch subdirectories in said root directory where each patch subdirectory stores source information for that patch, and
stores auto-generically generated interpretative information for said source information for that patch.

39. The computer memory of claim 38 wherein said metatree further comprises:
a patch file in one patch subdirectory wherein said patch file comprises original source information of one patch in said module.

40. The computer memory of claim 38 wherein said metatree further comprises:
a symbol reference statistics file in one patch subdirectory wherein said symbol reference statistics file comprises symbol reference statistics data for name symbols referring to elements in said original source information of one patch in said module.

41. The computer memory of claim 40 wherein said symbol reference statistics file comprises a hash file.

42. The computer memory of claim 40 wherein said metatree further comprises:
a generic annotation file in one patch subdirectory wherein said generic annotation file comprises auto-generically generated interpretative information for said original source information in one patch in said module.

43. The computer memory of claim 42 wherein said generic annotation file further comprises:
specific interpretative information for said original source information in one patch in said module wherein said specific interpretative information was included in said original source information in one patch in said module.

44. The computer memory of claim 42 wherein said generic annotation file comprises a hash file.

45. The computer memory of claim 42 wherein said metatree further comprises:
an application specific annotation file in one patch subdirectory wherein said application specific annotation file comprises specific interpretative information for said original source information in one patch in said module.

46. The computer memory of claim 45 wherein said specific interpretative information for said original source information in one patch in said module was added by a user of said metatree.

47. The computer memory of claim 45 wherein said application specific annotation file comprises a hash file.

48. The computer memory of claim 44 wherein said metatree further comprises:
a set of scope subdirectories in one patch subdirectory wherein each scope subdirectory in said set is defined by a namespace for a set of name symbols.

49. The computer memory of claim 44 wherein said each scope subdirectory includes a file for each name symbol belonging to a scope for said each scope subdirectory.

50. The computer memory of claim 38 wherein said structure further comprises a global metatree.

51. The computer memory of claim 50 wherein said global metatree further comprises a plurality of module subdirectories.

52. The computer memory of claim 50 wherein said global metatree further comprises a set of files including one file for each global name symbol contained in said original source information.

53. A computer memory having stored therein a structure comprising:
a metatree further comprising:
a root directory for a module in a computer program source file;
a patch subdirectory in said root directory;
a patch file in said patch subdirectory wherein said patch file comprises original source code of one patch in said module;
a symbol reference statistics file in said patch subdirectory wherein said symbol reference statistics file comprises symbol reference statistics data for name symbols referring to elements in said original source code of said patch in said module;
a generic annotation file in said patch subdirectory wherein said generic annotation file comprises auto-generically generated interpretative information for said original source code in said patch in said module;
an application specific annotation file in said patch subdirectory wherein said application specific annotation file comprises specific interpretative information for said original source code in one patch in said module; and
a set of scope subdirectories in said patch subdirectory wherein each scope subdirectory in said set is defined by a namespace for a set of name symbols wherein said each scope subdirectory includes a file for each name symbol belonging to a scope for said each scope subdirectory.

54. The computer memory of claim 53 wherein said structure further comprises a global metatree.

55. The computer memory of claim 54 wherein said global metatree further comprises a plurality of module subdirectories.

56. The computer memory of claim 55 wherein said global metatree further comprises a set of files including one file for each global name symbol contained in said computer program source file.
